(19) United States
(12) Patent Application Publication
(10) Pub. No.: US 2024/0284375 A1
(43) Pub. Date: Aug. 22, 2024

(54) Logical Channel Prioritization for Reporting Delay Information

(71) Applicant: Comcast Cable Communications, LLC, Philadelphia, PA (US)

(72) Inventors: Mohammad Ghadir Khoshkholgh Dashtaki, Burnaby (CA); Ali Cagatay Cirik, Chantilly, VA (US); Esmael Hejazi Dinan, McLean, VA (US); Hsin-Hsi Tsai, Taichung City (TW); Hyoungsuk Jeon, Centreville, VA (US)

(21) Appl. No.: 18/443,867

(22) Filed: Feb. 16, 2024

Related U.S. Application Data
(60) Provisional application No. 63/446,119, filed on Feb. 16, 2023.

(51) Int. Cl. H04W 56/00; H04L 5/00

(52) U.S. Cl. CPC H04W 56/0065; H04L 5/0053

(57) ABSTRACT

One or more methods, apparatuses, computer-readable storage mediums, and systems for reporting delay information. One or more wireless devices may communicate with a base station in a wireless network. Logical channel configuration parameters may be used to trigger a reporting procedure in the one or more wireless devices. A report (e.g., reporting delay information) may be generated and sent to the base station based on the logical channel configuration parameters.

### CROSS-REFERENCE TO RELATED APPLICATIONS

This application claims the benefit of U.S. Provisional Application No. 63/446,119, filed on Feb. 16, 2023. The above referenced application is hereby incorporated by reference in its entirety.

### BACKGROUND

In a wireless communication system, wireless devices communicate with a base station. A wireless device performs a reporting procedure to provide a base station and/or a network with information associated with communication data in the wireless device.

### SUMMARY

The following summary presents a simplified summary of certain features. The summary is not an extensive overview and is not intended to identify key or critical elements.

One or more wireless devices may communicate with a base station in a wireless network. Logical channel configuration parameters may be used to trigger a reporting procedure in the one or more wireless devices. A report (e.g., reporting delay information and/or remaining time threshold) may be generated based on the logical channel configuration parameters. The report may allow the one or more wireless devices to timely inform the base station about the delay budget of the upload data. The base station may properly allocate enough upload resources for the one or more wireless devices to efficiently (e.g., without wasting the upload resources) to send the data before violating the delay budget of the upload data.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1A and FIG. 1B show example communication networks.

FIG. 2A shows an example user plane.

FIG. 2B shows an example control plane configuration.

FIG. 3 shows example of protocol layers.

FIG. 4A shows an example downlink data flow for a user plane configuration.

FIG. 4B shows an example format of a Medium Access Control (MAC) subheader in a MAC Protocol Data Unit (PDU).

FIG. 5A shows an example mapping for downlink channels.

FIG. 5B shows an example mapping for uplink channels.

FIG. 6 shows example radio resource control (RRC) states and RRC state transitions.

FIG. 7 shows an example configuration of a frame.

FIG. 8 shows an example resource configuration of one or more carriers.

FIG. 9 shows an example configuration of bandwidth parts (BWPs).

FIG. 10A shows example carrier aggregation configurations based on component carriers.

FIG. 10B shows example group of cells.

FIG. 11A shows an example mapping of one or more synchronization signal/physical broadcast channel (SS/PBCH) blocks.

FIG. 11B shows an example mapping of one or more channel state information reference signals (CSI-RSs).

FIG. 12A shows examples of downlink beam management procedures.

FIG. 12B shows examples of uplink beam management procedures.

FIG. 13A shows an example four-step random access procedure.

FIG. 13B shows an example two-step random access procedure.

FIG. 13C shows an example two-step random access procedure.

FIG. 14A shows an example of control resource set (CORESET) configurations.

FIG. 14B shows an example of a control channel element to resource element group (CCE-to-REG) mapping.

FIG. 15A shows an example of communications between a wireless device and a base station.

FIG. 15B shows example elements of a computing device that may be used to implement any of the various devices described herein.

FIG. 16A, FIG. 16B, FIG. 16C, and FIG. 16D show examples of uplink and downlink signal transmission.

FIG. 17A shows a method/procedure for sending (e.g., transmitting) delay information in wireless communications systems.

FIG. 17B shows a method/procedure for sending (e.g., transmitting) delay information in wireless communications systems.

FIG. 18 shows an example of a logical channel prioritization (LCP) procedure in wireless communications systems.

FIG. 19 shows an example embodiment of a logical channel prioritization (LCP) procedure.

FIG. 20 shows an example of priority (e.g., a logical channel priority) of a MAC CE for delay information.

FIG. 21 shows an example of a logical channel prioritization (LCP) procedure in wireless communications systems.

FIG. 22 shows an example embodiment of a logical channel prioritization (LCP) procedure.

FIG. 23 shows an example of priority (e.g., a logical channel priority) of an enhanced BSR MAC CE.

FIG. 24 shows a method/procedure for prioritization of BSR in wireless communications systems.

FIG. 25 shows an example of a logical channel prioritization (LCP) procedure.

FIG. 26 shows an example of a logical channel prioritization (LCP) procedure.

FIG. 27 shows an example of priority (e.g., a logical channel priority) of a MAC CE for prioritized BSR.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of wireless communication systems.

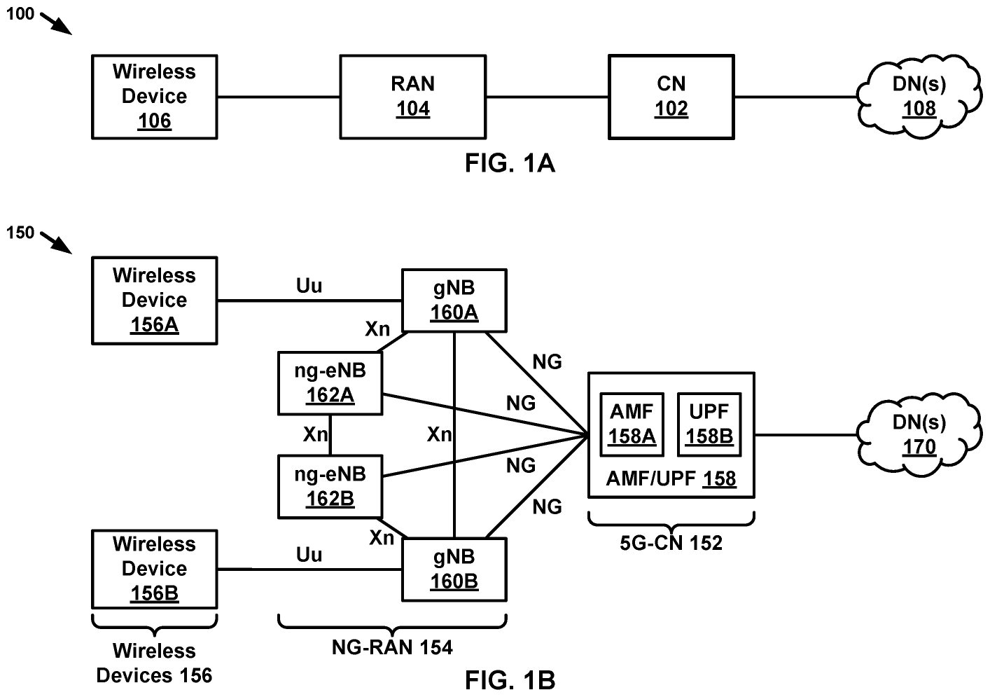

FIG. 1A shows an example communication network 100. The communication network 100 may comprise a mobile communication network). The communication network 100 may comprise, for example, a public land mobile network (PLMN) operated/managed/run by a network operator. The communication network 100 may comprise one or more of a core network (CN) 102, a radio access network (RAN) 104, and/or a wireless device 106. The communication network 100 may comprise, and/or a device within the communication network 100 may communicate with (e.g., via CN 102), one or more data networks (DN(s)) 108. The wireless device 106 may communicate with one or more DNs 108, such as public DNs (e.g., the Internet), private DNs, and/or intra-operator DNs. The wireless device 106 may communicate with the one or more DNs 108 via the RAN 104 and/or via the CN 102. The CN 102 may provide/configure the wireless device 106 with one or more interfaces to the one or more DNs 108. As part of the interface functionality, the CN 102 may set up end-to-end connections between the wireless device 106 and the one or more DNs 108, authenticate the wireless device 106, provide/configure charging functionality, etc.

The wireless device 106 may communicate with the RAN 104 via radio communications over an air interface. The RAN 104 may communicate with the CN 102 via various communications (e.g., wired communications and/or wireless communications). The wireless device 106 may establish a connection with the CN 102 via the RAN 104. The RAN 104 may provide/configure scheduling, radio resource management, and/or retransmission protocols, for example, as part of the radio communications. The communication direction from the RAN 104 to the wireless device 106 over/via the air interface may be referred to as the downlink and/or downlink communication direction. The communication direction from the wireless device 106 to the RAN 104 over/via the air interface may be referred to as the uplink and/or uplink communication direction. Downlink transmissions may be separated and/or distinguished from uplink transmissions, for example, based on at least one of: frequency division duplexing (FDD), time-division duplexing (TDD), any other duplexing schemes, and/or one or more combinations thereof.

As used throughout, the term “wireless device” may comprise one or more of: a mobile device, a fixed (e.g., non-mobile) device for which wireless communication is configured or usable, a computing device, a node, a device capable of wirelessly communicating, or any other device capable of sending and/or receiving signals. As non-limiting examples, a wireless device may comprise, for example: a telephone, a cellular phone, a Wi-Fi phone, a smartphone, a tablet, a computer, a laptop, a sensor, a meter, a wearable device, an Internet of Things (IoT) device, a hotspot, a cellular repeater, a vehicle road side unit (RSU), a relay node, an automobile, a wireless user device (e.g., user equipment (UE), a user terminal (UT), etc.), an access terminal (AT), a mobile station, a handset, a wireless transmit and receive unit (WTRU), a wireless communication device, and/or any combination thereof.

The RAN 104 may comprise one or more base stations (not shown). As used throughout, the term “base station” may comprise one or more of: a base station, a node, a Node B (NB), an evolved NodeB (CNB), a gNB, an ng-eNB, a relay node (e.g., an integrated access and backhaul (IAB) node), a donor node (e.g., a donor eNB, a donor gNB, etc.), an access point (e.g., a Wi-Fi access point), a transmission and reception point (TRP), a computing device, a device capable of wirelessly communicating, or any other device capable of sending and/or receiving signals. A base station may comprise one or more of each element listed above. For example, a base station may comprise one or more TRPs. As other non-limiting examples, a base station may comprise for example, one or more of: a Node B (e.g., associated with Universal Mobile Telecommunications System (UMTS) and/or third-generation (3G) standards), an Evolved Node B (eNB) (e.g., associated with Evolved-Universal Terrestrial Radio Access (E-UTRA) and/or fourth-generation (4G) standards), a remote radio head (RRH), a baseband processing unit coupled to one or more remote radio heads (RRHs), a repeater node or relay node used to extend the coverage area of a donor node, a Next Generation Evolved Node B (ng-cNB), a Generation Node B (gNB) (e.g., associated with NR and/or fifth-generation (5G) standards), an access point (AP) (e.g., associated with, for example, Wi-Fi or any other suitable wireless communication standard), any other generation base station, and/or any combination thereof. A base station may comprise one or more devices, such as at least one base station central device (e.g., a gNB Central Unit (gNB-CU)) and at least one base station distributed device (e.g., a gNB Distributed Unit (gNB-DU)).

A base station (e.g., in the RAN 104) may comprise one or more sets of antennas for communicating with the wireless device 106 wirelessly (e.g., via an over the air interface). One or more base stations may comprise sets (e.g., three sets or any other quantity of sets) of antennas to respectively control multiple cells or sectors (e.g., three cells, three sectors, any other quantity of cells, or any other quantity of sectors). The size of a cell may be determined by a range at which a receiver (e.g., a base station receiver) may successfully receive transmissions from a transmitter (e.g., a wireless device transmitter) operating in the cell. One or more cells of base stations (e.g., by alone or in combination with other cells) may provide/configure a radio coverage to the wireless device 106 over a wide geographic area to support wireless device mobility. A base station comprising three sectors (e.g., or n-sector, where n refers to any quantity n) may be referred to as a three-sector site (e.g., or an n-sector site) or a three-sector base station (e.g., an n-sector base station).

One or more base stations (e.g., in the RAN 104) may be implemented as a sectored site with more or less than three sectors. One or more base stations of the RAN 104 may be implemented as an access point, as a baseband processing device/unit coupled to several RRHs, and/or as a repeater or relay node used to extend the coverage area of a node (e.g., a donor node). A baseband processing device/unit coupled to RRHs may be part of a centralized or cloud RAN architecture, for example, where the baseband processing device/unit may be centralized in a pool of baseband processing devices/units or virtualized. A repeater node may amplify and send (e.g., transmit, retransmit, rebroadcast, etc.) a radio signal received from a donor node. A relay node may perform the substantially the same/similar functions as a repeater node. The relay node may decode the radio signal received from the donor node, for example, to remove noise before amplifying and sending the radio signal.

The RAN 104 may be deployed as a homogenous network of base stations (e.g., macrocell base stations) that have similar antenna patterns and/or similar high-level transmit powers. The RAN 104 may be deployed as a heterogeneous network of base stations (e.g., different base stations that have different antenna patterns). In heterogeneous networks, small cell base stations may be used to provide/configure small coverage areas, for example, coverage areas that overlap with comparatively larger coverage areas provided/configured by other base stations (e.g., macrocell base stations). The small coverage areas may be provided/configured in areas with high data traffic (or so-called “hotspots”) or in areas with a weak macrocell coverage. Examples of small cell base stations may comprise, in order of decreasing coverage area, microcell base stations, picocell base stations, and femtocell base stations or home base stations.

Examples described herein may be used in a variety of types of communications. For example, communications may be in accordance with the Third-Generation Partnership Project (3GPP) (e.g., one or more network elements similar to those of the communication network 100), communications in accordance with Institute of Electrical and Electronics Engineers (IEEE), communications in accordance with International Telecommunication Union (ITU), communications in accordance with International Organization for Standardization (ISO), etc. The 3GPP has produced specifications for multiple generations of mobile networks: a 3G network known as UMTS, a 4G network known as Long-Term Evolution (LTE) and LTE Advanced (LTE-A), and a 5G network known as 5G System (5GS) and NR system. 3GPP may produce specifications for additional generations of communication networks (e.g., 6G and/or any other generation of communication network). Examples may be described with reference to one or more elements (e.g., the RAN) of a 3GPP 5G network, referred to as a next-generation RAN (NG-RAN), or any other communication network, such as a 3GPP network and/or a non-3GPP network. Examples described herein may be applicable to other communication networks, such as 3G and/or 4G networks, and communication networks that may not yet be finalized/specified (e.g., a 3GPP 6G network), satellite communication networks, and/or any other communication network. NG-RAN implements and updates 5G radio access technology referred to as NR and may be provisioned to implement 4G radio access technology and/or other radio access technologies, such as other 3GPP and/or non-3GPP radio access technologies.

FIG. 1B shows an example communication network 150. The communication network may comprise a mobile communication network. The communication network 150 may comprise, for example, a PLMN operated/managed/run by a network operator. The communication network 150 may comprise one or more of: a CN 152 (e.g., a 5G core network (5G-CN)), a RAN 154 (e.g., an NG-RAN), and/or wireless devices 156A and 156B (collectively wireless device(s) 156). The communication network 150 may comprise, and/or a device within the communication network 150 may communicate with (e.g., via CN 152), one or more data networks (DN(s)) 170. These components may be implemented and operate in substantially the same or similar manner as corresponding components described with respect to FIG. 1A.

The CN 152 (e.g., 5G-CN) may provide/configure the wireless device(s) 156 with one or more interfaces to one or more DNs 170, such as public DNS (e.g., the Internet), private DNs, and/or intra-operator DNs. As part of the interface functionality, the CN 152 (e.g., 5G-CN) may set up end-to-end connections between the wireless device(s) 156 and the one or more DNs, authenticate the wireless device(s) 156, and/or provide/configure charging functionality. The CN 152 (e.g., the 5G-CN) may be a service-based architecture, which may differ from other CNs (e.g., such as a 3GPP 4G CN). The architecture of nodes of the CN 152 (e.g., 5G-CN) may be defined as network functions that offer services via interfaces to other network functions. The network functions of the CN 152 (e.g., 5G CN) may be implemented in several ways, for example, as network elements on dedicated or shared hardware, as software instances running on dedicated or shared hardware, and/or as virtualized functions instantiated on a platform (e.g., a cloud-based platform).

The CN 152 (e.g., 5G-CN) may comprise an Access and Mobility Management Function (AMF) device 158A and/or a User Plane Function (UPF) device 158B, which may be separate components or one component AMF/UPF device 158. The UPF device 158B may serve as a gateway between a RAN 154 (e.g., NG-RAN) and the one or more DNs 170. The UPF device 158B may perform functions, such as: packet routing and forwarding, packet inspection and user plane policy rule enforcement, traffic usage reporting, uplink classification to support routing of traffic flows to the one or more DNs 170, quality of service (QOS) handling for the user plane (e.g., packet filtering, gating, uplink/downlink rate enforcement, and uplink traffic verification), downlink packet buffering, and/or downlink data notification triggering. The UPF device 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The wireless device(s) 156 may be configured to receive services via a PDU session, which may be a logical connection between a wireless device and a DN.

The AMF device 158A may perform functions, such as: Non-Access Stratum (NAS) signaling termination, NAS signaling security, Access Stratum (AS) security control, inter-CN node signaling for mobility between access networks (e.g., 3GPP access networks and/or non-3GPP networks), idle mode wireless device reachability (e.g., idle mode UE reachability for control and execution of paging retransmission), registration arca management, intra-system and inter-system mobility support, access authentication, access authorization including checking of roaming rights, mobility management control (e.g., subscription and policies), network slicing support, and/or session management function (SMF) selection. NAS may refer to the functionality operating between a CN and a wireless device, and AS may refer to the functionality operating between a wireless device and a RAN.

The CN 152 (e.g., 5G-CN) may comprise one or more additional network functions that may not be shown in FIG. 1B. The CN 152 (e.g., 5G-CN) may comprise one or more devices implementing at least one of: a Session Management Function (SMF), an NR Repository Function (NRF), a Policy Control Function (PCF), a Network Exposure Function (NEF), a Unified Data Management (UDM), an Application Function (AF), an Authentication Server Function (AUSF), and/or any other function.

The RAN 154 (e.g., NG-RAN) may communicate with the wireless device(s) 156 via radio communications (e.g., an over the air interface). The wireless device(s) 156 may communicate with the CN 152 via the RAN 154. The RAN 154 (e.g., NG-RAN) may comprise one or more first-type base stations (e.g., gNBs comprising a gNB 160A and a gNB 160B (collectively gNBs 160)) and/or one or more second-type base stations (e.g., ng cNBs comprising an ng-eNB 162A and an ng-eNB 162B (collectively ng eNBs 162)). The RAN 154 may comprise one or more of any quantity of types of base station. The gNBs 160 and ng eNBs 162 may be referred to as base stations. The base stations (e.g., the gNBs 160 and ng eNBs 162) may comprise one or more sets of antennas for communicating with the wireless device(s) 156 wirelessly (e.g., an over an air interface). One or more base stations (e.g., the gNBs 160 and/or the ng eNBs 162) may comprise multiple sets of antennas to respectively control multiple cells (or sectors). The cells of the base stations (e.g., the gNBs 160 and the ng-eNBs 162) may provide a radio coverage to the wireless device(s) 156 over a wide geographic area to support wireless device mobility.

The base stations (e.g., the gNBs 160 and/or the ng-eNBs 162) may be connected to the CN 152 (e.g., 5G CN) via a first interface (e.g., an NG interface) and to other base stations via a second interface (e.g., an Xn interface). The NG and Xn interfaces may be established using direct physical connections and/or indirect connections over an underlying transport network, such as an internet protocol (IP) transport network. The base stations (e.g., the gNBs 160 and/or the ng-eNBs 162) may communicate with the wireless device(s) 156 via a third interface (e.g., a Uu interface). A base station (e.g., the gNB 160A) may communicate with the wireless device 156A via a Uu interface. The NG, Xn, and Uu interfaces may be associated with a protocol stack. The protocol stacks associated with the interfaces may be used by the network elements shown in FIG. 1B to exchange data and signaling messages. The protocol stacks may comprise two planes: a user plane and a control plane. Any other quantity of planes may be used (e.g., in a protocol stack). The user plane may handle data of interest to a user. The control plane may handle signaling messages of interest to the network elements.

One or more base stations (e.g., the gNBs 160 and/or the ng-eNBs 162) may communicate with one or more AMF/UPF devices, such as the AMF/UPF 158, via one or more interfaces (e.g., NG interfaces). A base station (e.g., the gNB 160A) may be in communication with, and/or connected to, the UPF 158B of the AMF/UPF 158 via an NG-User plane (NG-U) interface. The NG-U interface may provide/perform delivery (e.g., non-guaranteed delivery) of user plane PDUs between a base station (e.g., the gNB 160A) and a UPF device (e.g., the UPF 158B). The base station (e.g., the gNB 160A) may be in communication with, and/or connected to, an AMF device (e.g., the AMF 158A) via an NG-Control plane (NG-C) interface. The NG-C interface may provide/perform, for example, NG interface management, wireless device context management (e.g., UE context management), wireless device mobility management (e.g., UE mobility management), transport of NAS messages, paging, PDU session management, configuration transfer, and/or warning message transmission.

A wireless device may access the base station, via an interface (e.g., Uu interface), for the user plane configuration and the control plane configuration. The base stations (e.g., gNBs 160) may provide user plane and control plane protocol terminations towards the wireless device(s) 156 via the Uu interface. A base station (e.g., the gNB 160A) may provide user plane and control plane protocol terminations toward the wireless device 156A over a Uu interface associated with a first protocol stack. A base station (e.g., the ng-eNBs 162) may provide Evolved UMTS Terrestrial Radio Access (E UTRA) user plane and control plane protocol terminations towards the wireless device(s) 156 via a Uu interface (e.g., where E UTRA may refer to the 3GPP 4G radio-access technology). A base station (e.g., the ng-eNB 162B) may provide E UTRA user plane and control plane protocol terminations towards the wireless device 156B via a Uu interface associated with a second protocol stack. The user plane and control plane protocol terminations may comprise, for example, NR user plane and control plane protocol terminations, 4G user plane and control plane protocol terminations, etc.

The CN 152 (e.g., 5G-CN) may be configured to handle one or more radio accesses (e.g., NR, 4G, and/or any other radio accesses). It may also be possible for an NR network/device (or any first network/device) to connect to a 4G core network/device (or any second network/device) in a non-standalone mode (e.g., non-standalone operation). In a non-standalone mode/operation, a 4G core network may be used to provide (or at least support) control-plane functionality (e.g., initial access, mobility, and/or paging). Although only one AMF/UPF 158 is shown in FIG. 1B, one or more base stations (e.g., one or more gNBs and/or one or more ng-eNBs) may be connected to multiple AMF/UPF nodes, for example, to provide redundancy and/or to load share across the multiple AMF/UPF nodes.

An interface (e.g., Uu, Xn, and/or NG interfaces) between network elements (e.g., the network elements shown in FIG. 1B) may be associated with a protocol stack that the network elements may use to exchange data and signaling messages. A protocol stack may comprise two planes: a user plane and a control plane. Any other quantity of planes may be used (e.g., in a protocol stack). The user plane may handle data associated with a user (e.g., data of interest to a user). The control plane may handle data associated with one or more network elements (e.g., signaling messages of interest to the network elements).

The communication network 100 in FIG. 1A and/or the communication network 150 in FIG. 1B may comprise any quantity/number and/or type of devices, such as, for example, computing devices, wireless devices, mobile devices, handsets, tablets, laptops, internet of things (IoT) devices, hotspots, cellular repeaters, computing devices, and/or, more generally, user equipment (e.g., UE). Although one or more of the above types of devices may be referenced herein (e.g., UE, wireless device, computing device, etc.), it should be understood that any device herein may comprise any one or more of the above types of devices or similar devices. The communication network, and any other network referenced herein, may comprise a terrestrial network (e.g., a LTE network, a 5G network, a 6G network), a non-terrestrial network (e.g., a satellite network), and/or any other network for wireless communications (e.g., any 3GPP network and/or any non-3GPP network). Apparatuses, systems, and/or methods described herein may generally be described as implemented on one or more devices (e.g., wireless device, base station, eNB, gNB, computing device, etc.), in one or more networks, but it will be understood that one or more features and steps may be implemented on any device and/or in any network.

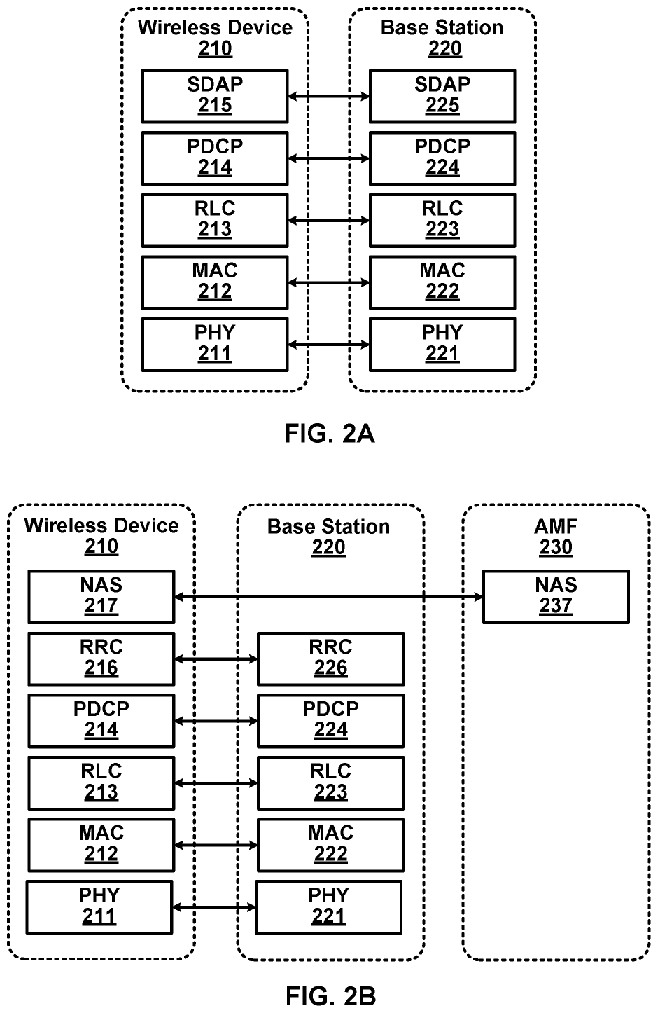

FIG. 2A shows an example user plane configuration. The user plane configuration may comprise, for example, an NR user plane protocol stack. FIG. 2B shows an example control plane configuration. The control plane configuration may comprise, for example, an NR control plane protocol stack. One or more of the user plane configuration and/or the control plane configuration may use a Uu interface that may be between a wireless device 210 and a base station 220. The protocol stacks shown in FIG. 2A and FIG. 2B may be substantially the same or similar to those used for the Uu interface between, for example, the wireless device 156A and the base station 160A shown in FIG. 1B.

A user plane configuration (e.g., an NR user plane protocol stack) may comprise multiple layers (e.g., five layers or any other quantity of layers) implemented in the wireless device 210 and the base station 220 (e.g., as shown in FIG. 2A). At the bottom of the protocol stack, physical layers (PHYs) 211 and 221 may provide transport services to the higher layers of the protocol stack and may correspond to layer 1 of the Open Systems Interconnection (OSI) model. The protocol layers above PHY 211 may comprise a medium access control layer (MAC) 212, a radio link control layer (RLC) 213, a packet data convergence protocol layer (PDCP) 214, and/or a service data application protocol layer (SDAP) 215. The protocol layers above PHY 221 may comprise a medium access control layer (MAC) 222, a radio link control layer (RLC) 223, a packet data convergence protocol layer (PDCP) 224, and/or a service data application protocol layer (SDAP) 225. One or more of the four protocol layers above PHY 211 may correspond to layer 2, or the data link layer, of the OSI model. One or more of the four protocol layers above PHY 221 may correspond to layer 2, or the data link layer, of the OSI model.

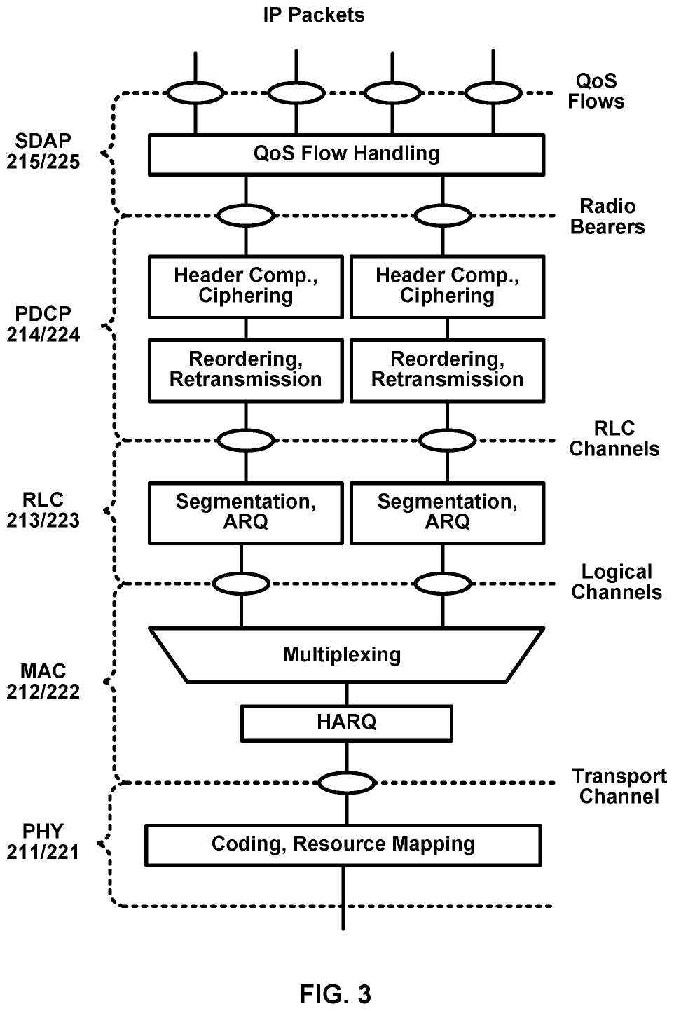

FIG. 3 shows an example of protocol layers. The protocol layers may comprise, for example, protocol layers of the NR user plane protocol stack. One or more services may be provided between protocol layers. SDAPs (e.g., SDAPS 215 and 225 shown in FIG. 2A and FIG. 3) may perform Quality of Service (QOS) flow handling. A wireless device (e.g., the wireless devices 106, 156A, 156B, and 210) may receive services through/via a PDU session, which may be a logical connection between the wireless device and a DN. The PDU session may have one or more QoS flows 310. A UPF (e.g., the UPF 158B) of a CN may map IP packets to the one or more QoS flows of the PDU session, for example, based on one or more QoS requirements (e.g., in terms of delay, data rate, error rate, and/or any other quality/service requirement). The SDAPs 215 and 225 may perform mapping/de-mapping between the one or more QoS flows 310 and one or more radio bearers 320 (e.g., data radio bearers). The mapping/de-mapping between the one or more QoS flows 310 and the radio bearers 320 may be determined by the SDAP 225 of the base station 220. The SDAP 215 of the wireless device 210 may be informed of the mapping between the QoS flows 310 and the radio bearers 320 via reflective mapping and/or control signaling received from the base station 220. For reflective mapping, the SDAP 225 of the base station 220 may mark the downlink packets with a QoS flow indicator (QFI), which may be monitored/detected/identified/indicated/observed by the SDAP 215 of the wireless device 210 to determine the mapping/de-mapping between the one or more QoS flows 310 and the radio bearers 320.

PDCPs (e.g., the PDCPs 214 and 224 shown in FIG. 2A and FIG. 3) may perform header compression/decompression, for example, to reduce the amount of data that may need to be transmitted over the air interface, ciphering/deciphering to prevent unauthorized decoding of data transmitted over the air interface, and/or integrity protection (e.g., to ensure control messages originate from intended sources). The PDCPs 214 and 224 may perform retransmissions of undelivered packets, in-sequence delivery and reordering of packets, and/or removal of packets received in duplicate due to, for example, a handover (e.g., an intra-gNB handover). The PDCPs 214 and 224 may perform packet duplication, for example, to improve the likelihood of the packet being received. A receiver may receive the packet in duplicate and may remove any duplicate packets. Packet duplication may be useful for certain services, such as services that require high reliability.

The PDCP layers (e.g., PDCPs 214 and 224) may perform mapping/de-mapping between a split radio bearer and RLC channels (e.g., RLC channels 330) (e.g., in a dual connectivity example/configuration). Dual connectivity may refer to a technique that allows a wireless device to communicate with multiple cells (e.g., two cells) or, more generally, multiple cell groups comprising: a master cell group (MCG) and a secondary cell group (SCG). A split bearer may be configured and/or used, for example, if a single radio bearer (e.g., such as one of the radio bearers provided/configured by the PDCPs 214 and 224 as a service to the SDAPs 215 and 225) is handled by cell groups in dual connectivity. The PDCPs 214 and 224 may map/de-map between the split radio bearer and RLC channels 330 belonging to the cell groups.

RLC layers (e.g., RLCs 213 and 223) may perform segmentation, retransmission via Automatic Repeat Request (ARQ), and/or removal of duplicate data units received from MAC layers (e.g., MACs 212 and 222, respectively). The RLC layers (e.g., RLCs 213 and 223) may support multiple transmission modes (e.g., three transmission modes: transparent mode (TM); unacknowledged mode (UM); and acknowledged mode (AM)). The RLC layers may perform one or more of the noted functions, for example, based on the transmission mode an RLC layer is operating. The RLC configuration may be per logical channel. The RLC configuration may not depend on numerologies and/or Transmission Time Interval (TTI) durations (or other durations). The RLC layers (e.g., RLCs 213 and 223) may provide/configure RLC channels as a service to the PDCP layers (e.g., PDCPs 214 and 224, respectively), such as shown in FIG. 3.

The MAC layers (e.g., MACs 212 and 222) may perform multiplexing/demultiplexing of logical channels and/or mapping between logical channels and transport channels. The multiplexing/demultiplexing may comprise multiplexing/demultiplexing of data units/data portions, belonging to the one or more logical channels, into/from Transport Blocks (TBs) delivered to/from the PHY layers (e.g., PHYs 211 and 221, respectively). The MAC layer of a base station (e.g., MAC 222) may be configured to perform scheduling, scheduling information reporting, and/or priority handling between wireless devices via dynamic scheduling. Scheduling may be performed by a base station (e.g., the base station 220 at the MAC 222) for downlink/or and uplink. The MAC layers (e.g., MACs 212 and 222) may be configured to perform error correction(s) via Hybrid Automatic Repeat Request (HARQ) (e.g., one HARQ entity per carrier in case of Carrier Aggregation (CA)), priority handling between logical channels of the wireless device 210 via logical channel prioritization and/or padding. The MAC layers (e.g., MACs 212 and 222) may support one or more numerologies and/or transmission timings. Mapping restrictions in a logical channel prioritization may control which numerology and/or transmission timing a logical channel may use. The MAC layers (e.g., the MACs 212 and 222) may provide/configure logical channels 340 as a service to the RLC layers (e.g., the RLCs 213 and 223).

The PHY layers (e.g., PHYs 211 and 221) may perform mapping of transport channels to physical channels and/or digital and analog signal processing functions, for example, for sending and/or receiving information (e.g., via an over the air interface). The digital and/or analog signal processing functions may comprise, for example, coding/decoding and/or modulation/demodulation. The PHY layers (e.g., PHYs 211 and 221) may perform multi-antenna mapping. The PHY layers (e.g., the PHYs 211 and 221) may provide/configure one or more transport channels (e.g., transport channels 350) as a service to the MAC layers (e.g., the MACs 212 and 222, respectively).

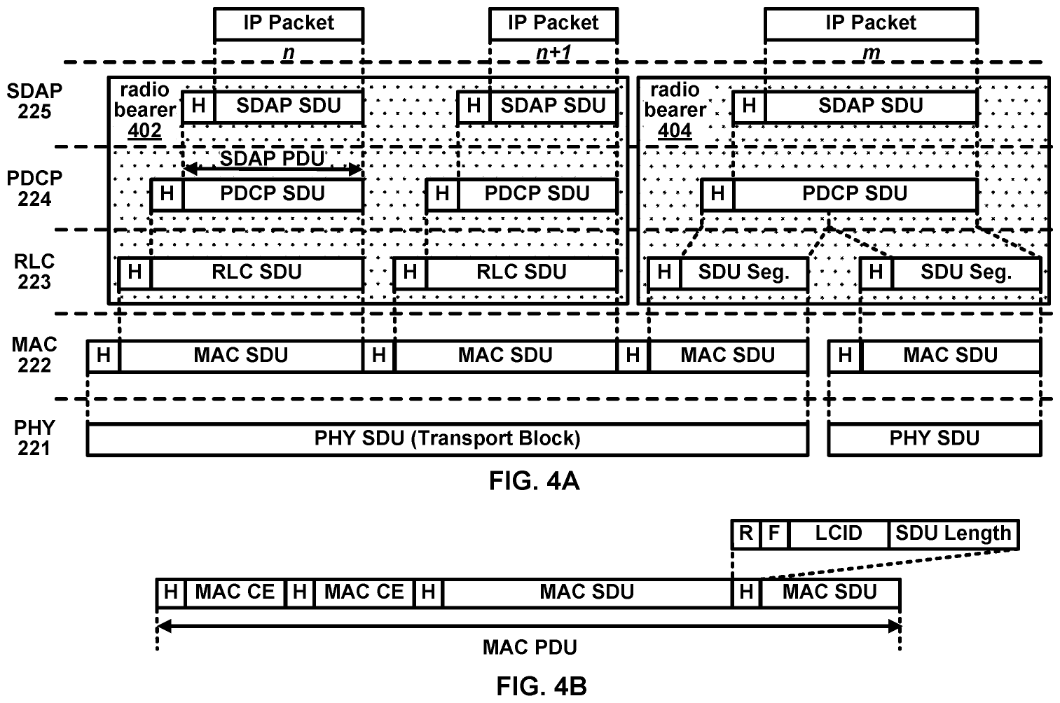

FIG. 4A shows an example downlink data flow for a user plane configuration. The user plane configuration may comprise, for example, the NR user plane protocol stack shown in FIG. 2A. One or more TBs may be generated, for example, based on a data flow via a user plane protocol stack. As shown in FIG. 4A, a downlink data flow of three IP packets (n, n+1, and m) via the NR user plane protocol stack may generate two TBs (e.g., at the base station 220). An uplink data flow via the NR user plane protocol stack may be similar to the downlink data flow shown in FIG. 4A. The three IP packets (n, n+1, and m) may be determined from the two TBs, for example, based on the uplink data flow via an NR user plane protocol stack. A first quantity of packets (e.g., three or any other quantity) may be determined from a second quantity of TBs (e.g., two or another quantity).

The downlink data flow may begin, for example, if the SDAP 225 receives the three IP packets (or other quantity of IP packets) from one or more QoS flows and maps the three packets (or other quantity of packets) to radio bearers (e.g., radio bearers 402 and 404). The SDAP 225 may map the IP packets n and n+1 to a first radio bearer 402 and map the IP packet m to a second radio bearer 404. An SDAP header (labeled with “H” preceding each SDAP SDU shown in FIG. 4A) may be added to an IP packet to generate an SDAP PDU, which may be referred to as a PDCP SDU. The data unit transferred from/to a higher protocol layer may be referred to as a service data unit (SDU) of the lower protocol layer, and the data unit transferred to/from a lower protocol layer may be referred to as a protocol data unit (PDU) of the higher protocol layer. As shown in FIG. 4A, the data unit from the SDAP 225 may be an SDU of lower protocol layer PDCP 224 (e.g., PDCP SDU) and may be a PDU of the SDAP 225 (e.g., SDAP PDU).

Each protocol layer (e.g., protocol layers shown in FIG. 4A) or at least some protocol layers may: perform its own function(s) (e.g., one or more functions of each protocol layer described with respect to FIG. 3), add a corresponding header, and/or forward a respective output to the next lower layer (e.g., its respective lower layer). The PDCP 224 may perform an IP-header compression and/or ciphering. The PDCP 224 may forward its output (e.g., a PDCP PDU, which is an RLC SDU) to the RLC 223. The RLC 223 may optionally perform segmentation (e.g., as shown for IP packet m in FIG. 4A). The RLC 223 may forward its outputs (e.g., two RLC PDUs, which are two MAC SDUs, generated by adding respective subheaders to two SDU segments (SDU Segs)) to the MAC 222. The MAC 222 may multiplex a number of RLC PDUs (MAC SDUs). The MAC 222 may attach a MAC subheader to an RLC PDU (MAC SDU) to form a TB. The MAC subheaders may be distributed across the MAC PDU (e.g., in an NR configuration as shown in FIG. 4A). The MAC subheaders may be entirely located at the beginning of a MAC PDU (e.g., in an LTE configuration). The NR MAC PDU structure may reduce a processing time and/or associated latency, for example, if the MAC PDU subheaders are computed before assembling the full MAC PDU.

FIG. 4B shows an example format of a MAC subheader in a MAC PDU. A MAC PDU may comprise a MAC subheader (H) and a MAC SDU. Each of one or more MAC subheaders may comprise an SDU length field for indicating the length (e.g., in bytes) of the MAC SDU to which the MAC subheader corresponds; a logical channel identifier (LCID) field for identifying/indicating the logical channel from which the MAC SDU originated to aid in the demultiplexing process; a flag (F) for indicating the size of the SDU length field; and a reserved bit (R) field for future use.

One or more MAC control elements (CEs) may be added to, or inserted into, the MAC PDU by a MAC layer, such as MAC 223 or MAC 222. As shown in FIG. 4B, two MAC CEs may be inserted/added before two MAC PDUs. The MAC CEs may be inserted/added at the beginning of a MAC PDU for downlink transmissions (as shown in FIG. 4B). One or more MAC CEs may be inserted/added at the end of a MAC PDU for uplink transmissions. MAC CEs may be used for in band control signaling. Example MAC CEs may comprise scheduling-related MAC CEs, such as buffer status reports and power headroom reports; activation/deactivation MAC CEs (e.g., MAC CEs for activation/deactivation of PDCP duplication detection, channel state information (CSI) reporting, sounding reference signal (SRS) transmission, and prior configured components); discontinuous reception (DRX)-related MAC CEs; timing advance MAC CEs; and random access-related MAC CEs. A MAC CE may be preceded by a MAC subheader with a similar format as described for the MAC subheader for MAC SDUs and may be identified with a reserved value in the LCID field that indicates the type of control information included in the corresponding MAC CE.

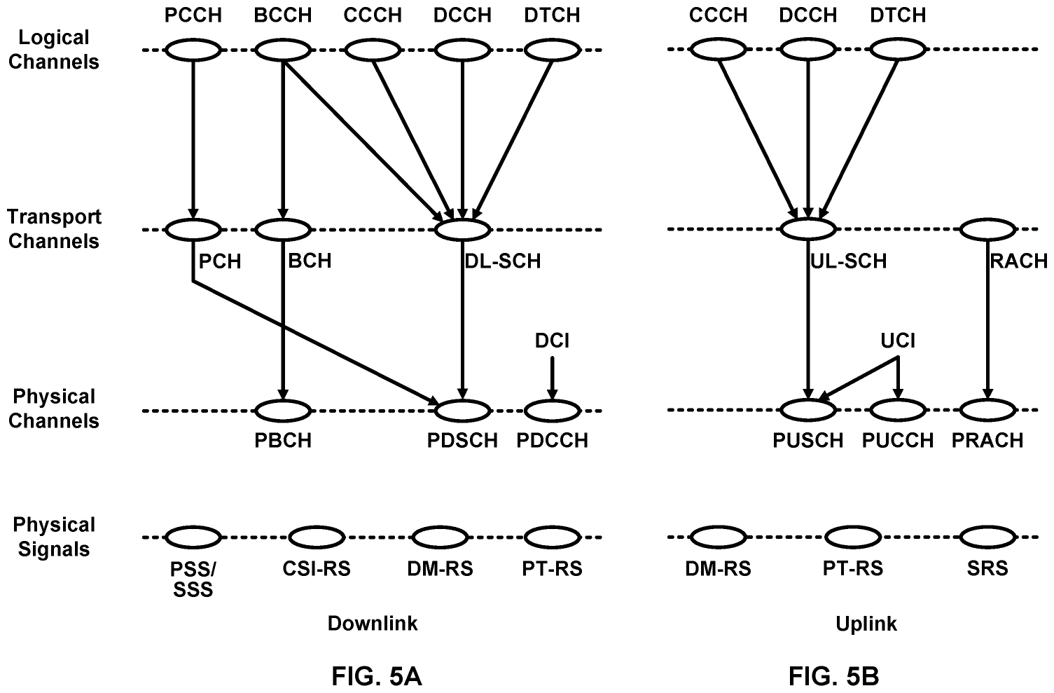

FIG. 5A shows an example mapping for downlink channels. The mapping for uplink channels may comprise mapping between channels (e.g., logical channels, transport channels, and physical channels) for downlink. FIG. 5B shows an example mapping for uplink channels. The mapping for uplink channels may comprise mapping between channels (e.g., logical channels, transport channels, and physical channels) for uplink. Information may be passed through/via channels between the RLC, the MAC, and the PHY layers of a protocol stack (e.g., the NR protocol stack). A logical channel may be used between the RLC and the MAC layers. The logical channel may be classified/indicated as a control channel that may carry control and/or configuration information (e.g., in the NR control plane), or as a traffic channel that may carry data (e.g., in the NR user plane). A logical channel may be classified/indicated as a dedicated logical channel that may be dedicated to a specific wireless device, and/or as a common logical channel that may be used by more than one wireless device (e.g., a group of wireless devices).

A logical channel may be defined by the type of information it carries. The set of logical channels (e.g., in an NR configuration) may comprise one or more channels described below. A paging control channel (PCCH) may comprise/carry one or more paging messages used to page a wireless device whose location is not known to the network on a cell level. A broadcast control channel (BCCH) may comprise/carry system information messages in the form of a master information block (MIB) and several system information blocks (SIBs). The system information messages may be used by wireless devices to obtain information about how a cell is configured and how to operate within the cell. A common control channel (CCCH) may comprise/carry control messages together with random access. A dedicated control channel (DCCH) may comprise/carry control messages to/from a specific wireless device to configure the wireless device with configuration information. A dedicated traffic channel (DTCH) may comprise/carry user data to/from a specific wireless device.

Transport channels may be used between the MAC and PHY layers. Transport channels may be defined by how the information they carry is sent/transmitted (e.g., via an over the air interface). The set of transport channels (e.g., that may be defined by an NR configuration or any other configuration) may comprise one or more of the following channels. A paging channel (PCH) may comprise/carry paging messages that originated from the PCCH. A broadcast channel (BCH) may comprise/carry the MIB from the BCCH. A downlink shared channel (DL-SCH) may comprise/carry downlink data and signaling messages, including the SIBs from the BCCH. An uplink shared channel (UL-SCH) may comprise/carry uplink data and signaling messages. A random access channel (RACH) may provide a wireless device with an access to the network without any prior scheduling.

The PHY layer may use physical channels to pass/transfer information between processing levels of the PHY layer. A physical channel may have an associated set of time-frequency resources for carrying the information of one or more transport channels. The PHY layer may generate control information to support the low-level operation of the PHY layer. The PHY layer may provide/transfer the control information to the lower levels of the PHY layer via physical control channels (e.g., referred to as L1/L2 control channels). The set of physical channels and physical control channels (e.g., that may be defined by an NR configuration or any other configuration) may comprise one or more of the following channels. A physical broadcast channel (PBCH) may comprise/carry the MIB from the BCH. A physical downlink shared channel (PDSCH) may comprise/carry downlink data and signaling messages from the DL-SCH, as well as paging messages from the PCH. A physical downlink control channel (PDCCH) may comprise/carry downlink control information (DCI), which may comprise downlink scheduling commands, uplink scheduling grants, and uplink power control commands. A physical uplink shared channel (PUSCH) may comprise/carry uplink data and signaling messages from the UL-SCH and in some instances uplink control information (UCI) as described below. A physical uplink control channel (PUCCH) may comprise/carry UCI, which may comprise HARQ acknowledgments, channel quality indicators (CQI), pre-coding matrix indicators (PMI), rank indicators (RI), and scheduling requests (SR). A physical random access channel (PRACH) may be used for random access.

The physical layer may generate physical signals to support the low-level operation of the physical layer, which may be similar to the physical control channels. As shown in FIG. 5A and FIG. 5B, the physical layer signals (e.g., that may be defined by an NR configuration or any other configuration) may comprise primary synchronization signals (PSS), secondary synchronization signals (SSS), channel state information reference signals (CSI-RS), demodulation reference signals (DM-RS), sounding reference signals (SRS), phase-tracking reference signals (PT RS), and/or any other signals.

One or more of the channels (e.g., logical channels, transport channels, physical channels, etc.) may be used to carry out functions associated with the control plan protocol stack (e.g., NR control plane protocol stack). FIG. 2B shows an example control plane configuration (e.g., an NR control plane protocol stack). As shown in FIG. 2B, the control plane configuration (e.g., the NR control plane protocol stack) may use substantially the same/similar one or more protocol layers (e.g., PHY 211 and 221, MAC 212 and 222, RLC 213 and 223, and PDCP 214 and 224) as the example user plane configuration (e.g., the NR user plane protocol stack). Similar four protocol layers may comprise the PHYs 211 and 221, the MACs 212 and 222, the RLCs 213 and 223, and the PDCPs 214 and 224. The control plane configuration (e.g., the NR control plane stack) may have radio resource controls (RRCs) 216 and 226 and NAS protocols 217 and 237 at the top of the control plane configuration (e.g., the NR control plane protocol stack), for example, instead of having the SDAPs 215 and 225. The control plane configuration may comprise an AMF 230 comprising the NAS protocol 237.

The NAS protocols 217 and 237 may provide control plane functionality between the wireless device 210 and the AMF 230 (e.g., the AMF 158A or any other AMF) and/or, more generally, between the wireless device 210 and a CN (e.g., the CN 152 or any other CN). The NAS protocols 217 and 237 may provide control plane functionality between the wireless device 210 and the AMF 230 via signaling messages, referred to as NAS messages. There may be no direct path between the wireless device 210 and the AMF 230 via which the NAS messages may be transported. The NAS messages may be transported using the AS of the Uu and NG interfaces. The NAS protocols 217 and 237 may provide control plane functionality, such as authentication, security, a connection setup, mobility management, session management, and/or any other functionality.

The RRCs 216 and 226 may provide/configure control plane functionality between the wireless device 210 and the base station 220 and/or, more generally, between the wireless device 210 and the RAN (e.g., the base station 220). The RRC layers 216 and 226 may provide/configure control plane functionality between the wireless device 210 and the base station 220 via signaling messages, which may be referred to as RRC messages. The RRC messages may be sent/transmitted between the wireless device 210 and the RAN (e.g., the base station 220) using signaling radio bearers and the same/similar PDCP, RLC, MAC, and PHY protocol layers. The MAC layer may multiplex control-plane and user-plane data into the same TB. The RRC layers 216 and 226 may provide/configure control plane functionality, such as one or more of the following functionalities: broadcast of system information related to AS and NAS; paging initiated by the CN or the RAN; establishment, maintenance and release of an RRC connection between the wireless device 210 and the RAN (e.g., the base station 220); security functions including key management; establishment, configuration, maintenance and release of signaling radio bearers and data radio bearers; mobility functions; QOS management functions; wireless device measurement reporting (e.g., the wireless device measurement reporting) and control of the reporting; detection of and recovery from radio link failure (RLF); and/or NAS message transfer. As part of establishing an RRC connection, RRC layers 216 and 226 may establish an RRC context, which may involve configuring parameters for communication between the wireless device 210 and the RAN (e.g., the base station 220).

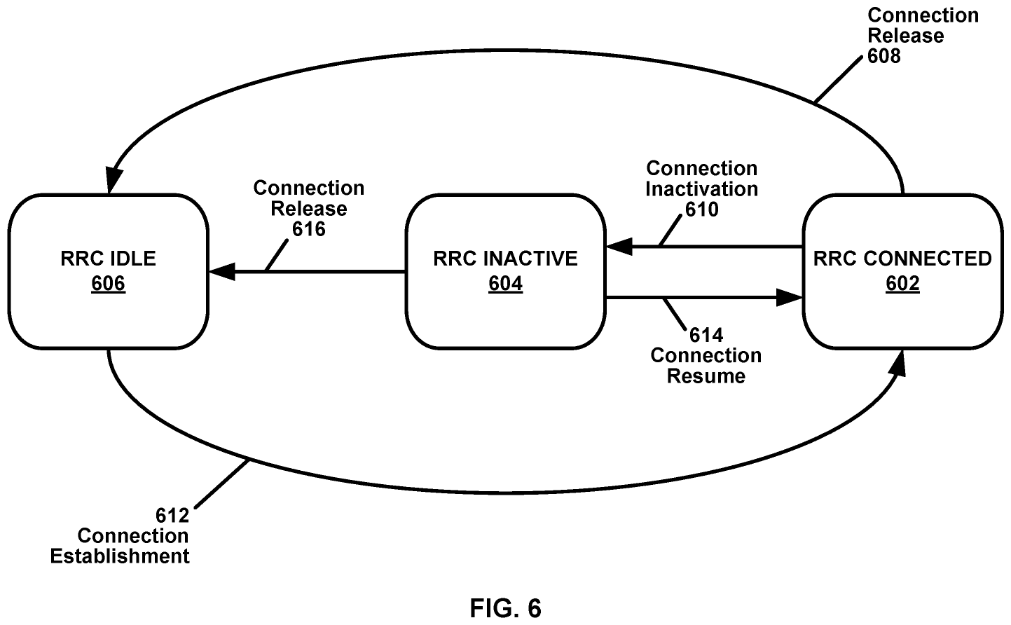

FIG. 6 shows example RRC states and RRC state transitions. An RRC state of a wireless device may be changed to another RRC state (e.g., RRC state transitions of a wireless device). The wireless device may be substantially the same or similar to the wireless device 106, 210, or any other wireless device. A wireless device may be in at least one of a plurality of states, such as three RRC states comprising RRC connected 602 (e.g., RRC_CONNECTED), RRC idle 606 (e.g., RRC_IDLE), and RRC inactive 604 (e.g., RRC_INACTIVE). The RRC inactive 604 may be RRC connected but inactive.

An RRC connection may be established for the wireless device. For example, this may be during an RRC connected state. During the RRC connected state (e.g., during the RRC connected 602), the wireless device may have an established RRC context and may have at least one RRC connection with a base station. The base station may be similar to one of the one or more base stations (e.g., one or more base stations of the RAN 104 shown in FIG. 1A, one of the gNBs 160 or ng-eNBs 162 shown in FIG. 1B, the base station 220 shown in FIG. 2A and FIG. 2B, or any other base stations). The base station with which the wireless device is connected (e.g., has established an RRC connection) may have the RRC context for the wireless device. The RRC context, which may be referred to as a wireless device context (e.g., the UE context), may comprise parameters for communication between the wireless device and the base station. These parameters may comprise, for example, one or more of: AS contexts; radio link configuration parameters; bearer configuration information (e.g., relating to a data radio bearer, a signaling radio bearer, a logical channel, a QoS flow, and/or a PDU session); security information; and/or layer configuration information (e.g., PHY, MAC, RLC, PDCP, and/or SDAP layer configuration information). During the RRC connected state (e.g., the RRC connected 602), mobility of the wireless device may be managed/controlled by a RAN (e.g., the RAN 104 or the NG RAN 154). The wireless device may measure received signal levels (e.g., reference signal levels, reference signal received power, reference signal received quality, received signal strength indicator, etc.) based on one or more signals sent from a serving cell and neighboring cells. The wireless device may report these measurements to a serving base station (e.g., the base station currently serving the wireless device). The serving base station of the wireless device may request a handover to a cell of one of the neighboring base stations, for example, based on the reported measurements. The RRC state may transition from the RRC connected state (e.g., RRC connected 602) to an RRC idle state (e.g., the RRC idle 606) via a connection release procedure 608. The RRC state may transition from the RRC connected state (e.g., RRC connected 602) to the RRC inactive state (e.g., RRC inactive 604) via a connection inactivation procedure 610.

An RRC context may not be established for the wireless device. For example, this may be during the RRC idle state. During the RRC idle state (e.g., the RRC idle 606), an RRC context may not be established for the wireless device. During the RRC idle state (e.g., the RRC idle 606), the wireless device may not have an RRC connection with the base station. During the RRC idle state (e.g., the RRC idle 606), the wireless device may be in a sleep state for the majority of the time (e.g., to conserve battery power). The wireless device may wake up periodically (e.g., each discontinuous reception (DRX) cycle) to monitor for paging messages (e.g., paging messages set from the RAN). Mobility of the wireless device may be managed by the wireless device via a procedure of a cell reselection. The RRC state may transition from the RRC idle state (e.g., the RRC idle 606) to the RRC connected state (e.g., the RRC connected 602) via a connection establishment procedure 612, which may involve a random access procedure.

A previously established RRC context may be maintained for the wireless device. For example, this may be during the RRC inactive state. During the RRC inactive state (e.g., the RRC inactive 604), the RRC context previously established may be maintained in the wireless device and the base station. The maintenance of the RRC context may enable/allow a fast transition to the RRC connected state (e.g., the RRC connected 602) with reduced signaling overhead as compared to the transition from the RRC idle state (e.g., the RRC idle 606) to the RRC connected state (e.g., the RRC connected 602). During the RRC inactive state (e.g., the RRC inactive 604), the wireless device may be in a sleep state and mobility of the wireless device may be managed/controlled by the wireless device via a cell reselection. The RRC state may transition from the RRC inactive state (e.g., the RRC inactive 604) to the RRC connected state (e.g., the RRC connected 602) via a connection resume procedure 614. The RRC state may transition from the RRC inactive state (e.g., the RRC inactive 604) to the RRC idle state (e.g., the RRC idle 606) via a connection release procedure 616 that may be the same as or similar to connection release procedure 608.

An RRC state may be associated with a mobility management mechanism. During the RRC idle state (e.g., RRC idle 606) and the RRC inactive state (e.g., the RRC inactive 604), mobility may be managed/controlled by the wireless device via a cell reselection. The purpose of mobility management during the RRC idle state (e.g., the RRC idle 606) or during the RRC inactive state (e.g., the RRC inactive 604) may be to enable/allow the network to be able to notify the wireless device of an event via a paging message without having to broadcast the paging message over the entire mobile communications network. The mobility management mechanism used during the RRC idle state (e.g., the RRC idle 606) or during the RRC idle state (e.g., the RRC inactive 604) may enable/allow the network to track the wireless device on a cell-group level, for example, so that the paging message may be broadcast over the cells of the cell group that the wireless device currently resides within (e.g. instead of sending the paging message over the entire mobile communication network). The mobility management mechanisms for the RRC idle state (e.g., the RRC idle 606) and the RRC inactive state (e.g., the RRC inactive 604) may track the wireless device on a cell-group level. The mobility management mechanisms may do the tracking, for example, using different granularities of grouping. There may be a plurality of levels of cell-grouping granularity (e.g., three levels of cell-grouping granularity: individual cells; cells within a RAN area identified by a RAN area identifier (RAI); and cells within a group of RAN areas, referred to as a tracking area and identified by a tracking area identifier (TAI)).

Tracking areas may be used to track the wireless device (e.g., tracking the location of the wireless device at the CN level). The CN (e.g., the CN 102, the 5G CN 152, or any other CN) may send to the wireless device a list of TAIs associated with a wireless device registration area (e.g., a UE registration area). A wireless device may perform a registration update with the CN to allow the CN to update the location of the wireless device and provide the wireless device with a new the UE registration area, for example, if the wireless device moves (e.g., via a cell reselection) to a cell associated with a TAI that may not be included in the list of TAIs associated with the UE registration area.

RAN areas may be used to track the wireless device (e.g., the location of the wireless device at the RAN level). For a wireless device in an RRC inactive state (e.g., the RRC inactive 604), the wireless device may be assigned/provided/configured with a RAN notification area. A RAN notification area may comprise one or more cell identities (e.g., a list of RAIs and/or a list of TAIs). A base station may belong to one or more RAN notification areas. A cell may belong to one or more RAN notification areas. A wireless device may perform a notification area update with the RAN to update the RAN notification area of the wireless device, for example, if the wireless device moves (e.g., via a cell reselection) to a cell not included in the RAN notification area assigned/provided/configured to the wireless device.

A base station storing an RRC context for a wireless device or a last serving base station of the wireless device may be referred to as an anchor base station. An anchor base station may maintain an RRC context for the wireless device at least during a period of time that the wireless device stays in a RAN notification area of the anchor base station and/or during a period of time that the wireless device stays in an RRC inactive state (e.g., RRC inactive 604).

A base station (e.g., gNBs 160 in FIG. 1B or any other base station) may be split in two parts: a central unit (e.g., a base station central unit, such as a gNB CU) and one or more distributed units (e.g., a base station distributed unit, such as a gNB DU). A base station central unit (CU) may be coupled to one or more base station distributed units (DUs) using an F1 interface (e.g., an F1 interface defined in an NR configuration). The base station CU may comprise the RRC, the PDCP, and the SDAP layers. A base station distributed unit (DU) may comprise the RLC, the MAC, and the PHY layers.

The physical signals and physical channels (e.g., described with respect to FIG. 5A and FIG. 5B) may be mapped onto one or more symbols (e.g., orthogonal frequency divisional multiplexing (OFDM) symbols in an NR configuration or any other symbols). OFDM is a multicarrier communication scheme that sends/transmits data over F orthogonal subcarriers (or tones). The data may be mapped to a series of complex symbols (e.g., M-quadrature amplitude modulation (M-QAM) symbols or M-phase shift keying (M PSK) symbols or any other modulated symbols), referred to as source symbols, and divided into F parallel symbol streams, for example, before transmission of the data. The F parallel symbol streams may be treated as if they are in the frequency domain. The F parallel symbols may be used as inputs to an Inverse Fast Fourier Transform (IFFT) block that transforms them into the time domain. The IFFT block may take in F source symbols at a time, one from each of the F parallel symbol streams. The IFFT block may use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. An OFDM symbol provided/output by the IFFT block may be sent/transmitted over the air interface on a carrier frequency, for example, after one or more processes (e.g., addition of a cyclic prefix) and up-conversion. The F parallel symbol streams may be mixed, for example, using a Fast Fourier Transform (FFT) block before being processed by the IFFT block. This operation may produce Discrete Fourier Transform (DFT)-precoded OFDM symbols and may be used by one or more wireless devices in the uplink to reduce the peak to average power ratio (PAPR). Inverse processing may be performed on the OFDM symbol at a receiver using an FFT block to recover the data mapped to the source symbols.

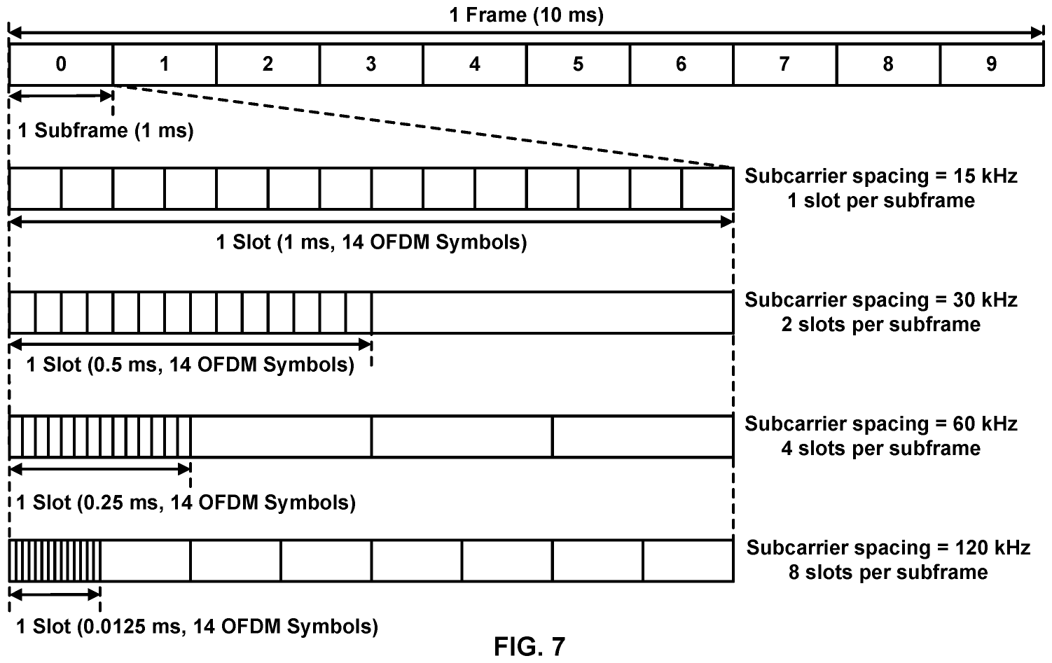

FIG. 7 shows an example configuration of a frame. The frame may comprise, for example, an NR radio frame into which OFDM symbols may be grouped. A frame (e.g., an NR radio frame) may be identified/indicated by a system frame number (SFN) or any other value. The SFN may repeat with a period of 1024 frames. One NR frame may be 10 milliseconds (ms) in duration and may comprise 10 subframes that are 1 ms in duration. A subframe may be divided into one or more slots (e.g., depending on numerologies and/or different subcarrier spacings). Each of the one or more slots may comprise, for example, 14 OFDM symbols per slot. Any quantity of symbols, slots, or duration may be used for any time interval.

The duration of a slot may depend on the numerology used for the OFDM symbols of the slot. A flexible numerology may be supported, for example, to accommodate different deployments (e.g., cells with carrier frequencies below 1 GHz up to cells with carrier frequencies in the mm-wave range). A flexible numerology may be supported, for example, in an NR configuration or any other radio configurations. A numerology may be defined in terms of subcarrier spacing and/or cyclic prefix duration. Subcarrier spacings may be scaled up by powers of two from a baseline subcarrier spacing of 15 kHz. Cyclic prefix durations may be scaled down by powers of two from a baseline cyclic prefix duration of 4.7 μs, for example, for a numerology in an NR configuration or any other radio configurations. Numerologies may be defined with the following subcarrier spacing/cyclic prefix duration combinations: 15 kHz/4.7 μs; 30 kHz/2.3 μs; 60 kHz/1.2 μs; 120 kHz/0.59 μs; 240 kHz/0.29 μs, and/or any other subcarrier spacing/cyclic prefix duration combinations.

A slot may have a fixed number/quantity of OFDM symbols (e.g., 14 OFDM symbols). A numerology with a higher subcarrier spacing may have a shorter slot duration and more slots per subframe. Examples of numerology-dependent slot duration and slots-per-subframe transmission structure are shown in FIG. 7 (the numerology with a subcarrier spacing of 240 kHz is not shown in FIG. 7). A subframe (e.g., in an NR configuration) may be used as a numerology-independent time reference. A slot may be used as the unit upon which uplink and downlink transmissions are scheduled. Scheduling (e.g., in an NR configuration) may be decoupled from the slot duration. Scheduling may start at any OFDM symbol. Scheduling may last for as many symbols as needed for a transmission, for example, to support low latency. These partial slot transmissions may be referred to as mini-slot or sub-slot transmissions.

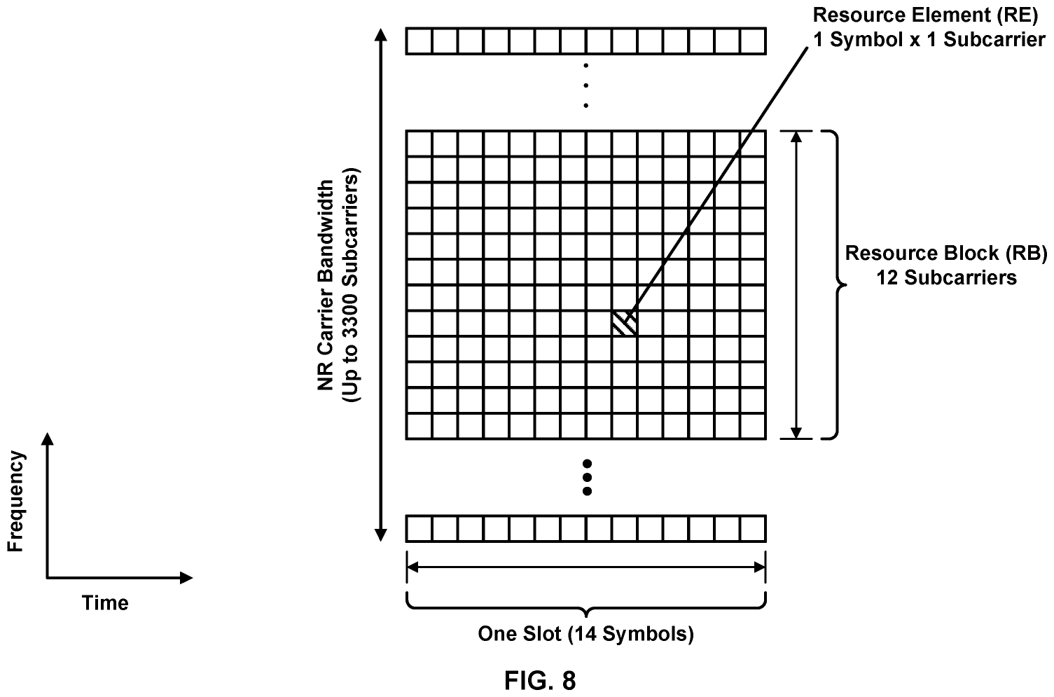

FIG. 8 shows an example resource configuration of one or more carriers. The resource configuration of may comprise a slot in the time and frequency domain for an NR carrier or any other carrier. The slot may comprise resource elements (REs) and resource blocks (RBs). A resource element (RE) may be the smallest physical resource (e.g., in an NR configuration). An RE may span one OFDM symbol in the time domain by one subcarrier in the frequency domain, such as shown in FIG. 8. An RB may span twelve consecutive REs in the frequency domain, such as shown in FIG. 8. A carrier (e.g., an NR carrier) may be limited to a width of a certain quantity of RBs and/or subcarriers (e.g., 275 RBs or 275×12=3300 subcarriers). Such limitation(s), if used, may limit the carrier (e.g., NR carrier) frequency based on subcarrier spacing (e.g., carrier frequency of 50, 100, 200, and 400 MHz for subcarrier spacings of 15, 30, 60, and 120 kHz, respectively). A 400 MHZ bandwidth may be set based on a 400 MHz per carrier bandwidth limit. Any other bandwidth may be set based on a per carrier bandwidth limit.

A single numerology may be used across the entire bandwidth of a carrier (e.g., an NR such as shown in FIG. 8). In other example configurations, multiple numerologies may be supported on the same carrier. NR and/or other access technologies may support wide carrier bandwidths (e.g., up to 400 MHz for a subcarrier spacing of 120 kHz). Not all wireless devices may be able to receive the full carrier bandwidth (e.g., due to hardware limitations and/or different wireless device capabilities). Receiving and/or utilizing the full carrier bandwidth may be prohibitive, for example, in terms of wireless device power consumption. A wireless device may adapt the size of the receive bandwidth of the wireless device, for example, based on the amount of traffic the wireless device is scheduled to receive (e.g., to reduce power consumption and/or for other purposes). Such an adaptation may be referred to as bandwidth adaptation.

Configuration of one or more bandwidth parts (BWPs) may support one or more wireless devices not capable of receiving the full carrier bandwidth. BWPs may support bandwidth adaptation, for example, for such wireless devices not capable of receiving the full carrier bandwidth. A BWP (e.g., a BWP of an NR configuration) may be defined by a subset of contiguous RBs on a carrier. A wireless device may be configured (e.g., via an RRC layer) with one or more downlink BWPs per serving cell and one or more uplink BWPs per serving cell (e.g., up to four downlink BWPs per serving cell and up to four uplink BWPs per serving cell). One or more of the configured BWPs for a serving cell may be active, for example, at a given time. The one or more BWPs may be referred to as active BWPs of the serving cell. A serving cell may have one or more first active BWPs in the uplink carrier and one or more second active BWPs in the secondary uplink carrier, for example, if the serving cell is configured with a secondary uplink carrier.

A downlink BWP from a set of configured downlink BWPs may be linked with an uplink BWP from a set of configured uplink BWPs (e.g., for unpaired spectra). A downlink BWP and an uplink BWP may be linked, for example, if a downlink BWP index of the downlink BWP and an uplink BWP index of the uplink BWP are the same. A wireless device may expect that the center frequency for a downlink BWP is the same as the center frequency for an uplink BWP (e.g., for unpaired spectra).

A base station may configure a wireless device with one or more control resource sets (CORESETs) for at least one search space. The base station may configure the wireless device with one or more CORESETS, for example, for a downlink BWP in a set of configured downlink BWPs on a primary cell (PCell) or on a secondary cell (SCell). A search space may comprise a set of locations in the time and frequency domains where the wireless device may monitor/find/detect/identify control information. The search space may be a wireless device-specific search space (e.g., a UE-specific search space) or a common search space (e.g., potentially usable by a plurality of wireless devices or a group of wireless user devices). A base station may configure a group of wireless devices with a common search space, on a PCell or on a primary secondary cell (PSCell), in an active downlink BWP.

A base station may configure a wireless device with one or more resource sets for one or more PUCCH transmissions, for example, for an uplink BWP in a set of configured uplink BWPs. A wireless device may receive downlink receptions (e.g., PDCCH or PDSCH) in a downlink BWP, for example, according to a configured numerology (e.g., a configured subcarrier spacing and/or a configured cyclic prefix duration) for the downlink BWP. The wireless device may send/transmit uplink transmissions (e.g., PUCCH or PUSCH) in an uplink BWP, for example, according to a configured numerology (e.g., a configured subcarrier spacing and/or a configured cyclic prefix length for the uplink BWP).

One or more BWP indicator fields may be provided/comprised in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a wireless device with a default downlink BWP within a set of configured downlink BWPs associated with a PCell. A default downlink BWP may be an initial active downlink BWP, for example, if the base station does not provide/configure a default downlink BWP to/for the wireless device. The wireless device may determine which BWP is the initial active downlink BWP, for example, based on a CORESET configuration obtained using the PBCH.

A base station may configure a wireless device with a BWP inactivity timer value for a PCell. The wireless device may start or restart a BWP inactivity timer at any appropriate time. The wireless device may start or restart the BWP inactivity timer, for example, if one or more conditions are satisfied. The one or more conditions may comprise at least one of: the wireless device detects DCI indicating an active downlink BWP other than a default downlink BWP for a paired spectra operation; the wireless device detects DCI indicating an active downlink BWP other than a default downlink BWP for an unpaired spectra operation; and/or the wireless device detects DCI indicating an active uplink BWP other than a default uplink BWP for an unpaired spectra operation. The wireless device may start/run the BWP inactivity timer toward expiration (e.g., increment from zero to the BWP inactivity timer value, or decrement from the BWP inactivity timer value to zero), for example, if the wireless device does not detect DCI during a time interval (e.g., 1 ms or 0.5 ms). The wireless device may switch from the active downlink BWP to the default downlink BWP, for example, if the BWP inactivity timer expires.

A base station may semi-statically configure a wireless device with one or more BWPs. A wireless device may switch an active BWP from a first BWP to a second BWP, for example, after (e.g., based on or in response to) receiving DCI indicating the second BWP as an active BWP. A wireless device may switch an active BWP from a first BWP to a second BWP, for example, after (e.g., based on or in response to) an expiry of the BWP inactivity timer (e.g., if the second BWP is the default BWP).

A downlink BWP switching may refer to switching an active downlink BWP from a first downlink BWP to a second downlink BWP (e.g., the second downlink BWP is activated and the first downlink BWP is deactivated). An uplink BWP switching may refer to switching an active uplink BWP from a first uplink BWP to a second uplink BWP (e.g., the second uplink BWP is activated and the first uplink BWP is deactivated). Downlink and uplink BWP switching may be performed independently (e.g., in paired spectrum/spectra). Downlink and uplink BWP switching may be performed simultaneously (e.g., in unpaired spectrum/spectra). Switching between configured BWPs may occur, for example, based on RRC signaling, DCI signaling, expiration of a BWP inactivity timer, and/or an initiation of random access.

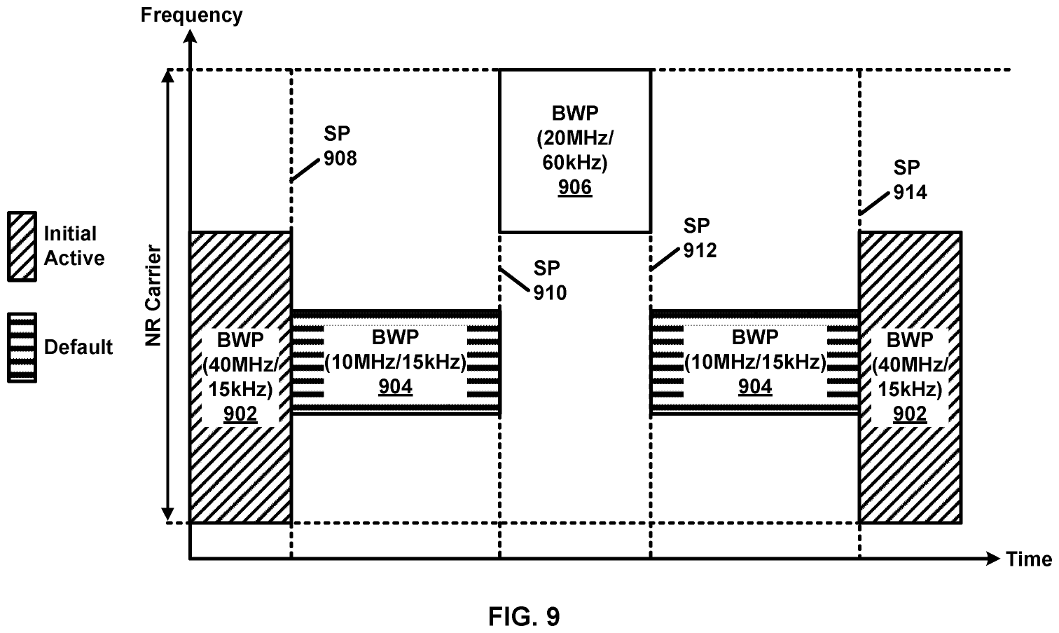

FIG. 9 shows an example of configured BWPs. Bandwidth adaptation using multiple BWPs (e.g., three configured BWPs for an NR carrier) may be available. A wireless device configured with multiple BWPs (e.g., the three BWPs) may switch from one BWP to another BWP at a switching point. The BWPs may comprise: a BWP 902 having a bandwidth of 40 MHz and a subcarrier spacing of 15 kHz; a BWP 904 having a bandwidth of 10 MHz and a subcarrier spacing of 15 kHz; and a BWP 906 having a bandwidth of 20 MHz and a subcarrier spacing of 60 kHz. The BWP 902 may be an initial active BWP, and the BWP 904 may be a default BWP. The wireless device may switch between BWPs at switching points. The wireless device may switch from the BWP 902 to the BWP 904 at a switching point 908. The switching at the switching point 908 may occur for any suitable reasons. The switching at a switching point 908 may occur, for example, after (e.g., based on or in response to) an expiry of a BWP inactivity timer (e.g., indicating switching to the default BWP). The switching at the switching point 908 may occur, for example, after (e.g., based on or in response to) receiving DCI indicating BWP 904 as the active BWP. The wireless device may switch at a switching point 910 from an active BWP 904 to the BWP 906, for example, after or in response receiving DCI indicating BWP 906 as a new active BWP. The wireless device may switch at a switching point 912 from an active BWP 906 to the BWP 904, for example, after (e.g., based on or in response to) an expiry of a BWP inactivity timer. The wireless device may switch at the switching point 912 from an active BWP 906 to the BWP 904, for example, after or in response receiving DCI indicating BWP 904 as a new active BWP. The wireless device may switch at a switching point 914 from an active BWP 904 to the BWP 902, for example, after or in response receiving DCI indicating the BWP 902 as a new active BWP.

Wireless device procedures for switching BWPs on a secondary cell may be the same/similar as those on a primary cell, for example, if the wireless device is configured for a secondary cell with a default downlink BWP in a set of configured downlink BWPs and a timer value. The wireless device may use the timer value and the default downlink BWP for the secondary cell in the same/similar manner as the wireless device uses the timer value and/or default BWPs for a primary cell. The timer value (e.g., the BWP inactivity timer) may be configured per cell (e.g., for one or more BWPs), for example, via RRC signaling or any other signaling. One or more active BWPs may switch to another BWP, for example, based on an expiration of the BWP inactivity timer.

Two or more carriers may be aggregated and data may be simultaneously sent/transmitted to/from the same wireless device using carrier aggregation (CA) (e.g., to increase data rates). The aggregated carriers in CA may be referred to as component carriers (CCs). There may be a number/quantity of serving cells for the wireless device (e.g., one serving cell for a CC), for example, if CA is configured/used. The CCs may have multiple configurations in the frequency domain.

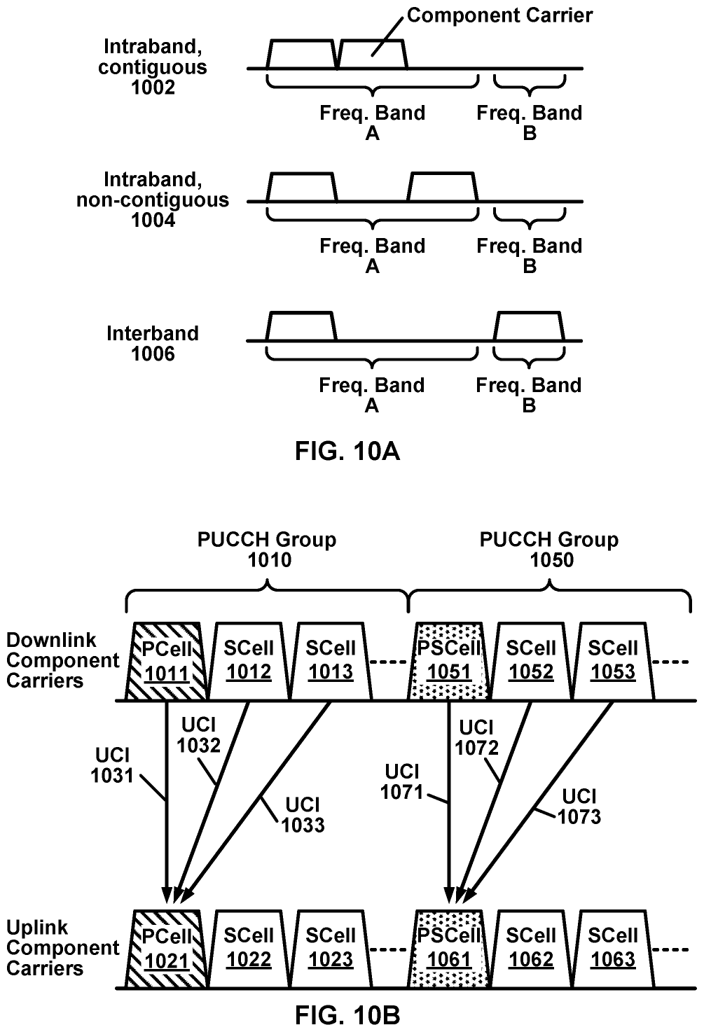

FIG. 10A shows example CA configurations based on CCs. As shown in FIG. 10A, three types of CA configurations may comprise an intraband (contiguous) configuration 1002, an intraband (non-contiguous) configuration 1004, and/or an interband configuration 1006. In the intraband (contiguous) configuration 1002, two CCs may be aggregated in the same frequency band (frequency band A) and may be located directly adjacent to each other within the frequency band. In the intraband (non-contiguous) configuration 1004, two CCs may be aggregated in the same frequency band (frequency band A) but may be separated from each other in the frequency band by a gap. In the interband configuration 1006, two CCs may be located in different frequency bands (e.g., frequency band A and frequency band B, respectively).

A network may set the maximum quantity of CCs that can be aggregated (e.g., up to 32 CCs may be aggregated in NR, or any other quantity may be aggregated in other systems). The aggregated CCs may have the same or different bandwidths, subcarrier spacing, and/or duplexing schemes (TDD, FDD, or any other duplexing schemes). A serving cell for a wireless device using CA may have a downlink CC. One or more uplink CCs may be optionally configured for a serving cell (e.g., for FDD). The ability to aggregate more downlink carriers than uplink carriers may be useful, for example, if the wireless device has more data traffic in the downlink than in the uplink.

One of the aggregated cells for a wireless device may be referred to as a primary cell (PCell), for example, if a CA is configured. The PCell may be the serving cell that the wireless initially connects to or access to, for example, during or at an RRC connection establishment, an RRC connection reestablishment, and/or a handover. The PCell may provide/configure the wireless device with NAS mobility information and the security input. Wireless device may have different PCells. For the downlink, the carrier corresponding to the PCell may be referred to as the downlink primary CC (DL PCC). For the uplink, the carrier corresponding to the PCell may be referred to as the uplink primary CC (UL PCC). The other aggregated cells (e.g., associated with CCs other than the DL PCC and UL PCC) for the wireless device may be referred to as secondary cells (SCells). The SCells may be configured, for example, after the PCell is configured for the wireless device. An SCell may be configured via an RRC connection reconfiguration procedure. For the downlink, the carrier corresponding to an SCell may be referred to as a downlink secondary CC (DL SCC). For the uplink, the carrier corresponding to the SCell may be referred to as the uplink secondary CC (UL SCC).

Configured SCells for a wireless device may be activated or deactivated, for example, based on traffic and channel conditions. Deactivation of an SCell may cause the wireless device to stop PDCCH and PDSCH reception on the SCell and PUSCH, SRS, and CQI transmissions on the SCell. Configured SCells may be activated or deactivated, for example, using a MAC CE (e.g., the MAC CE described with respect to FIG. 4B). A MAC CE may use a bitmap (e.g., one bit per SCell) to indicate which SCells (e.g., in a subset of configured SCells) for the wireless device are activated or deactivated. Configured SCells may be deactivated, for example, after (e.g., based on or in response to) an expiration of an SCell deactivation timer (e.g., one SCell deactivation timer per SCell may be configured).

DCI may comprise control information, such as scheduling assignments and scheduling grants, for a cell. DCI may be sent/transmitted via the cell corresponding to the scheduling assignments and/or scheduling grants, which may be referred to as a self-scheduling. DCI comprising control information for a cell may be sent/transmitted via another cell, which may be referred to as a cross-carrier scheduling. Uplink control information (UCI) may comprise control information, such as HARQ acknowledgments and channel state feedback (e.g., CQI, PMI, and/or RI) for aggregated cells. UCI may be sent/transmitted via an uplink control channel (e.g., a PUCCH) of the PCell or a certain SCell (e.g., an SCell configured with PUCCH). For a larger number of aggregated downlink CCs, the PUCCH of the PCell may become overloaded. Cells may be divided into multiple PUCCH groups.

FIG. 10B shows example group of cells. Aggregated cells may be configured into one or more PUCCH groups (e.g., as shown in FIG. 10B). One or more cell groups or one or more uplink control channel groups (e.g., a PUCCH group 1010 and a PUCCH group 1050) may comprise one or more downlink CCs, respectively. The PUCCH group 1010 may comprise one or more downlink CCs, for example, three downlink CCs: a PCell 1011 (e.g., a DL PCC), an SCell 1012 (e.g., a DL SCC), and an SCell 1013 (e.g., a DL SCC). The PUCCH group 1050 may comprise one or more downlink CCs, for example, three downlink CCs: a PUCCH SCell (or PSCell) 1051 (e.g., a DL SCC), an SCell 1052 (e.g., a DL SCC), and an SCell 1053 (e.g., a DL SCC). One or more uplink CCs of the PUCCH group 1010 may be configured as a PCell 1021 (e.g., a UL PCC), an SCell 1022 (e.g., a UL SCC), and an SCell 1023 (e.g., a UL SCC). One or more uplink CCs of the PUCCH group 1050 may be configured as a PUCCH SCell (or PSCell) 1061 (e.g., a UL SCC), an SCell 1062 (e.g., a UL SCC), and an SCell 1063 (e.g., a UL SCC). UCI related to the downlink CCs of the PUCCH group 1010, shown as UCI 1031, UCI 1032, and UCI 1033, may be sent/transmitted via the uplink of the PCell 1021 (e.g., via the PUCCH of the PCell 1021). UCI related to the downlink CCs of the PUCCH group 1050, shown as UCI 1071, UCI 1072, and UCI 1073, may be sent/transmitted via the uplink of the PUCCH SCell (or PSCell) 1061 (e.g., via the PUCCH of the PUCCH SCell 1061). A single uplink PCell may be configured to send/transmit UCI relating to the six downlink CCs, for example, if the aggregated cells shown in FIG. 10B are not divided into the PUCCH group 1010 and the PUCCH group 1050. The PCell 1021 may become overloaded, for example, if the UCIs 1031, 1032, 1033, 1071, 1072, and 1073 are sent/transmitted via the PCell 1021. By dividing transmissions of UCI between the PCell 1021 and the PUCCH SCell (or PSCell) 1061, overloading may be prevented and/or reduced.

A PCell may comprise a downlink carrier (e.g., the PCell 1011) and an uplink carrier (e.g., the PCell 1021). An SCell may comprise only a downlink carrier. A cell, comprising a downlink carrier and optionally an uplink carrier, may be assigned with a physical cell ID and a cell index. The physical cell ID or the cell index may indicate/identify a downlink carrier and/or an uplink carrier of the cell, for example, depending on the context in which the physical cell ID is used. A physical cell ID may be determined, for example, using a synchronization signal (e.g., PSS and/or SSS) sent/transmitted via a downlink component carrier. A cell index may be determined, for example, using one or more RRC messages. A physical cell ID may be referred to as a carrier ID, and a cell index may be referred to as a carrier index. A first physical cell ID for a first downlink carrier may refer to the first physical cell ID for a cell comprising the first downlink carrier. Substantially the same/similar concept may apply to, for example, a carrier activation. Activation of a first carrier may refer to activation of a cell comprising the first carrier.

A multi-carrier nature of a PHY layer may be exposed/indicated to a MAC layer (e.g., in a CA configuration). A HARQ entity may operate on a serving cell. A transport block may be generated per assignment/grant per serving cell. A transport block and potential HARQ retransmissions of the transport block may be mapped to a serving cell.

For the downlink, a base station may send/transmit (e.g., unicast, multicast, and/or broadcast), to one or more wireless devices, one or more reference signals (RSS) (e.g., PSS, SSS, CSI-RS, DM-RS, and/or PT-RS). For the uplink, the one or more wireless devices may send/transmit one or more RSs to the base station (e.g., DM-RS, PT-RS, and/or SRS). The PSS and the SSS may be sent/transmitted by the base station and used by the one or more wireless devices to synchronize the one or more wireless devices with the base station. A synchronization signal (SS)/physical broadcast channel (PBCH) block may comprise the PSS, the SSS, and the PBCH. The base station may periodically send/transmit a burst of SS/PBCH blocks, which may be referred to as SSBs.

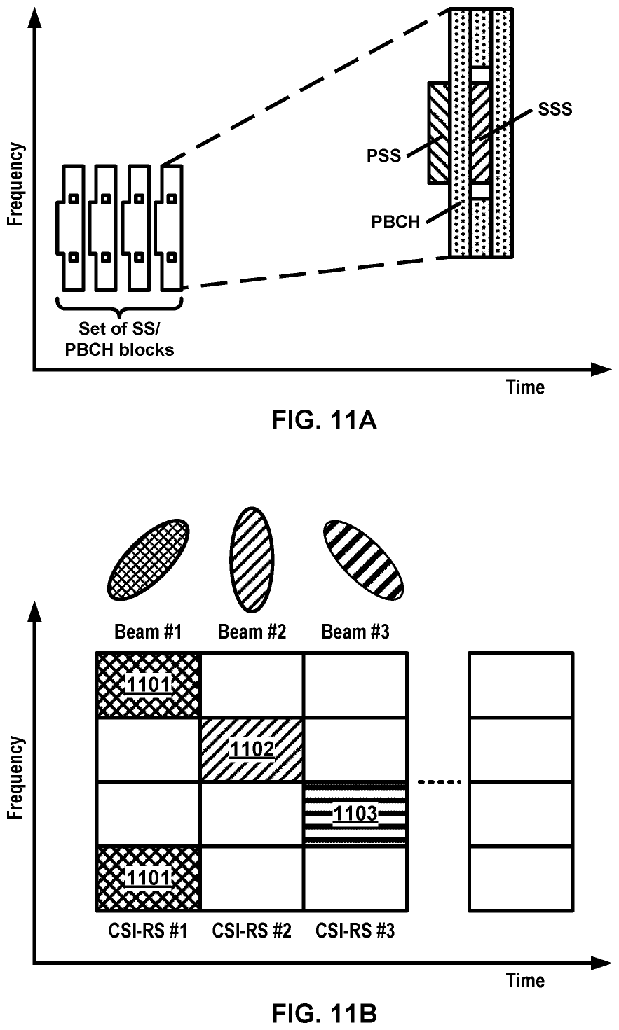

FIG. 11A shows an example mapping of one or more SS/PBCH blocks. A burst of SS/PBCH blocks may comprise one or more SS/PBCH blocks (e.g., 4 SS/PBCH blocks, as shown in FIG. 11A). Bursts may be sent/transmitted periodically (e.g., every 2 frames, 20 ms, or any other durations). A burst may be restricted to a half-frame (e.g., a first half-frame having a duration of 5 ms). Such parameters (e.g., the number of SS/PBCH blocks per burst, periodicity of bursts, position of the burst within the frame) may be configured, for example, based on at least one of: a carrier frequency of a cell in which the SS/PBCH block is sent/transmitted; a numerology or subcarrier spacing of the cell; a configuration by the network (e.g., using RRC signaling); and/or any other suitable factor(s). A wireless device may assume a subcarrier spacing for the SS/PBCH block based on the carrier frequency being monitored, for example, unless the radio network configured the wireless device to assume a different subcarrier spacing.

The SS/PBCH block may span one or more OFDM symbols in the time domain (e.g., 4 OFDM symbols, as shown in FIG. 11A or any other quantity/number of symbols) and may span one or more subcarriers in the frequency domain (e.g., 240 contiguous subcarriers or any other quantity/number of subcarriers). The PSS, the SSS, and the PBCH may have a common center frequency. The PSS may be sent/transmitted first and may span, for example, 1 OFDM symbol and 127 subcarriers. The SSS may be sent/transmitted after the PSS (e.g., two symbols later) and may span 1 OFDM symbol and 127 subcarriers. The PBCH may be sent/transmitted after the PSS (e.g., across the next 3 OFDM symbols) and may span 240 subcarriers (e.g., in the second and fourth OFDM symbols as shown in FIG. 11A) and/or may span fewer than 240 subcarriers (e.g., in the third OFDM symbols as shown in FIG. 11A).

The location of the SS/PBCH block in the time and frequency domains may not be known to the wireless device (e.g., if the wireless device is searching for the cell). The wireless device may monitor a carrier for the PSS, for example, to find and select the cell. The wireless device may monitor a frequency location within the carrier. The wireless device may search for the PSS at a different frequency location within the carrier, for example, if the PSS is not found after a certain duration (e.g., 20 ms). The wireless device may search for the PSS at a different frequency location within the carrier, for example, as indicated by a synchronization raster. The wireless device may determine the locations of the SSS and the PBCH, respectively, for example, based on a known structure of the SS/PBCH block if the PSS is found at a location in the time and frequency domains. The SS/PBCH block may be a cell-defining SS block (CD-SSB). A primary cell may be associated with a CD-SSB. The CD-SSB may be located on a synchronization raster. A cell selection/search and/or reselection may be based on the CD-SSB.

The SS/PBCH block may be used by the wireless device to determine one or more parameters of the cell. The wireless device may determine a physical cell identifier (PCI) of the cell, for example, based on the sequences of the PSS and the SSS, respectively. The wireless device may determine a location of a frame boundary of the cell, for example, based on the location of the SS/PBCH block. The SS/PBCH block may indicate that it has been sent/transmitted in accordance with a transmission pattern. An SS/PBCH block in the transmission pattern may be a known distance from the frame boundary (e.g., a predefined distance for a RAN configuration among one or more networks, one or more base stations, and one or more wireless devices).

The PBCH may use a QPSK modulation and/or forward error correction (FEC). The FEC may use polar coding. One or more symbols spanned by the PBCH may comprise/carry one or more DM-RSs for demodulation of the PBCH. The PBCH may comprise an indication of a current system frame number (SFN) of the cell and/or a SS/PBCH block timing index. These parameters may facilitate time synchronization of the wireless device to the base station. The PBCH may comprise a MIB used to send/transmit to the wireless device one or more parameters. The MIB may be used by the wireless device to locate remaining minimum system information (RMSI) associated with the cell. The RMSI may comprise a System Information Block Type 1 (SIB1). The SIB1 may comprise information for the wireless device to access the cell. The wireless device may use one or more parameters of the MIB to monitor a PDCCH, which may be used to schedule a PDSCH. The PDSCH may comprise the SIB1. The SIB1 may be decoded using parameters provided/comprised in the MIB. The PBCH may indicate an absence of SIB1. The wireless device may be pointed to a frequency, for example, based on the PBCH indicating the absence of SIB1. The wireless device may search for an SS/PBCH block at the frequency to which the wireless device is pointed.

The wireless device may assume that one or more SS/PBCH blocks sent/transmitted with a same SS/PBCH block index are quasi co-located (QCLed) (e.g., having substantially the same/similar Doppler spread, Doppler shift, average gain, average delay, and/or spatial Rx parameters). The wireless device may not assume QCL for SS/PBCH block transmissions having different SS/PBCH block indexes. SS/PBCH blocks (e.g., those within a half-frame) may be sent/transmitted in spatial directions (e.g., using different beams that span a coverage area of the cell). A first SS/PBCH block may be sent/transmitted in a first spatial direction using a first beam, a second SS/PBCH block may be sent/transmitted in a second spatial direction using a second beam, a third SS/PBCH block may be sent/transmitted in a third spatial direction using a third beam, a fourth SS/PBCH block may be sent/transmitted in a fourth spatial direction using a fourth beam, etc.

A base station may send/transmit a plurality of SS/PBCH blocks, for example, within a frequency span of a carrier. A first PCI of a first SS/PBCH block of the plurality of SS/PBCH blocks may be different from a second PCI of a second SS/PBCH block of the plurality of SS/PBCH blocks. The PCIs of SS/PBCH blocks sent/transmitted in different frequency locations may be different or substantially the same.

The CSI-RS may be sent/transmitted by the base station and used by the wireless device to acquire/obtain/determine channel state information (CSI). The base station may configure the wireless device with one or more CSI-RSs for channel estimation or any other suitable purpose. The base station may configure a wireless device with one or more of the same/similar CSI-RSs. The wireless device may measure the one or more CSI-RSs. The wireless device may estimate a downlink channel state and/or generate a CSI report, for example, based on the measuring of the one or more downlink CSI-RSs. The wireless device may send/transmit the CSI report to the base station (e.g., based on periodic CSI reporting, semi-persistent CSI reporting, and/or aperiodic CSI reporting). The base station may use feedback provided by the wireless device (e.g., the estimated downlink channel state) to perform a link adaptation.

The base station may semi-statically configure the wireless device with one or more CSI-RS resource sets. A CSI-RS resource may be associated with a location in the time and frequency domains and a periodicity. The base station may selectively activate and/or deactivate a CSI-RS resource. The base station may indicate to the wireless device that a CSI-RS resource in the CSI-RS resource set is activated and/or deactivated.

The base station may configure the wireless device to report CSI measurements. The base station may configure the wireless device to provide CSI reports periodically, aperiodically, or semi-persistently. For periodic CSI reporting, the wireless device may be configured with a timing and/or periodicity of a plurality of CSI reports. For aperiodic CSI reporting, the base station may request a CSI report. The base station may command the wireless device to measure a configured CSI-RS resource and provide a CSI report relating to the measurement(s). For semi-persistent CSI reporting, the base station may configure the wireless device to send/transmit periodically, and selectively activate or deactivate the periodic reporting (e.g., via one or more activation/deactivation MAC CEs and/or one or more DCIs). The base station may configure the wireless device with a CSI-RS resource set and CSI reports, for example, using RRC signaling.

The CSI-RS configuration may comprise one or more parameters indicating, for example, up to 32 antenna ports (or any other quantity of antenna ports). The wireless device may be configured to use/employ the same OFDM symbols for a downlink CSI-RS and a CORESET, for example, if the downlink CSI-RS and CORESET are spatially QCLed and resource elements associated with the downlink CSI-RS are outside of the physical resource blocks (PRBs) configured for the CORESET. The wireless device may be configured to use/employ the same OFDM symbols for a downlink CSI-RS and SS/PBCH blocks, for example, if the downlink CSI-RS and SS/PBCH blocks are spatially QCLed and resource elements associated with the downlink CSI-RS are outside of PRBs configured for the SS/PBCH blocks.

Downlink DM-RSs may be sent/transmitted by a base station and received/used by a wireless device for a channel estimation. The downlink DM-RSs may be used for coherent demodulation of one or more downlink physical channels (e.g., PDSCH). A network (e.g., an NR network) may support one or more variable and/or configurable DM-RS patterns for data demodulation. At least one downlink DM-RS configuration may support a front-loaded DM-RS pattern. A front-loaded DM-RS may be mapped over one or more OFDM symbols (e.g., one or two adjacent OFDM symbols). A base station may semi-statically configure the wireless device with a number/quantity (e.g. a maximum number/quantity) of front-loaded DM-RS symbols for a PDSCH. A DM-RS configuration may support one or more DM-RS ports. A DM-RS configuration may support up to eight orthogonal downlink DM-RS ports per wireless device (e.g., for single user-MIMO). A DM-RS configuration may support up to 4 orthogonal downlink DM-RS ports per wireless device (e.g., for multiuser-MIMO). A radio network may support (e.g., at least for CP-OFDM) a common DM-RS structure for downlink and uplink. A DM-RS location, a DM-RS pattern, and/or a scrambling sequence may be the same or different. The base station may send/transmit a downlink DM-RS and a corresponding PDSCH, for example, using the same precoding matrix. The wireless device may use the one or more downlink DM-RSs for coherent demodulation/channel estimation of the PDSCH.

A transmitter (e.g., a transmitter of a base station) may use a precoder matrices for a part of a transmission bandwidth. The transmitter may use a first precoder matrix for a first bandwidth and a second precoder matrix for a second bandwidth. The first precoder matrix and the second precoder matrix may be different, for example, based on the first bandwidth being different from the second bandwidth. The wireless device may assume that a same precoding matrix is used across a set of PRBs. The set of PRBs may be determined/indicated/identified/denoted as a precoding resource block group (PRG).

A PDSCH may comprise one or more layers. The wireless device may assume that at least one symbol with DM-RS is present on a layer of the one or more layers of the PDSCH. A higher layer may configure one or more DM-RSs for a PDSCH (e.g., up to 3 DMRSs for the PDSCH). Downlink PT-RS may be sent/transmitted by a base station and used by a wireless device, for example, for a phase-noise compensation. Whether a downlink PT-RS is present or not may depend on an RRC configuration. The presence and/or the pattern of the downlink PT-RS may be configured on a wireless device-specific basis, for example, using a combination of RRC signaling and/or an association with one or more parameters used/employed for other purposes (e.g., modulation and coding scheme (MCS)), which may be indicated by DCI. A dynamic presence of a downlink PT-RS, if configured, may be associated with one or more DCI parameters comprising at least MCS. A network (e.g., an NR network) may support a plurality of PT-RS densities defined in the time and/or frequency domains. A frequency domain density (if configured/present) may be associated with at least one configuration of a scheduled bandwidth. The wireless device may assume a same precoding for a DM-RS port and a PT-RS port. The quantity/number of PT-RS ports may be fewer than the quantity/number of DM-RS ports in a scheduled resource. Downlink PT-RS may be configured/allocated/confined in the scheduled time/frequency duration for the wireless device. Downlink PT-RS may be sent/transmitted via symbols, for example, to facilitate a phase tracking at the receiver.

The wireless device may send/transmit an uplink DM-RS to a base station, for example, for a channel estimation. The base station may use the uplink DM-RS for coherent demodulation of one or more uplink physical channels. The wireless device may send/transmit an uplink DM-RS with a PUSCH and/or a PUCCH. The uplink DM-RS may span a range of frequencies that is similar to a range of frequencies associated with the corresponding physical channel. The base station may configure the wireless device with one or more uplink DM-RS configurations. At least one DM-RS configuration may support a front-loaded DM-RS pattern. The front-loaded DM-RS may be mapped over one or more OFDM symbols (e.g., one or two adjacent OFDM symbols). One or more uplink DM-RSs may be configured to send/transmit at one or more symbols of a PUSCH and/or a PUCCH. The base station may semi-statically configure the wireless device with a number/quantity (e.g. the maximum number/quantity) of front-loaded DM-RS symbols for the PUSCH and/or the PUCCH, which the wireless device may use to schedule a single-symbol DM-RS and/or a double-symbol DM-RS. A network (e.g., an NR network) may support (e.g., for cyclic prefix orthogonal frequency division multiplexing (CP-OFDM)) a common DM-RS structure for downlink and uplink. A DM-RS location, a DM-RS pattern, and/or a scrambling sequence for the DM-RS may be substantially the same or different.

A PUSCH may comprise one or more layers. A wireless device may send/transmit at least one symbol with DM-RS present on a layer of the one or more layers of the PUSCH. A higher layer may configure one or more DM-RSs (e.g., up to three DMRSs) for the PUSCH. Uplink PT-RS (which may be used by a base station for a phase tracking and/or a phase-noise compensation) may or may not be present, for example, depending on an RRC configuration of the wireless device. The presence and/or the pattern of an uplink PT-RS may be configured on a wireless device-specific basis (e.g., a UE-specific basis), for example, by a combination of RRC signaling and/or one or more parameters configured/employed for other purposes (e.g., MCS), which may be indicated by DCI. A dynamic presence of an uplink PT-RS, if configured, may be associated with one or more DCI parameters comprising at least MCS. A radio network may support a plurality of uplink PT-RS densities defined in time/frequency domain. A frequency domain density (if configured/present) may be associated with at least one configuration of a scheduled bandwidth. The wireless device may assume a same precoding for a DM-RS port and a PT-RS port. A quantity/number of PT-RS ports may be less than a quantity/number of DM-RS ports in a scheduled resource. An uplink PT-RS may be configured/allocated/confined in the scheduled time/frequency duration for the wireless device.

One or more SRSs may be sent/transmitted by a wireless device to a base station, for example, for a channel state estimation to support uplink channel dependent scheduling and/or a link adaptation. SRS sent/transmitted by the wireless device may enable/allow a base station to estimate an uplink channel state at one or more frequencies. A scheduler at the base station may use/employ the estimated uplink channel state to assign one or more resource blocks for an uplink PUSCH transmission for the wireless device. The base station may semi-statically configure the wireless device with one or more SRS resource sets. For an SRS resource set, the base station may configure the wireless device with one or more SRS resources. An SRS resource set applicability may be configured, for example, by a higher layer (e.g., RRC) parameter. An SRS resource in an SRS resource set of the one or more SRS resource sets (e.g., with the same/similar time domain behavior, periodic, aperiodic, and/or the like) may be sent/transmitted at a time instant (e.g., simultaneously), for example, if a higher layer parameter indicates beam management. The wireless device may send/transmit one or more SRS resources in SRS resource sets. A network (e.g., an NR network) may support aperiodic, periodic, and/or semi-persistent SRS transmissions. The wireless device may send/transmit SRS resources, for example, based on one or more trigger types. The one or more trigger types may comprise higher layer signaling (e.g., RRC) and/or one or more DCI formats. At least one DCI format may be used/employed for the wireless device to select at least one of one or more configured SRS resource sets. An SRS trigger type 0 may refer to an SRS triggered based on higher layer signaling. An SRS trigger type 1 may refer to an SRS triggered based on one or more DCI formats. The wireless device may be configured to send/transmit an SRS, for example, after a transmission of a PUSCH and a corresponding uplink DM-RS if a PUSCH and an SRS are sent/transmitted in a same slot. A base station may semi-statically configure a wireless device with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; an offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port may be determined/defined such that the channel over which a symbol on the antenna port is conveyed can be inferred from the channel over which another symbol on the same antenna port is conveyed. The receiver may infer/determine the channel (e.g., fading gain, multipath delay, and/or the like) for conveying a second symbol on an antenna port, from the channel for conveying a first symbol on the antenna port, for example, if the first symbol and the second symbol are sent/transmitted on the same antenna port. A first antenna port and a second antenna port may be referred to as quasi co-located (QCLed), for example, if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming may require beam management. Beam management may comprise a beam measurement, a beam selection, and/or a beam indication. A beam may be associated with one or more reference signals. A beam may be identified by one or more beamformed reference signals. The wireless device may perform a downlink beam measurement, for example, based on one or more downlink reference signals (e.g., a CSI-RS) and generate a beam measurement report. The wireless device may perform the downlink beam measurement procedure, for example, after an RRC connection is set up with a base station.

FIG. 11B shows an example mapping of one or more CSI-RSs. The CSI-RSs may be mapped in the time and frequency domains. Each rectangular block shown in FIG. 11B may correspond to a resource block (RB) within a bandwidth of a cell. A base station may send/transmit one or more RRC messages comprising CSI-RS resource configuration parameters indicating one or more CSI-RSs. One or more of parameters may be configured by higher layer signaling (e.g., RRC and/or MAC signaling) for a CSI-RS resource configuration. The one or more of the parameters may comprise at least one of: a CSI-RS resource configuration identity, a number of CSI-RS ports, a CSI-RS configuration (e.g., symbol and resource element (RE) locations in a subframe), a CSI-RS subframe configuration (e.g., a subframe location, an offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

One or more beams may be configured for a wireless device in a wireless device-specific configuration. Three beams are shown in FIG. 11B (beam #1, beam #2, and beam #3), but more or fewer beams may be configured. Beam #1 may be allocated with CSI-RS 1101 that may be sent/transmitted in one or more subcarriers in an RB of a first symbol. Beam #2 may be allocated with CSI-RS 1102 that may be sent/transmitted in one or more subcarriers in an RB of a second symbol. Beam #3 may be allocated with CSI-RS 1103 that may be sent/transmitted in one or more subcarriers in an RB of a third symbol. A base station may use other subcarriers in the same RB (e.g., those that are not used to send/transmit CSI-RS 1101) to transmit another CSI-RS associated with a beam for another wireless device, for example, by using frequency division multiplexing (FDM). Beams used for a wireless device may be configured such that beams for the wireless device use symbols different from symbols used by beams of other wireless devices, for example, by using time domain multiplexing (TDM). A wireless device may be served with beams in orthogonal symbols (e.g., no overlapping symbols), for example, by using the TDM.

CSI-RSs (e.g., CSI-RSs 1101, 1102, 1103) may be sent/transmitted by the base station and used by the wireless device for one or more measurements. The wireless device may measure an RSRP of configured CSI-RS resources. The base station may configure the wireless device with a reporting configuration, and the wireless device may report the RSRP measurements to a network (e.g., via one or more base stations) based on the reporting configuration. The base station may determine, based on the reported measurement results, one or more transmission configuration indication (TCI) states comprising a number of reference signals. The base station may indicate one or more TCI states to the wireless device (e.g., via RRC signaling, a MAC CE, and/or DCI). The wireless device may receive a downlink transmission with an Rx beam determined based on the one or more TCI states. The wireless device may or may not have a capability of beam correspondence. The wireless device may determine a spatial domain filter of a transmit (Tx) beam, for example, based on a spatial domain filter of the corresponding Rx beam, if the wireless device has the capability of beam correspondence. The wireless device may perform an uplink beam selection procedure to determine the spatial domain filter of the Tx beam, for example, if the wireless device does not have the capability of beam correspondence. The wireless device may perform the uplink beam selection procedure, for example, based on one or more sounding reference signal (SRS) resources configured to the wireless device by the base station. The base station may select and indicate uplink beams for the wireless device, for example, based on measurements of the one or more SRS resources sent/transmitted by the wireless device.

A wireless device may determine/assess (e.g., measure) a channel quality of one or more beam pair links, for example, in a beam management procedure. A beam pair link may comprise a Tx beam of a base station and an Rx beam of the wireless device. The Tx beam of the base station may send/transmit a downlink signal, and the Rx beam of the wireless device may receive the downlink signal. The wireless device may send/transmit a beam measurement report, for example, based on the assessment/determination. The beam measurement report may indicate one or more beam pair quality parameters comprising at least one of: one or more beam identifications (e.g., a beam index, a reference signal index, or the like), an RSRP, a precoding matrix indicator (PMI), a channel quality indicator (CQI), and/or a rank indicator (RI).

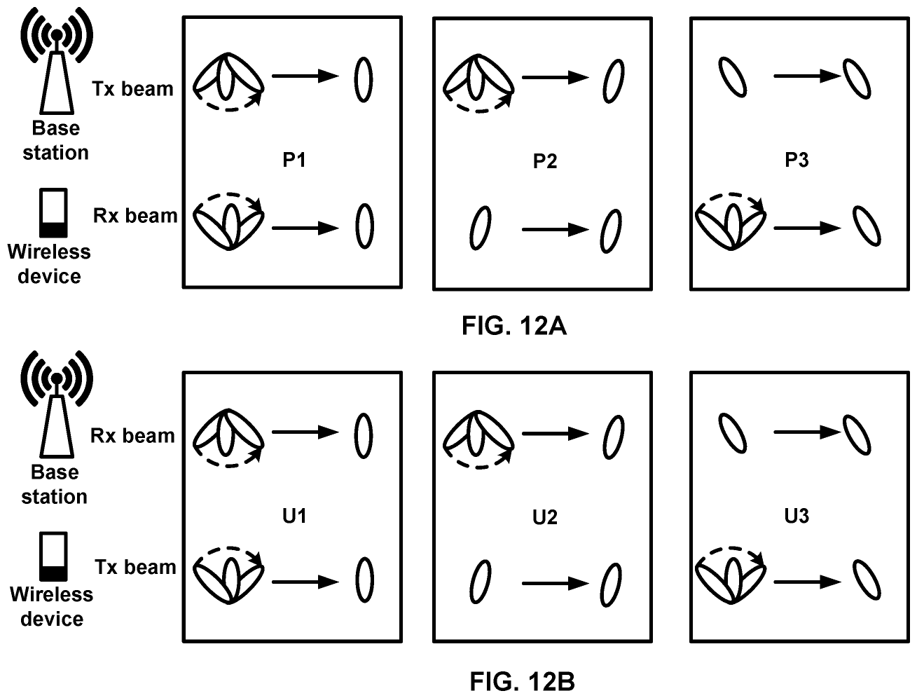

FIG. 12A shows examples of downlink beam management procedures. One or more downlink beam management procedures (e.g., downlink beam management procedures P1, P2, and P3) may be performed. Procedure P1 may enable a measurement (e.g., a wireless device measurement) on Tx beams of a TRP (or multiple TRPs) (e.g., to support a selection of one or more base station Tx beams and/or wireless device Rx beams). The Tx beams of a base station and the Rx beams of a wireless device are shown as ovals in the top row of P1 and bottom row of P1, respectively. Beamforming (e.g., at a TRP) may comprise a Tx beam sweep for a set of beams (e.g., the beam sweeps shown, in the top rows of P1 and P2, as ovals rotated in a counter-clockwise direction indicated by the dashed arrows). Beamforming (e.g., at a wireless device) may comprise an Rx beam sweep for a set of beams (e.g., the beam sweeps shown, in the bottom rows of P1 and P3, as ovals rotated in a clockwise direction indicated by the dashed arrows). Procedure P2 may be used to enable a measurement (e.g., a wireless device measurement) on Tx beams of a TRP (shown, in the top row of P2, as ovals rotated in a counter-clockwise direction indicated by the dashed arrow). The wireless device and/or the base station may perform procedure P2, for example, using a smaller set of beams than the set of beams used in procedure P1, or using narrower beams than the beams used in procedure P1. Procedure P2 may be referred to as a beam refinement. The wireless device may perform procedure P3 for an Rx beam determination, for example, by using the same Tx beam(s) of the base station and sweeping Rx beam(s) of the wireless device.

FIG. 12B shows examples of uplink beam management procedures. One or more uplink beam management procedures (e.g., uplink beam management procedures U1, U2, and U3) may be performed. Procedure U1 may be used to enable a base station to perform a measurement on Tx beams of a wireless device (e.g., to support a selection of one or more Tx beams of the wireless device and/or Rx beams of the base station). The Tx beams of the wireless device and the Rx beams of the base station are shown as ovals in the top row of U1 and bottom row of U1, respectively). Beamforming (e.g., at the wireless device) may comprise one or more beam sweeps, for example, a Tx beam sweep from a set of beams (shown, in the bottom rows of U1 and U3, as ovals rotated in a clockwise direction indicated by the dashed arrows). Beamforming (e.g., at the base station) may comprise one or more beam sweeps, for example, an Rx beam sweep from a set of beams (shown, in the top rows of U1 and U2, as ovals rotated in a counter-clockwise direction indicated by the dashed arrows). Procedure U2 may be used to enable the base station to adjust its Rx beam, for example, if the UE uses a fixed Tx beam. The wireless device and/or the base station may perform procedure U2, for example, using a smaller set of beams than the set of beams used in procedure P1, or using narrower beams than the beams used in procedure P1. Procedure U2 may be referred to as a beam refinement. The wireless device may perform procedure U3 to adjust its Tx beam, for example, if the base station uses a fixed Rx beam.

A wireless device may initiate/start/perform a beam failure recovery (BFR) procedure, for example, based on detecting a beam failure. The wireless device may send/transmit a BFR request (e.g., a preamble, UCI, an SR, a MAC CE, and/or the like), for example, based on the initiating the BFR procedure. The wireless device may detect the beam failure, for example, based on a determination that a quality of beam pair link(s) of an associated control channel is unsatisfactory (e.g., having an error rate higher than an error rate threshold, a received signal power lower than a received signal power threshold, an expiration of a timer, and/or the like).

The wireless device may measure a quality of a beam pair link, for example, using one or more reference signals (RSs) comprising one or more SS/PBCH blocks, one or more CSI-RS resources, and/or one or more DM-RSs. A quality of the beam pair link may be based on one or more of a block error rate (BLER), an RSRP value, a signal to interference plus noise ratio (SINR) value, an RSRQ value, and/or a CSI value measured on RS resources. The base station may indicate that an RS resource is QCLed with one or more DM-RSs of a channel (e.g., a control channel, a shared data channel, and/or the like). The RS resource and the one or more DM-RSs of the channel may be QCLed, for example, if the channel characteristics (e.g., Doppler shift, Doppler spread, an average delay, delay spread, a spatial Rx parameter, fading, and/or the like) from a transmission via the RS resource to the wireless device are similar or the same as the channel characteristics from a transmission via the channel to the wireless device.

A network (e.g., an NR network comprising a gNB and/or an ng-eNB) and/or the wireless device may initiate/start/perform a random access procedure. A wireless device in an RRC idle (e.g., an RRC_IDLE) state and/or an RRC inactive (e.g., an RRC_INACTIVE) state may initiate/perform the random access procedure to request a connection setup to a network. The wireless device may initiate/start/perform the random access procedure from an RRC connected (e.g., an RRC_CONNECTED) state. The wireless device may initiate/start/perform the random access procedure to request uplink resources (e.g., for uplink transmission of an SR if there is no PUCCH resource available) and/or acquire/obtain/determine an uplink timing (e.g., if an uplink synchronization status is non-synchronized). The wireless device may initiate/start/perform the random access procedure to request one or more system information blocks (SIBs) (e.g., other system information blocks, such as SIB2, SIB3, and/or the like). The wireless device may initiate/start/perform the random access procedure for a beam failure recovery request. A network may initiate/start/perform a random access procedure, for example, for a handover and/or for establishing time alignment for an SCell addition.

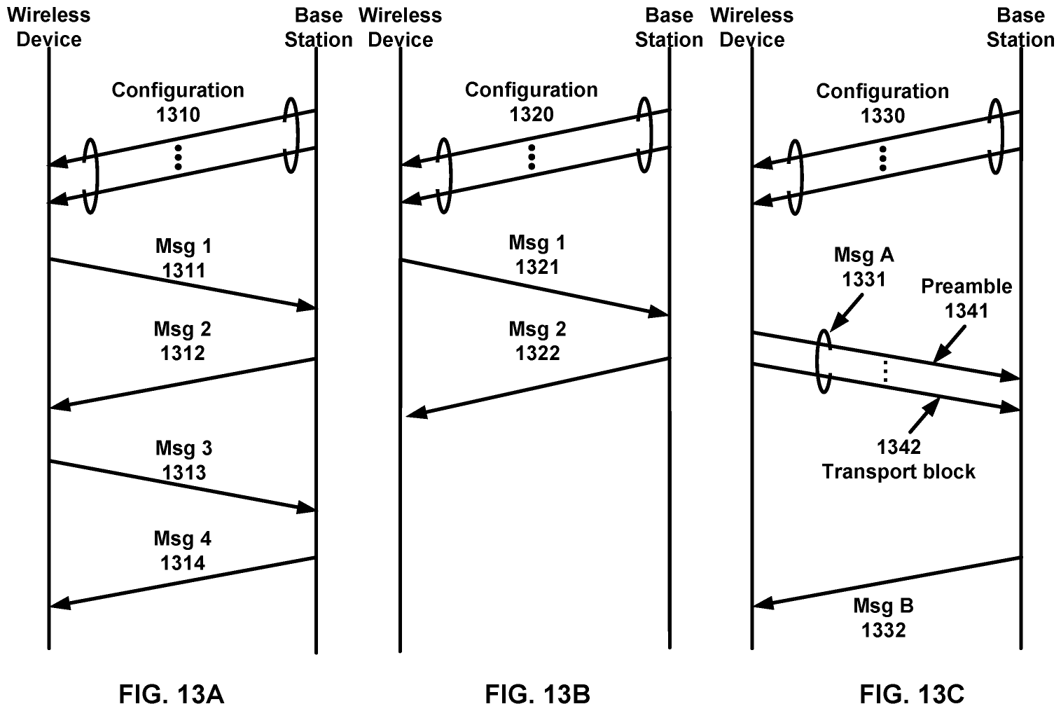

FIG. 13A shows an example four-step random access procedure. The four-step random access procedure may comprise a four-step contention-based random access procedure. A base station may send/transmit a configuration message 1310 to a wireless device, for example, before initiating the random access procedure. The four-step random access procedure may comprise transmissions of four messages comprising: a first message (e.g., Msg 1 1311), a second message (e.g., Msg 2 1312), a third message (e.g., Msg 3 1313), and a fourth message (e.g., Msg 4 1314). The first message (e.g., Msg 1 1311) may comprise a preamble (or a random access preamble). The first message (e.g., Msg 1 1311) may be referred to as a preamble. The second message (e.g., Msg 2 1312) may comprise as a random access response (RAR). The second message (e.g., Msg 2 1312) may be referred to as an RAR.

The configuration message 1310 may be sent/transmitted, for example, using one or more RRC messages. The one or more RRC messages may indicate one or more random access channel (RACH) parameters to the wireless device. The one or more RACH parameters may comprise at least one of: general parameters for one or more random access procedures (e.g., RACH-configGeneral); cell-specific parameters (e.g., RACH-ConfigCommon); and/or dedicated parameters (e.g., RACH-ConfigDedicated). The base station may send/transmit (e.g., broadcast or multicast) the one or more RRC messages to one or more wireless devices. The one or more RRC messages may be wireless device-specific. The one or more RRC messages that are wireless device-specific may be, for example, dedicated RRC messages sent/transmitted to a wireless device in an RRC connected (e.g., an RRC_CONNECTED) state and/or in an RRC inactive (e.g., an RRC_INACTIVE) state. The wireless devices may determine, based on the one or more RACH parameters, a time-frequency resource and/or an uplink transmit power for transmission of the first message (e.g., Msg 1 1311) and/or the third message (e.g., Msg 3 1313). The wireless device may determine a reception timing and a downlink channel for receiving the second message (e.g., Msg 2 1312) and the fourth message (e.g., Msg 4 1314), for example, based on the one or more RACH parameters.

The one or more RACH parameters provided/configured/comprised in the configuration message 1310 may indicate one or more Physical RACH (PRACH) occasions available for transmission of the first message (e.g., Msg 1 1311). The one or more PRACH occasions may be predefined (e.g., by a network comprising one or more base stations). The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. The one or more RACH parameters may indicate a quantity/number of SS/PBCH blocks mapped to a PRACH occasion and/or a quantity/number of preambles mapped to a SS/PBCH blocks.

The one or more RACH parameters provided/configured/comprised in the configuration message 1310 may be used to determine an uplink transmit power of first message (e.g., Msg 1 1311) and/or third message (e.g., Msg 3 1313). The one or more RACH parameters may indicate a reference power for a preamble transmission (e.g., a received target power and/or an initial power of the preamble transmission). There may be one or more power offsets indicated by the one or more RACH parameters. The one or more RACH parameters may indicate: a power ramping step; a power offset between SSB and CSI-RS; a power offset between transmissions of the first message (e.g., Msg 1 1311) and the third message (e.g., Msg 3 1313); and/or a power offset value between preamble groups. The one or more RACH parameters may indicate one or more thresholds, for example, based on which the wireless device may determine at least one reference signal (e.g., an SSB and/or CSI-RS) and/or an uplink carrier (e.g., a normal uplink (NUL) carrier and/or a supplemental uplink (SUL) carrier).

The first message (e.g., Msg 1 1311) may comprise one or more preamble transmissions (e.g., a preamble transmission and one or more preamble retransmissions). An RRC message may be used to configure one or more preamble groups (e.g., group A and/or group B). A preamble group may comprise one or more preambles. The wireless device may determine the preamble group, for example, based on a pathloss measurement and/or a size of the third message (e.g., Msg 3 1313). The wireless device may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The wireless device may select at least one preamble associated with the one or more reference signals and/or a selected preamble group, for example, if the association between the one or more preambles and the at least one reference signal is configured by an RRC message.

The wireless device may determine the preamble, for example, based on the one or more RACH parameters provided/configured/comprised in the configuration message 1310. The wireless device may determine the preamble, for example, based on a pathloss measurement, an RSRP measurement, and/or a size of the third message (e.g., Msg 3 1313). The one or more RACH parameters may indicate: a preamble format; a maximum quantity/number of preamble transmissions; and/or one or more thresholds for determining one or more preamble groups (e.g., group A and group B). A base station may use the one or more RACH parameters to configure the wireless device with an association between one or more preambles and one or more reference signals (e.g., SSBs and/or CSI-RSs). The wireless device may determine the preamble to be comprised in first message (e.g., Msg 1 1311), for example, based on the association if the association is configured. The first message (e.g., Msg 1 1311) may be sent/transmitted to the base station via one or more PRACH occasions. The wireless device may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The wireless device may perform a preamble retransmission, for example, if no response is received after (e.g., based on or in response to) a preamble transmission (e.g., for a period of time, such as a monitoring window for monitoring an RAR). The wireless device may increase an uplink transmit power for the preamble retransmission. The wireless device may select an initial preamble transmit power, for example, based on a pathloss measurement and/or a target received preamble power configured by the network. The wireless device may determine to resend/retransmit a preamble and may ramp up the uplink transmit power. The wireless device may receive one or more RACH parameters (e.g., PREAMBLE_POWER_RAMPING_STEP) indicating a ramping step for the preamble retransmission. The ramping step may be an amount of incremental increase in uplink transmit power for a retransmission. The wireless device may ramp up the uplink transmit power, for example, if the wireless device determines a reference signal (e.g., SSB and/or CSI-RS) that is the same as a previous preamble transmission. The wireless device may count the quantity/number of preamble transmissions and/or retransmissions, for example, using a counter parameter (e.g., PREAMBLE_TRANSMISSION_COUNTER). The wireless device may determine that a random access procedure has been completed unsuccessfully, for example, if the quantity/number of preamble transmissions exceeds a threshold configured by the one or more RACH parameters (e.g., preambleTransMax) without receiving a successful response (e.g., an RAR).

The second message (e.g., Msg 2 1312) (e.g., received by the wireless device) may comprise an RAR. The second message (e.g., Msg 2 1312) may comprise multiple RARs corresponding to multiple wireless devices. The second message (e.g., Msg 2 1312) may be received, for example, after (e.g., based on or in response to) the sending/sending (e.g., transmitting) of the first message (e.g., Msg 1 1311). The second message (e.g., Msg 2 1312) may be scheduled on the DL-SCH and may be indicated by a PDCCH, for example, using a random access radio network temporary identifier (RA RNTI). The second message (e.g., Msg 2 1312) may indicate that the first message (e.g., Msg 1 1311) was received by the base station. The second message (e.g., Msg 2 1312) may comprise a time-alignment command that may be used by the wireless device to adjust the transmission timing of the wireless device, a scheduling grant for transmission of the third message (e.g., Msg 3 1313), and/or a Temporary Cell RNTI (TC-RNTI). The wireless device may determine/start a time window (e.g., ra-Response Window) to monitor a PDCCH for the second message (e.g., Msg 2 1312), for example, after sending/sending (e.g., transmitting) the first message (e.g., Msg 1 1311) (e.g., a preamble). The wireless device may determine the start time of the time window, for example, based on a PRACH occasion that the wireless device uses to send/transmit the first message (e.g., Msg 1 1311) (e.g., the preamble). The wireless device may start the time window one or more symbols after the last symbol of the first message (e.g., Msg 1 1311) comprising the preamble (e.g., the symbol in which the first message (e.g., Msg 1 1311) comprising the preamble transmission was completed or at a first PDCCH occasion from an end of a preamble transmission). The one or more symbols may be determined based on a numerology. The PDCCH may be mapped in a common search space (e.g., a Type 1-PDCCH common search space) configured by an RRC message. The wireless device may identify/determine the RAR, for example, based on an RNTI. Radio network temporary identifiers (RNTIs) may be used depending on one or more events initiating/starting the random access procedure. The wireless device may use a RA-RNTI, for example, for one or more communications associated with random access or any other purpose. The RA-RNTI may be associated with PRACH occasions in which the wireless device sends/transmits a preamble. The wireless device may determine the RA-RNTI, for example, based on at least one of: an OFDM symbol index; a slot index; a frequency domain index; and/or a UL carrier indicator of the PRACH occasions. An example RA-RNTI may be determined as follows:

$$RA - RNTI = 1 + s\_id + 14 \times t\_id + 14 \times 80 \times f\_id + 14 \times 80 \times 8 \times ul\_carrier \_id$$

where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The wireless device may send/transmit the third message (e.g., Msg 3 1313), for example, after (e.g., based on or in response to) a successful reception of the second message (e.g., Msg 2 1312) (e.g., using resources identified in the Msg 2 1312). The third message (e.g., Msg 3 1313) may be used, for example, for contention resolution in the contention-based random access procedure. A plurality of wireless devices may send/transmit the same preamble to a base station, and the base station may send/transmit an RAR that corresponds to a wireless device. Collisions may occur, for example, if the plurality of wireless device interpret the RAR as corresponding to themselves. Contention resolution (e.g., using the third message (e.g., Msg 3 1313) and the fourth message (e.g., Msg 4 1314)) may be used to increase the likelihood that the wireless device does not incorrectly use an identity of another the wireless device. The wireless device may comprise a device identifier in the third message (e.g., Msg 3 1313) (e.g., a C-RNTI if assigned, a TC RNTI comprised in the second message (e.g., Msg 2 1312), and/or any other suitable identifier), for example, to perform contention resolution.

The fourth message (e.g., Msg 4 1314) may be received, for example, after (e.g., based on or in response to) the sending/sending (e.g., transmitting) of the third message (e.g., Msg 3 1313). The base station may address the wireless on the PDCCH (e.g., the base station may send the PDCCH to the wireless device) using a C-RNTI, for example, If the C-RNTI was included in the third message (e.g., Msg 3 1313). The random access procedure may be determined to be successfully completed, for example, if the unique C RNTI of the wireless device is detected on the PDCCH (e.g., the PDCCH is scrambled by the C-RNTI). Fourth message (e.g., Msg 4 1314) may be received using a DL-SCH associated with a TC RNTI, for example, if the TC RNTI is comprised in the third message (e.g., Msg 3 1313) (e.g., if the wireless device is in an RRC idle (e.g., an RRC_IDLE) state or not otherwise connected to the base station). The wireless device may determine that the contention resolution is successful and/or the wireless device may determine that the random access procedure is successfully completed, for example, if a MAC PDU is successfully decoded and a MAC PDU comprises the wireless device contention resolution identity MAC CE that matches or otherwise corresponds with the CCCH SDU sent/transmitted in third message (e.g., Msg 3 1313).

The wireless device may be configured with an SUL carrier and/or an NUL carrier. An initial access (e.g., random access) may be supported via an uplink carrier. A base station may configure the wireless device with multiple RACH configurations (e.g., two separate RACH configurations comprising: one for an SUL carrier and the other for an NUL carrier). For random access in a cell configured with an SUL carrier, the network may indicate which carrier to use (NUL or SUL). The wireless device may determine to use the SUL carrier, for example, if a measured quality of one or more reference signals (e.g., one or more reference signals associated with the NUL carrier) is lower than a broadcast threshold. Uplink transmissions of the random access procedure (e.g., the first message (e.g., Msg 1 1311) and/or the third message (e.g., Msg 3 1313)) may remain on, or may be performed via, the selected carrier. The wireless device may switch an uplink carrier during the random access procedure (e.g., between the Msg 1 1311 and the Msg 3 1313). The wireless device may determine and/or switch an uplink carrier for the first message (e.g., Msg 1 1311) and/or the third message (e.g., Msg 3 1313), for example, based on a channel clear assessment (e.g., a listen-before-talk).

FIG. 13B shows a two-step random access procedure. The two-step random access procedure may comprise a two-step contention-free random access procedure. Similar to the four-step contention-based random access procedure, a base station may, prior to initiation of the procedure, send/transmit a configuration message 1320 to the wireless device. The configuration message 1320 may be analogous in some respects to the configuration message 1310. The procedure shown in FIG. 13B may comprise transmissions of two messages: a first message (e.g., Msg 1 1321) and a second message (e.g., Msg 2 1322). The first message (e.g., Msg 1 1321) and the second message (e.g., Msg 2 1322) may be analogous in some respects to the first message (e.g., Msg 1 1311) and a second message (e.g., Msg 2 1312), respectively. The two-step contention-free random access procedure may not comprise messages analogous to the third message (e.g., Msg 3 1313) and/or the fourth message (e.g., Msg 4 1314).

The two-step (e.g., contention-free) random access procedure may be configured/initiated for a beam failure recovery, other SI request, an SCell addition, and/or a handover. A base station may indicate, or assign to, the wireless device a preamble to be used for the first message (e.g., Msg 1 1321). The wireless device may receive, from the base station via a PDCCH and/or an RRC, an indication of the preamble (e.g., ra-PreambleIndex).

The wireless device may start a time window (e.g., ra-ResponseWindow) to monitor a PDCCH for the RAR, for example, after (e.g., based on or in response to) sending (e.g., transmitting) the preamble. The base station may configure the wireless device with one or more beam failure recovery parameters, such as a separate time window and/or a separate PDCCH in a search space indicated by an RRC message (e.g., recoverySearchSpaceId). The base station may configure the one or more beam failure recovery parameters, for example, in association with a beam failure recovery request. The separate time window for monitoring the PDCCH and/or an RAR may be configured to start after sending (e.g., transmitting) a beam failure recovery request (e.g., the window may start any quantity of symbols and/or slots after sending (e.g., transmitting) the beam failure recovery request). The wireless device may monitor for a PDCCH transmission addressed to a Cell RNTI (C-RNTI) on the search space. During the two-step (e.g., contention-free) random access procedure, the wireless device may determine that a random access procedure is successful, for example, after (e.g., based on or in response to) sending (e.g., transmitting) first message (e.g., Msg 1 1321) and receiving a corresponding second message (e.g., Msg 2 1322). The wireless device may determine that a random access procedure has successfully been completed, for example, if a PDCCH transmission is addressed to a corresponding C-RNTI. The wireless device may determine that a random access procedure has successfully been completed, for example, if the wireless device receives an RAR comprising a preamble identifier corresponding to a preamble sent/transmitted by the wireless device and/or the RAR comprises a MAC sub-PDU with the preamble identifier. The wireless device may determine the response as an indication of an acknowledgement for an SI request.

FIG. 13C shows an example two-step random access procedure. Similar to the random access procedures shown in FIGS. 13A and 13B, a base station may, prior to initiation of the procedure, send/transmit a configuration message 1330 to the wireless device. The configuration message 1330 may be analogous in some respects to the configuration message 1310 and/or the configuration message 1320. The procedure shown in FIG. 13C may comprise transmissions of multiple messages (e.g., two messages comprising: a first message (e.g., Msg A 1331) and a second message (e.g., Msg B 1332)).

Msg A 1331 may be sent/transmitted in an uplink transmission by the wireless device. Msg A 1331 may comprise one or more transmissions of a preamble 1341 and/or one or more transmissions of a transport block 1342. The transport block 1342 may comprise contents that are similar and/or equivalent to the contents of the third message (e.g., Msg 3 1313) (e.g., shown in FIG. 13A). The transport block 1342 may comprise UCI (e.g., an SR, a HARQ ACK/NACK, and/or the like). The wireless device may receive the second message (e.g., Msg B 1332), for example, after (e.g., based on or in response to) sending (e.g., transmitting) the first message (e.g., Msg A 1331). The second message (e.g., Msg B 1332) may comprise contents that are similar and/or equivalent to the contents of the second message (e.g., Msg 2 1312) (e.g., an RAR shown in FIGS. 13A), the contents of the second message (e.g., Msg 2 1322) (e.g., an RAR shown in FIG. 13B) and/or the fourth message (e.g., Msg 4 1314) (e.g., shown in FIG. 13A).

The wireless device may start/initiate the two-step random access procedure (e.g., the two-step random access procedure shown in FIG. 13C) for a licensed spectrum and/or an unlicensed spectrum. The wireless device may determine, based on one or more factors, whether to start/initiate the two-step random access procedure. The one or more factors may comprise at least one of: a radio access technology in use (e.g., LTE, NR, and/or the like); whether the wireless device has a valid TA or not; a cell size; the RRC state of the wireless device; a type of spectrum (e.g., licensed vs. unlicensed); and/or any other suitable factors.

The wireless device may determine, based on two-step RACH parameters comprised in the configuration message 1330, a radio resource and/or an uplink transmit power for the preamble 1341 and/or the transport block 1342 (e.g., comprised in the first message (e.g., Msg A 1331)). The RACH parameters may indicate an MCS, a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the wireless device to determine a reception timing and a downlink channel for monitoring for and/or receiving second message (e.g., Msg B 1332).

The transport block 1342 may comprise data (e.g., delay-sensitive data), an identifier of the wireless device, security information, and/or device information (e.g., an International Mobile Subscriber Identity (IMSI)). The base station may send/transmit the second message (e.g., Msg B 1332) as a response to the first message (e.g., Msg A 1331). The second message (e.g., Msg B 1332) may comprise at least one of: a preamble identifier; a timing advance command; a power control command; an uplink grant (e.g., a radio resource assignment and/or an MCS); a wireless device identifier (e.g., a UE identifier for contention resolution); and/or an RNTI (e.g., a C-RNTI or a TC-RNTI). The wireless device may determine that the two-step random access procedure is successfully completed, for example, if a preamble identifier in the second message (e.g., Msg B 1332) corresponds to, or is matched to, a preamble sent/transmitted by the wireless device and/or the identifier of the wireless device in second message (e.g., Msg B 1332) corresponds to, or is matched to, the identifier of the wireless device in the first message (e.g., Msg A 1331) (e.g., the transport block 1342).

A wireless device and a base station may exchange control signaling (e.g., control information). The control signaling may be referred to as L1/L2 control signaling and may originate from the PHY layer (e.g., layer 1) and/or the MAC layer (e.g., layer 2) of the wireless device or the base station. The control signaling may comprise downlink control signaling sent/transmitted from the base station to the wireless device and/or uplink control signaling sent/transmitted from the wireless device to the base station.

The downlink control signaling may comprise at least one of: a downlink scheduling assignment; an uplink scheduling grant indicating uplink radio resources and/or a transport format; slot format information; a preemption indication; a power control command; and/or any other suitable signaling. The wireless device may receive the downlink control signaling in a payload sent/transmitted by the base station via a PDCCH. The payload sent/transmitted via the PDCCH may be referred to as downlink control information (DCI). The PDCCH may be a group common PDCCH (GC-PDCCH) that is common to a group of wireless devices. The GC-PDCCH may be scrambled by a group common RNTI.

A base station may attach one or more cyclic redundancy check (CRC) parity bits to DCI, for example, in order to facilitate detection of transmission errors. The base station may scramble the CRC parity bits with an identifier of a wireless device (or an identifier of a group of wireless devices), for example, if the DCI is intended for the wireless device (or the group of the wireless devices). Scrambling the CRC parity bits with the identifier may comprise Modulo-2 addition (or an exclusive-OR operation) of the identifier value and the CRC parity bits. The identifier may comprise a 16-bit value of an RNTI.

DCI messages may be used for different purposes. A purpose may be indicated by the type of an RNTI used to scramble the CRC parity bits. DCI having CRC parity bits scrambled with a paging RNTI (P-RNTI) may indicate paging information and/or a system information change notification. The P-RNTI may be predefined as “FFFE” in hexadecimal. DCI having CRC parity bits scrambled with a system information RNTI (SI-RNTI) may indicate a broadcast transmission of the system information. The SI-RNTI may be predefined as “FFFF” in hexadecimal. DCI having CRC parity bits scrambled with a random access RNTI (RA-RNTI) may indicate a random access response (RAR). DCI having CRC parity bits scrambled with a cell RNTI (C-RNTI) may indicate a dynamically scheduled unicast transmission and/or a triggering of PDCCH-ordered random access. DCI having CRC parity bits scrambled with a temporary cell RNTI (TC-RNTI) may indicate a contention resolution (e.g., a Msg 3 analogous to the Msg 3 1313 shown in FIG. 13A). Other RNTIs configured for a wireless device by a base station may comprise a Configured Scheduling RNTI (CS RNTI), a Transmit Power Control-PUCCH RNTI (TPC PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C RNTI), and/or the like.

A base station may send/transmit DCI messages with one or more DCI formats, for example, depending on the purpose and/or content of the DCI messages. DCI format 0_0 may be used for scheduling of a PUSCH in a cell. DCI format 0_0 may be a fallback DCI format (e.g., with compact DCI payloads). DCI format 0_1 may be used for scheduling of a PUSCH in a cell (e.g., with more DCI payloads than DCI format 0_0). DCI format 1_0 may be used for scheduling of a PDSCH in a cell. DCI format 1_0 may be a fallback DCI format (e.g., with compact DCI payloads). DCI format 1_1 may be used for scheduling of a PDSCH in a cell (e.g., with more DCI payloads than DCI format 1_0). DCI format 2_0 may be used for providing a slot format indication to a group of wireless devices. DCI format 2_1 may be used for informing/notifying a group of wireless devices of a physical resource block and/or an OFDM symbol where the group of wireless devices may assume no transmission is intended to the group of wireless devices. DCI format 2_2 may be used for transmission of a transmit power control (TPC) command for PUCCH or PUSCH. DCI format 2_3 may be used for transmission of a group of TPC commands for SRS transmissions by one or more wireless devices. DCI format(s) for new functions may be defined in future releases. DCI formats may have different DCI sizes, or may share the same DCI size.

The base station may process the DCI with channel coding (e.g., polar coding), rate matching, scrambling and/or QPSK modulation, for example, after scrambling the DCI with an RNTI. A base station may map the coded and modulated DCI on resource elements used and/or configured for a PDCCH. The base station may send/transmit the DCI via a PDCCH occupying a number of contiguous control channel elements (CCEs), for example, based on a payload size of the DCI and/or a coverage of the base station. The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

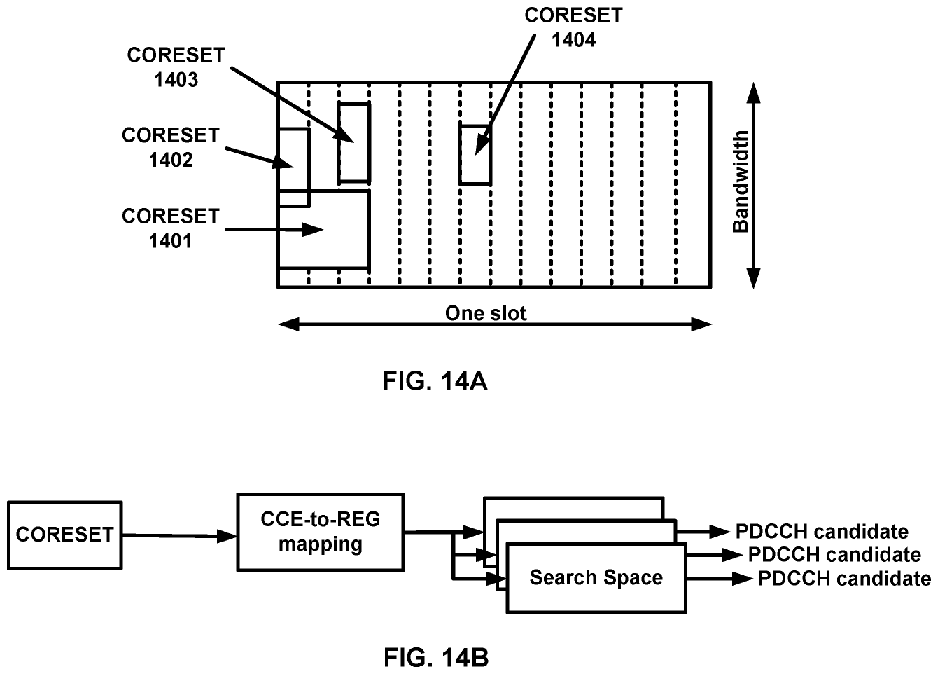

FIG. 14A shows an example of CORESET configurations. The CORESET configurations may be for a bandwidth part or any other frequency bands. The base station may send/transmit DCI via a PDCCH on one or more control resource sets (CORESETs). A CORESET may comprise a time-frequency resource in which the wireless device attempts/tries to decode DCI using one or more search spaces. The base station may configure a size and a location of the CORESET in the time-frequency domain. A first CORESET 1401 and a second CORESET 1402 may occur or may be set/configured at the first symbol in a slot. The first CORESET 1401 may overlap with the second CORESET 1402 in the frequency domain. A third CORESET 1403 may occur or may be set/configured at a third symbol in the slot. A fourth CORESET 1404 may occur or may be set/configured at the seventh symbol in the slot. CORESETs may have a different number of resource blocks in frequency domain.

FIG. 14B shows an example of a CCE-to-REG mapping. The CCE-to-REG mapping may be performed for DCI transmission via a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping (e.g., by an RRC configuration). A CORESET may be configured with an antenna port QCL parameter. The antenna port QCL parameter may indicate QCL information of a DM-RS for a PDCCH reception via the CORESET.

The base station may send/transmit, to the wireless device, one or more RRC messages comprising configuration parameters of one or more CORESETs and one or more search space sets. The configuration parameters may indicate an association between a search space set and a CORESET. A search space set may comprise a set of PDCCH candidates formed by CCEs (e.g., at a given aggregation level). The configuration parameters may indicate at least one of: a number of PDCCH candidates to be monitored per aggregation level; a PDCCH monitoring periodicity and a PDCCH monitoring pattern; one or more DCI formats to be monitored by the wireless device; and/or whether a search space set is a common search space set or a wireless device-specific search space set (e.g., a UE-specific search space set). A set of CCEs in the common search space set may be predefined and known to the wireless device. A set of CCEs in the wireless device-specific search space set (e.g., the UE-specific search space set) may be configured, for example, based on the identity of the wireless device (e.g., C-RNTI).

As shown in FIG. 14B, the wireless device may determine a time-frequency resource for a CORESET based on one or more RRC messages. The wireless device may determine a CCE-to-REG mapping (e.g., interleaved or non-interleaved, and/or mapping parameters) for the CORESET, for example, based on configuration parameters of the CORESET. The wireless device may determine a number (e.g., at most 10) of search space sets configured on/for the CORESET, for example, based on the one or more RRC messages. The wireless device may monitor a set of PDCCH candidates according to configuration parameters of a search space set. The wireless device may monitor a set of PDCCH candidates in one or more CORESETs for detecting one or more DCI messages. Monitoring may comprise decoding one or more PDCCH candidates of the set of the PDCCH candidates according to the monitored DCI formats. Monitoring may comprise decoding DCI content of one or more PDCCH candidates with possible (or configured) PDCCH locations, possible (or configured) PDCCH formats (e.g., the number of CCEs, the number of PDCCH candidates in common search spaces, and/or the number of PDCCH candidates in the wireless device-specific search spaces) and possible (or configured) DCI formats. The decoding may be referred to as blind decoding. The wireless device may determine DCI as valid for the wireless device, for example, after (e.g., based on or in response to) CRC checking (e.g., scrambled bits for CRC parity bits of the DCI matching an RNTI value). The wireless device may process information comprised in the DCI (e.g., a scheduling assignment, an uplink grant, power control, a slot format indication, a downlink preemption, and/or the like).

The wireless device may send/transmit uplink control signaling (e.g., UCI) to a base station. The uplink control signaling may comprise HARQ acknowledgements for received DL-SCH transport blocks. The wireless device may send/transmit the HARQ acknowledgements, for example, after (e.g., based on or in response to) receiving a DL-SCH transport block. Uplink control signaling may comprise CSI indicating a channel quality of a physical downlink channel. The wireless device may send/transmit the CSI to the base station. The base station, based on the received CSI, may determine transmission format parameters (e.g., comprising multi-antenna and beamforming schemes) for downlink transmission(s). Uplink control signaling may comprise scheduling requests (SR). The wireless device may send/transmit an SR indicating that uplink data is available for transmission to the base station. The wireless device may send/transmit UCI (e.g., HARQ acknowledgements (HARQ-ACK), CSI report, SR, and the like) via a PUCCH or a PUSCH. The wireless device may send/transmit the uplink control signaling via a PUCCH using one of several PUCCH formats.

There may be multiple PUCCH formats (e.g., five PUCCH formats). A wireless device may determine a PUCCH format, for example, based on a size of UCI (e.g., a quantity/number of uplink symbols of UCI transmission and a number of UCI bits). PUCCH format 0 may have a length of one or two OFDM symbols and may comprise two or fewer bits. The wireless device may send/transmit UCI via a PUCCH resource, for example, using PUCCH format 0 if the transmission is over/via one or two symbols and the quantity/number of HARQ-ACK information bits with positive or negative SR (HARQ-ACK/SR bits) is one or two. PUCCH format 1 may occupy a number of OFDM symbols (e.g., between four and fourteen OFDM symbols) and may comprise two or fewer bits. The wireless device may use PUCCH format 1, for example, if the transmission is over/via four or more symbols and the number of HARQ-ACK/SR bits is one or two. PUCCH format 2 may occupy one or two OFDM symbols and may comprise more than two bits. The wireless device may use PUCCH format 2, for example, if the transmission is over/via one or two symbols and the quantity/number of UCI bits is two or more. PUCCH format 3 may occupy a number of OFDM symbols (e.g., between four and fourteen OFDM symbols) and may comprise more than two bits. The wireless device may use PUCCH format 3, for example, if the transmission is four or more symbols, the quantity/number of UCI bits is two or more, and the PUCCH resource does not comprise an orthogonal cover code (OCC). PUCCH format 4 may occupy a number of OFDM symbols (e.g., between four and fourteen OFDM symbols) and may comprise more than two bits. The wireless device may use PUCCH format 4, for example, if the transmission is four or more symbols, the quantity/number of UCI bits is two or more, and the PUCCH resource comprises an OCC.

The base station may send/transmit configuration parameters to the wireless device for a plurality of PUCCH resource sets, for example, using an RRC message. The plurality of PUCCH resource sets (e.g., up to four sets in NR, or up to any other quantity of sets in other systems) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the wireless device may send/transmit using one of the plurality of PUCCH resources in the PUCCH resource set. The wireless device may select one of the plurality of PUCCH resource sets, for example, based on a total bit length of the UCI information bits (e.g., HARQ-ACK, SR, and/or CSI) if configured with a plurality of PUCCH resource sets. The wireless device may select a first PUCCH resource set having a PUCCH resource set index equal to “0,” for example, if the total bit length of UCI information bits is two or fewer. The wireless device may select a second PUCCH resource set having a PUCCH resource set index equal to “1,” for example, if the total bit length of UCI information bits is greater than two and less than or equal to a first configured value. The wireless device may select a third PUCCH resource set having a PUCCH resource set index equal to “2,” for example, if the total bit length of UCI information bits is greater than the first configured value and less than or equal to a second configured value. The wireless device may select a fourth PUCCH resource set having a PUCCH resource set index equal to “3,” for example, if the total bit length of UCI information bits is greater than the second configured value and less than or equal to a third value (e.g., 1406, 1706, or any other quantity of bits).

The wireless device may determine a PUCCH resource from the PUCCH resource set for UCI (HARQ-ACK, CSI, and/or SR) transmission, for example, after determining a PUCCH resource set from a plurality of PUCCH resource sets. The wireless device may determine the PUCCH resource, for example, based on a PUCCH resource indicator in DCI (e.g., with DCI format 1_0 or DCI for 1_1) received on/via a PDCCH. An n-bit (e.g., a three-bit) PUCCH resource indicator in the DCI may indicate one of multiple (e.g., eight) PUCCH resources in the PUCCH resource set. The wireless device may send/transmit the UCI (HARQ-ACK, CSI and/or SR) using a PUCCH resource indicated by the PUCCH resource indicator in the DCI, for example, based on the PUCCH resource indicator.

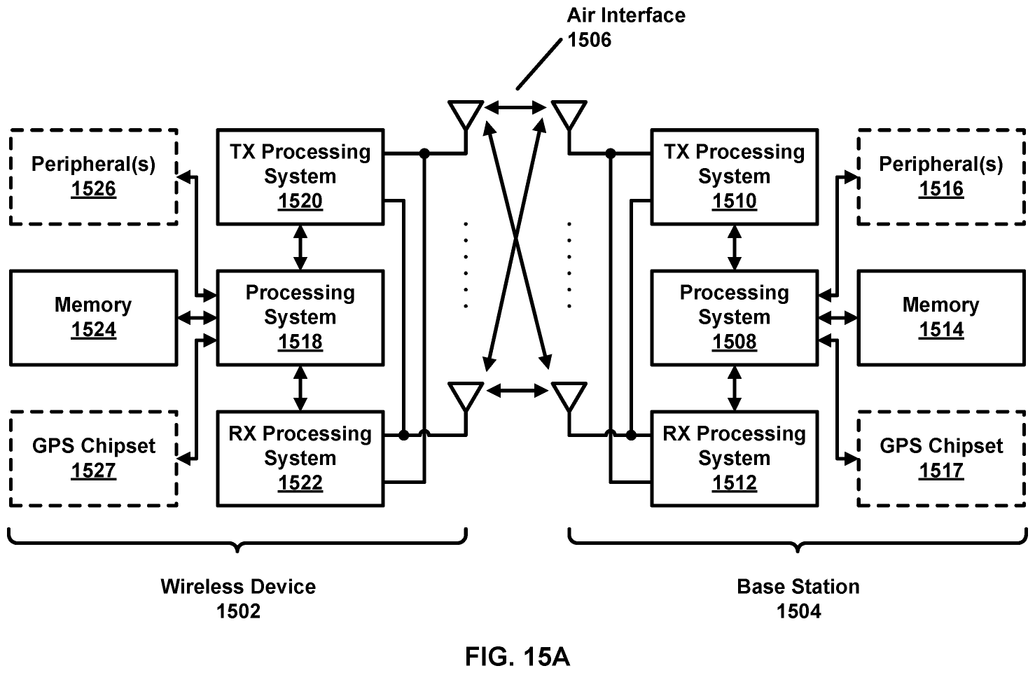

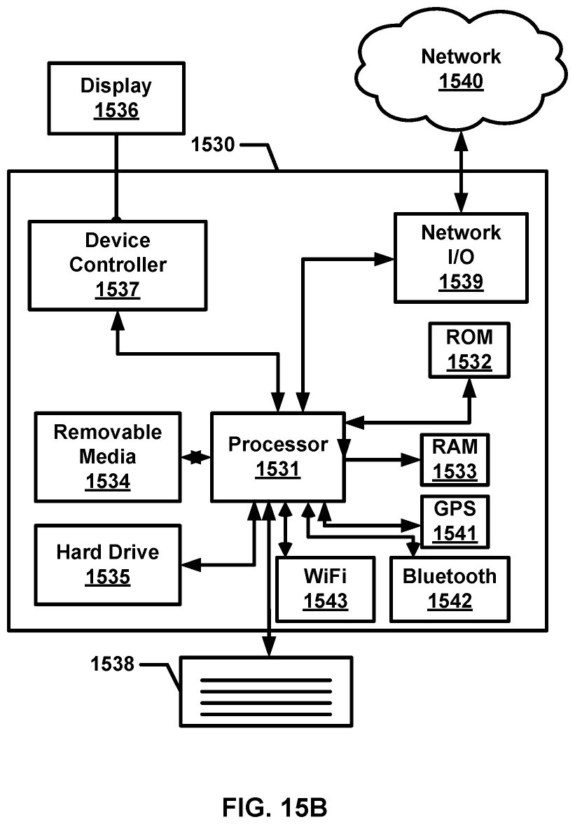

FIG. 15A shows example communications between a wireless device and a base station. A wireless device 1502 and a base station 1504 may be part of a communication network, such as the communication network 100 shown in FIG. 1A, the communication network 150 shown in FIG. 1B, or any other communication network. A communication network may comprise more than one wireless device and/or more than one base station, with substantially the same or similar configurations as those shown in FIG. 15A.

The base station 1504 may connect the wireless device 1502 to a core network (not shown) via radio communications over the air interface (or radio interface) 1506. The communication direction from the base station 1504 to the wireless device 1502 over the air interface 1506 may be referred to as the downlink. The communication direction from the wireless device 1502 to the base station 1504 over the air interface may be referred to as the uplink. Downlink transmissions may be separated from uplink transmissions, for example, using various duplex schemes (e.g., FDD, TDD, and/or some combination of the duplexing techniques).

For the downlink, data to be sent to the wireless device 1502 from the base station 1504 may be provided/transferred/sent to the processing system 1508 of the base station 1504. The data may be provided/transferred/sent to the processing system 1508 by, for example, a core network. For the uplink, data to be sent to the base station 1504 from the wireless device 1502 may be provided/transferred/sent to the processing system 1518 of the wireless device 1502. The processing system 1508 and the processing system 1518 may implement layer 3 and layer 2 OSI functionality to process the data for transmission. Layer 2 may comprise an SDAP layer, a PDCP layer, an RLC layer, and a MAC layer, for example, described with respect to FIG. 2A, FIG. 2B, FIG. 3, and FIG. 4A. Layer 3 may comprise an RRC layer, for example, described with respect to FIG. 2B.

The data to be sent to the wireless device 1502 may be provided/transferred/sent to a transmission processing system 1510 of base station 1504, for example, after being processed by the processing system 1508. The data to be sent to base station 1504 may be provided/transferred/sent to a transmission processing system 1520 of the wireless device 1502, for example, after being processed by the processing system 1518. The transmission processing system 1510 and the transmission processing system 1520 may implement layer 1 OSI functionality. Layer 1 may comprise a PHY layer, for example, described with respect to FIG. 2A, FIG. 2B, FIG. 3, and FIG. 4A. For sending/transmission processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

A reception processing system 1512 of the base station 1504 may receive the uplink transmission from the wireless device 1502. The reception processing system 1512 of the base station 1504 may comprise one or more TRPs. A reception processing system 1522 of the wireless device 1502 may receive the downlink transmission from the base station 1504. The reception processing system 1522 of the wireless device 1502 may comprise one or more antenna panels. The reception processing system 1512 and the reception processing system 1522 may implement layer 1 OSI functionality. Layer 1 may include a PHY layer, for example, described with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

The base station 1504 may comprise multiple antennas (e.g., multiple antenna panels, multiple TRPs, etc.). The wireless device 1502 may comprise multiple antennas (e.g., multiple antenna panels, etc.). The multiple antennas may be used to perform one or more MIMO or multi-antenna techniques, such as spatial multiplexing (e.g., single-user MIMO or multi-user MIMO), transmit/receive diversity, and/or beamforming. The wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518, respectively, to carry out one or more of the functionalities (e.g., one or more functionalities described herein and other functionalities of general computers, processors, memories, and/or other peripherals). The transmission processing system 1510 and/or the reception processing system 1512 may be coupled to the memory 1514 and/or another memory (e.g., one or more non-transitory computer readable mediums) storing computer program instructions or code that may be executed to carry out one or more of their respective functionalities. The transmission processing system 1520 and/or the reception processing system 1522 may be coupled to the memory 1524 and/or another memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and/or the base station 1504 to operate in a wireless environment.

The processing system 1508 may be connected to one or more peripherals 1516. The processing system 1518 may be connected to one or more peripherals 1526. The one or more peripherals 1516 and the one or more peripherals 1526 may comprise software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive input data (e.g., user input data) from, and/or provide output data (e.g., user output data) to, the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 may be connected to a Global Positioning System (GPS) chipset 1517. The processing system 1518 may be connected to a Global Positioning System (GPS) chipset 1527. The GPS chipset 1517 and the GPS chipset 1527 may be configured to determine and provide geographic location information of the wireless device 1502 and the base station 1504, respectively.

FIG. 15B shows example elements of a computing device that may be used to implement any of the various devices described herein, including, for example, the base station 160A, 160B, 162A, 162B, 220, and/or 1504, the wireless device 106, 156A, 156B, 210, and/or 1502, or any other base station, wireless device, AMF, UPF, network device, or computing device described herein. The computing device 1530 may include one or more processors 1531, which may execute instructions stored in the random-access memory (RAM) 1533, the removable media 1534 (such as a Universal Serial Bus (USB) drive, compact disk (CD) or digital versatile disk (DVD), or floppy disk drive), or any other desired storage medium. Instructions may also be stored in an attached (or internal) hard drive 1535. The computing device 1530 may also include a security processor (not shown), which may execute instructions of one or more computer programs to monitor the processes executing on the processor 1531 and any process that requests access to any hardware and/or software components of the computing device 1530 (e.g., ROM 1532, RAM 1533, the removable media 1534, the hard drive 1535, the device controller 1537, a network interface 1539, a GPS 1541, a Bluetooth interface 1542, a WiFi interface 1543, etc.). The computing device 1530 may include one or more output devices, such as the display 1536 (e.g., a screen, a display device, a monitor, a television, etc.), and may include one or more output device controllers 1537, such as a video processor. There may also be one or more user input devices 1538, such as a remote control, keyboard, mouse, touch screen, microphone, etc. The computing device 1530 may also include one or more network interfaces, such as a network interface 1539, which may be a wired interface, a wireless interface, or a combination of the two. The network interface 1539 may provide an interface for the computing device 1530 to communicate with a network 1540 (e.g., a RAN, or any other network). The network interface 1539 may include a modem (e.g., a cable modem), and the external network 1540 may include communication links, an external network, an in-home network, a provider's wireless, coaxial, fiber, or hybrid fiber/coaxial distribution system (e.g., a DOCSIS network), or any other desired network. Additionally, the computing device 1530 may include a location-detecting device, such as a global positioning system (GPS) microprocessor 1541, which may be configured to receive and process global positioning signals and determine, with possible assistance from an external server and antenna, a geographic position of the computing device 1530.

The example in FIG. 15B may be a hardware configuration, although the components shown may be implemented as software as well. Modifications may be made to add, remove, combine, divide, etc. components of the computing device 1530 as desired. Additionally, the components may be implemented using basic computing devices and components, and the same components (e.g., processor 1531, ROM storage 1532, display 1536, etc.) may be used to implement any of the other computing devices and components described herein. For example, the various components described herein may be implemented using computing devices having components such as a processor executing computer-executable instructions stored on a computer-readable medium, as shown in FIG. 15B. Some or all of the entities described herein may be software based, and may co-exist in a common physical platform (e.g., a requesting entity may be a separate software process and program from a dependent entity, both of which may be executed as software on a common computing device).

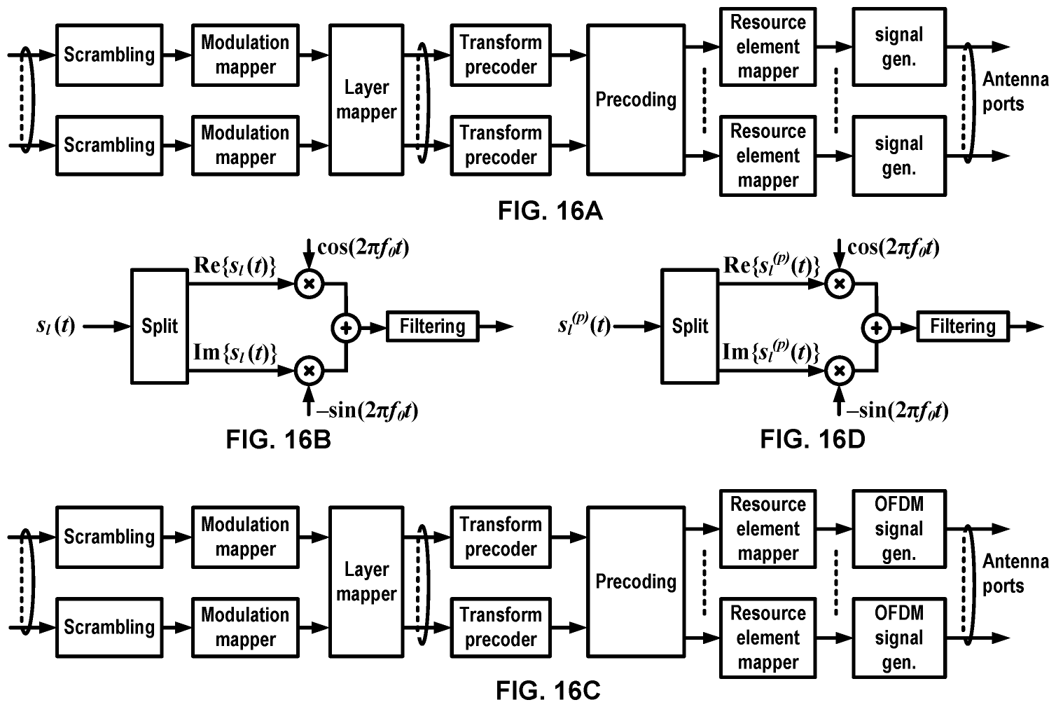

FIG. 16A shows an example structure for uplink transmission. Processing of a baseband signal representing a physical uplink shared channel may comprise/perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA), CP-OFDM signal for an antenna port, or any other signals; and/or the like. An SC-FDMA signal for uplink transmission may be generated, for example, if transform precoding is enabled. A CP-OFDM signal for uplink transmission may be generated, for example, if transform precoding is not enabled (e.g., as shown in FIG. 16A). These functions are examples and other mechanisms for uplink transmission may be implemented.

FIG. 16B shows an example structure for modulation and up-conversion of a baseband signal to a carrier frequency. The baseband signal may be a complex-valued SC-FDMA, CP-OFDM baseband signal (or any other baseband signals) for an antenna port and/or a complex-valued Physical Random Access Channel (PRACH) baseband signal. Filtering may be performed/employed, for example, prior to transmission.

FIG. 16C shows an example structure for downlink transmissions. Processing of a baseband signal representing a physical downlink channel may comprise/perform one or more functions. The one or more functions may comprise: scrambling of coded bits in a codeword to be sent/transmitted on/via a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are examples and other mechanisms for downlink transmission may be implemented.

FIG. 16D shows an example structure for modulation and up-conversion of a baseband signal to a carrier frequency. The baseband signal may be a complex-valued OFDM baseband signal for an antenna port or any other signal. Filtering may be performed/employed, for example, prior to transmission.

A wireless device may receive, from a base station, one or more messages (e.g. RRC messages) comprising configuration parameters of a plurality of cells (e.g., a primary cell, one or more secondary cells). The wireless device may communicate with at least one base station (e.g., two or more base stations in dual-connectivity) via the plurality of cells. The one or more messages (e.g. as a part of the configuration parameters) may comprise parameters of PHY, MAC, RLC, PCDP, SDAP, RRC layers for configuring the wireless device. The configuration parameters may comprise parameters for configuring PHY and MAC layer channels, bearers, etc. The configuration parameters may comprise parameters indicating values of timers for PHY, MAC, RLC, PCDP, SDAP, RRC layers, and/or communication channels.

A timer may begin running, for example, if it is started, and continue running until it is stopped or until it expires. A timer may be started, for example, if it is not running or restarted if it is running. A timer may be associated with a value (e.g., the timer may be started or restarted from a value or may be started from zero and expire if it reaches the value). The duration of a timer may not be updated, for example, until the timer is stopped or expires (e.g., due to BWP switching). A timer may be used to measure a time period/window for a process. With respect to an implementation and/or procedure related to one or more timers or other parameters, it will be understood that there may be multiple ways to implement the one or more timers or other parameters. One or more of the multiple ways to implement a timer may be used to measure a time period/window for the procedure. A random access response window timer may be used for measuring a window of time for receiving a random access response. The time difference between two time stamps may be used, for example, instead of starting a random access response window timer and determine the expiration of the timer. A process for measuring a time window may be restarted, for example, if a timer is restarted. Other example implementations may be configured/provided to restart a measurement of a time window.

A base station may transmit one or more MAC PDUs to a wireless device. A MAC PDU may be a bit string that is byte aligned (e.g., aligned to a multiple of eight bits) in length. In an example, bit strings may be represented by tables in which the most significant bit is the leftmost bit of the first line of the table, and the least significant bit is the rightmost bit on the last line of the table. More generally, the bit string may be read from left to right and then in the reading order of the lines. The bit order of a parameter field within a MAC PDU is represented with the first and most significant bit in the leftmost bit and the last and least significant bit in the rightmost bit. A MAC SDU may be a bit string that is byte aligned (e.g., aligned to a multiple of eight bits) in length. A MAC SDU may be included in a MAC PDU from the first bit onward. A MAC CE may be a bit string that is byte aligned (e.g., aligned to a multiple of eight bits) in length. A MAC subheader may be a bit string that is byte aligned (e.g., aligned to a multiple of eight bits) in length. A MAC subheader may be placed immediately in front of a corresponding MAC SDU, MAC CE, or padding. A MAC entity may ignore a value of reserved bits in a DL MAC PDU.

A MAC PDU may comprise one or more MAC subPDUs. A MAC subPDU of the one or more MAC subPDUs may comprise: a MAC subheader only (including padding); a MAC subheader and a MAC SDU; a MAC subheader and a MAC CE; a MAC subheader and padding, or a combination thereof. The MAC SDU may be of variable size. A MAC subheader may correspond to a MAC SDU, a MAC CE, or padding.

If a MAC subheader corresponds to a MAC SDU, a variable-sized MAC CE, or padding, the MAC subheader may comprise: a Reserve field (R field) with a one bit length; an Format filed (F field) with a one-bit length; a Logical Channel Identifier (LCID) field with a multi-bit length; a Length field (L field) with a multi-bit length, indicating the length of the corresponding MAC SDU or variable-size MAC CE in bytes, or a combination thereof. In an example, F field may indicate the size of the L field.

A MAC entity of the base station may transmit one or more MAC CEs (e.g., MAC CE commands) to a MAC entity of a wireless device. The one or more MAC CEs may comprise at least one of: a SP ZP CSI-RS Resource Set Activation/Deactivation MAC CE, a PUCCH spatial relation Activation/Deactivation MAC CE, a SP SRS Activation/Deactivation MAC CE, a SP CSI reporting on PUCCH Activation/Deactivation MAC CE, a TCI State Indication for UE-specific PDCCH MAC CE, a TCI State Indication for UE-specific PDSCH MAC CE, an Aperiodic CSI Trigger State Subselection MAC CE, a SP CSI-RS/CSI-IM Resource Set Activation/Deactivation MAC CE, a UE contention resolution identity MAC CE, a timing advance command MAC CE, a DRX command MAC CE, a Long DRX command MAC CE, an SCell activation/deactivation MAC CE (1 Octet), an SCell activation/deactivation MAC CE (4 Octet), and/or a duplication activation/deactivation MAC CE. A MAC CE, such as a MAC CE transmitted by a MAC entity of the base station to a MAC entity of the wireless device, may have an LCID in the MAC subheader corresponding to the MAC CE. A first MAC CE may have a first LCID in the MAC subheader that may be different than the second LCID in the MAC subheader of a second MAC CE. For example, an LCID given by 111011 in a MAC subheader may indicate that the MAC CE associated with the MAC subheader is a long DRX command MAC CE.

The MAC entity of the wireless device may transmit to the MAC entity of the base station one or more MAC CEs. The one or more MAC CEs may comprise at least one of: a short buffer status report (BSR) MAC CE, a long BSR MAC CE, a C-RNTI MAC CE, a configured grant confirmation MAC CE, a single entry PHR MAC CE, a multiple entry PHR MAC CE, a short truncated BSR, and/or a long truncated BSR. A MAC CE may have an LCID in the MAC subheader corresponding to the MAC CE. A first MAC CE may have a first LCID in the MAC subheader that may be different than the second LCID in the MAC subheader of a second MAC CE. For example, an LCID given by 111011 in a MAC subheader may indicate that a MAC CE associated with the MAC subheader is a short-truncated command MAC CE.

In carrier aggregation (CA), two or more component carriers (CCs) may be aggregated. The wireless device may, using the technique of CA, simultaneously receive or transmit on one or more CCs, depending on capabilities of the wireless device. In an example, the wireless device may support CA for contiguous CCs and/or for non-contiguous CCs. CCs may be organized into cells. For example, CCs may be organized into one primary cell (PCell) and one or more secondary cells (SCells). When configured with CA, the wireless device may have one RRC connection with a network. During an RRC connection establishment/re-establishment/handover, a cell providing NAS mobility information may be a serving cell. During an RRC connection re-establishment/handover procedure, a cell providing a security input may be the serving cell. The serving cell may be a PCell. In an example, the base station may transmit, to the wireless device, one or more messages (e.g., one or more downlink signals). The one or more messages may comprise one or more RRC messages, for example, one or more RRC configuration/reconfiguration messages. For example, the one or more RRC messages may comprise one or more configuration parameters (e.g., one or more RRC configuration parameters).

The one or more configuration parameters may comprise configuration parameters of a plurality of one or more SCells, depending on capabilities of the wireless device. When configured with CA, the base station and/or the wireless device may employ an activation/deactivation mechanism of an SCell to improve battery or power consumption of the wireless device. When the wireless device is configured with one or more SCells, the base station may activate or deactivate at least one of the one or more SCells. Upon configuration of an SCell, the SCell may be deactivated unless the SCell state associated with the SCell is set to “activated” or “dormant.” The wireless device may activate/deactivate an SCell, for example, based on (e.g., in response to) receiving the SCell Activation/Deactivation MAC CE.

For example, the base station may configure (e.g., via the one or more RRC messages/parameters) the wireless device with uplink (UL) bandwidth parts (BWPs) and downlink (DL) BWPs to enable bandwidth adaptation (BA) on a PCell. If carrier aggregation (CA) is configured, the base station may further configure the wireless device with at least one DL BWP (i.e., there may be no UL BWP in the UL) to enable BA on an SCell. For the PCell, an initial active BWP may be a first BWP used for initial access. In paired spectrum (e.g., FDD), the base station and/or the wireless device may independently switch a DL BWP and an UL BWP. In unpaired spectrum (e.g., TDD), the base station and/or the wireless device may simultaneously switch a DL BWP and an UL BWP.

A base station and/or a wireless device may switch a BWP between configured BWPs by means of a DCI or a BWP invalidity timer. When the BWP invalidity timer is configured for the serving cell, the base station and/or the wireless device may switch the active BWP to a default BWP, for example, based on (e.g., in response to) the expiry of the BWP invalidity timer associated with the serving cell. The default BWP may be configured by the network. In an example, for FDD systems, when configured with BA, one UL BWP for each uplink carrier and one DL BWP may be active at a time in the active serving cell. In an example, for TDD systems, one DL/UL BWP pair may be active at a time in the active serving cell. Operating on one UL BWP and one DL BWP (or the one DL/UL pair) may improve the wireless device battery consumption. One or more BWPs other than the active UL BWP and the active DL BWP which the wireless device may work on, may be deactivated. On the deactivated one or more BWPs, the wireless device may: not monitor PDCCH; and/or not transmit on PUCCH, PRACH, and UL-SCH. In an example, the MAC entity of the wireless device may apply normal operations on the active BWP for an activated serving cell configured with a BWP comprising: sending (e.g., transmitting) on UL-SCH; sending (e.g., transmitting) on RACH; monitoring a PDCCH; sending (e.g., transmitting) PUCCH; receiving DL-SCH; and/or (re-)initializing any suspended configured uplink grants of configured grant Type 1 according to a stored configuration, if any. On the inactive BWP for each activated serving cell configured with a BWP, the MAC entity of the wireless device may: not transmit on UL-SCH; not transmit on RACH; not monitor a PDCCH; not transmit PUCCH; not transmit SRS, not receive DL-SCH; clear any configured downlink assignment and configured uplink grant of configured grant Type 2; and/or suspend any configured uplink grant of configured Type 1.

DCI addressed to an RNTI may comprise a CRC of the DCI being scrambled with the RNTI. The wireless device may monitor PDCCH addressed to (or for) the RNTI for detecting the DCI. For example, the PDCCH may carry (or be with) the DCI. The PDCCH may not carry the DCI.

A set of PDCCH candidates for the wireless device to monitor may be defined in terms of one or more search space sets. A search space set may comprise a common search space (CSS) set or a UE-specific search space (USS) set. The wireless device may monitor one or more PDCCH candidates in one or more of the following search space sets: a Type0-PDCCH CSS set configured by pdcch-ConfigSIB1 in MIB or by searchSpaceSIB1 in PDCCH-ConfigCommon or by searchSpaceZero in PDCCH-ConfigCommon for a DCI format with CRC scrambled by a SI-RNTI on the primary cell of the MCG, a Type0A-PDCCH CSS set configured by searchSpaceOtherSystemInformation in PDCCH-ConfigCommon for a DCI format with CRC scrambled by the SI-RNTI on the primary cell of the MCG, a Type1-PDCCH CSS set configured by ra-SearchSpace in PDCCH-ConfigCommon for a DCI format with CRC scrambled by a RA-RNTI, a MSGB-RNTI, or a TC-RNTI on the primary cell, a Type2-PDCCH CSS set configured by pagingSearchSpace in PDCCH-ConfigCommon for a DCI format with CRC scrambled by a P-RNTI on the primary cell of the MCG, a Type3-PDCCH CSS set configured by SearchSpace in PDCCH-Config with searchSpaceType=common for DCI formats with CRC scrambled by a INT-RNTI, a SFI-RNTI, a TPC-PUSCH-RNTI, a TPC-PUCCH-RNTI, a TPC-SRS-RNTI, a CI-RNTI, or a power saving RNTI (PS-RNTI) and, only for the primary cell, a C-RNTI, a MCS-C-RNTI, or a CS-RNTI(s), and the USS set configured by SearchSpace in PDCCH-Config with searchSpaceType=ue-Specific for DCI formats with CRC scrambled by the C-RNTI, the MCS-C-RNTI, a SP-CSI-RNTI, the CS-RNTI(s), a SL-RNTI, a SL-CS-RNTI, or a SL-L-CS-RNTI.

A wireless device may monitor the one or more PDCCH candidates according to one or more configuration parameters of the search space set. For example, the search space set may comprise a plurality of search spaces (SSs). The wireless device may monitor the one or more PDCCH candidates in one or more CORESETs for detecting one or more DCIs. Monitoring the one or more PDCCH candidates may comprise decoding at least one PDCCH candidate of the one or more PDCCH candidates according to the monitored DCI formats. For example, monitoring the one or more PDCCH candidates may comprise decoding (e.g., blind decoding) a DCI content of the at least one PDCCH candidate via possible (or configured) PDCCH location(s), possible (or configured) PDCCH format(s) (e.g., number of CCEs, number of PDCCH candidates in CSS set(s), and/or number of PDCCH candidates in the USS(s), and/or possible (or configured) DCI format(s).

A wireless device may receive the C-RNTI (e.g., via one or more previous transmissions) from the base station. For example, the one or more previous transmissions may comprise a Msg2 1312, Msg4 1314, or a MsgB 1332. The wireless device may monitor the one or more PDCCH candidates for DCI format 0_0 and DCI format 1_0 with CRC scrambled by the C-RNTI in the Type1-PDCCH CSS set, for example, if the wireless device is not provided the Type3-PDCCH CSS set or the USS set and if provided the Type1-PDCCH CSS set.

The one or more search space sets may correspond to one or more search parameters. For example, the one or more search space sets may correspond to one or more of searchSpaceZero, searchSpaceSIB1, searchSpaceOtherSystemInformation, pagingSearchSpace, ra-SearchSpace, and the C-RNTI, the MCS-C-RNTI, or the CS-RNTI. The wireless device may monitor the one or more PDCCH candidates for the DCI format 0_0 and the DCI format 1_0 with CRC scrambled by the C-RNTI, the MCS-C-RNTI, or the CS-RNTI in the one or more search space sets in a slot where the wireless device monitors the one or more PDCCH candidates for at least the DCI format 0_0 or the DCI format 1_0 with CRC scrambled by the SI-RNTI, the RA-RNTI, the MSGB-RNTI, or the P-RNTI.

A base station may use the DCI formats to send (e.g., transmit) downlink control information (DCI) to the wireless device. The wireless device may use the DCI formats for PDCCH monitoring. Different DCI formats may comprise different DCI fields and/or have different DCI payload sizes. Different DCI formats may have different signaling purposes. DCI format 0_0 may be used to schedule PUSCH in one cell. DCI format 0_1 may be used to schedule one or multiple PUSCH in one cell or indicate configured grant-Downlink Feedback Information (CG-DFI) for configured grant PUSCH, etc.

Semi-persistent scheduling (SPS) may be supported in a downlink. A wireless device may be configured with a periodicity of data transmission using one or more configuration parameters (e.g., SPS-Config). Activation of semi-persistent scheduling may be done using PDCCH with CS-RNTI (e.g., receiving the PDCCH transmission addressed to/by the CS-RNTI). The PDCCH may carry necessary information in terms of time-frequency resources and other parameters. A HARQ process number/ID may be derived from a time, for example, if the downlink data transmission starts. Upon activation of semi-persistent scheduling, the wireless device may receive downlink transmission periodically according to the periodicity of the data transmission using one or more transmission parameters indicated in the PDCCH activating the semi-persistent scheduling.

In an uplink, two schemes for transmission without a dynamic grant may be supported. The two schemes may differ in the way they are activated: 1) type 1 of the configured grant (or configured grant Type 1), where an uplink grant is provided by the one or more configuration parameters (e.g., ConfiguredGrantConfig), including activation of the grant, 2) configured grant Type 2 (or type 2 of the configured grant), where the transmission periodicity is provided by the one or more configuration parameters (e.g., ConfiguredGrantConfig) and L1/L2 control signaling is used to activate/deactivate the transmission in a similar way as in the SPS. The two schemes may reduce control signaling overhead, and the latency before uplink data transmission, as no scheduling request-grant cycle is needed prior to data transmission. In an example of the configured grant Type 2, the one or more configuration parameters may indicate/configure the preconfigured periodicity and PDCCH activation may provide transmission parameters. Upon receiving the activation command, the wireless device may send (e.g., transmit) according to the preconfigured periodicity if there are data in the buffer. The wireless device may, similarly to the configured grant Type 1, not send (e.g., transmit) anything if there are no data to transmit. The wireless device may acknowledge the activation/deactivation of configured grant Type 2 by sending a MAC control element in the uplink. In both schemes, it may be possible to configure multiple wireless devices with overlapping time-frequency resources in the uplink. In this case, the network may differentiate between transmissions from different wireless devices. PUSCH resource allocation may be semi-statically configured by the one or more configuration parameters (e.g., ConfiguredGrantConfig).

A wireless device may support a baseline processing time/capability. The wireless device may support additional aggressive/faster processing time/capability. The wireless device may report to the base station a processing capability, e.g., per sub-carrier spacing. A PDSCH processing time may be considered to determine, by a wireless device, a first uplink symbol of a PUCCH (e.g., determined at least based on a HARQ-ACK timing K1 and one or more PUCCH resources to be used and including the effect of the timing advance) comprising the HARQ-ACK information of the PDSCH scheduled by a DCI. The first uplink symbol of the PUCCH may not start earlier than a time gap (e.g., T_{proc,1}) after a last symbol of the PDSCH reception associated with the HARQ-ACK information. The first uplink symbol of the PUCCH which carries the HARQ-ACK information may start no earlier than at symbol L1, where L1 may be defined as the next uplink symbol with its Cyclic Prefix (CP) starting after the time gap T_{proc,1} after the end of the last symbol of the PDSCH.

A PUSCH preparation/processing time may be considered for determining the transmission time of an UL data. The wireless device may perform sending (e.g., transmitting) the PUSCH if the first uplink symbol in the PUSCH allocation for a transport block (including DM-RS) is no earlier than at symbol L2. The symbol L2 may be determined, by a wireless device, at least based on a slot offset (e.g., K2), SLIV of the PUSCH allocation indicated by time domain resource assignment of a scheduling DCI. The symbol L2 may be specified as the next uplink symbol with its CP starting after a time gap with length T_{proc,2} after the end of the reception of the last symbol of the PDCCH carrying the DCI scheduling the PUSCH.

A wireless device may perform a logical channel prioritization (LCP) procedure if a new transmission is performed. The one or more configuration parameters may comprise one or more logical channel (LCH) configuration parameters (e.g., IE LogicalChannelConfig), e.g., to configure the logical channel parameters. The wireless device may determine (e.g., control) scheduling of uplink data based on the one or more LCH configuration parameters, e.g., for each logical channel of a plurality of logical channels, e.g., per MAC entity of the wireless device. For example, the one or more LCH configuration parameters may, e.g., corresponding to each logical channel of the plurality of logical channels, comprise a priority value (e.g., priority), e.g., where an increasing priority value indicates a lower priority level, prioritisedBitRate (e.g., which sets the Prioritized Bit Rate (PBR)), and/or bucketSizeDuration (e.g., which sets the Bucket Size Duration (BSD)). The one or more LCH configuration parameters may indicate mapping restrictions for each logical channel of the plurality of logical channels. allowedSCS-List of the one or more LCH configuration parameters may set/indicate allowed Subcarrier Spacing(s) for transmission of MAC PDU/TB corresponding to a logical channel of the plurality of logical channels; and/or maxPUSCH-Duration of the one or more LCH configuration parameters may set/indicate a maximum PUSCH duration allowed for transmission of MAC PDU/TB corresponding to a logical channel of the plurality of logical channels; and/or configuredGrantType1Allowed of the one or more LCH configuration parameters may set/indicate whether a configured grant Type 1 can be used for transmission of MAC PDU/TB corresponding to a logical channel of the plurality of logical channels; and/or allowedServingCells of the one or more LCH configuration parameters may indicate allowed cell(s) for transmission of MAC PDU/TB corresponding to a logical channel of the plurality of logical channels; and/or allowedCG-List of the one or more LCH configuration parameters allowed configured grant(s) for transmission of MAC PDU/TB corresponding to a logical channel of the plurality of logical channels; and/or allowedPHY-PriorityIndex of the one or more LCH configuration parameters allowed PHY priority index(es) of a dynamic grant for transmission of MAC PDU/TB corresponding to a logical channel of the plurality of logical channels.

A wireless device may maintain one or more variables for performing a LCP procedure. For example, the one or more variables may comprise Bj corresponding to a logical channel j of the plurality of logical channels. The wireless device may initialize Bj of the logical channel j to zero when the logical channel j is established. The wireless device may increment Bj by a product PBR×T before every instance of the LCP procedure. T may be the time elapsed since Bj was last incremented. The wireless device may set Bj to the bucket size, e.g., if the value of Bj is greater than the bucket size (e.g., PBR×BSD). The instance (e.g., exact moment(s)) when the wireless device updates Bj between the LCP procedures may be up to wireless device implementation, e.g., as long as Bj is up to date at the time when a grant is processed by the LCP.

A wireless device, for performing a LCP procedure, may select one or more logical channels of a plurality of logical channels and/or allocate resources to the one or more logical channels. The wireless device may select the one or more logical channels if a new transmission is performed. For example, the wireless device may select the one or more logical channels based on the mapping restrictions for each logical channel of the plurality of logical channels (e.g., a Subcarrier Spacing index, PUSCH transmission duration, Cell information, and/or priority index). The wireless device may receive uplink transmission information (e.g., dynamic grant and/or configured grant(s)) indicating the Subcarrier Spacing index, PUSCH transmission duration, Cell information, and/or priority index for the corresponding scheduled uplink transmission.

A wireless device may select one or more logical channels for each UL grant (e.g., dynamic grant and/or configured grant(s)) that may satisfy at least one of (e.g., all) the following conditions: a set of allowed Subcarrier Spacing index value(s) in allowedSCS-List, if configured, may comprise the Subcarrier Spacing index associated to the UL grant; maxPUSCH-Duration, if configured, may be larger than or equal to the PUSCH transmission duration associated to the UL grant; configuredGrantType1Allowed, if configured, may be set to true for the UL grant being a Configured Grant Type 1; allowedServingCells, if configured, may comprise the Cell information associated to the UL grant (e.g., allowedServingCells may not apply to logical channel(s) associated with a DRB configured with PDCP duplication within the same MAC entity of the wireless device (e.g., CA duplication) if CA duplication is deactivated for this DRB in this MAC entity of wireless device); allowedCG-List, if configured, may comprise the configured grant index associated to the UL grant; and/or allowedPHY-PriorityIndex, if configured, may comprise a priority index associated to the dynamic UL grant.

A wireless device may maintain a plurality of active (e.g., activated) protocol stacks, e.g., for and/or during a handover and/or dual connectivity. For example, for a handover, a target wireless device (e.g., MAC entity of the wireless device) may not select logical channel(s) corresponding to non-dual active (activated) protocol stack DRB(s) for an uplink grant received in a Random Access Response or the uplink grant for the transmission of the MSGA payload, e.g., before a successful completion of the Random Access procedure initiated for dual active (activated) protocol stack handover.

A wireless device may allocate (and/or determine) resources to one or more logical channels if a new transmission is performed. The wireless device may allocate resources to the one or more logical channels as follows: the wireless device may allocate resources to one or more logical channels selected (e.g., according to the present disclosure) for the UL grant with Bj>0 in a decreasing priority order (e.g., of the one or more logical channels). The wireless device may allocate resources for the data (e.g., all the data) that may be available for transmission on the logical channel before meeting the PBR of a lower priority logical channel, if the PBR of a logical channel of the one or more logical channels is set to a particular value predefined (e.g., infinity). The wireless device may decrement Bj by the total size of MAC SDUs served to logical channel j of the one or more logical channels. The wireless device may serve the one or more logical channels in a decreasing priority order.

A wireless device may determine the value of Bj as negative. The wireless device may determine which order grants are processed if the wireless device is scheduled to simultaneously send (e.g., transmit) multiple MAC PDUs, or if the wireless device receives the multiple UL grants within one or more coinciding PDCCH occasions (i.e. on different Serving Cells). The wireless device may not segment an RLC SDU (or partially transmitted SDU or retransmitted RLC PDU) if the whole SDU (or partially sent/transmitted SDU or re-sent/retransmitted RLC PDU) fits into the remaining resources of the associated wireless device (e.g., MAC entity of the wireless device). If the UE segments an RLC SDU from the logical channel, it may maximize the size of the segment to fill the grant of the associated wireless device (e.g., MAC entity of the wireless device) as much as possible. The wireless device may maximize the transmission of data. The wireless device may not send (e.g., transmit) only padding BSR and/or padding if the wireless device receives and/or has a UL grant size that is equal to or larger than 8 bytes while having data available and allowed for transmission.

The wireless device may not generate a MAC PDU for a HARQ entity. The wireless device may not generate a MAC PDU for a HARQ entity if the wireless device is configured with enhancedSkipUplinkTxDynamic with value true and the grant indicated to the HARQ entity was addressed to a C-RNTI, and/or if the wireless device (e.g., MAC entity of the wireless device) is configured with enhancedSkipUplinkTxConfigured with value true and the grant indicated to the HARQ entity is a configured uplink grant, and/or if the wireless device is not configured with Ich-basedPrioritization, and/or if there is no UCI to be multiplexed on this PUSCH transmission, and/or if there is no aperiodic CSI requested for this PUSCH transmission, and/or if the MAC PDU includes zero MAC SDUs, and/or if the MAC PDU includes only the periodic BSR and there is no data available for any logical channel group (LCG), or the MAC PDU includes only the padding BSR. The wireless device may not generate a MAC PDU for a HARQ entity if the wireless device is configured with skipUplinkTxDynamic with value true and the grant indicated to the HARQ entity was addressed to a C-RNTI, or the grant indicated to the HARQ entity is a configured uplink grant; and/or if there is no aperiodic CSI requested for this PUSCH transmission; and/or if the MAC PDU includes zero MAC SDUs; and/or if the MAC PDU includes only the periodic BSR and there is no data available for any LCG, or the MAC PDU includes only the padding BSR.

A wireless device may determine priorities of one or more logical channels. For example, the wireless device may prioritize the one or more logical channels in accordance with the following order (e.g., highest priority listed first):
C-RNTI MAC CE or data from UL-CCCH;
Configured Grant Confirmation MAC CE or BFR MAC CE or Multiple Entry Configured Grant Confirmation MAC CE;
Sidelink Configured Grant Confirmation MAC CE;
LBT failure MAC CE;
MAC CE for SL-BSR prioritized according to clause 5.22.1.6;
MAC CE for BSR, with exception of BSR included for padding;
Single Entry PHR MAC CE or Multiple Entry PHR MAC CE;
MAC CE for the quantity (e.g., number) of Desired Guard Symbols;
MAC CE for Pre-emptive BSR;
MAC CE for SL-BSR, with exception of SL-BSR prioritized and SL-BSR included for padding;
data from any Logical Channel, except data from UL-CCCH;
MAC CE for Recommended bit rate query;
MAC CE for BSR included for padding;
MAC CE for SL-BSR included for padding.

A wireless device may determine the prioritization among Configured Grant Confirmation MAC CE, Multiple Entry Configured Grant Confirmation MAC CE, and BFR MAC CE. The wireless device may prioritize any MAC CE listed in a higher order than data from any Logical Channel, e.g., except data from UL-CCCH over transmission of NR sidelink communication.

A wireless device may multiplex MAC CEs and MAC SDUs in a MAC PDU. The wireless device may not change the content of a MAC PDU, for example, after being built for transmission on a dynamic uplink grant (e.g., regardless of LBT outcome).

A wireless device may perform a buffer status reporting (BSR) procedure to provide a base station (e.g., a serving base station) and/or a network with information about UL data volume in an MAC entity of the wireless device. The wireless device may receive message(s) (e.g., RRC message and/or system information) indicating values of parameters of the BSR procedure.

Message(s) may comprise information element(s) indicating values of following parameters: a periodic BSR timer, a retransmission BSR timer, a logical channel SR delay timer, a logical channel SR-delay timer applied, a logical channel SR mask, and/or a logical channel group. For example, logicalChannelSR-DelayTimer (e.g., a logical channel SR delay timer) may have a value in quantity (e.g., number) of subframes. The value sf20 may correspond to 20 subframes, sf40 corresponds to 40 subframes, and so on. periodicBSR-Timer (e.g., a periodic BSR timer) may have a value in quantity (e.g., number) of subframes. The value sf1 may correspond to 1 subframe, value sf5 corresponds to 5 subframes and so on. retxBSR-Timer (e.g., a retransmission BSR timer) may have a value in quantity (e.g., number) of subframes. The value sf10 may correspond to 10 subframes, value sf20 corresponds to 20 subframes and so on.

A BSR configuration (e.g., BSR-config) may comprise logicalChannelSR-DelayTimer, periodicBSR-Timer, and/or retxBSR-Timer. The BSR configuration may be per an MAC entity of the wireless device. The wireless device may receive the message(s) comprising a first BSR configuration of a first wireless device (e.g., MAC entity of the wireless device) of a master (e.g., primary) cell group and/or a second BSR configuration of a second wireless device (e.g., MAC entity of the wireless device) of a secondary cell group.

logicalChannelSR-Mask (e.g., a logical channel SR mask) may control SR triggering if a configured uplink grant of type1 or type2 is configured. A value ‘true’ of the logicalChannelSR-Mask may indicate that SR masking is configured for this logical channel. A value ‘false’ of the logicalChannelSR-Mask may indicate that SR masking is not configured for this logical channel. logicalChannelSR-DelayTimerApplied (e.g., a logical channel SR delay timer applied) may indicate whether to apply the delay timer for SR transmission for this logical channel. The value may be set to false in the message(s) if logicalChannelSR-DelayTimer is not in a BSR configuration (e.g., BSR-Config). logicalChannelGroup (e.g., a logical channel group) may be an ID (e.g., index and/or identifier) of a logical channel group that a logical channel belongs to.

A logical channel configuration of a particular logical channel may comprise logicalChannelSR-Mask, logicalChannelSR-DelayTimerApplied, and/or logicalChannelGroup. A value ‘true’ of the logicalChannelSR-Mask may indicate that SR masking is configured for the particular logical channel. A value ‘false’ of the logicalChannelSR-Mask may indicate that SR masking is not configured for the particular logical channel. logicalChannelSR-DelayTimerApplied (e.g., a logical channel SR delay timer applied) may indicate whether to apply the delay timer for SR transmission for the particular logical channel. The value of logicalChannelSR-DelayTimerApplied may be set to false in the message(s) if logicalChannelSR-DelayTimer is not in the BSR configuration. logicalChannelGroup (e.g., a logical channel group) may be an ID (e.g., index and/or identifier) of a logical channel group that the particular logical channel belongs to.

Each logical channel (LC) may be allocated to (e.g., associated with) a logical channel group (LCG) using the logicalChannelGroup. A quantity (e.g., number) of LCGs configured to the wireless device may be limited. A maximum quantity (e.g., number) of LCGs configurable may be predefined and/or configured by an RRC message. The maximum quantity (e.g., number) of LCGs may be two, four, eight, and/or any integer number. An MAC entity of a wireless device may determine an amount of UL data available for a logical channel according to the data volume calculation procedure.

A wireless device may trigger a BSR if at least one of the one or more events occur. The one or more events may comprise a first event that UL data, for a logical channel which belongs to an LCG, becomes available to the MAC entity of the wireless device, and/or the UL data may belong to the logical channel with higher priority than the priority of any logical channel containing available UL data which belong to any LCG. The one or more events may comprise a second event that UL data, for a logical channel which belongs to an LCG, becomes available to the MAC entity of the wireless device, and/or none of logical channels which belong to an LCG may contain any available UL data, e.g., when the UL data becomes available. The BSR triggered, based on the first event and/or the second event, may be referred below to as Regular BSR. The one or more events comprise the one that UL resource(s) may be allocated, and quantity (e.g., number) of padding bits is equal to or larger than the size of the Buffer Status Report MAC CE plus its subheader, in which case the BSR is referred below to as Padding BSR. For example, the one or more events comprise the one that retxBSR-Timer expires, and/or at least one of logical channels which belong to an LCG contains UL data, in which case the BSR is referred below to as Regular BSR. For example, the one or more events comprise the one that periodic BSR-Timer expires, in which case the BSR is referred below to as periodic BSR. For example, each logical channel may trigger one separate Regular BSR, e.g., when Regular BSR triggering events occur for multiple logical channels simultaneously.

A MAC entity of the wireless device, for Regular BSR, may start or restart the logicalChannelSR-Delay Timer if the BSR is triggered for a logical channel for which logicalChannelSR-DelayTimerApplied with value true is configured by upper layers (e.g., by an RRC message). The MAC entity of the wireless device, for Regular BSR, may, if running, stop the logicalChannelSR-DelayTimer if the BSR is triggered for a logical channel for which logicalChannelSR-DelayTimerApplied with value true is not configured (e.g., logicalChannelSR-DelayTimerApplied with value false is configured and/or logicalChannelSR-DelayTimerApplied is absent in the message(s)) by upper layers (e.g., by an RRC message).

A MAC entity of the wireless device, for regular and/or periodic BSR, may report Long BSR for all LCGs which have data available for transmission, if more than one LCG has data available for transmission and the MAC PDU containing the BSR is to be built. For regular and/or periodic BSR, the MAC entity of the wireless device may report Short BSR, if more than one LCG has not data available for transmission and the MAC PDU containing the BSR is to be built and/or if a single LCG has data available for transmission and the MAC PDU containing the BSR is to be built.

A MAC entity of the wireless device, for Padding BSR, may report Long BSR for one or more LCGs (e.g., all LCGs) which have data available for transmission if a quantity (e.g., number) of padding bits is equal to or larger than a size of the Long BSR plus its subheader. There may be a case for Padding BSR that a quantity (e.g., number) of padding bits may be equal to or larger than the size of the Short BSR plus its subheader and/or smaller than the size of the Long BSR plus its subheader. The MAC entity of the wireless device may report Short BSR if more than one LCG has not data available for transmission and the BSR is to be built and/or if a single LCG has data available for transmission and the BSR is to be built. The MAC entity of the wireless device may report Short Truncated BSR of the LCG with the highest priority logical channel with data available for transmission if more than one LCG has data available for transmission and the BSR is to be built and/or if a quantity (e.g., number) of padding bits is equal to the size of the Short BSR plus its subheader.

A MAC entity of the wireless device may report Long Truncated BSR of the LCG(s) with the logical channel(s) having data available for transmission following a decreasing order of the highest priority logical channel (with or without data available for transmission) in each of these LCG(s), and in case of equal priority, in increasing order of LCGID, e.g., if more than one LCG has data available for transmission when the BSR is to be built and/or if a quantity (e.g., number) of padding bits is not equal to the size of the Short BSR plus its subheader.

A wireless device (e.g., MAC entity of the wireless device), for BSR triggered by retxBSR-Timer expiry, may determine that the logical channel that triggered the BSR may be the highest priority logical channel that has data available for transmission at the time the BSR is triggered. The MAC entity of the wireless device (e.g., the Buffer Status reporting procedure triggered by the wireless device) may determine whether at least one BSR has been triggered and/or not cancelled. The wireless device may determine that the at least one BSR is pending if the at least one BSR has been triggered and/or not cancelled.

A wireless device may determine, based on (e.g., in response) to at least one BSR being pending (e.g., having been triggered and/or not cancelled), if UL-SCH resources are available for a new transmission and/or if the UL-SCH resources may accommodate a BSR MAC CE plus its subheader as a result of logical channel prioritization. The BSR MAC CE may comprise and/or indicate the at least one BSR.

A wireless device may perform instruct the multiplexing and assembly procedure to generate the BSR MAC CE(s), if at least one BSR is pending (e.g., has been triggered and/or not cancelled), if UL-SCH resources are available for a new transmission and/or if the UL-SCH resources may accommodate a BSR MAC CE plus its subheader as a result of logical channel prioritization. A wireless device may further start or restart periodicBSR-Timer and/or start or restart retxBSR-Timer, if at least one BSR is pending (e.g., has been triggered and/or not cancelled), if UL-SCH resources are available for a new transmission and/or if the UL-SCH resources may accommodate a BSR MAC CE plus its subheader as a result of logical channel prioritization. A wireless device may not start or not restart (e.g., may skip to start or restart) periodicBSR-Timer, if the generated BSR(s) (e.g., all generated BSR(s)) are long or short Truncated BSRs, if at least one BSR is pending (e.g., has been triggered and/or not cancelled), if UL-SCH resources are available for a new transmission and/or if the UL-SCH resources may accommodate a BSR MAC CE plus its subheader as a result of logical channel prioritization.

A wireless device may trigger a scheduling request if at least one BSR is pending (e.g., has been triggered and/or not cancelled). The wireless device may trigger a scheduling request, if at least one BSR is pending (e.g., has been triggered and/or not cancelled), if a regular BSR has been triggered and logicalChannelSR-DelayTimer is not running, and/or if there is no UL-SCH resource available for a new transmission. The wireless device may trigger a scheduling request, if at least one BSR is pending (e.g., has been triggered and/or not cancelled), if a regular BSR has been triggered and logicalChannelSR-DelayTimer is not running, and/or if the wireless device (e.g., MAC entity of the wireless device) is configured with configured uplink grant(s) and the regular BSR was triggered for a logical channel for which logicalChannelSR-Mask is set to false. The wireless device may trigger a scheduling request, if at least one BSR is pending (e.g., has been triggered and/or not cancelled), if a regular BSR has been triggered and logicalChannelSR-DelayTimer is not running, and/or if the UL-SCH resources available for a new transmission do not meet the LCP mapping restrictions configured for the logical channel that triggered the BSR.

A wireless device may determine that UL-SCH resources are available if a MAC entity of the wireless device has been configured with, receives, and/or determines an uplink grant. UL-SCH resources determined as available may be available for use at a point in time that the UL-SCH resources are determined as available. UL-SCH resources determined as available may not be available for use at a point in time that the UL-SCH resources are determined as available. UL-SCH resources determined as available may not be available for use at a point in time that the UL-SCH resources are determined as available if the UL-SCH resources are overlapped with other resources (e.g., SSB transmission) and/or if the UL-SCH resources are invalid.

A MAC PDU may comprise at least one (e.g., at most one) BSR MAC CE. A MAC PDU may comprise at least one (e.g., at most one) BSR MAC CE if multiple events have triggered one or more BSRs. A wireless device may select a BSR among the one or more BSRs and/or may multiplex the MAC PDU comprising the at least one (e.g., at most one) BSR MAC CE corresponding to the selecting BSR. The wireless device may select the BSR among the one or more BSRs based on a priority among the one or more BSRs. The Regular BSR may have precedence over the padding BSR. The periodic BSR may have precedence over the padding BSR.

A MAC entity of the wireless device may start or restart retxBSR-Timer upon reception of a grant for transmission of new data (and/or retransmission of data) on UL-SCH (e.g., any UL-SCH). The MAC entity of the wireless device may cancel one or more (e.g., all) triggered BSRs if the UL grant(s) may accommodate pending data (e.g., all pending data) available for transmission and/or may be not sufficient to additionally accommodate the BSR MAC CE plus its subheader. All BSRs triggered prior to MAC PDU assembly shall be cancelled if a MAC PDU is sent (e.g., transmitted) and this PDU includes a Long or Short BSR MAC CE which contains buffer status up to (and including) the last event that triggered a BSR prior to the MAC PDU assembly.

A wireless device may perform a MAC PDU assembly, e.g., at any point, in time between uplink grant reception and actual transmission of the corresponding MAC PDU. The wireless device may trigger BSR and SR after (e.g., in response to) the assembly of a MAC PDU which may comprise a BSR MAC CE, and/or before the transmission of this MAC PDU. The wireless device may trigger BSR and SR during MAC PDU assembly.

A wireless device may trigger and/or send (e.g., transmit) a scheduling request (SR) to request UL-SCH resources for a transmission (e.g., new transmission). An MAC entity of the wireless device may be configured with zero, one, or more SR configurations. An SR configuration may comprise a set of PUCCH resource(s) for SR across different BWP(s) and/or cell(s). The wireless device, for a logical channel, for beam failure recovery (e.g., secondary cell beam failure recovery), and/or for consistent LBT failure recovery, may receive a message (e.g., RRC message and/or system information) indicating and/or configuring one or more PUCCH resource(s) for SR per BWP. The wireless device, for a logical channel, may receive a message (e.g., RRC message and/or system information) indicating and/or configuring at most one PUCCH resource for SR per BWP. The wireless device, for beam failure recovery (e.g., secondary cell beam failure recovery), may receive a message (e.g., RRC message and/or system information) indicating and/or configuring at most one PUCCH resource for SR per BWP. The wireless device, for consistent LBT failure recovery, may receive a message (e.g., RRC message and/or system information) indicating and/or configuring at most one PUCCH resource for SR per BWP.

Each SR configuration may correspond to one or more logical channels and/or to SCell beam failure recovery and/or to consistent LBT failure recovery (e.g., which may be configured by an RRC message). Each logical channel, SCell beam failure recovery, and/or consistent LBT failure recovery, may be mapped to zero or one SR configuration (e.g., which may be configured by an RRC message). The wireless device may determine the SR configuration of the logical channel that triggered a BSR or the SCell beam failure recovery or the consistent LBT failure recovery (if such a configuration exists) as corresponding SR configuration for the triggered SR. The wireless device may use any SR configuration for an SR triggered by Pre-emptive BSR.

A wireless device may receive message(s) (e.g., RRC message and/or system information). The message(s) may comprise configuration parameters associated with ch SR procedure. The configuration parameters for the SR procedure may comprise sr-ProhibitTimer and/or sr-TransMax. A SR configuration (e.g., each SR configuration) may comprise schedulingRequestId (e.g., a scheduling request index and/or identifier) of the SR configuration, sr-ProhibitTimer (e.g., per SR configuration) and/or sr-TransMax (e.g., per SR configuration). schedulingRequestId may be used to modify a SR configuration and/or to indicate, in LogicalChannelConfig, the SR configuration to which a logical channel is mapped and to indicate, in SchedulingRequestresourceConfig, the SR configuration for which a scheduling request resource is used. sr-ProhibitTimer may be a timer for SR transmission on PUCCH. Value of sr-ProhibitTimer may be in ms (or any time unit such as second, milliseconds, etc.). Value ms1 may correspond to 1 ms, value ms2 corresponds to 2 ms, and so on. The wireless device may determine to apply the value 0, if the field of sr-ProhibitTimer in the SR configuration is absent. sr-TransMax may be a (e.g., maximum) quantity (e.g., number) of SR transmissions, e.g., allowed to the wireless device to transmit the SR. Value n4 of sr-TransMax may correspond to 4, value n8 corresponds to 8, and so on.

A wireless device may maintain one or more variables used for the scheduling request procedure. The one or more variables may comprise a counter, e.g., SR_COUNTER, counting a quantity (e.g., number) of SR triggered and/or a quantity (e.g., number) of transmissions of SR triggered and/or pending. The wireless device may maintain the SR_COUNTER per SR configuration. The wireless device may set the SR_COUNTER of the corresponding SR configuration to 0 (e.g., or any initial value), if an SR is triggered and there are no other SRs pending corresponding to the same SR configuration. The wireless device may determine an SR as pending until it is cancelled, if the SR is triggered.

A wireless device may cancel pending SR(s) (e.g., all pending SR(s)) for BSR triggered according to the BSR procedure, e.g., prior to the MAC PDU assembly and/or may stop each respective sr-ProhibitTimer, e.g., when the wireless device transmit the MAC PDU and this PDU comprises a Long and/or Short BSR MAC CE which contains buffer status up to (and comprising) the last event that triggered a BSR prior to the MAC PDU assembly. The wireless device may cancel pending SR(s) (e.g., all pending SR(s)) for BSR triggered according to the BSR procedure and may stop each respective sr-ProhibitTimer, e.g., when the UL grant(s) accommodate pending data (e.g., all pending data) available for transmission.

An MAC entity of the wireless device may, for each pending SR not triggered according to the BSR procedure for a Serving Cell, cancel the pending SR and stop the corresponding sr-ProhibitTimer (e.g., if running), if this SR was triggered by Pre-emptive BSR procedure prior to the MAC PDU assembly and/or a MAC PDU comprising the relevant Pre-emptive BSR MAC CE is transmitted. The wireless device (e.g., MAC entity of the wireless device) may, for each pending SR not triggered according to the BSR procedure for a Serving Cell, cancel the pending SR and stop the corresponding sr-ProhibitTimer (e.g., if running), if this SR was triggered by beam failure recovery of an SCell and/or a MAC PDU is transmitted and this PDU comprises a BFR MAC CE or a Truncated BFR MAC CE which contains beam failure recovery information for this SCell. The wireless device (e.g., MAC entity of the wireless device) may, for each pending SR not triggered according to the BSR procedure for a Serving Cell, cancel the pending SR and stop the corresponding sr-ProhibitTimer (e.g., if running), if this SR was triggered by beam failure recovery of an SCell and this SCell is deactivated. The wireless device (e.g., MAC entity of the wireless device) may, for each pending SR not triggered according to the BSR procedure for a Serving Cell, cancel the pending SR and stop the corresponding sr-ProhibitTimer (e.g., if running), if this SR was triggered by consistent LBT failure recovery of a cell (e.g., an SCell) and a MAC PDU is sent (e.g., transmitted) and the MAC PDU comprises an LBT failure MAC CE that indicates consistent LBT failure for this cell (e.g., SCell). The wireless device (e.g., MAC entity of the wireless device) may, for each pending SR not triggered according to the BSR procedure for a Serving Cell, cancel the pending SR and stop the corresponding sr-ProhibitTimer (e.g., if running), if this SR was triggered by consistent LBT failure recovery of a cell (e.g., SCell) and the triggered consistent LBT failure(s) (e.g., all the triggered consistent LBT failure(s)) for this cell (e.g., SCell) are cancelled.

A wireless device may determine that one or more PUCCH resources are valid, if the one or more PUCCH resources are scheduled on a BWP which is active at the time of SR transmission occasion. The wireless device (e.g., MAC entity of the wireless device) may, for each pending SR, initiate a random access procedure on a cell (e.g., SpCell) and cancel the pending SR, if at least one SR is pending and/or if the wireless device (e.g., MAC entity of the wireless device) has no valid PUCCH resource configured for the pending SR.

A MAC entity may, for each pending SR and/or for the SR configuration corresponding to the pending SR, determine whether one or more first conditions to signal an SR on one valid PUCCH resource for SR, satisfy, if at least one SR is pending, and/or if the wireless device (e.g., MAC entity of the wireless device) has valid PUCCH resource(s) configured for the pending SR, and/or if the wireless device (e.g., MAC entity of the wireless device) has an SR transmission occasion on the valid PUCCH resource for SR configured. The one or more first conditions may comprise sr-ProhibitTimer being not running at the time of the SR transmission occasion and/or the PUCCH resource for the SR transmission occasion being not overlap with a measurement gap.

A wireless device may further check at least one of one or more second conditions satisfied to signal an SR on one valid PUCCH resource for SR. One or more second conditions may comprise the PUCCH resource (for the SR transmission occasion) overlapping with neither a UL-SCH resource nor an SL-SCH resource. One or more second conditions may comprise such a condition that the wireless device (e.g., MAC entity of the wireless device) is able to perform this SR transmission simultaneously with the transmission of the SL-SCH resource. One or more second conditions may comprise such a condition that the wireless device (e.g., MAC entity of the wireless device) is configured with Ich-basedPrioritization, the PUCCH resource for the SR transmission occasion does not overlap with the PUSCH duration of an uplink grant received in a Random Access Response or with the PUSCH duration of an uplink grant addressed to Temporary C-RNTI or with the PUSCH duration of a MSGA payload, the PUCCH resource for the SR transmission occasion for the pending SR triggered overlaps with any other UL-SCH resource(s), the physical layer can signal the SR on one valid PUCCH resource for SR, the priority of the logical channel that triggered SR is higher than the priority of the uplink grant(s) for any UL-SCH resource(s) where the uplink grant was not already de-prioritized, and/or the priority of the uplink grant is determined. One or more second conditions may comprise such a condition that sl-PrioritizationThres and/or ul-PrioritizationThres are configured and the PUCCH resource for the SR transmission occasion for the pending SR triggered overlaps with any UL-SCH resource(s) carrying a MAC PDU, the value of the priority of the triggered SR determined is lower than sl-PrioritizationThres, the value of the highest priority of the logical channel(s) in the MAC PDU is higher than or equal to ul-PrioritizationThres, and/or the MAC PDU is not prioritized by upper layer. One or more second conditions may comprise such a condition that a SL-SCH resource overlaps with the PUCCH resource for the SR transmission occasion for the pending SR triggered, the wireless device (e.g., MAC entity of the wireless device) is not able to perform this SR transmission simultaneously with the transmission of the SL-SCH resource, and/or either transmission on the SL-SCH resource is not prioritized or the priority value of the logical channel that triggered SR is lower than ul-PrioritizationThres, if configured. One or more second conditions may comprise such a condition that a SL-SCH resource overlaps with the PUCCH resource for the SR transmission occasion for the pending SR triggered, the wireless device (e.g., MAC entity of the wireless device) is not able to perform this SR transmission simultaneously with the transmission of the SL-SCH resource, and the priority of the triggered SR determined is higher than the priority of the MAC PDU determined for the SL-SCH resource.

A wireless device may determine that the SR transmission as a prioritized SR transmission, if at least one of the one or more first conditions satisfies and/or if at least one of the one or more second conditions satisfies. The wireless device may determine that the other overlapping uplink grant(s), as a de-prioritized uplink grant(s), if at least one of the one or more conditions satisfies and/or if at least one of the one or more second conditions satisfies. A wireless device may stop a configuredGrantTimer for a corresponding HARQ process of the de-prioritized uplink grant(s), if at least one of the one or more conditions satisfies, and/or if at least one of the one or more second conditions satisfies, and/or if the de-prioritized uplink grant(s) is a configured uplink grant configured with autonomousTx whose PUSCH has already started.

A wireless device may instruct the physical layer to signal the SR on one valid PUCCH resource for SR, if at least one of the one or more conditions satisfies, and/or if at least one of the one or more second conditions satisfies, and/or if SR_COUNTER<sr-TransMax. The wireless device may increment SR_COUNTER by 1 and/or start the sr-ProhibitTimer, if at least one of the one or more conditions satisfies, and/or if at least one of the one or more second conditions satisfies, and/or if SR_COUNTER<sr-TransMax, and/or if LBT failure indication is not received from lower layers. The wireless device may increment SR_COUNTER by 1 and/or may not start the sr-ProhibitTimer, if at least one of the one or more conditions satisfies, and/or if at least one of the one or more second conditions satisfies, and/or if SR_COUNTER<sr-TransMax, and/or if LBT failure indication is not received from lower layers, and/or if Ibt-FailureRecoveryConfig is not configured.

A MAC entity of the wireless device may notify an RRC layer of the wireless device to release PUCCH for one or more Cells (e.g., all serving cells), may notify the RRC to release SRS for one or more Cells (e.g., all serving cells), may clear any configured downlink assignments and uplink grants, may clear any PUSCH resources for semi-persistent CSI reporting, may initiate a Random Access procedure on a cell (e.g., SpCell) and/or cancel one or more pending SRs (e.g., all pending SRs), if at least one of the one or more conditions satisfies, and/or if at least one of the one or more second conditions satisfies, and/or if SR_COUNTER≥sr-TransMax.

A wireless device may determine the SR transmission as a de-prioritized SR transmission, if at least one of the one or more conditions satisfies. The wireless device may determine the SR transmission as a de-prioritized SR transmission, if at least one of the one or more conditions satisfies, and/or if (e.g., all) the one or more second conditions do not satisfy.

A wireless device may select which valid PUCCH resource for SR to signal SR on if the wireless device (e.g., MAC entity of the wireless device) has more than one overlapping valid PUCCH resource for the SR transmission occasion. The wireless device may not select which valid PUCCH resource for SR for a beam failure recovery (e.g., of Scell) to signal SR on if the wireless device (e.g., MAC entity of the wireless device) has more than one overlapping valid PUCCH resource for the SR transmission occasion. The wireless device may increment SR_COUNTER once for the relevant SR configuration, if more than one individual SR triggers an instruction from the wireless device (e.g., MAC entity of the wireless device) to the PHY layer to signal the SR on the same valid PUCCH resource.

A wireless device may stop (e.g., if any) ongoing Random Access procedure due to a pending SR for BSR, which was initiated by the wireless device (e.g., MAC entity of the wireless device) prior to the MAC PDU assembly and which has no valid PUCCH resources configured, if a MAC PDU is sent (e.g., transmitted) using a UL grant other than a UL grant provided by Random Access Response or a UL grant determined for the transmission of the MSGA payload, and/or this PDU comprises a BSR MAC CE which contains buffer status up to (and comprising) the last event that triggered a BSR prior to the MAC PDU assembly. The wireless device may stop (e.g., if any) ongoing Random Access procedure due to a pending SR for BSR, which was initiated by the wireless device (e.g., MAC entity of the wireless device) prior to the MAC PDU assembly and which has no valid PUCCH resources configured, if the UL grant(s) can accommodate pending data (e.g., all pending data) available for transmission.

Extended reality (XR) may be refer to all real-and-virtual combined environments and human-machine interactions generated by computer technology and wearables. XR may be an umbrella term for different types of realities, e.g., Virtual reality (VR), Augmented reality (AR), Mixed reality (MR), and/or Cloud Gaming, and the like. XR application(s) may provide a sense of being surrounded by the virtual environment (e.g., Immersion) and/or a feeling of being physically and spatially located in the virtual environment (e.g., Presence). The acronym XR may refer to equipment(s), application(s) and function(s) used for VR, AR, Cloud Gaming, and/or MR, e.g., to HMDs for VR, optical see-through glasses and camera see-through HMDs for AR and MR and mobile devices with positional tracking and camera. An XR device may be a wireless device that run/use/perform one or more XR functions/applications/use cases (e.g., AR). An XR device may be a wireless device that has XR equipment's to perform one or more XR services. The XR device may send (e.g., transmit) or receive XR data/packets/traffic (e.g., to/from the base station).

Some XR uses cases (e.g., Cloud Gaming and/or VR) may be characterized by quasi-periodic traffic (e.g., 45/60/90/120 frames per second (FPS)), with possible jitter and/or a non-integer periodicity. For example, the frame rate for XR video varies from 30 frames per second up to 90 or even 120 frames per second, with a typical minimum of 60 for VR. In some other cases, a jitter may be up to couple of milliseconds (e.g., 4 ms, 8 ms, 10 ms, or higher, depending on application, network delay, and/or video coding standards). XR use cases may require high data rate in DL (e.g., for transmission of video steam and/or audio data) combined with the frequent UL data (i.e., pose/control update or pose Information) and/or UL video stream. Both DL and UL traffic are also characterized by relatively strict packet delay budget (PDB). For example, PDB of posc/control update may be around 4 ms. In some applications, PDB of DL/UL video steam may be 10 ms or 20 ms or 30 ms. For example, the latency of action of the angular or rotational vestibulo-ocular reflex is known to be of the order of 10 ms or in a range from 7-15 milliseconds. In another example, a motion-to-photon latency of less than 10-20 milliseconds may be required (e.g., the PDB of less than 10-20 ms).

Bit rates of XR use cases (or applications) may be between 10 and 200 Mbps, depending on frame rate, resolution and codec efficiency. Volume of DL/UL data (or bit rate) across traffic periods (or burst of data or data burst or PDU set) may change. In a first traffic period (or burst of data) the volume of DL video stream may be a first value (e.g., 100 Mbyte) and in a second traffic period (or burst of data) the volume of DL video stream may be a second value (e.g., 50 Mbyte). Data burst may comprise a set of multiple PDUs (SDAP/PDCP/RLC/MAC PDUs) generated and sent by the application in a short period of time (e.g., a traffic period). A data burst may comprise one or multiple PDU sets and/or one or more data packets (e.g., IP packets) and/or one or more bundles of PUSCHs/PDSCHs and/or one or more PDUs from at least one PDU set. The PDU set (or PDU-set or PDU set/bundle/collection) may comprise one or more PDUs carrying the payload of one unit of information generated at the application level (e.g., a frame or video slice for XRM Services). A PDU set information (e.g., corresponding to a PDU) may indicate/comprise at least one of the following: a PDU set identifier; and/or a start (or earliest/starting/initial) PDU and an end (or latest/final/ending) PDU of the PDU set; and/or a PDU serial number (SN) of a PDU within the PDU set; and/or a PDU set size; and/or a PDU set importance; and/or an end of data burst indication (e.g., indicating an end of the data burst). For example, the end of data burst indication may correspond to the end PDU. The end of data burst indication may indicate a last/final/ending/latest PDU within a data burst.

A network (e.g., base station) and/or a wireless device may not be aware of (or accurately measure) instantaneous jitter value/range in advance and/or volume of UL/DL traffic (e.g., within each traffic period). The network (e.g., base station) and/or the wireless device may determine/measure via statistical measurements (and/or AI/ML methods) one or more statistics/characteristics (e.g., average, variance, probability density function, and the like) of the jitter and/or the volume of UL/DL data (or bit rate).

A PDU set related assistance information (e.g., provided via control plane to user plane of the wireless device and/or the base station) may define/indicate one or more assistance information corresponding to a PDU set. The PDU set information and/or the PDU set related assistance information may allow an XR aware operation of RAN (e.g., user plane of the base station and/or the wireless device). The PDU set related assistance information may comprise a PDU-Set QoS parameters and/or a burst (or XR data or data burst or PDU set) periodicity, e.g., a periodicity of a quasi-periodic traffic, e.g., 45/60/90/120 FPS. A PDU-Set QoS parameters (e.g., provided via control plane to user plane of the wireless device and/or the base station) corresponding to a PDU set may comprise at least one of the following a PDU-Set Delay Budget (PSDB); a PDU-Set Error Rate (PSER); and/or a PDU Set Integrated Indication (PSII). The PDU-Set Delay Budget (PSDB) of a PDU set may indicate/define/measure delay of the PDU set (or PDU-Set) between a wireless device and an N6 termination point at the UPF. The PSDB of a PDU set may indicate a time between reception of a first/initial/starting/earliest PDU (e.g., a Start PDU) of the PDU set and a successful delivery of a last/final/ending/latest PDU (e.g., an End PDU) of the PDU set. For a certain 5QI the value of the PSDB may be the same in UL and DL. In the case of 3GPP access, the PSDB may be used to support the configuration of scheduling and link layer functions (e.g., the setting of scheduling priority weights and HARQ target operating points). The PDU-Set may be considered/determined as lost (e.g., if the corresponding QoS Flow is not exceeding the GFBR and/or for GBR QOS Flows using the Delay-critical resource type) if a PDU-Set is delayed more than the PSDB. The PSDB of a PDU set may depend on a PDB of a PDU of the PDU set (e.g., smallest/largest PDB or the like).

A PDU-Set Error Rate (PSER) of a PDU set may define/indicate an upper bound for an error rate of the PDU-Set. An upper layer (e.g., the RLC/PDCP/SDAP layer) of a sender (e.g., the base station and/or the wireless device) may process a PDU-Set to determine whether all of the PDUs in the PDU-Set are successfully delivered by the corresponding receiver to the upper layers (e.g., the PDCP/RLC/SDAP layer).

The PDU Set Integrated Indication (PSII) of a PDU set may define/indicate/measure whether all PDUs of the PDU set are needed for the usage of PDU set by application layer. All PDUs in a PDU set may be needed by the application layer to use the corresponding unit of information. The application layer may still recover parts all or of the information unit, if some PDUs of the PDU set are missing. A PDU sets may comprise one or more data packets (e.g., IP packets) or may correspond to a higher layer SDU/PDU (e.g., the PDCP/RLC/SDAP/MAC layer).

There may be different methods/procedures/alternatives to map PDU sets onto QoS flows (e.g., in the NAS) and/or to map the QoS flows onto DRBs (e.g., in the Access Stratum (AS)), one-to-one mapping between types of PDU sets and QoS flows in the NAS and one-to-one mapping between QoS flows and DRBs in the AS; one-to-one mapping between types of PDU sets and QoS flows in the NAS and multiplexing of QoS flows in one DRB in the AS; a multiplexing of PDU sets in one QoS flow in the NAS and one-to-one mapping between QoS flows and DRBs in the AS; and/or N multiplexing of PDU sets in one QoS flow in the NAS and demultiplexing of PDU sets from one QoS flow on multiple DRBs in the AS. The wireless device and/or the base station may map one or more PDU sets in DRBs to logical channels, 1-to-1 mapping wherein the PDCP layer maps the one or more PDU sets to one logical channel or 1-to-many wherein the PDCP layer maps the one or more PDU sets to one or more logical channels.

A wireless device (e.g., an XR device) may report/send/transmit delay information (or delay budget) of UL (pending) data (e.g., XR data/traffic comprising one or more PDUs or one or more PDU sets) to the base station. Delay information may comprise delay budget/remaining time (e.g., PDB) of the one or more PDUs. Delay information may, for example, comprise a PDU-Set Delay Budget (PSDB) of the one or more PDU sets. Reporting/sending/transmitting the delay information of UL data may allow the base station to properly/timely schedule the wireless device to transmit the UL data, before a violation of delay budget of the UL data (e.g., violating PDB of one or more PDUs or PSDB of the one or more PDU sets). The base station may schedule transmission of a first PDU of the one or more PDUs with a smaller remaining time (e.g., and/or a smaller/stricter delay budget, e.g., 10 ms) prior to a second PDU of the one or more PDUs with a larger remaining time (e.g., and/or a larger/looser delay budget, e.g., 30 ms).

A base station may configure the wireless device with one or more new BSR tables (different than Release 15-17 BSR tables in 3GPP TR 38.321, e.g., Table 6.2.1-2 and Table 6.2.1-2b) and/or a predefined (compression) BSR formula. The one or more new BSR tables (or the predefined BSR formula) may allow the wireless device to calculate/report data volume (BSR) with a more precision (e.g., a more refined data volume information) compared to the legacy BSR tables in 3GPP TR 38.321 (e.g., Table 6.2.1-2 and Table 6.2.1-2b). The wireless device may, based on the new BSR tables or the predefined BSR formula, derive/produce/calculate the enhanced BSR report (e.g., enhanced Short/Long BSR and/or enhanced Truncated BSR and/or enhanced Short/Long Truncated BSR, or the like) using UL pending data of certain logical channel(s) (e.g., one or more logical channels corresponding to XR streams/flows and/or the one or more PDU sets or the one or more PDUs). The enhanced BSR report may comprise the data volume information of a first set of logical channels (e.g., based on the legacy BSR tables and/or the new BSR tables and/or the predefined BSR formula) and a delay budget/information (or remaining time) of a second (or the first) set of logical channels. Using the enhanced BSR report the base station may more efficiently/timely allocate UL resources (e.g., time and frequency) to the wireless device for transmission of the UL data.

A base station may, without timely informing the base station about the delay information (e.g., remaining time) of the UL pending data, schedule the wireless device to send (e.g., transmit) the first PDU after the violation of the delay budget of the first PDU, which may reduce quality of service (e.g., increase the PSER of a PDU set). Improvements described herein for at least some procedures (e.g., an LCP procedure at the wireless device) may allow the wireless device to timely inform the base station about the delay budget of the UL data. The base station may, without timely transmitting/reporting the enhanced BSR, unnecessarily allocate UL resources to the wireless device to send (e.g., transmit) the UL data. At least some wireless communications may result in wasting the UL resources. Improvements described herein for at least some procedures (e.g., the LCP procedure at the wireless device) may provide various such advantages such as: decrease the PSER of the PDU set (e.g., improve quality of service), reduce possibility of PSDB violation, improve user experience (e.g., improvement in video/screen freezing), and/or improve resource efficiency for transmitting the UL data. Enhancements in the LCP procedure to allow the wireless device to properly/timely transmit/report the enhance BSR MAC CE to the base station to improve UL spectral efficiency or data transmission delay may be achieved by examples described herein.

A wireless device may, via at least one uplink shared channel (UL-SCH) resource, send (e.g., transmit) a MAC PDU comprising at least one of the first MAC CE and a second MAC CE, for sending (e.g., transmitting) delay information, corresponding to one or more logical channels, via a first medium access control (MAC) control element (CE). The wireless device may determine prioritization of a logical channel of the first MAC CE and a logical channel of the second MAC CE. The wireless device may trigger a delay reporting procedure for sending (e.g., transmitting) the delay information. The wireless device may determine a priority of a logical channel of the first MAC CE being higher than or equal to a priority of a logical channel of a second MAC CE, wherein the second MAC CE is different than the first MAC CE. The wireless device may first multiplex the first MAC CE in the MAC PDU based on the at least one UL-SCH accommodating the first MAC CE. The wireless device may multiplex the second MAC CE in the MAC PDU based on the at least one UL-SCH accommodating the first MAC CE, after multiplexing the first MAC CE in the MAC PDU. The wireless device may avoid/skip multiplexing the second MAC CE in the MAC PDU based on the at least one UL-SCH not accommodating the first MAC CE, after multiplexing the first MAC CE in the MAC PDU.

A wireless device may determine a priority of the logical channel of the first MAC CE being greater than or equal to a priority of the logical channel of the second MAC CE and the at least one UL-SCH resource accommodating the first MAC CE. The wireless device may, to send (e.g., transmit) the MAC PDU, multiplex the first MAC CE in the MAC PDU before multiplexing the second MAC CE in the MAC PDU (e.g., the MAC PDU comprises the first MAC CE and the second MAC CE). The wireless device may skip/avoid multiplexing the second MAC CE in the MAC PDU based on the at least one UL-SCH resource not accommodating the second MAC CE (e.g., the MAC PDU comprises the first MAC CE and does not comprise the second MAC CE).

A wireless device may determine a priority of the logical channel of the first MAC CE being lower than or equal to a priority of the logical channel of the second MAC CE; and the at least one UL-SCH resource accommodating the second MAC CE. The wireless device may multiplex the second MAC CE in the MAC PDU before multiplexing the first MAC CE in the MAC PDU (e.g., the MAC PDU comprises the first MAC CE and the second MAC CE). The wireless device may avoid/skip multiplexing the first MAC CE in the MAC PDU based on the at least one UL-SCH resource not accommodating the first MAC CE (e.g., the MAC PDU comprises the second MAC CE and does not comprise the first MAC CE).

A wireless device may determine the first MAC CE having a higher priority that a first pending data (e.g., except data from UL-CCCH) of the one or more logical channels. The MAC PDU may not comprise the first pending data of the one or more logical channels.

A second MAC CE may be at least one of: a MAC CE for LBT failure; a MAC CE for timing advance report (TAR); a MAC CE for buffer status report (BSR); a MAC CE for power headroom report (PHR); a MAC CE for positioning measurement gap activation/deactivation request; a MAC CE for a quantity (e.g., number) of desired guard symbols; and/or a MAC CE for case-6 timing request. The BSR may not comprise padding BSR. The BSR may be at least one of: an extended BSR; a Pre-emptive BSR; an extended Pre-emptive BSR; a side-link (SL)-BSR. The SL-BSR may be prioritized for logical channel prioritization (LCP) procedure. The PHR may be at least one of: a single entry PHR; an enhanced single entry PHR; a multiple entry PHR; and/or an enhanced multiple entry PHR.

A wireless device may trigger an enhanced buffer status report (BSR) based on (e.g., in response to) arrival of a first uplink data, corresponding to one or more first logical channels, for sending (e.g., transmitting) the enhanced BSR via a first medium access control (MAC) control element (CE). The wireless device may, via at least one UL-SCH resource, send (e.g., transmit) a MAC PDU comprising at least one of the first MAC CE and a second MAC CE, wherein the sending (e.g., transmitting) is based on prioritization of: a logical channel of the first MAC CE; and a logical channel of the second MAC CE. The wireless device may determine the first MAC CE having a higher priority that the first uplink data of the one or more logical channels. The MAC PDU may not comprise the first uplink data of the one or more logical channels.

A wireless device may determine a priority of the logical channel of the first MAC CE being greater than or equal to a priority of the logical channel of the second MAC CE and the at least one UL-SCH resource accommodating the first MAC CE. The wireless device may multiplex the first MAC CE in the MAC PDU before multiplexing the second MAC CE in the MAC PDU (e.g., the MAC PDU comprises the first MAC CE and the second MAC CE). The wireless device may avoid/skip multiplexing the second MAC CE in the MAC PDU based on the at least one UL-SCH resource not accommodating the second MAC CE (e.g., the MAC PDU comprises the first MAC CE and does not comprise the second MAC CE).

A wireless device may determine a priority of the logical channel of the first MAC CE being lower than or equal to a priority of the logical channel of the second MAC CE and the at least one UL-SCH resource accommodating the second MAC CE. The wireless device may multiplex the second MAC CE in the MAC PDU before multiplexing the first MAC CE in the MAC PDU (e.g., the MAC PDU comprises the first MAC CE and the second MAC CE). The wireless device may avoid/skip multiplexing the first MAC CE in the MAC PDU based on the at least one UL-SCH resource not accommodating the first MAC CE (e.g., the MAC PDU may comprise the second MAC CE and may not comprise the first MAC CE).

A second MAC CE may be for a second BSR corresponding to a second uplink data of one or more second logical channels. The wireless device may determine at least one of the following being satisfied: that data volume size of the first uplink data being larger than data volume size of the second uplink data; and/or data volume size of the first uplink data being larger than a threshold; and/or data volume size of the second uplink data being smaller than the threshold; and/or a (quantization) granularity of buffer size levels of the enhanced BSR being smaller than a (quantization) granularity of buffer size levels of the second BSR; and/or buffer size levels of the second BSR are derived based on legacy BSR tables (e.g., Table 6.2.1-2 of 3GPP TR 38.321 or Table 6.2.1-2b of 3GPP TR 38.321); and/or buffer size levels of the enhanced BSR not being derived based on the legacy BSR tables (e.g., Table 6.2.1-2 of 3GPP TR 38.321 or Table 6.2.1-2b of 3GPP TR 38.321); and/or the enhanced BSR comprising the delay information of the first uplink data.

A wireless device may trigger a first buffer status report (BSR) based on (e.g., in response to) arrival of a first uplink data corresponding to one or more first logical channels. The wireless device may, based on (e.g., in response to) at least one BSR prioritization rule being satisfied, prioritize the first BSR for a logical channel prioritization (LCP) procedure. The wireless device may, based on (e.g., in response to) the first BSR being prioritized for the LCP procedure and via at least one UL-SCH resource, send (e.g., transmit) a MAC PDU comprising at least one of a first MAC CE for the first BSR and a second MAC CE, wherein the sending (e.g., transmitting) is based on prioritization of: a logical channel of the first MAC CE; and a logical channel of the second MAC CE. The at least one BSR prioritizing rule may be satisfied based on at least one of: data size volume of the first uplink data of the first BSR being based on a first BSR table, wherein the first BSR table is different than the legacy BSR tables (e.g., Table 6.2.1-2 of 3GPP TR 38.321 or Table 6.2.1-2b of 3GPP TR 38.321); the first BSR comprises delay information of the one or more first logical channels; data size volume of the first uplink data being larger than a threshold; the first uplink data comprising an End PDU of a PDU set; a delay budget/remaining time of a PDU of the PDU set being smaller than a threshold; and/or the at least one UL-SCH resources not accommodating the first BSR corresponding to the one or more logical channels, wherein the one or more logical channels is prioritized.

A wireless device may determine whether the at least one BSR prioritizing rule is satisfied or not based on a PDU set information of at least one PDU set corresponding to the first uplink data. The wireless device may determine whether the at least one BSR prioritizing rule is satisfied or not based on a PDU set related assistance information of at least one PDU set. The PDU set related assistance information may comprise a PDU Set Integrated Indication (PSII) of a PDU set of the at least one PDU set. The at least one BSR prioritizing rule may be satisfied in response to the PSII of the PDU set indicating all PDUs of the PDU set are needed for the usage of the PDU set by application layer. The PDU set related assistance information may comprise a PDU-Set Delay Budget (PSDB) of a PDU set of the at least one PDU set. The at least one BSR prioritizing rule may be satisfied in response to the PSDB of the PDU set being smaller than a threshold.

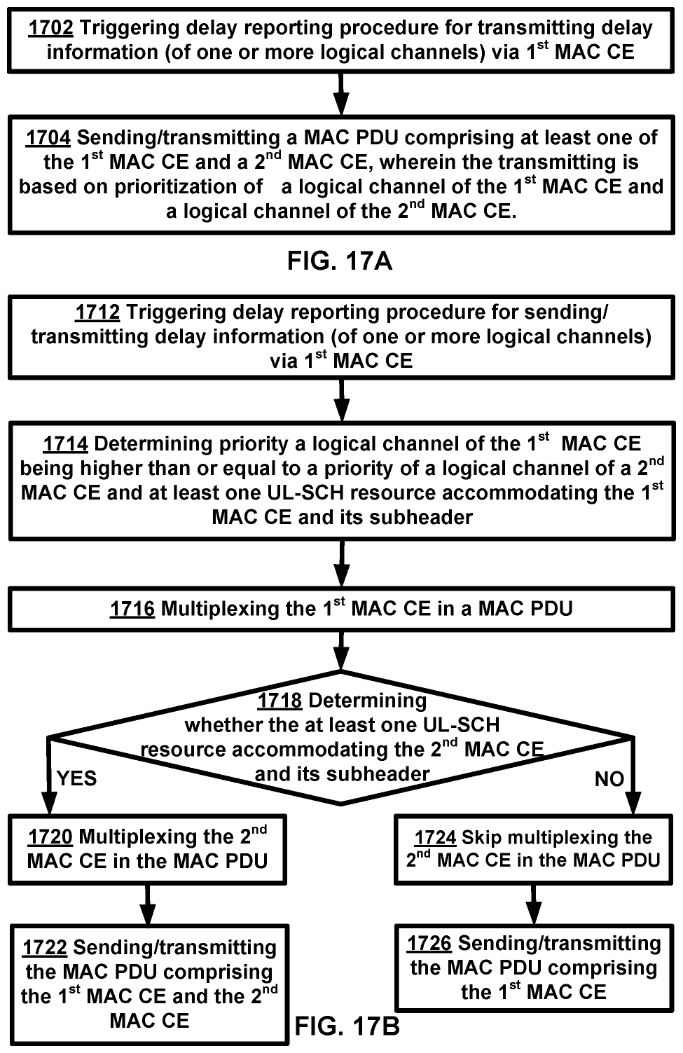

FIG. 17A shows a flowchart of a method/procedure for sending (e.g., transmitting) delay information in wireless communications systems per an aspect of the present disclosure. FIG. 17A may show example embodiments for multiplexing and assembly of the MAC PDU comprising the MAC CE for delay information. FIG. 17A may show example embodiments for determining whether to generate the MAC CE for delay information or not for performing a new UL transmission. The wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state).

The wireless device as shown in step 1702 of FIG. 17A may trigger a delay reporting procedure for sending (e.g., transmitting) the delay information corresponding to one or more logical channels. The wireless device may send (e.g., transmit) the delay information via a first MAC CE. The first MAC CE may be a MAC CE for/corresponding to the delay information (e.g., the MAC CE for delay information). The wireless device may send (e.g., transmit) a MAC PDU in step 1704 comprising at least one of the first MAC CE and a second MAC CE. The wireless device may determine prioritization of a logical channel of the first MAC CE and a logical channel of the second MAC CE, for send (e.g., transmitting) the delay information via at least one uplink shared channel (UL-SCH) resource. The transmission of the MAC PDU may correspond to a new UL transmission.

Example embodiments may allow the wireless device to properly generate/send/transmit the MAC CE for delay information to report/sent delay information of the one or more logical channels to the base station. Example embodiments may improve the LCP procedure in order to determine priority/order of the first MAC CE (e.g., the MAC CE for delay information).

FIG. 17B shows a flowchart of a method/procedure for sending (e.g., transmitting) delay information in wireless communications systems per an aspect of the present disclosure. FIG. 17B may show example embodiments for multiplexing and assembly of the MAC PDU comprising the MAC CE for delay information. FIG. 17B may show example embodiments for determining whether to generate the MAC CE for delay information or not, e.g., for performing a new UL transmission. The wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state). The wireless device in step 1712 may trigger the delay reporting procedure for sending (e.g., transmitting) the delay information corresponding to the one or more logical channels.

A wireless device, as shown in step 1714 of FIG. 17B, may determine a priority of a logical channel of the first MAC CE being higher than or equal to a priority of a logical channel of the second MAC CE. The wireless device may determine the priority of the first MAC CE not being lower/smaller than the priority of the second MAC CE. The second MAC CE may be different than the first MAC CE.

A wireless device in step 1716 may first multiplex the first MAC CE in the MAC PDU based on the at least one UL-SCH accommodating the first MAC CE. After multiplexing the first MAC CE in the MAC PDU, the wireless device may multiplex the second MAC CE in the MAC PDU in step 1720 based on the determination (step 1718) whether at least one UL-SCH resource accommodates the second MAC CE and its subheader. Example embodiments may allow the wireless device to properly generate/send/transmit (step 1722) the MAC CE for delay information based on priority/order of the first MAC CE and/or whether the at least one UL-SCH resource accommodating the second MAC CE or not. For example, the wireless device may determine the at least one UL-SCH accommodating the second MAC CE (plus its subheader) based on (available) quantity (e.g., number) of bits in/of the at least one UL-SCH resource being larger than (decoded/modulated information) bits of the first MAC CE (plus its subheader). The wireless device may in step 1724 avoid/skip multiplexing the second MAC CE in the MAC PDU based on the determination (step 1718) whether at least one UL-SCH does not accommodate the second MAC CE and its subheader after multiplexing the first MAC CE in the MAC PDU. The wireless device may send (e.g., transmit) the MAC PDU comprising the first MAC CE (step 1726) if the wireless device avoids/skips multiplexing the second MAC CE in the MAC PDU.

A wireless device may determine a priority of the logical channel of the first MAC CE being greater than or equal to a priority of the logical channel of the second MAC CE and the at least one UL-SCH resource accommodating the first MAC CE. The wireless device may, to send (e.g., transmit) the MAC PDU, multiplex the first MAC CE in the MAC PDU before multiplexing the second MAC CE in the MAC PDU (e.g., the MAC PDU comprises the first MAC CE and the second MAC CE). The wireless device may skip/avoid multiplexing the second MAC CE in the MAC PDU based on the at least one UL-SCH resource not accommodating the second MAC CE (e.g., the MAC PDU comprises the first MAC CE and does not comprise the second MAC CE).

A wireless device may determine a priority of the logical channel of the first MAC CE being lower than or equal to a priority of the logical channel of the second MAC CE; and the at least one UL-SCH resource accommodating the second MAC CE (plus its subheader). The wireless device may multiplex the second MAC CE in the MAC PDU before multiplexing the first MAC CE in the MAC PDU (e.g., the MAC PDU comprises the first MAC CE and the second MAC CE). The wireless device may send (e.g., transmit) the MAC PDU comprising the first MAC CE and the second MAC CE based on the at least one UL-SCH resource accommodating the first MAC CE and the second MAC CE. The wireless device may avoid/skip multiplexing the first MAC CE in the MAC PDU based on the at least one UL-SCH resource not accommodating the first MAC CE (e.g., the MAC PDU comprises the second MAC CE and does not comprise the first MAC CE).

A second MAC CE may be at least one of: a MAC CE for timing advance report (TAR); a MAC CE for buffer status report (BSR); a MAC CE for power headroom report (PHR); a MAC CE for positioning measurement gap activation/deactivation request; a MAC CE for a quantity (e.g., number) of desired guard symbols; and/or a MAC CE for case-6 timing request. The BSR may not comprise padding BSR. The BSR may be at least one of: an extended BSR; a Pre-emptive BSR; an extended Pre-emptive BSR; and/or a side-link (SL)-BSR. The SL-BSR may be prioritized for logical channel prioritization (LCP) procedure. The PHR may be at least one of: a single entry PHR; an enhanced single entry PHR; a multiple entry PHR; and/or an enhanced multiple entry PHR.

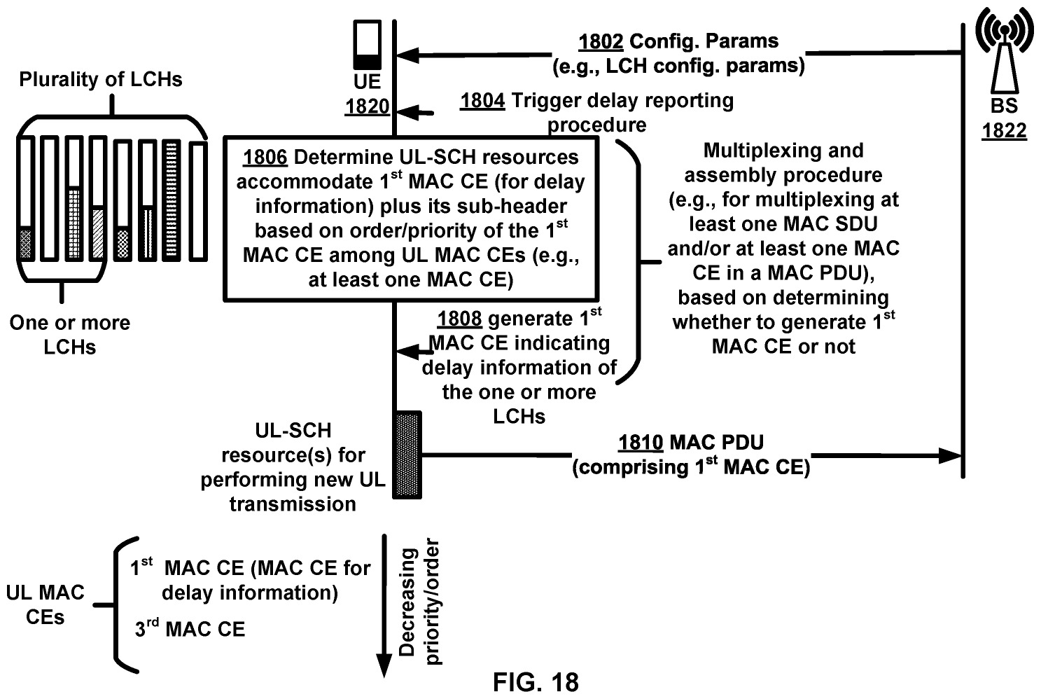

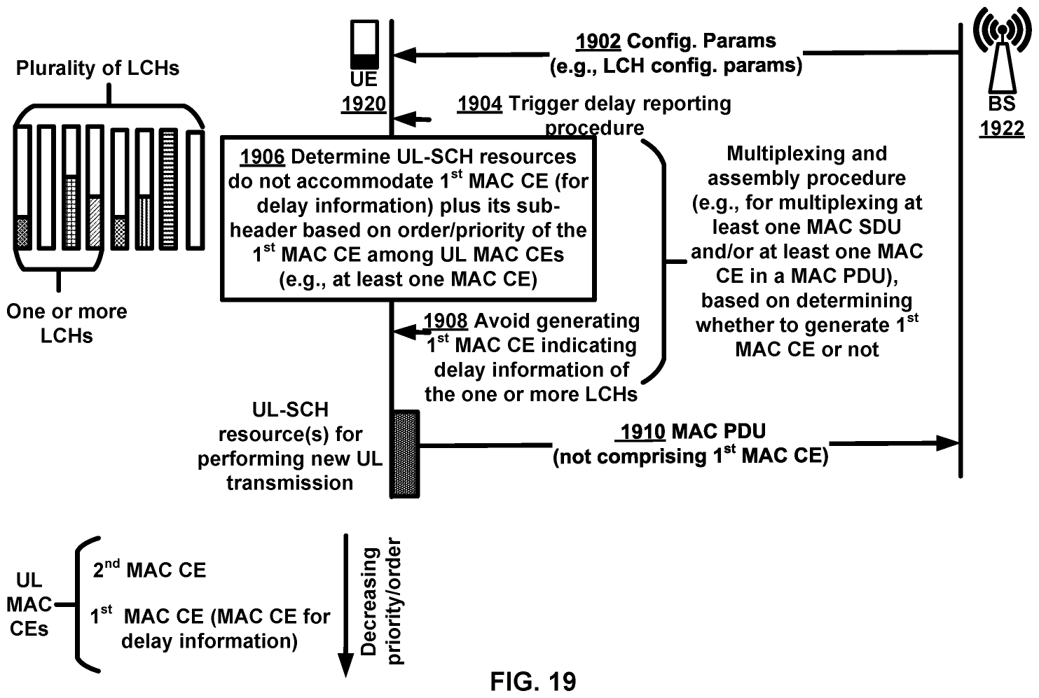

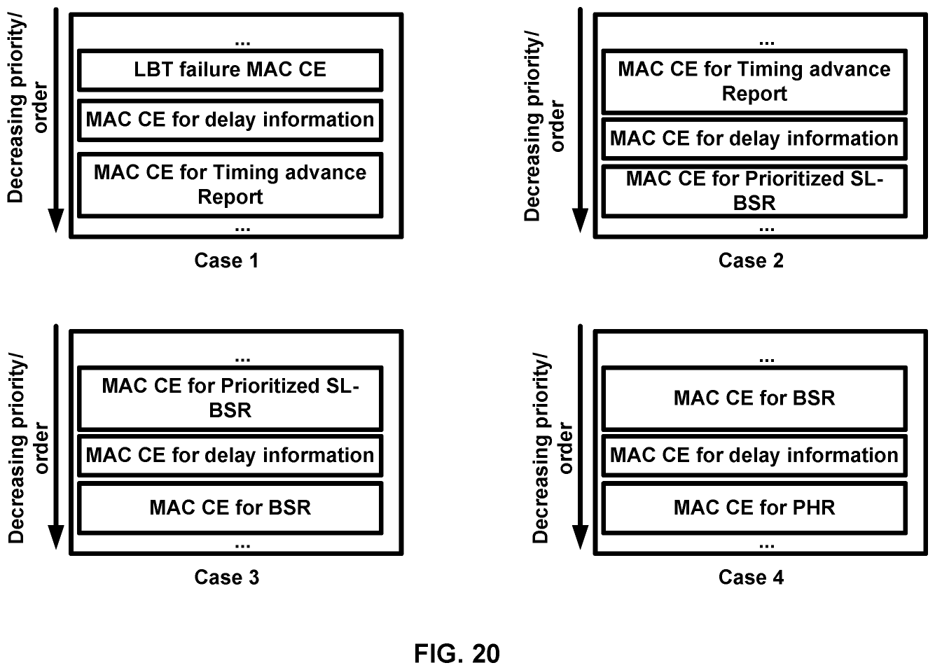

FIG. 18 shows an example embodiment of a logical channel prioritization (LCP) procedure in wireless communications systems per an aspect of the present disclosure. FIG. 19 shows an example embodiment of a logical channel prioritization (LCP) procedure in wireless communications systems per an aspect of the present disclosure. FIG. 20 shows an example embodiment of priority (e.g., a logical channel priority) of a MAC CE for delay information per an aspect of the present disclosure. FIG. 20 may demonstrate several examples of priority/order of the MAC CE for delay information compared to UL MAC CEs (e.g., an LBT failure MAC CE, a BSR MAC CE, or the like).

FIGS. 18-20 may show example implementations of a method/procedure for sending (e.g., transmitting) delay information of one or more PDUs at the wireless device (e.g., an XR device) and/or receiving the delay information at the base station. FIGS. 18-20 may show example embodiments for multiplexing and assembly of the MAC PDU comprising the MAC CE for delay information. FIGS. 18-20 may show example embodiments for determining whether to generate the MAC CE for delay information or not, e.g., for performing a new UL transmission. The wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state).

A wireless device (e.g., UE 1820, UE 1920), as shown in step 1802 of FIG. 18 and step 1902 of FIG. 19, may, from a base station (e.g., BS 1822, BS 1922), receive the one or more configuration parameters (e.g., the one or more RRC configuration parameters). The one or more configuration parameters may, for example, comprise one or more serving cell (e.g., the one or more Serving Cells or the one or more cells) configuration parameters (e.g., ServingCellConfigCommon, ServingCellConfigCommonSIB, and/or ServingCellConfig) for configuring one or more cells (e.g., one or more serving cells, e.g., the one or more Serving Cells). The one or more cells may comprise a master (or primary) cell group (MSG) and/or a secondary cell group (SCG). A cell of the one or more cells may be a primary secondary cell (PSCell), or a primary cell (PCell), or a secondary cell (SCell), or a special cell (SpCell). A cell of the one or more cells may belong to a first cell group corresponding to a primary TAG (pTAG) or a second cell group corresponding to a secondary TAG (sTAG). The one or more configuration parameters may configure the wireless device for multi-cell communication and/or carrier aggregation (CA).

One or more configuration parameters (e.g., the one or more RRC configuration parameters) may comprise one or more BWP configuration parameters (e.g., BWP-DownlinkDedicated IE), e.g., of a downlink (DL) BWP (e.g., initial downlink BWP) of a serving cell and/or of an UL BWP of the serving cell. The one or more WBP configuration parameters (e.g., of the downlink BWP) may comprise: one or more PDCCH configuration parameters (e.g., for PDCCH of the downlink BWP, e.g., in pdcch-Config IE and/or PDCCH-ServingCellConfig IE applicable for all downlink BWPs of the serving cell). The one or more configuration parameters may comprise MAC parameters (e.g., MAC-CellGroupConfig) of a cell group (e.g., the primary cell group and/or the secondary cell group). The one or more configuration parameters may comprise one or more logical channel (LCH) configuration parameters (e.g., IE LogicalChannelConfig) to configure a plurality of logical channels. The one or more configuration parameters may comprise one or more BSR configuration parameters (e.g., BSR-Config).

A plurality of logical channels, as shown in FIG. 18 and FIG. 19, may comprise the one or more logical channels. The one or more configuration parameters may configure/enable the wireless device to send/report/transmit the delay information of (pending) UL data, to the base station. Pending UL data may belong to the one or more logical channels. All logical channels of the one or more logical channels may have data for UL transmissions. At least one logical channel of the one or more logical channels may have data for UL transmissions. The wireless device may trigger a BSR due to the UL data of the one or more logical channels (e.g., the at least one logical channel of the one or more logical).

A wireless device may send (e.g., transmit) the delay information based on a first MAC CE (e.g., the MAC CE for delay information). The first MAC CE may be for sending (e.g., transmitting) the remaining time of the one or more logical channels/one or more PDUs/the at least one PDU set. A first logical channel of the plurality of logical channels may correspond to the first MAC CE. The first MAC CE may have a first LCID/eLCID. An index corresponding to the first LCID may be between 37 to 42 or be 47. The index corresponding to the first LCID may be different than at least one of the following: 45, 45, 59, 60, 61, 62, and/or 63. An index/codepoint corresponding to the first eLCID may be between 64 to 292. The index/codepoint corresponding to the first eLCID may be different than at least one of the following: 309, 310, 311, 312, 313 and/or 319.

A first MAC CE may comprise one or more fields. The one or more fields may comprise one or more IDs/identifiers of the one or more logical channels and/or an ID/identifier of the first LCG. The one or more fields may comprise the one or more first values and/or the one or more second values. The one or more fields may comprise the first metric/measure/indication and/or the second metric/measure/indication. The one or more fields may comprise delay budgets/remaining times of at least one logical channel of the one or more logical channels. A delay budget/remaining time of the at least one logical channel of the one or more logical channels may be smaller than a threshold (e.g., configured by the one or more configuration parameters). The at least one logical channel of the one or more logical channels may have pending data for transmission.

A wireless device, as shown in FIG. 18 and FIG. 19, may perform/transmit a new UL transmission via the at least one UL-SCH (available) resource to the base station. For example, the at least one UL-SCH resource may not be for a retransmission of an UL transmission. The at least one UL-SCH resource may correspond to a Type1/Type 2 configured grant PUSCH resource and/or a dynamic grant PUSCH resource (e.g., scheduled by a scheduling DCI). For example, the wireless device (e.g., UE 1820, UE 1920) may receive a DCI indicating the at least one UL-SCH resource (e.g., UL grant) after/in response to/once a delay reporting (procedure), e.g., for transmission of the delay information, being triggered (step 1804, 1904). In some other cases, the at least one UL-SCH resource may be part of a random-access procedure (e.g., Msg3/MsgA PUSCH resource).

A wireless device may perform a multiplexing and assembly procedure (MAP) to perform the new UL transmission. The wireless device may, by performing the MAP, multiplex/build at least one MAC SDU and at least one MAC CE (of the UL MAC CEs) in the MAC PDU. The wireless device may determine whether to generate/produce/build the first MAC CE or not. The at last one MAC CE may comprise the first MAC CE based on the first MAC CE being generated/produced. The at last one MAC CE may not comprise the first MAC CE based on the first MAC CE not being generated/produced. The wireless device (e.g., UE 1820, UE 1920), as shown in step 1806 of FIG. 18 and step 1906 FIG. 19, may, to determine whether to generate/produce/build the first MAC CE or not, determine whether or not the at least one UL-SCH resource for the new UL transmission accommodating the first MAC CE (plus its sub-header), e.g., as a result of/based on a logical channel prioritization (LCP).

As shown in step 1808 of FIG. 18, a wireless device (e.g., UE 1820) may instruct the MAP to generate/produce/build the first MAC CE, based on (e.g., in response to) the at least one UL-SCH resource for the new UL transmission accommodating the first MAC CE (plus its sub-header) of the at least one MAC CE (e.g., as a result of/based on the LCP procedure). The wireless device may multiplex/build the first MAC CE and the MAC SDU in the MAC PDU, e.g., the MAC PDU may comprise the first MAC CE. The wireless device (e.g., UE 1820) may send (e.g., transmit) to the base station (e.g., BS 1822) the MAC PDU comprising the first MAC CE via the at least one UL-SCH resource (step 1810). The wireless device may transmit the first MAC CE via the at least one UL-SCH resource.

As shown in step 1908 of FIG. 19, a wireless device (e.g., UE 1920) may not instruct (or skip/avoid instructing) the MAP to generate/produce/build the first MAC CE, based on (e.g., in response to) the at least one UL-SCH resource for the new UL transmission not accommodating the first MAC CE (plus its sub-header) of the at least one MAC CE (e.g., as a result of/based on the LCP procedure). The wireless device may not multiplex/build (or skip/avoid multiplexing) the first MAC CE and the MAC SDU in the MAC PDU (e.g., the MAC PDU may not comprise the first MAC CE). The wireless device (e.g. UE 1920) may send (e.g., transmit) to the base station (e.g., BS 1922) the MAC PDU not comprising the first MAC CE via the at least one UL-SCH resource (step 1910). The wireless device may refrain from sending (e.g., transmitting) the first MAC CE via the at least one UL-SCH resource.

A wireless device for performing the LCP, for transmission/generation of the first MAC CE (e.g., the MAC CE for delay information), may determine an order (or a priority) of the first MAC CE among UL MAC CEs (e.g., the at least one MAC CE) and/or the plurality of logical channels. The wireless device may determine the first MAC CE being prioritized among/from the at least one MAC CE. A logical channel of the first MAC CE has a higher priority than other MAC CEs of the at least one MAC CE. The wireless device may generate the first MAC CE before/prior to generating the other MAC CEs of the at least one MAC CE (e.g., the wireless device may generate the other MAC CEs of the at least one MAC CE after generating the first MAC CE). The first MAC CE may be listed above the other MAC CEs of the at least one MAC CE. FIG. 20 shows some examples of possible order/priority of the first MAC CE compared to (among) the UL MAC CEs.

As shown in FIG. 18, a wireless device (e.g., UE 1820), as a result of/based on the LCP procedure, may determine the at least one UL-SCH resource for the new UL transmission accommodating the first MAC CE (plus its sub-header) of the at least one MAC CE and not accommodating the other MAC CEs of the at least one MAC CE (e.g., a third MAC CE of the UL MAC CEs). The wireless device may instruct the MAP to generate the first MAC CE (e.g., and not generate the other MAC CEs of the at least one MAC CE). The wireless device may multiplex the first MAC CE and the MAC SDU in the MAC PDU (e.g., the MAC PDU may not comprise the other MAC CEs of the at least one MAC CE and may comprise the first MAC CE). As shown in FIG. 18, the wireless device may send (e.g., transmit) the MAC PDU via the at least one UL-SCH resource. The MAC PDU may comprise the at least one MAC SDU. The MAC PDU may not comprise any MAC SDU, (e.g., the MAC PDU may comprise the first MAC CE).

As shown in FIG. 19, a wireless device (e.g., UE 1920), as a result of/based on the LCP procedure, may determine the at least one UL-SCH resource for the new UL transmission not accommodating the first MAC CE (plus its sub-header) of the at least one MAC CE and accommodating other MAC CEs of the at least one MAC CE (e.g., a second MAC CE of the UL MAC CEs). The wireless device may avoid/skip instructing the MAP to generate the first MAC CE. The wireless device may avoid/skip multiplexing the first MAC CE and the MAC SDU in the MAC PDU (e.g., the MAC PDU may comprise the other MAC CEs of the at least one MAC CE and may not comprise the first MAC CE). The wireless device, as shown in FIG. 19, may send (e.g., transmit) the MAC PDU via the at least one UL-SCH resource.

A wireless device (e.g., UE 1920), as shown in FIG. 19, may determine/identify the second MAC CE of the UL MAC CEs that has a higher/greater/larger/bigger priority/order than the first MAC CE (e.g., a priority of a logical channel of the second MAC CE is higher than or equal to a priority of a logical channel of the first MAC CE). The at least one MAC CE may comprise the second MAC CE. The at least one MAC CE may not comprise the second MAC CE. The wireless device, as a result of/based on the LCP procedure, may determine the at least one UL-SCH resource for the new UL transmission accommodating the second MAC CE (plus its sub-header) of the at least one MAC CE and not accommodating the first MAC CE (plus its sub-header) of the at least one MAC CE. The wireless device may instruct the MAP to generate the second MAC CE. The wireless device may multiplex the second MAC CE and the MAC SDU in the MAC PDU (e.g., the MAC PDU may not comprise the first MAC CE and may comprise the second MAC CE). The wireless device may send (e.g., transmit) the MAC PDU via the at least one UL-SCH resource.

A wireless device may determine the at least one UL-SCH resource accommodating the first MAC CE plus its subheader, for example, after multiplexing the second MAC CE in the MAC PDU. The wireless device may instruct the MAP to generate the first MAC CE. The wireless device may multiplex the first MAC CE and the MAC SDU in the MAC PDU (e.g., the MAC PDU may comprise the first MAC CE and may comprise the second MAC CE).

A wireless device (e.g., UE 1820), as shown in FIG. 18, may determine/identify a third MAC CE of the UL MAC CEs that has a lower/smaller priority/order than the first MAC CE (e.g., a priority of a logical channel of the first MAC CE is higher than or equal to a priority of a logical channel of the third MAC CE). The at least one MAC CE may comprise the third MAC CE. The at least one MAC CE may not comprise the third MAC CE. The wireless device, as a result of/based on the LCP procedure, may determine the at least one UL-SCH resource for the new UL transmission accommodating the first MAC CE (plus its sub-header) of the at least one MAC CE and not accommodating the third MAC CE (plus its sub-header) of the at least one MAC CE. The wireless device may instruct the MAP to generate the first MAC CE. The wireless device may multiplex the first MAC CE and the MAC SDU in the MAC PDU (e.g., the MAC PDU may not comprise the third MAC CE and may comprise the first MAC CE). The wireless device may send (e.g., transmit) the MAC PDU via the at least one UL-SCH resource. The at least one MAC CE may not comprise the third MAC CE.

The wireless device may determine the at least one UL-SCH resource accommodating the third MAC CE plus its subheader, for example, after multiplexing the first MAC CE in the MAC PDU. The wireless device may instruct the MAP to generate the third MAC CE. The wireless device may multiplex the third MAC CE and the MAC SDU in the MAC PDU (e.g., the MAC PDU may comprise the first MAC CE and may comprise the third MAC CE).

The second MAC CE, as shown in Case 1 in FIG. 20, may be an LBT failure MAC CE, if an LBT failure indication is received from lower layers (physical layer) of the wireless device to the MAC layer of the wireless device. The wireless device may determine the priority/order of the LBT failure MAC CE being greater/higher (or equal or not lower) than the priority/order of the first MAC CE. The LBT failure MAC CE may have greater/higher priority than the first MAC CE if the LBT failure provides a more crucial information (e.g., availability of wireless medium) to the base station (compared to the first MAC CE). The base station, in the case of the LBT failure, may not be able to schedule the wireless device despite the delay information is indicated to the base station. The wireless device may determine the priority/order of the first MAC CE being greater/higher (or equal or not lower) than the priority/order of the LBT failure MAC CE. The third MAC CE may be a MAC CE for Timing Advance Report if a Timing Advance reporting (TAR) procedure determines that at least one TAR is triggered and not cancelled. The wireless device may determine the priority/order of the MAC CE for Timing Advance Report being lower (or equal or not greater) than the priority of the first MAC CE. The MAC CE for Timing Advance Report may have lower/smaller priority than the first MAC CE as the delay information may provide a more crucial information (for scheduling and/or radio resource management) to the base station (e.g., if a PSII of a PDU set indicates all PDUs of the PDU set are needed for the usage of PDU set by application layer and/or if remaining time of an End PDU is smaller than a threshold, e.g., 10 ms).

The second MAC CE, as shown in Case 2 in FIG. 20, may be the MAC CE for Timing Advance Report, if the TAR procedure determines that at least one TAR is triggered and not cancelled. The wireless device may determine the priority/order of the MAC CE for Timing Advance Report being greater/higher (or equal or not lower) than the priority/order of the first MAC CE. The MAC CE for Timing Advance Report may have higher/greater priority than the first MAC CE if the base station is allowed to measure/estimate round-trip transmission delay (RTT) between the wireless device and the base station and/or improve efficiency of the UL transmission (e.g., lower UL transmission latency). The third MAC CE may be a MAC CE for prioritized SL-BSR (e.g., prioritized according to clause 5.22.1.6 of the 3GPP TS 38.321). The wireless device may determine a Regular and/or a Periodic SL-BSR being triggered. The wireless device may determine the priority/order of the MAC CE for prioritized SL-BSR being lower (or equal or not greater) than the priority/order of the first MAC CE. The MAC CE for prioritized SL-BSR may have lower/smaller priority than the first MAC CE if violation of the delay budget of a PDU (e.g., an End PDU) of a PDU set, for XR applications, may result in inapplicability of the PDU set (e.g., if a PSII of the PDU set indicates all PDUs of the PDU set are needed for the usage of PDU set by application layer).

A second MAC CE, as shown in Case 3 in FIG. 20, may be the MAC CE for prioritized SL-BSR, if a Regular and/or a Periodic SL-BSR is triggered. The wireless device may determine the priority/order of the second MAC CE for prioritized SL-BSR being greater/higher (or equal or not lower) than the priority/order of the first MAC CE. The MAC CE for prioritized SL-BSR may have higher priority than the first MAC CE as pending data of side link (SL) being prioritized. The third MAC CE may be a MAC CE for BSR, if a BSR (e.g., a Regular BSR and/or a pre-emptive BSR and/or a SL BSR) is triggered. The MAC CE for BSR may be at least one of the following: a BSR MAC CE; and/or a Short/Long BSR MAC CE; and/or a Truncated BSR MAC CE; and/or a Short/Long Truncated BSR MAC CE; and/or an extended BSR MAC CE; and/or a MAC CE for enhanced BSR; and/or a MAC CE for (Extended) Pre-emptive BSR; and/or a MAC CE for SL-BSR (with exception of the prioritized SL-BSR and SL-BSR included for padding). The BSR may not comprise padding BSR (e.g., MAC CE for BSR included for padding and/or MAC CE for SL-BSR included for padding). The wireless device may determine the priority/order of the MAC CE for BSR being lower (or equal or not greater) than the priority/order of the first MAC CE. The MAC CE for BSR may have lower/smaller priority than the first MAC CE if violation of the delay budget of a PDU of a PDU set, for XR applications, may result in inapplicability of the PDU set (e.g., if a PSII of the PDU set indicates all PDUs of the PDU set are needed for the usage of PDU set by application layer).

A second MAC CE, as shown in Case 4 in FIG. 20, may be the MAC CE for BSR, if the BSR is triggered. The wireless device may determine the priority/order of the MAC CE for BSR being greater/higher (or equal or not lower) than the priority/order of the first MAC CE. The MAC CE for BSR may have higher priority than the first MAC CE if volume of pending data in the buffer of the wireless device (e.g., via the BSR MAC CE) may provide a more crucial information to the base station (e.g., for scheduling). The third MAC CE may be a MAC CE for power headroom (PHR) (e.g., the third MAC CE is the MAC CE for PHR). The wireless device may determine a PHR being triggered. The MAC CE for PHR may be a MAC CE for extended PHR. The MAC CE for PHR may be a MAC CE for single entry PHR and/or a MAC CE for multiple entry PHR. The wireless device may determine the priority/order of the MAC CE for PHR being lower (or equal or not greater) than the priority of the first MAC CE. The MAC CE for PHR may have lower/smaller priority than the first MAC CE if violation of the delay budget of a PDU of a PDU set for XR applications may result in inapplicability of the PDU set (e.g., if a PSII of the PDU set indicates all PDUs of the PDU set are needed for the usage of PDU set by application layer).

A second MAC CE may be the MAC CE for PHR. The wireless device may determine the PHR being triggered. The wireless device may determine the priority/order of the MAC CE for PHR being greater/higher (or equal or not lower) than the priority of the first MAC CE. The MAC CE for PHR may have higher priority than the first MAC CE as power headroom of the wireless device may provide a more crucial information (e.g., transmission power of the wireless device) to the base station (e.g., for scheduling and/or power efficiency/battery life of the wireless device). The third MAC CE may be a MAC CE for Positioning Measurement Gap Activation/Deactivation Request. The wireless device may determine that an upper layer of the wireless device is triggered to send a Positioning Measurement Gap Activation/Deactivation Request. The wireless device may determine the priority/order of the MAC CE for Positioning Measurement Gap Activation/Deactivation Request being lower (or equal or not greater) than the priority/order of the first MAC CE. The MAC CE for Positioning Measurement Gap Activation/Deactivation Request may have lower/smaller priority than the first MAC CE if violation of the delay budget of a PDU of a PDU set for XR applications may result in inapplicability of the PDU set (e.g., if a PSII of the PDU set indicates all PDUs of the PDU set are needed for the usage of PDU set by application layer).

A second MAC CE may be the MAC CE for Positioning Measurement Gap Activation/Deactivation Request. The wireless device may determine that the upper layer of the wireless device is triggered to send the Positioning Measurement Gap Activation/Deactivation Request. The wireless device may determine the priority/order of the MAC CE for Positioning Measurement Gap Activation/Deactivation Request being greater/higher (or equal or not lower) than the priority/order of the first MAC CE. The MAC CE for Positioning Measurement Gap Activation/Deactivation Request may have higher priority than the first MAC CE if activation/deactivation of a measurement gap (e.g., for positioning) may provide resource efficiency and/or positioning efficiency/accuracy. The third MAC CE may be at least one of the following: a MAC CE for the quantity (e.g., number) of Desired Guard Symbols (e.g., an IAB-MT on the child node, e.g., the wireless device, may inform a parent IAB-DU or IAB-donor-DU about the quantity (e.g., number) of guard symbols desired via the Desired Guard Symbols MAC CE); and/or a MAC CE for Case-6 Timing Request; and/or a MAC CE for IAB-MT Recommended Beam Indication; and/or a MAC CE for Desired IAB-MT PSD range; and/or a MAC CE for Desired DL Tx Power Adjustment. The wireless device may determine the priority/order of the third MAC CE being lower (or equal or not greater) than the priority/order of the first MAC CE, if violation of the delay budget of a PDU of a PDU set for XR applications may result in inapplicability of the PDU set (e.g., when a PSII of the PDU set indicates all PDUs of the PDU set are needed for the usage of PDU set by application layer).

A wireless device may determine the priority/order of data from the plurality of logical channels (except UL-CCCH) being lower (or equal or not greater) than the priority/order of the first MAC CE. The wireless device may determine the priority/order of data from the one or more logical channels (e.g., data of XR application) being lower (or equal or not greater) than the priority/order of the first MAC CE. Timely sending (e.g., transmitting) the first MAC CE for XR applications may reduce possibility of violation of the delay budget of a PDU of a PDU set (e.g., if a PSII of the PDU set indicates all PDUs of the PDU set are needed for the usage of PDU set by application layer).

A wireless device may determine the priority/order of data (except UL-CCCH) from the one or more logical channels (e.g., data of XR application or a PDU set) and/or the plurality of logical channels being higher (or equal or not lower) than the priority/order of the first MAC CE. The wireless device may determine the priority/order of data from the plurality of logical channels (except UL-CCCH) being higher (or equal or not lower) than the priority/order of the first MAC CE. The wireless device may determine XR data being available in the one or more logical channels. Timely sending (e.g., transmitting) the data of the XR applications may reduce possibility of violation of the delay budget of a PDU of the PDU set (e.g., if a PSII of the PDU set indicates all PDUs of the PDU set are needed for the usage of PDU set by application layer).

A wireless device may determine the priority/order of the first MAC CE being higher (or equal or not lower) that priority/order of a padding BSR (e.g., a BSR included/comprised for padding). The padding BSR may comprise SL-BSR included/comprised for padding (e.g., padding SL-BSR). The wireless device for XR applications may instead of triggering the padding BSR (e.g., for sending/transmitting MAC CE for BSR included for padding) trigger transmitting the delay information (e.g., via the generating the first MAC CE). Timely sending (e.g., transmitting) the delay information may reduce possibility of violation of the delay budget of a PDU of the PDU set (e.g., if a PSII of the PDU set indicates all PDUs of the PDU set are needed for the usage of PDU set by application layer).

One or more logical channels may belong to at least one logical channel group (LCG), e.g., a first LCG with a first LCG identifier. A first logical channel of the one or more logical channels may have an indication indicating/enabling reporting/sending delay information of corresponding UL pending data of the first logical channel. A second logical channel of the plurality of logical channels (excluding the one or more logical channels) may not have the indication indicating/enabling reporting/sending delay information of corresponding UL pending data of the second logical channel.

A wireless device may determine that UL data may be available/pending at the buffer of the wireless device (e.g., corresponding to the one or more logical channels). The UL (pending) data may comprise one or more PDUs of at least one PDU set. The UL data may comprise one or more PDUs (e.g., of a PDU set or of the at least one PDU set). The at least one PDU set may correspond to (or associated with) the one or more logical channels. The UL (pending) data may correspond to at least one of the following: an XR QoS flow and/or an XR video stream and/or an XR audio data and/or an XR pause/control information.

The one or more configuration parameters may configure the wireless device to report/transmit/send delay information of the one or more logical channels (and/or the one or more PDUs and/or the at least one PDU set). The delay information may indicate to the base station (or inform the base station) about delay budget/remaining time of the pending data in the buffer of the wireless device (e.g., and/or how much data is buffered in the wireless device for the delay budget/remaining information). The UL data may correspond to XR data/traffic (e.g., an XR QoS flow and/or an XR video stream and/or an XR audio data and/or an XR pause/control information).

UL data may correspond to one or more XR QoS flows and/or streams. The UL data may correspond to the one or more logical channels of the plurality of logical channels. The one or more logical channels my correspond to (or be associated with) the one or more XR QOS flows and/or streams. The wireless device may determine the delay information based on/using PDU set information (e.g., of/corresponding to the or more PDUs and/or the at least one PDU set). The wireless device may determine the delay information based on/using a PDU set related assistance information (e.g., of/corresponding to the or more PDUs and/or the at least one PDU set).

Delay information may, for example, comprise delay budgets/remaining times (e.g., PDB) of the one or more PDUs. The delay information may indicate/comprise one or more second values corresponding to delay budgets/remaining times of the one or more PDUs. The wireless device may determine/calculate remaining time/delay information of the one or more PDUs to determine the one or more second values. A value of the one or more second values may indicate/measure/indicate a remaining time to violation/expiry of delay budget of a PDU of the one or more PDUs. The value of the one or more second values may indicate/measure/indicate a remaining time to a PDU of the one or more PDUs being dropped by the wireless device. The PDU may be an End PDU of the one or more PDUs (e.g., of the at least one PDU set). The PDU may be a Start PDU of the one or more PDUs (e.g., of the at least one PDU set). The PDU may be any PDU of the one or more PDUs (e.g., of the at least one PDU set). The PDU may have a first PDU SN/ID/number/identifier. A PDU set of the at least one PDU set may have a first PDU set identifier. The delay information may depend on the importance of a PDU set of the at least one PDU set. The wireless device may determine the value of the one or more second values being smaller than a threshold (e.g., configured by the one or more configured parameters). The wireless device may determine the value of the one or more second values being smaller than a threshold (e.g., configured by the one or more configured parameters).

A wireless device may determine/measure the delay information based on a PDU set related assistance information (e.g., of/corresponding to the or more PDUs and/or the at least one PDU set). The delay information may comprise a second measure/metric/value/indication (e.g., minimum/shortest/smallest and/or a maximum/largest/longest and/or an average) of the one or more second values (e.g., remaining times/delay budgets of the one or more PDUs of the at least one PDU set), if the PDU Set Integrated Indication (PSII) of a PDU set indicates all PDUs of the PDU set are needed for the usage of PDU set by application layer. The wireless device may determine the measure/metric/value/indication being smaller than a threshold. The one or more configuration parameters may configure the threshold.

Delay information may, for example, comprise/indicate one or more first values corresponding to PDU-Set Delay Budget (PSDB) of the at least one PDU set. The wireless device may determine/calculate remaining time/delay information of the at least one PDU set to determine the one or more first values. A value of the one or more first values may indicate/measure/indicate a remaining time to violation/expiry of delay budget (e.g., of a PDU set of the at least one PDU set). The value of the one or more first values may indicate/measure/indicate a remaining time to a PDU set of the at least one PDU sets being dropped/ignored (or becoming irrelevant to the application layer of the wireless device) by the wireless device. The wireless device may determine the value of the one or more first values being smaller than a threshold (e.g., configured by the one or more configured parameters).

Delay information may comprise a first measure/metric/value/indication (e.g., minimum/shortest/smallest and/or a maximum/largest/longest and/or an average) of the one or more first values (e.g., remaining times/delay budgets of the one or more PDUs, e.g., of a PDU set), if the PDU Set Integrated Indication (PSII) of the PDU set indicates all PDUs of the PDU set are needed for the usage of PDU set by application layer. The wireless device may determine the measure/metric/value/indication being smaller than a threshold. The one or more configuration parameters may configure the threshold. the remaining time/delay budget (e.g., PSDB) of the at least one PDU set.

Each value of the one or more first/second values may be represented in milliseconds. Each value of the one or more first/second values may be represented in quantity (e.g., number) of slots/subframes/symbols. The slot/subframe/symbol duration for representing each value of the one or more first/second values may be based on a default (or a predefined) numerology/SCS (e.g., 15 KHz, or 30 KHz, or 60 KHz, or the like). The one or more configuration parameter may indicate the default numerology/SCS.

A wireless device may, to send (e.g., transmit) the delay information, determine a delay reporting (procedure) being triggered. The wireless device may determine the delay reporting (procedure) not being cancelled. The wireless device may attempt to send (e.g., transmit) the delay information, based on (e.g., in response to) the delay reporting (procedure) being triggered (and not being cancelled), (e.g., the triggered delay reporting being pending). The wireless device may cancel the triggered delay reporting (procedure) based on (e.g., in response to) sending (e.g., transmitting) the delay information (e.g., the first MAC CE or the RRC message comprising the delay information). The wireless device may cancel the triggered delay reporting based on (e.g., in response to) sending (e.g., transmitting) the UL data (e.g., of the one or more logical channels) to the base station. The wireless device may trigger the delay reporting (procedure) based on determining a BSR corresponding to the UL data (e.g., of the one or more logical channels) being triggered and not being cancelled. The triggering the delay reporting may be based on (e.g., in response to/after) the triggering BSR corresponding to the UL data. The wireless device may cancel the triggered delay reporting (procedure) based on (e.g., in response to) the BSR corresponding to the UL data being cancelled. The wireless device may cancel the triggered delay reporting based on sending (e.g., transmitting) the first MAC CE. The MAC PDU comprising the first MAC CE may not comprise the UL data of the one or more logical channels.

A wireless device may cancel the triggered delay reporting (procedure) based on (e.g., in response to) dropping the UL data (e.g., of the one or more logical channels). The wireless device may determine a PDU of the one or more PDUs being dropped at the RLC layer and/or PDCP layer and/or the MAC layer (of the wireless device and/or the base station). The wireless device may determine a PDU set of the at least one PDU set being dropped at the RLC layer and/or PDCP layer and/or the MAC layer (of the wireless device and/or the base station). RLC/PDCP layer of the wireless device may send a dropping indication to the MAC layer of the wireless device. The dropping indication may indicate the UL data (e.g., the PDU and/or the PDU set) being dropped at the RLC/PDCP layer of the wireless device. The MAC layer of the wireless device may cancel the triggered delay reporting (procedure) based on (e.g., in response to) the receiving the dropping indication.

A wireless device may send (e.g., transmit) an UL message comprising UE-capability information/parameters/messages to the base station. The UE-capability message may comprise (or indicate to the base station) a capability for determining/calculating/deriving the delay information. The UE-capability message may comprise (or indicate to the base station) a capability for transmitting the first MAC CE. The wireless device may not expect sending (e.g., transmitting) the first MAC CE (or the delay information) to the base station, based on (e.g., in response to) sending (e.g., transmitting) the UE-capability not indicating the capability for determining/calculating/deriving the delay information and/or sending (e.g., transmitting) the delay information.

A wireless device may send (e.g., transmit) the delay information via an RRC message to the base station. The wireless device may send (e.g., transmit) assistance information comprising the delay information to the base station. The one or more configuration parameters may indicate whether the delay information is sent (e.g., transmitted) based on the first MAC CE or the RRC message.

The base station may enable/configure the wireless device (and/or other wireless devices in the serving cell) to report/transmit/send the delay information to the base station, if in the serving cell accommodates/resides a large quantity (e.g., number) of (e.g., 10 or more) wireless devices with XR traffic that are communicating with the base station. The base station may use the delay information of the wireless device (and/or the other wireless devices in the serving cell) to schedule wireless devices (and/or share UL resources among the wireless devices) based on buffer status (e.g., comprising volume of data and/or the delay information of the data) of the wireless device (and/or the other wireless devices in the serving cell). This may improve the UL resource efficiency and increase a quantity (e.g., number) of satisfied wireless devices.

A rest of (e.g., already received) PDUs of the one or more PDUs may become useless/redundant if a PDU of the one or more PDUs not being received (at the base station). By enabling/configuring the wireless device to send (e.g., transmit) the delay information, the UL transmission may become more efficient by reducing a possibility of the rest of PDUs being use/less redundant.

Example described herein may allow a wireless device to properly generate/send/transmit the MAC CE for delay information to report/sent delay information of the UL data to the base station. Examples described herein may provide advantages such as: improve the LCP procedure in order to determine priority/order of the e MAC CE for delay information. A base station, by properly receiving the MAC CE for delay information, may timely allocate UL resources (e.g., via scheduling DCIs) to the wireless device to transmit the UL data before violation of the delay budget of the UL data.

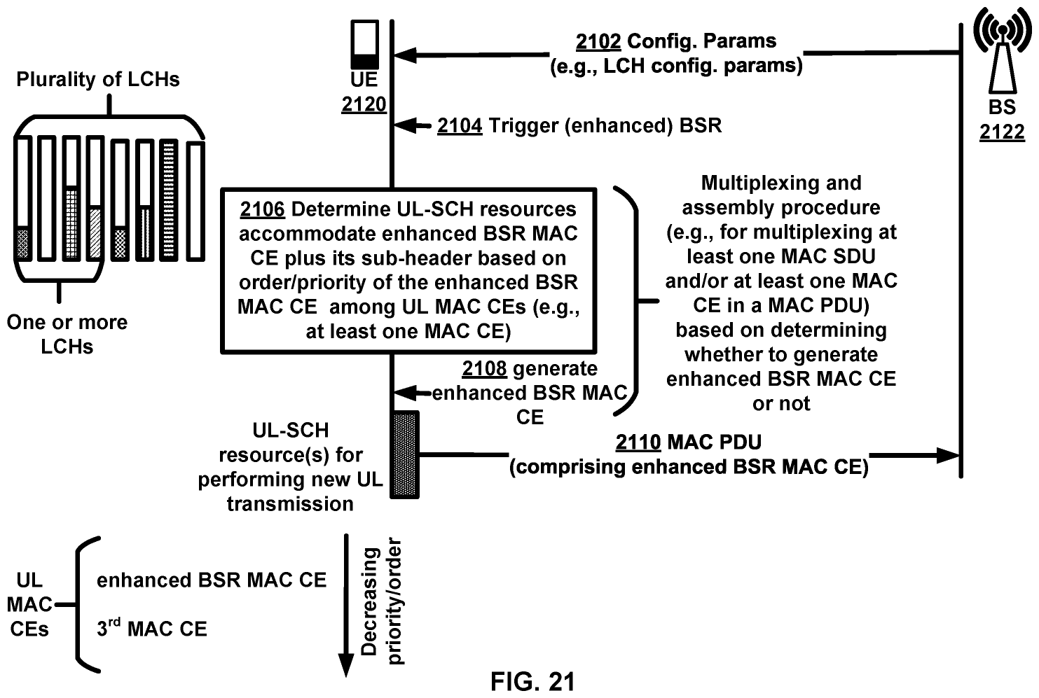

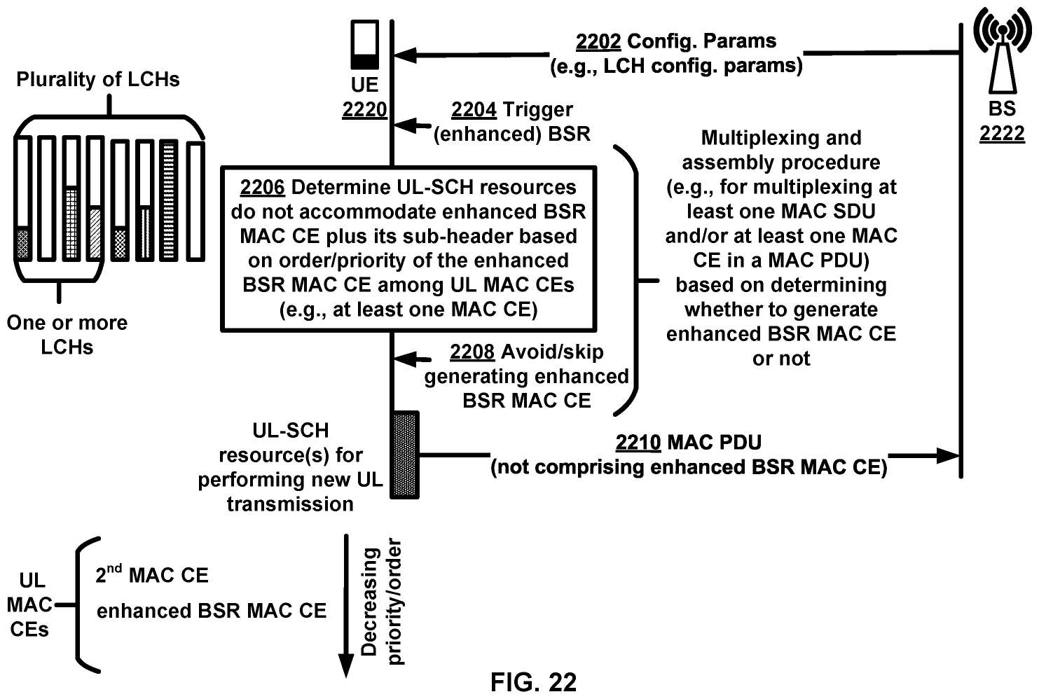

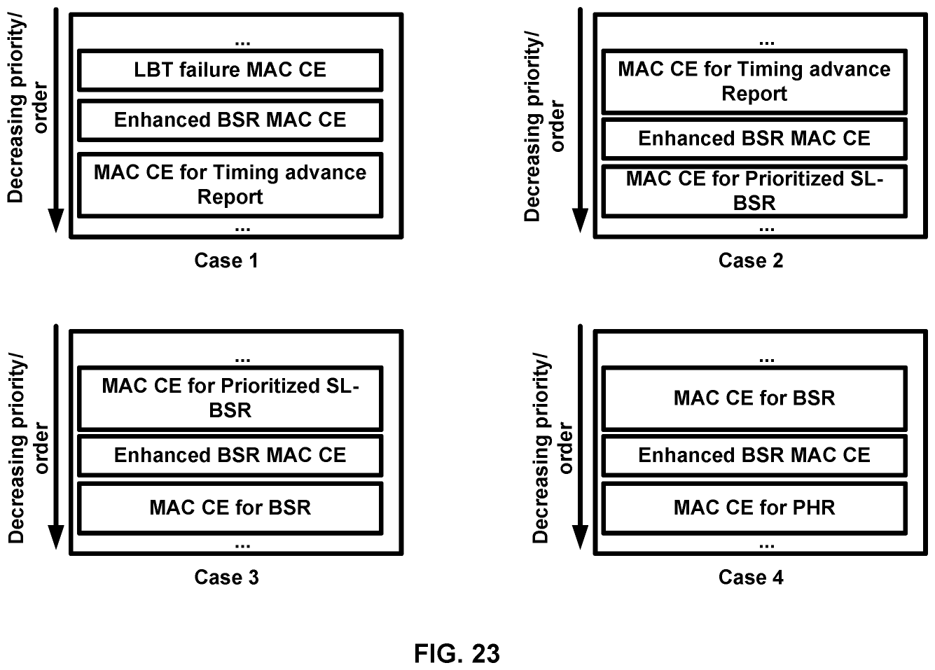

FIG. 21 shows an example embodiment of a logical channel prioritization (LCP) procedure in wireless communications systems per an aspect of the present disclosure. FIG. 22 shows an example embodiment of a logical channel prioritization (LCP) procedure in wireless communications systems per an aspect of the present disclosure. FIG. 23 shows an example embodiment of priority (e.g., a logical channel priority) of an enhanced BSR MAC CE per an aspect of the present disclosure. FIG. 23 may demonstrate several examples of priority/order of the enhanced BSR MAC CE compared to other UL MAC CEs (e.g., an LBT failure MAC CE, a BSR MAC CE, or the like).

FIGS. 21-23 may show example implementations of the method/procedure for sending (e.g., transmitting) enhanced buffer size levels (in bytes) for n-bit Buffer Size filed (e.g., n>8 or n>5), e.g., of the one or more PDUs at the wireless device (e.g., an XR device) and/or receiving the enhanced BSR at the base station. FIGS. 21-23 may show example embodiments for multiplexing and assembly of a MAC PDU comprising the enhanced BSR MAC CE. FIGS. 21-23 may show example embodiments for determining whether to generate the enhanced BSR MAC CE or not for performing a new UL transmission. The wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state). Similar to embodiments of FIG. 18 and FIG. 19, as shown in step 2102 of FIG. 21 and step 2202 of FIG. 22, the wireless device (e.g., UE 2120, UE 2220) may receive from the base station (e.g., BS 2122, BS 2222) the one or more configuration parameters.

A wireless device (e.g., UE 2120, UE 2220), as shown in step 2104 of FIG. 21 and step 2204 of FIG. 22, may trigger a BSR (e.g., due to arrival/pending first UL data in the one or more logical channels). The wireless device may determine the triggered BSR being an enhanced BSR, e.g., in response to the first UL data (e.g., the UL data) corresponding to the one or more logical channels. The wireless device may determine that the first UL data is available/pending at the buffer of the wireless device (e.g., corresponding to the one or more logical channels) for transmission. The first UL (pending) data may comprise the one or more PDUs of the at least one PDU set. The first UL data may comprise the one or more PDUs (e.g., of a PDU set or of the at least one PDU set). The first UL (pending) data may correspond to at least one of the following: one or more XR QoS flows and/or one or more XR video streams and/or one or more XR audio data and/or one or more XR pause/control information. The enhanced BSR may be a BSR comprising padding delay information (e.g., instead of padding BSR). The wireless device, instead of including padding BSR in a buffer status report, may include the delay information.

One or more configuration parameters may configure the wireless device to report/transmit/send enhanced BSR of the one or more logical channels (and/or the one or more PDUs and/or the at least one PDU set). The enhanced BSR may indicate to the base station (or inform the base station) about delay budget/remaining time of the pending data in the buffer of the wireless device and/or precise/detailed buffer size levels (or data volume of the buffer) of the wireless device.

A wireless device may, to trigger the BSR for sending (e.g., transmitting) the enhanced BSR, determine a PDU of the one or more PDUs being an End PDU of the one or more PDUs (e.g., of the at least one PDU set). The PDU may be a Start PDU of the one or more PDUs (e.g., of the at least one PDU set). The PDU may be any PDU of the one or more PDUs (e.g., of the at least one PDU set). The PDU may have a first PDU SN/ID/number/identifier. A PDU set of the at least one PDU set may have a first PDU set identifier. The wireless device may determine to produce/generate enhanced BSR using the new BSR tables based on the importance of a PDU set of the at least one PDU set.

A wireless device, to derive/calculate buffer size levels (e.g., to report index of) of Buffer Size filed of the enhanced BSR, may determine whether to use legacy BSR tables (e.g., Release 15-17 BSR tables in 3GPP TR 38.321, e.g., Table 6.2.1-2 and Table 6.2.1-2b) and/or new BSR tables (different than Release 15-17 BSR tables in 3GPP TR 38.321, e.g., Table 6.2.1-2 and Table 6.2.1-2b). Using the new BSR tables may reduce quantization inaccuracy/error in determining buffer size levels (e.g., of packet sizes with large size, e.g., larger than 40 Mbyte) for reporting/indicating the buffer status to the base station. The new BSR tables may provide more detailed/accurate buffer size levels (e.g., by providing more than N=256 indexes for 8-bit (long) Buffer size filed or more than N=32 indexes for 5-bit (short) Buffer size filed). The new BSR tables may provide finer granularity for reporting the enhanced BSR. The wireless device may use the legacy BSR tables to determine/derive a first (e.g., rough/inaccurate) buffer size level (e.g., a first index) and may use the first index to derive a second buffer size level (e.g., a second index). The wireless device may report/send/transmit both the first index and the second index to report the enhanced BSR.

Legacy BSR tables may be based on a first (exponential) function/formula Bₖ=Bₘᵢₙ·(1+p)^{k}, where p=(Bₘₐₓ/Bₘᵢₙ)^{1/(N-1)}−1, wherein Bₘᵢₙ a minimum buffer size and Bₘₐₓ is a maximum buffer size that may be reported by the wireless device. The legacy BSR tables may provide a constant step size across all encoding points, i.e. (Bₖ₊₁−Bₖ)/Bₖ is a constant for all k. The new BSR tables may have larger values for the minimum buffer size, to allow the wireless device to choose the new BSR tables for determining buffer size levels if the packet size/pending data is larger than the minimum buffer size.

A wireless device may use a predefined/preconfigured compression formula/method (e.g., a compressing algorithm based on a u-Law or an A-law) to derive the buffer size levels (of the one or more logical channels). The one or more configuration parameters may configure the compression formula. The 3GPP standard may define the compression formula (e.g., the compression formula is hardcoded for the wireless device). Compared to the legacy BSR tables, the new BSR tables may provide more accurate buffer size levels to the base station. The base station may, based on receiving the enhanced BSR, determine more accurate (e.g., less wasteful) UL resources for transmission of the first UL data. This may reduce radio resource efficiency in XR applications that volume/size of XR packets are large (e.g., 20-100 Mbyte). The enhanced BSR may be a multiple-entry BSR.

A wireless device, for reporting a second UL data corresponding to one or more second logical channels of the plurality of logical channels, may use the legacy BSR tables. The one or more logical channels may not comprise the one or more second logical channels (e.g., a logical channel of the one or more logical channels may not belong to the one or more second logical channels).

A wireless device may determine UL data volume of the buffer (e.g., corresponding to the one or more logical channels and/or the plurality of logical channels) of the wireless device being larger than a threshold. The UL data volume may indicate volume/size of the first UL data and/or volume/size of the second UL data. The one or more configuration parameters may indicate the threshold. The wireless device may, based on (e.g., in response to) the UL data volume being larger than the threshold, use the new BSR tables to generate/derive/determine the enhanced BSR. The wireless device may, based on (e.g., in response to) the UL data volume being smaller than the threshold, use the legacy BSR tables to generate/derive/determine the BSR. The wireless device may, based on (e.g., in response to) the UL data volume being larger than the threshold, apply the predefined compression formula to derive the enhanced BSR.

A first MAC CE may be an enhanced BSR MAC CE. The first MAC CE may comprise the enhanced BSR. The enhanced BSR MAC CE may comprise the delay information and/or buffer size levels of the first UL data. The enhanced BSR MAC CE may be different than the first MAC CE. The enhanced MAC CE may comprise the delay information (e.g., corresponding to the one or more logical channels) and/or buffer status (e.g., corresponding to the first UL data) of the wireless device. The UL data volume of the first UL data may indicate UL pending data of the one or more logical channels.

Enhanced BSR may be at least one of an enhanced Short/Long BSR and/or an enhanced Long BSR and/or an enhanced Truncated BSR and/or an enhanced Short/Long Truncated BSR and/or an enhance extended BSR and/or an enhanced pre-emptive BSR or the like. The enhanced BSR MAC CE may have a second LCID/eLCID. The second LCID/eLCID may be different than the first LCID/eLCID. The second LCID/eLCID may be the first LCID/eLCID. An index corresponding to the second LCID may be between 37 to 42 or be 47. The index corresponding to the second LCID may be different than at least one of the following: 45, 45, 59, 60, 61, 62, and/or 63. An index/codepoint corresponding to the second eLCID may be between 64 to 292. The index/codepoint corresponding to the second eLCID may be different than at least one of the following: 309, 310, 311, 312, 313 and/or 319.

A wireless device, as shown in FIG. 21 and FIG. 22, may perform/transmit a new UL transmission via the at least one UL-SCH (available) resource to the base station. For example, the wireless device may determine whether to generate/produce/build the enhanced BSR MAC CE or not. The at last one MAC CE, as shown in FIG. 21, may comprise the enhanced BSR MAC CE based on the enhanced BSR MAC CE being generated/produced (e.g., see FIG. 21). The at last one MAC CE may not comprise the enhanced BSR MAC CE based on the enhanced BSR MAC CE not being generated/produced (e.g., see FIG. 22). The wireless device (e.g., UE 2120, UE 2220) may in step 2106/2206, to determine whether to generate/produce/build the enhanced BSR MAC CE or not, determine whether or not the at least one UL-SCH resource for the new UL transmission accommodating the enhanced BSR MAC CE (plus its sub-header), e.g., as a result of/based on the LCP.

As shown in step 2108 of FIG. 21, a wireless device (e.g., UE 2120), based on (e.g., in response to) the at least one UL-SCH resource for the new UL transmission accommodating the enhanced BSR MAC CE (plus its sub-header) (e.g., as a result of/based on the LCP procedure), may instruct the MAP to generate/produce/build the enhanced BSR MAC CE. The wireless device may multiplex the enhanced BSR MAC CE and the MAC SDU in the MAC PDU (e.g., the MAC PDU may comprise the enhanced BSR MAC CE). The wireless device (e.g., UE 2120) in step 2110 may send (e.g., transmit) to the base station (e.g., BS 2122) the MAC PDU comprising the enhanced BSR MAC CE via the at least one UL-SCH resource. The wireless device may send (e.g., transmit) the enhanced BSR MAC CE via the at least one UL-SCH resource.

As shown in step 2208 of FIG. 22, a wireless device (e.g., UE 2220), based on (e.g., in response to) the at least one UL-SCH resource for the new UL transmission not accommodating the enhanced BSR MAC CE (plus its sub-header) (e.g., as a result of/based on the LCP procedure), may not instruct (or skip/avoid instructing) the MAP to generate/produce/build the enhanced BSR MAC CE. The wireless device may not multiplex (or skip/avoid multiplexing) the enhanced BSR MAC CE and the MAC SDU in the MAC PDU (e.g., the MAC PDU may not comprise the enhanced BSR MAC CE). The wireless device (e.g., UE 2220) in step 2210 may send (e.g., transmit) to the base station (e.g., BS 2222) the MAC PDU not comprising the enhanced BSR MAC CE via the at least one UL-SCH resource. The wireless device may not send (e.g., transmit) the enhanced BSR MAC CE via the at least one UL-SCH resource.

The wireless device for performing the LCP (e.g., for transmission/generation of the enhanced BSR MAC CE) may determine an order (and/or a priority) of the enhanced BSR MAC CE among UL MAC CEs (e.g., the at least one MAC CE) and/or the plurality of logical channels. The wireless device may determine the enhanced BSR MAC CE being prioritized among/out of/from the at least one MAC CE. For example, the enhanced BSR MAC CE has a higher priority than other MAC CEs of the at least one MAC CE. In an example, the enhanced BSR MAC CE may be listed first in the at least one MAC CE. For example, FIG. 23 shows some examples of possible order/priority of the enhanced BSR MAC CE among (compared to) the UL MAC CEs.

As shown in FIG. 21, the wireless device, as a result of/based on the LCP procedure, may determine the at least one UL-SCH resource for the new UL transmission accommodating the enhanced BSR MAC CE (plus its sub-header) of the at least one MAC CE and not accommodating the other MAC CEs of the at least one MAC CE (e.g., a third MAC CE of the UL MAC CEs). The wireless device may instruct the MAP to generate the enhanced BSR MAC CE (e.g., and not generate the other MAC CEs of the at least one MAC CE). The wireless device may multiplex the enhanced BSR MAC CE and the MAC SDU in the MAC PDU (e.g., the MAC PDU may not comprise the other MAC CEs of the at least one MAC CE and may comprise the enhanced BSR MAC CE). As shown in FIG. 21, the wireless device may send (e.g., transmit) the MAC PDU via the at least one UL-SCH resource. The MAC PDU may comprise the at least one MAC SDU. The MAC PDU may not comprise any MAC SDU, e.g., the MAC PDU may comprise the enhanced BSR MAC CE.

A wireless device may determine/identify the third MAC CE of the UL MAC CEs that has a lower/smaller priority/order than the enhanced BSR MAC CE (e.g., a priority of a logical channel of the third MAC CE is lower than or equal to a priority of a logical channel of the enhanced BSR MAC CE). The at least one MAC CE, as shown in FIG. 21, may comprise the third MAC CE. The at least one MAC CE may not comprise the third MAC CE. As a result of/based on the LCP procedure, the wireless device may determine the at least one UL-SCH resource for the new UL transmission accommodating the enhanced BSR MAC CE (plus its sub-header) of the at least one MAC CE and not accommodating the third MAC CE (plus its sub-header) of the at least one MAC CE. The wireless device may instruct the MAP to generate the enhanced BSR MAC CE. The wireless device may multiplex the enhanced BSR MAC CE and the MAC SDU in the MAC PDU (e.g., the MAC PDU may not comprise the third MAC CE and may comprise the enhanced BSR MAC CE). The wireless device may send (e.g., transmit) the MAC PDU via the at least one UL-SCH resource.

A wireless device may, via the at least one UL-SCH resource, send (e.g., transmit) the MAC PDU comprising at least one of the enhanced BSR MAC CE and the third MAC CE, wherein the sending (e.g., transmitting) is based on prioritization of a logical channel of the enhanced BSR MAC CE and a logical channel of the third MAC CE. The wireless device may determine the at least one UL-SCH accommodating the third MAC CE plus its subheader, after multiplexing the enhanced BSR MAC CE in the MAC PDU. The wireless device may multiplex the third MAC CE in the MAC PDU (e.g., the MAC PDU comprises the enhanced BSR MAC CE and the third MAC CE).

A wireless device may determine the at least one UL-SCH not accommodating the third MAC CE plus its subheader, after multiplexing the enhanced BSR MAC CE in the MAC PDU. The wireless device may skip/avoid multiplexing the third MAC CE in the MAC PDU (e.g., the MAC PDU comprises the enhanced BSR MAC CE and does not comprise the third MAC CE).

As shown in FIG. 22, a wireless device, as a result of/based on the LCP procedure, may determine the at least one UL-SCH resource for the new UL transmission not accommodating the enhanced BSR MAC CE (plus its sub-header) of the at least one MAC CE and accommodating other MAC CEs of the at least one MAC CE (e.g., a second MAC CE of the UL MAC CEs). The wireless device may skip/avoid instructing the MAP to generate the enhanced BSR MAC CE. The wireless device may skip/avoid/refuse multiplexing the enhanced BSR MAC CE and the MAC SDU in the MAC PDU (e.g., the MAC PDU may comprise the other MAC CEs of the at least one MAC CE and may not comprise the enhanced BSR MAC CE). As shown in FIG. 22, the wireless device may send (e.g., transmit) the MAC PDU via the at least one UL-SCH resource.

As shown in FIG. 22, a wireless device may determine/identify a second MAC CE of the UL MAC CEs that has a higher/greater/larger/bigger priority/order than the enhanced BSR MAC CE (e.g., a priority of a logical channel of the enhanced MAC CE is lower than or equal to a priority of a logical channel of the second BSR MAC CE). The at least one MAC CE may comprise the second MAC CE. The at least one MAC CE may not comprise the second MAC CE. The wireless device, as a result of/based on the LCP procedure, may determine the at least one UL-SCH resource for the new UL transmission accommodating the second MAC CE (plus its sub-header) of the at least one MAC CE and not accommodating the enhanced BSR MAC CE (plus its sub-header) of the at least one MAC CE. The wireless device may instruct the MAP to generate the second MAC CE. The wireless device may multiplex the second MAC CE and the MAC SDU in the MAC PDU (e.g., the MAC PDU may not comprise the enhanced BSR MAC CE and may comprise the second MAC CE). The wireless device may send (e.g., transmit) the MAC PDU via the at least one UL-SCH resource.

A wireless device may, via the at least one UL-SCH resource, send (e.g., transmit) the MAC PDU comprising at least one of the enhanced BSR MAC CE and the second MAC CE, wherein the send (e.g., transmitting) is based on prioritization of a logical channel of the enhanced BSR MAC CE and a logical channel of the second MAC CE. The wireless device may determine the at least one UL-SCH accommodating the enhanced BSR MAC CE plus its subheader, after multiplexing the second MAC CE in the MAC PDU. The wireless device may multiplex the enhanced BSR MAC CE in the MAC PDU (e.g., the MAC PDU comprises the enhanced BSR MAC CE and the second MAC CE).

A wireless device may determine the at least one UL-SCH not accommodating the enhanced BSR MAC CE plus its subheader, after multiplexing the second MAC CE in the MAC PDU. The wireless device may avoid/skip multiplexing the enhanced BSR MAC CE in the MAC PDU (e.g., the MAC PDU does not comprise the enhanced BSR MAC CE and comprises the second MAC CE).

A second MAC CE, as shown in Case 1 in FIG. 23, may be the LBT failure MAC CE, if an LBT failure indication is received from lower layers (physical layer) of the wireless device to the MAC layer of the wireless device. The wireless device may determine the priority/order of the LBT failure MAC CE being greater/higher (or equal or not lower) than the priority/order of the enhanced BSR MAC CE. The LBT failure MAC CE may have greater/higher priority than the enhanced BSR MAC CE if the LBT failure provides a more crucial information (e.g., availability of wireless medium) to the base station (compared to the enhanced BSR MAC CE). The base station, in the case of the LBT failure, may not be able to schedule the wireless device despite a detailed/precise buffer status (e.g., the enhanced BSR) is indicated to the base station. The third MAC CE may be the MAC CE for Timing Advance Report, if a Timing Advance reporting (TAR) procedure determines that at least one TAR is triggered and not cancelled. The wireless device may determine the priority/order of the MAC CE for Timing Advance Report being lower (or equal or not greater) than the priority of the enhanced BSR MAC CE. The MAC CE for Timing Advance Report may have lower/smaller priority than the enhanced BSR MAC CE if the enhanced BSR (e.g., comprising detailed/precise buffer status and/or the delay information) may provide a more crucial information (for efficient scheduling and/or efficient radio resource management) to the base station (e.g., when a PSII of a PDU set indicates all PDUs of the PDU set are needed for the usage of PDU set by application layer and/or when remaining time of an End PDU is smaller than a threshold, e.g., 10 ms).

A second MAC CE, as shown in Case 2 in FIG. 23, may be the MAC CE for Timing Advance Report (e.g., the second MAC CE is the MAC CE for Timing Advance Report), if the TAR procedure determines that at least one TAR is triggered and not cancelled. The wireless device may determine the priority/order of the MAC CE for Timing Advance Report being greater/higher (or equal or not lower) than the priority/order of the enhanced BSR MAC CE. The MAC CE for Timing Advance Report may have higher/greater priority than the enhanced BSR MAC CE if the base station is allowed to measure/estimate round-trip transmission delay (RTT) between the wireless device and the base station and/or improve efficiency of the UL transmission (e.g., lower UL transmission latency). The third MAC CE may be the MAC CE for prioritized SL-BSR (e.g., prioritized according to clause 5.22.1.6 of the 3GPP TS 38.321). The wireless device may determine a Regular and/or a Periodic SL-BSR being triggered. The wireless device may determine the priority/order of the MAC CE for prioritized SL-BSR being lower (or equal or not greater) than the priority/order of the enhanced BSR MAC CE. The MAC CE for prioritized SL-BSR may have lower/smaller priority than the enhanced BSR MAC CE as for XR applications violation of the delay budget of a PDU (e.g., an End PDU) of a PDU set may result in inapplicability of the PDU set (e.g., if a PSII of the PDU set indicates all PDUs of the PDU set are needed for the usage of PDU set by application layer). The MAC CE for prioritized SL-BSR may have lower/smaller priority than the enhanced BSR MAC CE as for XR applications with large packet sizes (e.g., 80 Mbyte), providing precise/detailed buffer size levels may substantially improve the UL resource efficiency (e.g., reduce wastage of UL resources).

A second MAC CE, as shown in Case 3 in FIG. 23, may be the MAC CE for prioritized SL-BSR if a Regular and/or a Periodic SL-BSR is triggered. The wireless device may determine the priority/order of the second MAC CE for prioritized SL-BSR being greater/higher (or equal or not lower) than the priority/order of the enhanced BSR MAC CE. The MAC CE for prioritized SL-BSR may have higher priority than the enhanced BSR MAC CE as pending data of side link (SL) being prioritized. The third MAC CE may be the MAC CE for BSR if a second BSR (e.g., a Regular BSR and/or a pre-emptive BSR and/or a SL BSR) is triggered. The MAC CE for BSR may be at least one of the following: the BSR MAC CE; and/or the Short/Long BSR MAC CE; and/or the Truncated BSR MAC CE; and/or the Short/Long Truncated BSR MAC CE; and/or the extended BSR MAC CE; and/or the MAC CE for (Extended) Pre-emptive BSR; and/or the MAC CE for SL-BSR (with exception of the prioritized SL-BSR and SL-BSR included for padding). The BSR may not comprise padding BSR (e.g., MAC CE for BSR included for padding and/or MAC CE for SL-BSR included for padding). The BSR MAC CE may be different than the enhanced BSR MAC CE. The wireless device may determine buffer size levels for generation/transmission of the BSR MAC CE based on the legacy BSR tables. The wireless device may determine the priority/order of the MAC CE for BSR being lower (or equal or not greater) than the priority/order of the enhanced BSR MAC CE. The MAC CE for BSR may have lower/smaller priority than the enhanced BSR MAC CE if violation of the delay budget of a PDU of a PDU set for XR applications may result in inapplicability of the PDU set (e.g., if a PSII of the PDU set indicates all PDUs of the PDU set are needed for the usage of PDU set by application layer). The MAC CE for BSR may have lower/smaller priority than the enhanced BSR MAC CE if providing precise/detailed buffer size levels, for XR applications with large packet sizes (e.g., 80 Mbyte), may substantially improve the UL resource efficiency (e.g., reduce wastage of UL resources).

A second MAC CE, as shown in Case 4 in FIG. 23, may be the MAC CE for BSR if the BSR is triggered. The wireless device may determine the priority/order of the MAC CE for BSR being greater/higher (or equal or not lower) than the priority/order of the enhanced BSR MAC CE. The MAC CE for BSR may have higher priority than the enhanced BSR MAC CE as (frequently) providing precise/detailed buffer size levels (e.g., using the enhanced BSR) to the base station may consume higher UL resources and may reduce UL data efficiency. The third MAC CE may be the MAC CE for power headroom (PHR). The wireless device may determine a PHR being triggered. The MAC CE for PHR may be a MAC CE for extended PHR. The MAC CE for PHR may be a MAC CE for single entry PHR and/or a MAC CE for multiple entry PHR. The wireless device may determine the priority/order of the MAC CE for PHR being lower (or equal or not greater) than the priority of the enhanced BSR MAC CE. The MAC CE for PHR may have lower/smaller priority than the enhanced BSR MAC CE if violation of the delay budget of a PDU of a PDU set for XR applications may result in inapplicability of the PDU set (e.g., if a PSII of the PDU set indicates all PDUs of the PDU set are needed for the usage of PDU set by application layer). The MAC CE for PHR may have lower/smaller priority than the enhanced BSR MAC CE as for XR applications with large packet sizes (e.g., 80 Mbyte), providing precise/detailed buffer size levels may substantially improve the UL resource efficiency (e.g., reduce wastage of UL resources).

A second MAC CE may be the MAC CE for PHR. The wireless device may determine the PHR being triggered. The wireless device may determine the priority/order of the MAC CE for PHR being greater/higher (or equal or not lower) than the priority of the enhanced BSR MAC CE. The MAC CE for PHR may have higher priority than the enhanced BSR MAC CE if power headroom of the wireless device may provide a more crucial information (e.g., transmission power of the wireless device) to the base station (e.g., for scheduling and/or power efficiency/battery life of the wireless device). The third MAC CE may be the MAC CE for Positioning Measurement Gap Activation/Deactivation Request. The wireless device may determine that an upper layer of the wireless device is triggered to send a Positioning Measurement Gap Activation/Deactivation Request. The wireless device may determine the priority/order of the MAC CE for Positioning Measurement Gap Activation/Deactivation Request being lower (or equal or not greater) than the priority/order of the enhanced BSR MAC CE. The MAC CE for Positioning Measurement Gap Activation/Deactivation Request may have lower/smaller priority than the enhanced BSR MAC CE if violation of the delay budget of a PDU of a PDU set for XR applications may result in inapplicability of the PDU set (e.g., if a PSII of the PDU set indicates all PDUs of the PDU set are needed for the usage of PDU set by application layer). The MAC CE for Positioning Measurement Gap Activation/Deactivation Request may have lower/smaller priority than the enhanced BSR MAC CE if providing precise/detailed buffer size levels, for XR applications with large packet sizes (e.g., 80 Mbyte), may substantially improve the UL resource efficiency (e.g., reduce wastage of UL resources).

The second MAC CE may be the MAC CE for Positioning Measurement Gap Activation/Deactivation Request. The wireless device may determine that the upper layer of the wireless device is triggered to send the Positioning Measurement Gap Activation/Deactivation Request. The wireless device may determine the priority/order of the MAC CE for Positioning Measurement Gap Activation/Deactivation Request being greater/higher (or equal or not lower) than the priority/order of the enhanced BSR MAC CE. The MAC CE for Positioning Measurement Gap Activation/Deactivation Request may have higher priority than the enhanced BSR MAC CE if activation/deactivation of a measurement gap (e.g., for positioning) may provide resource efficiency and/or positioning efficiency/accuracy. The third MAC CE may be at least one of the following: the MAC CE for the quantity (e.g., number) of Desired Guard Symbols (e.g., an IAB-MT) on the child node (e.g., the wireless device may inform a parent IAB-DU or IAB-donor-DU about the quantity (e.g., number) of guard symbols desired via the Desired Guard Symbols MAC CE); and/or the MAC CE for Case-6 Timing Request; and/or the MAC CE for IAB-MT Recommended Beam Indication; and/or the MAC CE for Desired IAB-MT PSD range; and/or the MAC CE for Desired DL Tx Power Adjustment. The wireless device may determine the priority/order of the third MAC CE being lower (or equal or not greater) than the priority/order of the enhanced BSR MAC CE if violation of the delay budget of a PDU of a PDU set for XR applications may result in inapplicability of the PDU set (e.g., if a PSII of the PDU set indicates all PDUs of the PDU set are needed for the usage of PDU set by application layer). The third MAC CE may have lower/smaller priority than the enhanced BSR MAC CE if providing precise/detailed buffer size levels, for XR applications with large packet sizes (e.g., 80 Mbyte), may substantially improve the UL resource efficiency (e.g., reduce wastage of UL resources).

A wireless device may determine the priority/order of data from the plurality of logical channels (except UL-CCCH) being lower (or equal or not greater) than the priority/order of the enhanced BSR MAC CE. The wireless device may, for example, determine the priority/order of data from the one or more logical channels (e.g., data of XR application) being lower (or equal or not greater) than the priority/order of the enhanced BSR MAC CE. For XR applications, timely sending (e.g., transmitting) the enhanced BSR MAC CE may reduce possibility of violation of the delay budget of a PDU of a PDU set (e.g., if a PSII of the PDU set indicates all PDUs of the PDU set are needed for the usage of PDU set by application layer). Timely sending (e.g., transmitting) the enhanced BSR MAC CE, for XR applications with large packet sizes (e.g., 80 Mbyte), may substantially improve the UL resource efficiency (e.g., reduce wastage of UL resources).

A wireless device may determine the priority/order of data (except UL-CCCH) from the one or more logical channels (e.g., data of XR application) being higher (or equal or not lower) than the priority/order of the enhanced BSR MAC CE. The wireless device may determine XR data being available in the one or more logical channels. The wireless device may determine the priority/order of data from the plurality of logical channels (except UL-CCCH) being higher (or equal or not lower) than the priority/order of the enhanced BSR MAC CE. Timely sending (e.g., transmitting) the data of the XR applications for XR applications may reduce possibility of violation of the delay budget of a PDU of the PDU set (e.g., if a PSII of the PDU set indicates all PDUs of the PDU set are needed for the usage of PDU set by application layer).

A wireless device may determine the priority/order of the enhanced BSR MAC CE comprising padding enhanced BSR (e.g., padding enhanced BSR) being higher (or equal or not lower) that priority/order of a padding BSR (e.g., a BSR included/comprised for padding). The wireless device may generate the padding enhanced BSR based on the new BSR tables and/or the predetermined compression formula to report UL pending data of the one or more logical channels. The wireless device may generate the padding BSR based on the legacy BSR tables to report UL pending data of the plurality of logical channels (e.g., not comprising UL data of the one or more logical channels). Timely sending (e.g., transmitting) the delay information may reduce possibility of violation of the delay budget of a PDU of the PDU set (e.g., if a PSII of the PDU set indicates all PDUs of the PDU set are needed for the usage of PDU set by application layer). Providing precise/detailed buffer size levels, for XR applications with large packet sizes (e.g., 80 Mbyte), may substantially improve the UL resource efficiency (e.g., reduce wastage of UL resources).

A second MAC CE may be the MAC CE for delay information. The wireless device may determine the priority/order of the MAC CE for delay information being greater/higher (or equal or not lower) than the priority of the enhanced BSR MAC CE. The MAC CE for delay information may have higher priority than the enhanced BSR MAC CE as the delay information may provide a more crucial information (e.g., transmission power of the wireless device) to the base station, e.g., when violation of the delay budget of a PDU of a PDU set may result in inapplicability of the PDU set (e.g., when a PSII of the PDU set indicates all PDUs of the PDU set are needed for the usage of PDU set by application layer).

A third MAC CE may be the MAC CE for delay information. The wireless device may determine the priority/order of the MAC CE for delay information being lower/smaller (or equal or not greater) than the priority of the enhanced BSR MAC CE. The MAC CE for delay information may have lower priority than the enhanced BSR MAC CE if providing precise/detailed buffer size levels may substantially improve the UL resource efficiency (e.g., reduce wastage of UL resources).

A wireless device, to send (e.g., transmit) the enhanced BSR, may determine a delay reporting (procedure) being triggered and not being cancelled. The wireless device may determine an enhanced BSR (procedure) being triggered and not being cancelled. The wireless device may send (e.g., transmit) the enhanced BSR MAC CE based on (e.g., in response to) the enhanced BSR (and/or the delay reporting) procedure being triggered. The wireless device may cancel the triggered enhanced BSR (and/or the delay reporting) based on (e.g., in response to) sending (e.g., transmitting) the enhanced BSR (e.g., the enhanced BSR MAC CE). The wireless device may cancel the triggered the enhanced BSR (and/or the delay reporting) procedure based on (e.g., in response to) sending (e.g., transmitting) the first UL data (e.g., of the one or more logical channels) to the base station.

A wireless device may cancel the triggered enhanced BSR (and/or the delay reporting) procedure based on (e.g., in response to) dropping the first UL data (e.g., of the one or more logical channels). The wireless device may determine a PDU of the one or more PDUs being dropped at the RLC layer and/or PDCP layer and/or the MAC layer (of the wireless device and/or the base station). The wireless device may determine a PDU set of the at least one PDU set being dropped at the RLC layer and/or PDCP layer and/or the MAC layer (of the wireless device and/or the base station). The MAC layer of the wireless device may cancel the triggered the enhanced BSR (and/or the delay reporting) procedure based on (e.g., in response to) the receiving the dropping indication from the RLC/PDCP layer of the wireless device.

A UE-capability message may comprise (or indicate to the base station) a capability for determining/calculating/deriving the enhanced BSR. The UE-capability message may comprise (or indicate to the base station) a capability for sending (e.g., transmitting) the enhanced BSR MAC CE. The wireless device may expect receiving the new BSR tables and/or the compression formula, based on (e.g., in response to) sending (e.g., transmitting) the UE-capability indicating the capability for determining/calculating/deriving the enhanced BSR.

Examples described herein may provide various advantages such as allowing the wireless device to properly generate/transmit the enhanced BSR to report/sent precise/detailed buffer size levels to the base station. The examples described herein may improve the LCP procedure in order to determine priority/order of the enhanced BSR for sending (e.g., transmitting) the enhanced BSR. At least some solutions may allow the wireless device to determine whether to transmit the BSR or the enhanced BSR. The base station may allocate enough UL resources (e.g., via scheduling DCIs) to the wireless device to transmit the UL data without wasting the UL resources, by properly receiving the enhanced BSR from the wireless device.

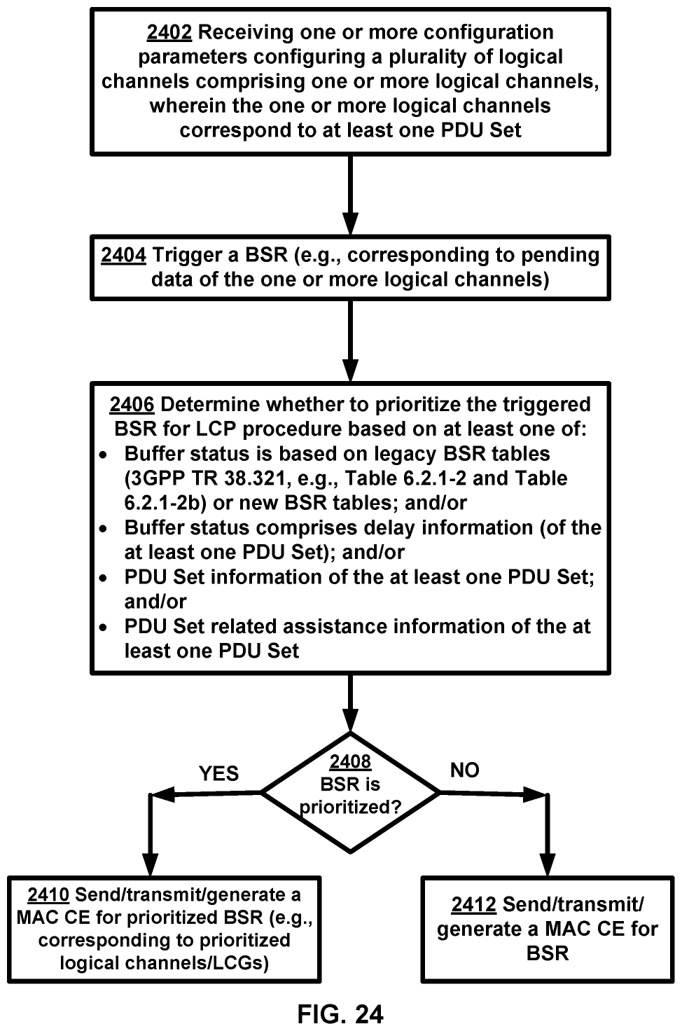

FIG. 24 shows a flowchart of a method/procedure for prioritization of BSR in wireless communications systems per an aspect of the present disclosure. For example, FIG. 24 may show example embodiment of the method/procedure for determining whether to prioritize a BSR for the LCP procedure, if at least one BSR prioritization rule is satisfied. FIG. 24 may show example embodiment of the method/procedure for transmission of an important PDU/PDU set and/or the delay information combined with buffer status device (e.g., corresponding to the one or more PDUs) of a wireless device (e.g., an XR device). The wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state).

A wireless device, as shown in step 2402 of FIG. 24, may receive from the base station the one or more configuration parameters. The one or more configuration parameters may comprise the one or more logical channel configuration parameters. The one or more configuration parameters may configure the plurality of logical channels. The plurality of logical channels may comprise the one or more logical channels (e.g., corresponding to the at least one PDU set and/or the one or more PDUs).

The wireless device may trigger a BSR in step 2404. For example, the wireless device may trigger the BSR in response to pending (or arrival) of the UL data corresponding to the one or more logical channels (e.g., the at least one PDU set and/or the one or more PDUs). The triggered BSR may be the enhanced BSR. For example, the UL data may be (or may comprise) the first UL data.

A wireless device in step 2406, for the triggered BSR, may determine whether to prioritize the triggered BSR for the LCP procedure or not. The wireless device may prioritize the triggered BSR for the LCP procedure based on the at least one BSR prioritization rule being satisfied. The at least one BSR prioritization rule may comprise: buffer status being based on legacy BSR tables (3GPP TR 38.321, e.g., Table 6.2.1-2 and Table 6.2.1-2b) or new BSR tables; and/or buffer status comprises delay information (of the at least one PDU Set); and/or PDU Set information of the at least one PDU Set; and/or PDU Set related assistance information of the at least one PDU Set. The wireless device may skip/avoid/refuse prioritizing the triggered BSR for the LCP procedure based on the at least one BSR prioritization rule not being satisfied.

A wireless device may determine whether the at least one BSR prioritization rule being satisfied. The wireless device, based on (e.g., in response to) the UL data not comprising the first UL data (e.g., the UL data being/comprising the second UL data), may determine the at least one BSR prioritization rule not being satisfied.

A wireless device as shown in FIG. 24 may determine the at least one BSR prioritization rule being satisfied based on (e.g., in response to) buffer size levels for reporting/sending the buffer status (e.g., corresponding to the UL data) being determined/generated (e.g., by the wireless device) using/based on the new BSR tables. The wireless device may determine buffer size levels for reporting/sending the buffer status (e.g., corresponding to the UL data) being determined/generated using/based on the predefined/preconfigured compression formula. The wireless device may determine the at least one BSR prioritization rule not being satisfied in response to buffer size levels for reporting/sending the buffer status (e.g., corresponding to the UL data) being determined/generated (e.g., by the wireless device) using/based on the legacy BSR tables.

A wireless device may determine the at least one BSR prioritization rule being satisfied in response to buffer status comprising the delay information (e.g., corresponding to the one or more logical channels and/or the one or more PDUs and/or the at least one PDU set). The wireless device may determine the at least one BSR prioritization rule not being satisfied in response to buffer status not comprising the delay information. The one or more configuration parameters configure/enable prioritization of BSR corresponding to the one or more logical channels (e.g., when the triggered BSR is based on the first UL data). The wireless device, based on the triggered BSR being based on the second UL data, may avoid prioritizing the BSR.

A wireless device, as shown in FIG. 24, may determine whether the at least one BSR prioritization rule being satisfied or not based on a PDU set information of the at least one PDU set. The wireless device may determine a PDU of the one or more PDUs being an End PDU of the one or more PDUs (e.g., of the at least one PDU set). The wireless device may determine the at least one BSR prioritization rule being satisfied based on the one or more PDUs comprising the End PDU of a PDU set. The wireless device may determine the at least one BSR prioritization rule not being satisfied based on the one or more PDUs not comprising the End PDU of the PDU set.

A wireless device may determine the at least one BSR prioritization rule being satisfied based on the delay budget/remaining time of a PDU of the one or more PDUs (e.g., of the at least one PDU set) being smaller than a threshold (e.g., configured by the one or more configured parameters). The wireless device may determine a value of the one or more second values being smaller than the threshold. The wireless device may determine the second measure/metric/value/indication (e.g., a minimum/shortest/smallest and/or a maximum/largest/longest and/or an average) of the one or more second values (e.g., remaining times/delay budgets of the one or more PDUs, e.g., of the at least one PDU set) being smaller than the threshold.

A wireless device may determine the at least one BSR prioritization rule not being satisfied based on the delay budget/remaining time of the PDU being greater than the threshold. The wireless device may determine a value of the one or more second values being greater than the threshold. The wireless device may determine the second measure/metric/value/indication (e.g., a minimum/shortest/smallest and/or a maximum/largest/longest and/or an average) of the one or more second values (e.g., remaining times/delay budgets of the one or more PDUs, e.g., of the at least one PDU set) being greater than the threshold.

A wireless device may determine the at least one BSR prioritization rule being satisfied based on an importance of the PDU set importance (of a PDU set of the at least one PDU set) being high (or not being low) or being higher than an importance threshold (e.g., configured by the one or more configured parameters). The wireless device may determine the at least one BSR prioritization rule not being satisfied based on the importance of the PDU set importance being low (or not being high) or being lower than the importance threshold.

A wireless device, as shown in FIG. 24, may determine whether the at least one BSR prioritization rule being satisfied or not based on a PDU set related assistance information of the at least one PDU set. The wireless device may, to determine the at least one BSR prioritization rule being satisfied, determine the PDU Set Integrated Indication (PSII) of a PDU set (of the at least one PDU set) indicating all PDUs of the PDU set are needed for the usage of the PDU set by application layer (e.g., XR application). The wireless device may, to determine the at least one BSR prioritization rule not being satisfied, determine the PDU Set Integrated Indication (PSII) of a PDU set (of the at least one PDU set) indicating not all PDUs of the PDU set are needed for the usage of the PDU set by application layer (e.g., XR application).

A wireless device may determine the at least one BSR prioritization rule being satisfied based on PDU-Set Delay Budget (PSDB) of a PDU set of the at least one PDU set being smaller than a threshold (e.g., configured by the one or more configured parameters). The wireless device may determine a value of the one or more first values being smaller than the threshold. The wireless device may determine the first measure/metric/value/indication (e.g., a minimum/shortest/smallest and/or a maximum/largest/longest and/or an average) of the one or more first values being smaller than the threshold.

A wireless device in step 2408 may determine the at least one BSR prioritization rule not being satisfied based on the PSDB of the PDU set being greater than the threshold. The wireless device may determine a value of the one or more first values being greater than the threshold. The wireless device may determine the first measure/metric/value/indication (e.g., a minimum/shortest/smallest and/or a maximum/largest/longest and/or an average) of the one or more first values being smaller than the threshold.

One or more configuration parameters may indicate/configure a parameter (e.g., a prioritization threshold). The prioritization threshold may be ul-PrioritizationThres. The prioritization threshold may be different than ul-PrioritizationThres. The wireless device may determine the at least one BSR prioritization rule not being satisfied based on a value of a highest/greatest/maximum priority (of at least one logical channel) of the one or more logical channels being higher or equal to the prioritization threshold. The wireless device may prioritize the one or more logical channels (and/or the at least one logical channel) for the LCP procedure. The wireless device may prioritize the BSR (e.g., corresponding to the one or more logical channels and/or the at least one logical channel) for the LCP procedure. The at least one logical channel may be with data (e.g., the UL data). The wireless device may prioritize at least one LCG corresponding to the one or more logical channels and/or the at least one logical channel. The wireless device may determine the triggered BSR not being cancelled. The at least one UL-SCH resource (e.g., one or more UL grants) may not accommodate the (enhanced) BSR MAC CE, e.g., containing buffer status corresponding to (and/or only for) the one or more logical channels and/or the at least one logical channel, plus the subheader of the (enhanced) BSR, the wireless device may prioritize the BSR for the LCP procedure.

A wireless device as shown in FIG. 24, in response to/based on at least one BSR prioritization rule being satisfied, may prioritize the triggered BSR for the LCP procedure. The wireless device in step 2410 may send/transmit (or generate) a MAC CE for the prioritized BSR (e.g., a prioritized BSR MAC CE). The wireless device may report/send/transmit (enhanced) Truncated BSR (e.g., for sending/transmitting the prioritized BSR MAC CE) containing/comprising buffer status for the at least one LCG having UL data available for transmission as possible. The wireless device may contain buffer status of as many prioritized LCGs (of the at least one LCG) or for as many prioritized LCHs (of the at least one logical channel) having UL data available for transmission as possible. The wireless device may consider a quantity (e.g., number) of bits in the one or more UL grants (e.g., the at least UL-SCH resource) for sending (e.g., transmitting) the MAC CE for the prioritized BSR.

A wireless device as shown in FIG. 24, in response to/based on the at least one BSR prioritization rule not being satisfied, may avoid/skip/refuse prioritizing the triggered BSR. The wireless device in step 2412 may send/transmit (or generate) a MAC CE for BSR (e.g., the BSR MAC CE and/or the enhanced BSR MAC CE). The wireless device may report/send/transmit the BSR containing/comprising buffer status for the plurality of logical channels (e.g., having data available for transmission) and/or the one or more logical channels (e.g., having data available for transmission).

A UE-capability message may comprise (or indicate to the base station) a capability for prioritizing the BSR. The UE-capability message may comprise (or indicate to the base station) a capability for sending (e.g., transmitting) the prioritized BSR MAC CE. The wireless device, based on (e.g., in response to) sending (e.g., transmitting) the UE-capability not indicating the capability for prioritizing the BSR, may not expect receiving the prioritization parameter. The wireless device may skip prioritizing the BSR and/or transmitting the prioritized BSR MAC CE.

One or more configuration parameters may indicate a first parameter to enable/configure the wireless device to prioritize the BSR. The wireless device, based on (e.g., in response to) the first parameter being configured/indicated (or enabled with value true), may prioritize the BSR (e.g., based on the at least one BSR prioritization rule being satisfied). The wireless device, based on (e.g., in response to) the first parameter not being configured/indicated (or not being enabled with value true or being disabled or being absent), may skip/avoid prioritizing the BSR (e.g., based on the at least one BSR prioritization rule not being satisfied).

Examples described herein may provide various advantages such as allowing the wireless device to prioritize the BSR, for example, based on importance of a PDU/PDU set and/or delay budget of the PDU/PDU set and/or data volume of the one or more logical channels. At least some examples may allow the wireless device to timely report/transmit the buffer status (and/or delay information) to the base station. The base station may properly allocate enough UL resources for the wireless device to efficiently (e.g., without wasting the UL resources) transmit the UL data (e.g., the first UL data) and/or before violating the delay budget of the UL data.

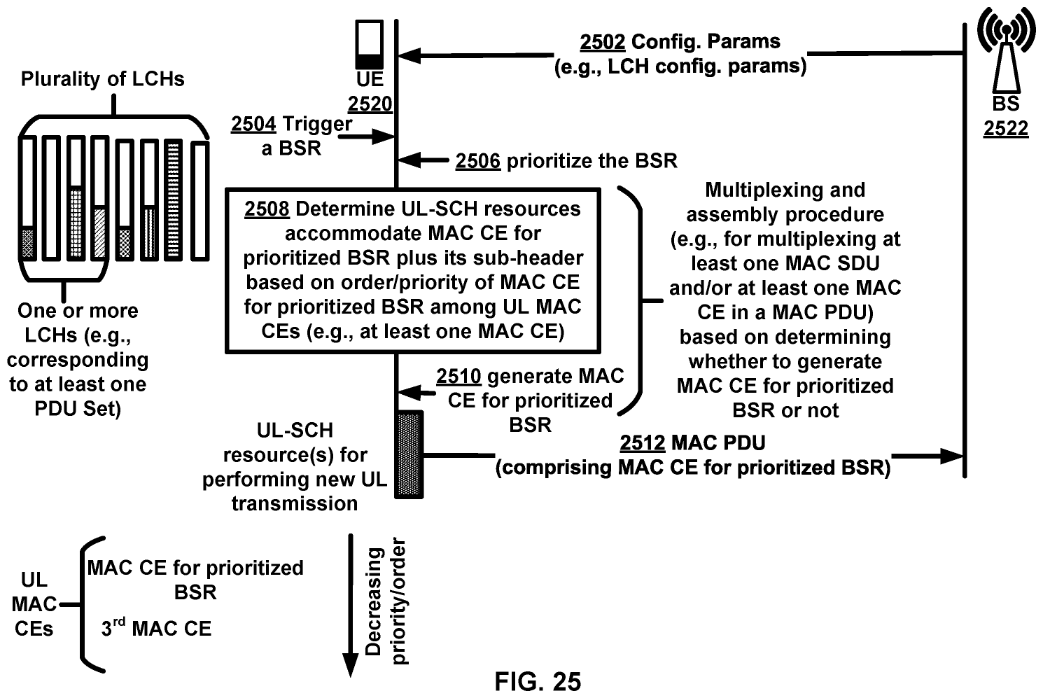

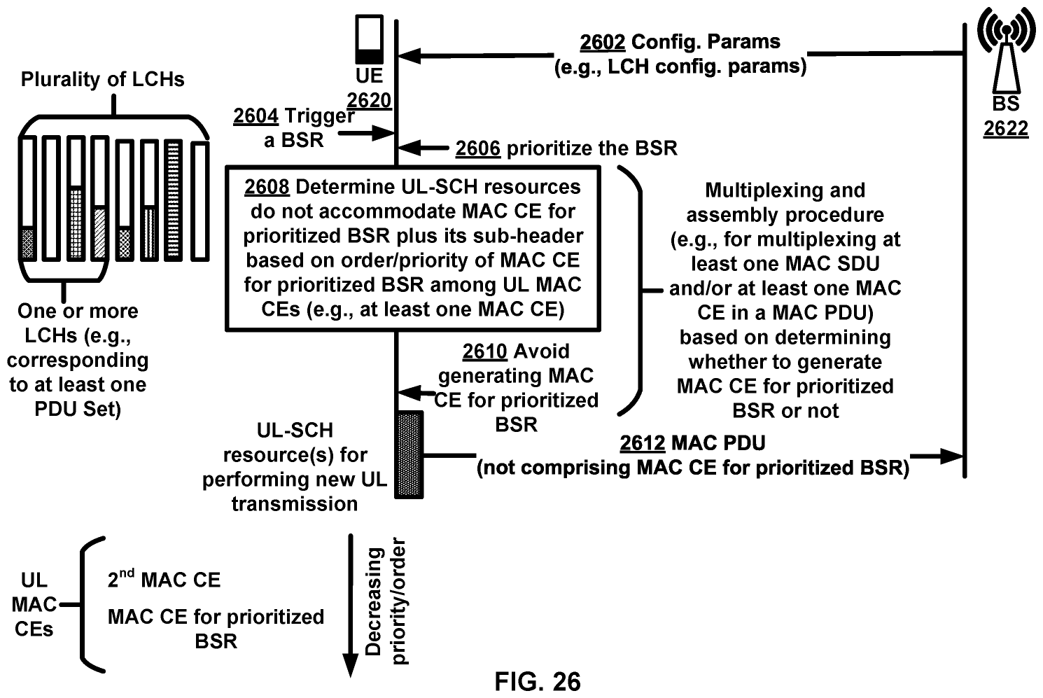

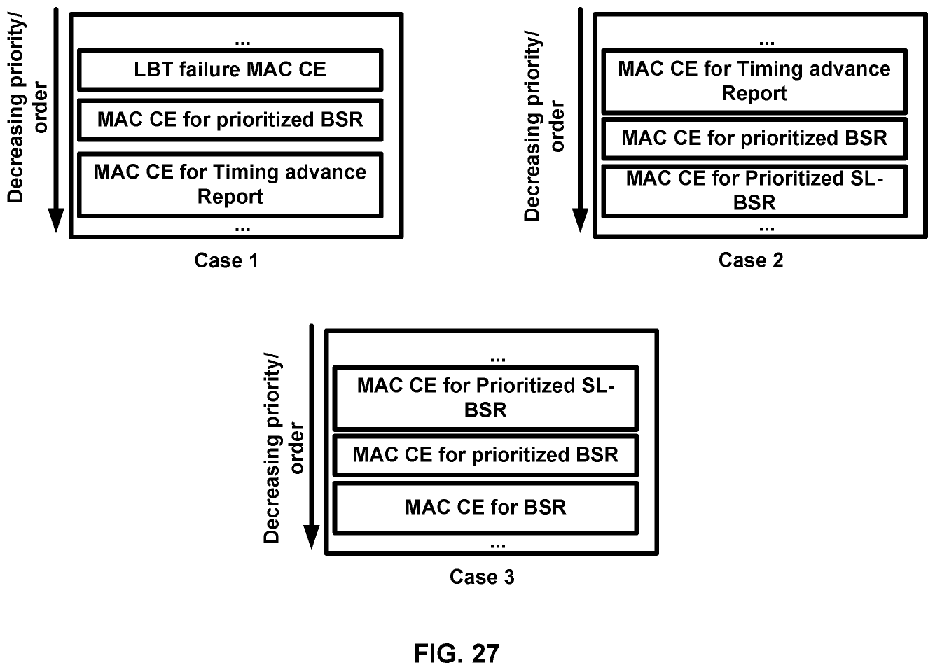

FIG. 25 shows an example embodiment of a logical channel prioritization (LCP) procedure in wireless communications systems per an aspect of the present disclosure. FIG. 26 shows an example embodiment of a logical channel prioritization (LCP) procedure in wireless communications systems per an aspect of the present disclosure. FIG. 27 shows an example embodiment of priority (e.g., a logical channel priority) of a MAC CE for prioritized BSR per an aspect of the present disclosure. FIG. 27 may demonstrate several examples of priority/order of the MAC CE for prioritized BSR compared to other UL MAC CEs (e.g., the LBT failure MAC CE, the BSR MAC CE, or the like).

FIG. 25, FIG. 26 and FIG. 27 may show example implementations of the method/procedure for sending (e.g., transmitting) the MAC CE for prioritized BSR at the wireless device (e.g., an XR device) and/or receiving the MAC CE for prioritized BSR at the base station. FIG. 25, FIG. 26 and FIG. 27 may show example embodiments for multiplexing and assembly of the MAC PDU comprising the MAC CE for prioritized BSR. FIG. 25, FIG. 26 and FIG. 27 may show example embodiments for determining whether to generate the MAC CE for prioritized BSR or not, for performing a new UL transmission. The wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state). Similar to embodiments of FIG. 24, as shown in step 2502 of FIG. 25 and step 2602 of FIG. 26, the wireless device (e.g., UE 2520, UE 2620) may receive from the base station (e.g., BS 2522, BS 2622) the one or more configuration parameters.

A wireless device (e.g., UE 2520, UE 2620), similar to discussions above corresponding to embodiments of FIG. 24 as shown in step 2504 of FIG. 25 and step 2604 of FIG. 26, may trigger the BSR (e.g., due to arrival/pending first UL data in the one or more logical channels). The wireless device (e.g., UE 2520, UE 2620) may prioritized the BSR for the triggered BSR in step 2506/2606. The wireless device, in response to/based on at least one BSR prioritization rule being satisfied, may prioritize the triggered BSR for the LCP procedure. The wireless device may attempt to send (e.g., transmit) the MAC CE for prioritized BSR (e.g., the prioritized BSR MAC CE). The wireless device may determine the BSR being triggered according to embodiments of FIG. 24.

A wireless device as shown in FIG. 25, based on (e.g., in response to) the at least one UL-SCH resource for the new UL transmission accommodating the MAC CE for prioritized BSR (plus its sub-header) (e.g., as a result of/based on the LCP procedure), may instruct the MAP to generate/produce/build the MAC CE for prioritized BSR (e.g., the (enhanced) Truncated BSR). The wireless device may multiplex the MAC CE for prioritized BSR and the MAC SDU in the MAC PDU (e.g., the MAC PDU may comprise the MAC CE for prioritized BSR). The wireless device may send (e.g., transmit) to the base station the MAC PDU comprising the MAC CE for prioritized BSR via the at least one UL-SCH resource. The wireless device may send (e.g., transmit) the MAC CE for prioritized BSR via the at least one UL-SCH resource.

A wireless device as shown in FIG. 26, based on (e.g., in response to) the at least one UL-SCH resource for the new UL transmission not accommodating the MAC CE for prioritized BSR (plus its sub-header) (e.g., as a result of/based on the LCP procedure), may not instruct (or skip/avoid instructing) the MAP to generate/produce/build the MAC CE for prioritized BSR. The wireless device may not multiplex (or skip/avoid multiplexing) the MAC CE for prioritized BSR and the MAC SDU in the MAC PDU (e.g., the MAC PDU may not comprise the MAC CE for prioritized BSR). The wireless device may send (e.g., transmit) to the base station the MAC PDU not comprising the MAC CE for prioritized BSR via the at least one UL-SCH resource. The wireless device may not send (e.g., transmit) the MAC CE for prioritized BSR via the at least one UL-SCH resource.

A wireless device for performing the LCP, e.g., for transmission/generation of the MAC CE for prioritized BSR, may determine an order (or a priority) of the MAC CE for prioritized BSR among UL MAC CEs (e.g., the at least one MAC CE) and/or the plurality of logical channels. The wireless device may determine the MAC CE for prioritized BSR CE being prioritized among/out of/from the at least one MAC CE. The MAC CE for prioritized BSR has a higher priority than other MAC CEs of the at least one MAC CE. The MAC CE for prioritized BSR may be listed first in the at least one MAC CE. For example, FIG. 27 shows some examples of possible order/priority of the MAC CE for prioritized BSR among (compared to) the UL MAC CEs.

A wireless device (e.g., UE 2520), as shown in step 2508 of FIG. 25, as a result of/based on the LCP procedure, may determine the at least one UL-SCH resource for the new UL transmission accommodating the MAC CE for prioritized BSR (plus its sub-header) of the at least one MAC CE and not accommodating the other MAC CEs of the at least one MAC CE (e.g., a third MAC CE of the UL MAC CEs). The wireless device (e.g., UE 2520) at step 2510 may instruct the MAP to generate the MAC CE for prioritized BSR (e.g., and not generate the other MAC CEs of the at least one MAC CE). The wireless device may multiplex the MAC CE for prioritized BSR and the MAC SDU in the MAC PDU, e.g., the MAC PDU may not comprise the other MAC CEs of the at least one MAC CE and may comprise the enhanced BSR MAC CE. As shown in FIG. 25, the wireless device may send (e.g., transmit) the MAC PDU via the at least one UL-SCH resource. The MAC PDU may comprise the at least one MAC SDU. The MAC PDU may not comprise any MAC SDU, e.g., the MAC PDU may comprise the MAC CE for prioritized BSR.

A wireless device may determine/identify the third MAC CE of the UL MAC CEs that has a lower/smaller priority/order than the MAC CE for prioritized BSR (e.g., a priority of a logical channel of the third MAC CE is lower than or equal to a priority order of a logical channel of the MAC CE for prioritized BSR). The at least one MAC CE, as shown in FIG. 25, may comprise the third MAC CE. The at least one MAC CE may not comprise the third MAC CE. The wireless device, As a result of/based on the LCP procedure, may determine the at least one UL-SCH resource for the new UL transmission accommodating the MAC CE for prioritized BSR (plus its sub-header) of the at least one MAC CE and not accommodating the third MAC CE (plus its sub-header) of the at least one MAC CE. The wireless device may instruct the MAP to generate the MAC CE for prioritized BSR. The wireless device may multiplex the MAC CE for prioritized BSR and the MAC SDU in the MAC PDU (e.g., the MAC PDU may not comprise the third MAC CE and may comprise the MAC CE for prioritized BSR). The wireless device may send (e.g., transmit) the MAC PDU via the at least one UL-SCH resource. The at least one MAC CE may not comprise the third MAC CE.

A wireless device (e.g., UE 2520) in step 2512 may, via the at least one UL-SCH resource, send (e.g., transmit) the MAC PDU, comprising at least one of the MAC CE for prioritized BSR and the third MAC CE, to the base station (e.g., BS 2522), wherein the transmitting is based on prioritization of a logical channel of the MAC CE for prioritized BSR and a logical channel of the third MAC CE. For example, after multiplexing the MAC CE for prioritized BSR in the MAC PDU, the wireless device may determine the at least one UL-SCH accommodating the third MAC CE plus its subheader. The wireless device may multiplex the third MAC CE in the MAC PDU (e.g., the MAC PDU comprises the MAC CE for prioritized BSR and the third MAC CE).

A wireless device may determine the at least one UL-SCH not accommodating the third MAC CE plus its subheader, after multiplexing the MAC CE for prioritized BSR in the MAC PDU. The wireless device may skip/avoid multiplexing the third MAC CE in the MAC PDU (e.g., the MAC PDU comprises the MAC CE for prioritized BSR and does not comprise the third MAC CE).

As shown in step 2608 of FIG. 26, as a result of/based on the LCP procedure, the wireless device (e.g., UE 2620) may determine the at least one UL-SCH resource for the new UL transmission not accommodating the MAC CE for prioritized BSR (plus its sub-header) of the at least one MAC CE and accommodating other MAC CEs of the at least one MAC CE (e.g., a second MAC CE of the UL MAC CEs). The wireless device (e.g., UE 2620) in step 2610 may skip/avoid instructing the MAP to generate the MAC CE for prioritized BSR. The wireless device may skip/avoid/refuse multiplexing the MAC CE for prioritized BSR and the MAC SDU in the MAC PDU, e.g., the MAC PDU may comprise the other MAC CEs of the at least one MAC CE and may not comprise the MAC CE for prioritized BSR. As shown in step 2612 of FIG. 22, the wireless device (e.g., UE 2620) may send (e.g., transmit) the MAC PDU via the at least one UL-SCH resource to the base station (e.g., BS 2622).

A wireless device (e.g., UE 2620), as shown in FIG. 26, may determine/identify a second MAC CE of the UL MAC CEs that has a higher/greater/larger/bigger priority/order than the MAC CE for prioritized BSR (e.g., a priority of a logical channel of the second MAC CE is greater than or equal to a priority order of a logical channel of the MAC CE for prioritized BSR). The at least one MAC CE may comprise the second MAC CE. The at least one MAC CE may not comprise the second MAC CE. The wireless device, as a result of/based on the LCP procedure, may determine the at least one UL-SCH resource for the new UL transmission accommodating the second MAC CE (plus its sub-header) of the at least one MAC CE and not accommodating the MAC CE for prioritized BSR (plus its sub-header) of the at least one MAC CE. The wireless device may instruct the MAP to generate the second MAC CE. The wireless device may multiplex the second MAC CE and the MAC SDU in the MAC PDU (e.g., the MAC PDU may not comprise the MAC CE for prioritized BSR and may comprise the second MAC CE) The wireless device may send (e.g., transmit) the MAC PDU via the at least one UL-SCH resource.

A wireless device may, via the at least one UL-SCH resource, send (e.g., transmit) the MAC PDU comprising at least one of the MAC CE for prioritized BSR and the second MAC CE, wherein the sending (e.g., transmitting) is based on prioritization of a logical channel of the MAC CE for prioritized BSR and a logical channel of the second MAC CE. The wireless device may determine the at least one UL-SCH accommodating the MAC CE for prioritized BSR plus its subheader, after multiplexing the second MAC CE in the MAC PDU. The wireless device may multiplex the MAC CE for prioritized BSR in the MAC PDU (e.g., the MAC PDU comprises the MAC CE for prioritized BSR and the second MAC CE).

The wireless device may determine the at least one UL-SCH not accommodating the MAC CE for prioritized BSR plus its subheader after multiplexing the second MAC CE in the MAC PDU. The wireless device may skip/avoid multiplexing the MAC CE for prioritized BSR in the MAC PDU (e.g., the MAC PDU does not comprise the MAC CE for prioritized BSR and comprises the third MAC CE).

The second MAC CE, as shown in Case 1 in FIG. 27, may be the LBT failure MAC CE if an LBT failure indication is received from lower layers (physical layer) of the wireless device to the MAC layer of the wireless device. The wireless device may determine the priority/order of the LBT failure MAC CE being greater/higher (or equal or not lower) than the priority/order of the MAC CE for prioritized BSR. The LBT failure MAC CE may have greater/higher priority than the MAC CE for prioritized BSR as the LBT failure provides a more crucial information (e.g., availability of wireless medium) to the base station (compared to the MAC CE for prioritized BSR). The base station, in the case of the LBT failure, may not be able to schedule the wireless device despite the buffer status is indicated/sent/transmitted to the base station. The third MAC CE may be the MAC CE for Timing Advance Report, if a Timing Advance reporting (TAR) procedure determines that at least one TAR is triggered and not cancelled. The wireless device may determine the priority/order of the MAC CE for Timing Advance Report being lower (or equal or not greater) than the priority of the MAC CE for prioritized BSR. The MAC CE for Timing Advance Report may have lower/smaller priority than the MAC CE for prioritized BSR as the prioritized BSR (e.g., comprising detailed/precise buffer status and/or the delay information) may provide a more crucial information (for efficient scheduling and/or efficient radio resource management) to the base station (e.g., if a PSII of a PDU set indicates all PDUs of the PDU set are needed for the usage of PDU set by application layer and/or if remaining time of an End PDU is smaller than a threshold, e.g., 10 ms).

The second MAC CE, as shown in Case 2 in FIG. 27, may be the MAC CE for Timing Advance Report (e.g., the second MAC CE is the MAC CE for Timing Advance Report), e.g., if the TAR procedure determines that at least one TAR is triggered and not cancelled. The wireless device may determine the priority/order of the MAC CE for Timing Advance Report being greater/higher (or equal or not lower) than the priority/order of the MAC CE for prioritized BSR. The MAC CE for Timing Advance Report may have higher/greater priority than the MAC CE for prioritized BSR as it allows the base station to measure/estimate round-trip transmission delay (RTT) between the wireless device and the base station and/or improve efficiency of the UL transmission (e.g., lower UL transmission latency). The third MAC CE may be the MAC CE for prioritized SL-BSR (e.g., prioritized according to clause 5.22.1.6 of the 3GPP TS 38.321). The wireless device may determine a Regular and/or a Periodic SL-BSR being triggered. The wireless device may determine the priority/order of the MAC CE for prioritized SL-BSR being lower (or equal or not greater) than the priority/order of the MAC CE for prioritized BSR. The MAC CE for prioritized SL-BSR may have lower/smaller priority than the MAC CE for prioritized BSR as for XR applications violation of the delay budget of a PDU (e.g., an End PDU) of a PDU set may result in inapplicability of the PDU set (e.g., when a PSII of the PDU set indicates all PDUs of the PDU set are needed for the usage of PDU set by application layer). The MAC CE for prioritized SL-BSR may have lower/smaller priority than the MAC CE for prioritized BSR as for XR applications with large packet sizes (e.g., 80 Mbyte), providing precise/detailed buffer size levels may substantially improve the UL resource efficiency (e.g., reduce wastage of UL resources).

The second MAC CE, as shown in Case 3 in FIG. 27, may be the MAC CE for prioritized SL-BSR, if a Regular and/or a Periodic SL-BSR is triggered. The wireless device may determine the priority/order of the second MAC CE for prioritized SL-BSR being greater/higher (or equal or not lower) than the priority/order of the MAC CE for prioritized BSR. The MAC CE for prioritized SL-BSR may have higher priority than the MAC CE for prioritized BSR as pending data of side link (SL) being prioritized and/or the pending data of the SL having higher priority than the UL data of the wireless device. The third MAC CE may be the MAC CE for BSR, if a second BSR (e.g., a Regular BSR and/or a pre-emptive BSR and/or a SL BSR) is triggered. The MAC CE for BSR may be at least one of the following: the BSR MAC CE; and/or the Short/Long BSR MAC CE; and/or the Truncated BSR MAC CE; and/or the Short/Long Truncated BSR MAC CE; and/or the enhanced BSR MAC CE; and/or the extended BSR MAC CE; and/or the MAC CE for (Extended) Pre-emptive BSR; and/or the MAC CE for SL-BSR; (with exception of the prioritized SL-BSR and SL-BSR included for padding). The BSR may not comprise padding BSR (e.g., MAC CE for BSR included for padding and/or MAC CE for SL-BSR included for padding). The BSR MAC CE may be different than the MAC CE for prioritized BSR. The wireless device may determine buffer size levels for generation/transmission of the BSR MAC CE based on the legacy BSR tables. The wireless device may determine the priority/order of the MAC CE for BSR being lower (or equal or not greater) than the priority/order of the MAC CE for prioritized BSR. The MAC CE for BSR may have lower/smaller priority than the MAC CE for prioritized BSR as for XR applications violation of the delay budget of a PDU of a PDU set may result in inapplicability of the PDU set (e.g., if a PSII of the PDU set indicates all PDUs of the PDU set are needed for the usage of PDU set by application layer). The MAC CE for BSR may have lower/smaller priority than the MAC CE for prioritized BSR as for XR applications with large packet sizes (e.g., 80 Mbyte), providing precise/detailed buffer size levels may substantially improve the UL resource efficiency (e.g., reduce wastage of UL resources).

The wireless device may determine the priority/order of data from the plurality of logical channels (except UL-CCCH) being lower (or equal or not greater) than the priority/order of the MAC CE for prioritized BSR. The wireless device may, for example, determine the priority/order of data from the one or more logical channels (e.g., data of XR application) being lower (or equal or not greater) than the priority/order of the MAC CE for prioritized BSR. Timely sending (e.g., transmitting) the MAC CE for prioritized BSR for XR applications may reduce possibility of violation of the delay budget of a PDU of a PDU set (e.g., if a PSII of the PDU set indicates all PDUs of the PDU set are needed for the usage of PDU set by application layer). Timely sending (e.g., transmitting) the MAC CE for prioritized BSR, for XR applications with large packet sizes (e.g., 80 Mbyte), may substantially improve the UL resource efficiency (e.g., reduce wastage of UL resources).

A wireless device may determine the priority/order of data (except UL-CCCH) from the one or more logical channels (e.g., data of XR application) being higher (or equal or not lower) than the priority/order of the MAC CE for prioritized BSR. The wireless device may determine XR data being available in the one or more logical channels. The wireless device may determine the priority/order of data from the plurality of logical channels (except UL-CCCH) being higher (or equal or not lower) than the priority/order of the MAC CE for prioritized BSR. Timely sending (e.g., transmitting) the data of the XR applications, for XR applications, may reduce possibility of violation of the delay budget of a PDU of the PDU set (e.g., if a PSII of the PDU set indicates all PDUs of the PDU set are needed for the usage of PDU set by application layer).

The second MAC CE may be the MAC CE for delay information. The wireless device may determine the priority/order of the MAC CE for delay information being greater/higher (or equal or not lower) than the priority of the MAC CE for prioritized BSR. The MAC CE for delay information may have higher priority than the MAC CE for prioritized BSR as the delay information may provide a more crucial information (e.g., transmission power of the wireless device) to the base station, e.g., if violation of the delay budget of a PDU of a PDU set may result in inapplicability of the PDU set (e.g., when a PSII of the PDU set indicates all PDUs of the PDU set are needed for the usage of PDU set by application layer).

The third MAC CE may be the MAC CE for delay information. The wireless device may determine the priority/order of the MAC CE for delay information being lower/smaller (or equal or not greater) than the priority of the MAC CE for prioritized BSR. The MAC CE for delay information may have lower priority than the MAC CE for prioritized BSR as providing precise/detailed buffer size levels may substantially improve the UL resource efficiency (e.g., reduce wastage of UL resources).

Examples described herein may provide various advantages such as allowing the wireless device to properly generate/send/transmit the prioritized BSR to report/send precise/detailed buffer size levels to the base station and/or to report/send the delay information to the base station. Examples described herein may improve the LCP procedure in order to determine priority/order of the prioritized BSR for sending (e.g., transmitting) the buffer status/delay information to the base station. At least some solutions described herein may allow the wireless device to determine whether to send (e.g., transmit) the prioritized BSR or the BSR. The base station may allocate enough UL resources (e.g., via scheduling DCIs) to the wireless device to send (e.g., transmit) the UL data without wasting the UL resources and/or violating the delay budget of the UL data, if the wireless device properly/timely sends (e.g., transmits) the prioritized BSR to the base station.

The wireless device, in examples of FIG. 20 and/or FIG. 23 and/or FIG. 27, may, for each case (e.g., Case 1/2/3/4), first generate a MAC CE on top of the list of MAC CEs before generating the MAC CEs in the list that are listed below/after the MAC CE. The wireless device may generate a MAC CE at the end of the list after generating the MAC CEs in the list that are listed above the MAC CE.

A wireless device may perform various operations. The wireless device may trigger a delay reporting procedure for transmitting delay information, corresponding to one or more logical channels, via a first medium access control (MAC) control element (CE); and send (e.g., transmit) a MAC PDU comprising at least one of the first MAC CE and a second MAC CE, wherein the sending (e.g., transmitting) may be based on prioritization of: a logical channel of the first MAC CE; and a logical channel of the second MAC CE; wherein the sending (e.g., transmitting) the MAC PDU may be via at least one uplink shared channel (UL-SCH) resource. The wireless device may further determine: a priority of the logical channel of the first MAC CE being greater than or equal to a priority of the logical channel of the second MAC CE; and the at least one UL-SCH resource accommodating the first MAC CE. The wireless device may further multiplex the first MAC CE in the MAC PDU before multiplexing the second MAC CE in the MAC PDU, wherein the MAC PDU may comprise the first MAC CE and the second MAC CE. The wireless device may further not multiplex the second MAC CE in the MAC PDU based on the at least one UL-SCH resource not accommodating the second MAC CE, wherein the MAC PDU may comprise the first MAC CE and may not comprise the second MAC CE. The wireless device may further determine: a priority of the logical channel of the first MAC CE being lower than or equal to a priority of the logical channel of the second MAC CE; and the at least one UL-SCH resource accommodating the second MAC CE. The wireless device may further multiplex the second MAC CE in the MAC PDU before multiplexing the first MAC CE in the MAC PDU, wherein the MAC PDU may comprise the first MAC CE and the second MAC CE. The wireless device may further not multiplex the first MAC CE in the MAC PDU based on the at least one UL-SCH resource not accommodating the first MAC CE, wherein the MAC PDU may comprise the second MAC CE and may not comprise the first MAC CE. The wireless device may further determine the one or more logical channels being with a first pending data. The wireless device may further determine the first MAC CE having a higher priority that the first pending data of the one or more logical channels, wherein the MAC PDU may not comprise the first pending data of the one or more logical channels, wherein the second MAC CE may be at least one of: a MAC CE for timing advance report (TAR); a MAC CE for buffer status report (BSR); a MAC CE for power headroom report (PHR); a MAC CE for positioning measurement gap activation/deactivation request; a MAC CE for a quantity (e.g., number) of desired guard symbols; or a MAC CE for case-6 timing request, wherein the BSR may not comprise padding BSR, wherein the BSR may be at least one of: an extended BSR; a Pre-emptive BSR; an extended Pre-emptive BSR; a side-link (SL)-BSR, wherein the SL-BSR may be prioritized for logical channel prioritization (LCP) procedure; wherein the SL-BSR may not be prioritized for LCP procedure; wherein the SL-BSR may not comprise padding SL-BSR; wherein the PHR may be at least one of: a single entry PHR; an enhanced single entry PHR; a multiple entry PHR; or an enhanced multiple entry PHR; wherein the BSR may correspond to one or more second logical channels, wherein the one or more second logical channels may be different than the one or more logical channels; wherein the BSR may correspond to the one or more logical channels; wherein the triggering the delay reporting may be after/in response to the BSR being triggered. The wireless device may further determine the triggered BSR not being canceled. The wireless device may further cancel the triggered delay reporting based on the triggered BSR being cancelled. The wireless device may further cancel the triggered delay reporting based on the transmitting the MAC PDU comprising the first MAC CE, wherein the first pending data may comprise one or more PDUs; wherein the one or more PDUs may belong to a PDU set; wherein the one or more PDUs may belong to at least one PDU set; wherein a PDU of the one or more PDUs may be an End PDU of a PDU set; wherein the first MAC CE may comprise/indicate one or more first values, wherein each value of one or more first values may indicate a remaining time or delay budget of a PDU of the one or more PDUs; wherein the first MAC CE may comprise/indicate one or more second values, wherein each value of one or more second values may indicate a remaining time or delay budget of a PDU set of the at least one PDU set; wherein the first MAC CE may comprise/indicate a minimum/maximum/average remaining time/delay budget of the one or more PDUs; wherein the first MAC CE may comprise/indicate a minimum/maximum/average remaining time/delay budget of the at least one PDU set. The wireless device may further send (e.g., transmit) a user equipment (UE)-capability message to a base station, wherein the UE-capability message may comprise at least one of: a capability for sending (e.g., transmitting) a delay information; a capability for triggering the delay reporting procedure; or a capability for measuring/determining delay budget/remaining time of a first pending data of the one or more logical channels. The wireless device may further receive one or more configuration parameters configuring a plurality of logical channels, wherein the plurality of logical channels may comprise the one or more logical channels; wherein the one or more configuration parameters may enable/configure the wireless device for the triggering the delay reporting procedure; wherein the one or more configuration parameters may enable/configure the wireless device for transmitting the first MAC CE.

A wireless device may perform various operations. The wireless device may trigger a delay reporting procedure for sending (e.g., transmitting) delay information, corresponding to one or more logical channels, via a first medium access control (MAC) control element (CE); and sending (e.g., transmitting) a MAC PDU comprising at least one of the first MAC CE and a second MAC CE, wherein the sending (e.g., transmitting) may be based on a logical channel prioritization of the first MAC CE and a logical channel of the second MAC CE.

A wireless device may perform various operations. The wireless device may trigger a delay reporting procedure for sending (e.g., transmitting) delay information, corresponding to one or more logical channels, via a first medium access control (MAC) control element (CE); and sending (e.g., transmitting) a MAC PDU comprising at least one of the first MAC CE and a second MAC CE, wherein: the sending (e.g., transmitting) may be based on prioritization of: a logical channel of the first MAC CE; and a logical channel of the second MAC CE; and the second MAC CE may not correspond to the delay reporting procedure; wherein the first MAC CE may be different than the second MAC CE.

A wireless device may perform various operations. The wireless device may trigger a delay reporting procedure for sending (e.g., transmitting) a first medium access control (MAC) control element (CE) for delay information corresponding to one or more logical channels; and sending (e.g., transmitting) the MAC PDU comprising the first MAC CE based on a priority of a logical channel of the first MAC CE being higher than or equal to a priority of a logical channel of a second MAC CE, wherein the second MAC CE may be different than the first MAC CE.

A wireless device may perform various operations. The wireless device may trigger a delay reporting procedure for sending (e.g., transmitting) delay information, corresponding to one or more logical channels, via a first medium access control (MAC) control element (CE); multiplexing the first MAC CE in a MAC packet data unit (PDU) based on: a logical channel of the first MAC CE having a higher priority than a logical channel of a second MAC CE, wherein the second MAC CE may correspond to a triggered buffer status report (BSR); and at least one uplink shared channel (UL-SCH) resource accommodating the first MAC CE; and sending (e.g., transmitting), via the at least one UL-SCH resource, the MAC PDU comprising the first MAC CE.

A wireless device may perform various operations. The wireless device may trigger a delay reporting procedure for sending (e.g., transmitting) delay information, corresponding to one or more logical channels, via a first medium access control (MAC) control element (CE); multiplexing, to generate a MAC packet data unit (PDU), the first MAC CE in a MAC service data unit (SDU) based on: a logical channel of the first MAC CE having a higher priority than a logical channel of a second MAC CE, wherein the second MAC CE may correspond to a triggered buffer status report (BSR); and at least one uplink shared channel (UL-SCH) resource accommodating the first MAC CE; and sending (e.g., transmitting), via the at least one UL-SCH resource, the MAC PDU comprising the first MAC CE.

A wireless device may perform various operations. The wireless device may trigger a delay reporting procedure for sending (e.g., transmitting) delay information, corresponding to one or more logical channels, via a first medium access control (MAC) control element (CE), wherein at least one logical channel of the one or more logical channels may be with pending data; multiplexing the first MAC CE in a MAC packet data unit (PDU) based on: a logical channel of the first MAC CE having a higher priority than a logical channel of a second MAC CE, wherein the second MAC CE may correspond to a triggered buffer status report (BSR); and at least one uplink shared channel (UL-SCH) resource accommodating the first MAC CE; and sending (e.g., transmitting), via the at least one UL-SCH resource, the MAC PDU comprising the first MAC CE.

A wireless device may perform various operations. The wireless device may trigger a delay reporting procedure for sending (e.g., transmitting) delay information corresponding to one or more logical channels via a first medium access control (MAC) control element (CE); multiplexing, to generate a MAC packet data unit (PDU), the first MAC CE in a MAC service data unit (SDU) before multiplexing a second MAC CE in the MAC SDU based on the first MAC CE having a higher priority than the second MAC CE, wherein the second MAC CE I different than the first MAC CE; and sending (e.g., transmitting) the MAC PDU comprising the first MAC CE and the second MAC CE.

A wireless device may perform various operations. The wireless device may trigger a delay reporting procedure for sending (e.g., transmitting) delay information corresponding to one or more logical channels via a first medium access control (MAC) control element (CE); triggering a buffer status report (BSR); multiplexing, to generate a MAC packet data unit (PDU), the first MAC CE in a MAC service data unit (SDU) based on the first MAC CE having a higher priority than a second MAC CE, wherein the second MAC CE may correspond to the triggered buffer status report (BSR); and sending (e.g., transmitting) the MAC PDU comprising the first MAC CE. The wireless device may further determine whether to multiplex the second MAC CE in the MAC SDU after the multiplexing the first MAC CE in the MAC SDU. The wireless device may further multiplex the second MAC CE in the MAC SDU after the multiplexing the first MAC CE in the MAC SDU, wherein the MAC PDU may comprise the second MAC CE. The wireless device may further skip multiplexing the second MAC CE in the MAC SDU after the multiplexing the first MAC CE in the MAC SDU, wherein the MAC PDU may not comprise the second MAC CE.

A wireless device may perform various operations. The wireless device may trigger a delay reporting procedure for sending (e.g., transmitting) a first medium access control (MAC) control element (CE) for delay information corresponding to one or more logical channels; triggering a second procedure, wherein: the second procedure may be different than the delay reporting procedure; and the second procedure may be for transmission of a second MAC CE that may be different than the first MAC CE; and sending (e.g., transmitting) the MAC PDU comprising the first MAC CE based on a priority of a logical channel of the first MAC CE being higher than or equal to a priority of a logical channel of the second MAC CE.

A wireless device may perform various operations. The wireless device may trigger a delay reporting procedure for sending (e.g., transmitting) a first medium access control (MAC) control element (CE) for delay information corresponding to one or more logical channels; and sending (e.g., transmitting) the MAC PDU comprising a second MAC CE based on a priority of a logical channel of the first MAC CE being lower than or equal to a priority of a logical channel of the second MAC CE, wherein the second MAC CE may be different than the first MAC CE.

A wireless device may perform various operations. The wireless device may trigger a delay reporting procedure for sending (e.g., transmitting) delay information, corresponding to one or more logical channels, via a first medium access control (MAC) control element (CE); multiplexing a second MAC CE in a MAC packet data unit (PDU) based on: a logical channel of the first MAC CE having a higher priority than a logical channel of the second MAC CE, wherein the second MAC CE may correspond to a triggered buffer status report (BSR); and at least one uplink shared channel (UL-SCH) resource accommodating the second MAC CE; and sending (e.g., transmitting), via the at least one UL-SCH resource, the MAC PDU comprising the second MAC CE.

A wireless device may perform various operations. The wireless device may trigger a delay reporting procedure for sending (e.g., transmitting) delay information, corresponding to one or more logical channels, via a first medium access control (MAC) control element (CE); multiplexing, to generate a MAC packet data unit (PDU), the first MAC CE in a MAC service data unit (SDU) based on: a logical channel of the first MAC CE having a lower priority than a logical channel of a second MAC CE, wherein the second MAC CE may correspond to a triggered buffer status report (BSR); and at least one uplink shared channel (UL-SCH) resource accommodating the second MAC CE; and sending (e.g., transmitting), via the at least one UL-SCH resource, the MAC PDU comprising the second MAC CE.

A wireless device may perform various operations. The wireless device may trigger a delay reporting procedure for sending (e.g., transmitting) delay information, corresponding to one or more logical channels, via a first medium access control (MAC) control element (CE), wherein at least one logical channel of the one or more logical channels may be with pending data; multiplexing a second MAC CE in a MAC packet data unit (PDU) based on: a logical channel of the first MAC CE having a lower priority than a logical channel of the second MAC CE, wherein the second MAC CE may correspond to a triggered buffer status report (BSR); and at least one uplink shared channel (UL-SCH) resource accommodating the second MAC CE; and sending (e.g., transmitting), via the at least one UL-SCH resource, the MAC PDU comprising the second MAC CE.

A wireless device may perform various operations. The wireless device may trigger a delay reporting procedure for sending (e.g., transmitting) delay information corresponding to one or more logical channels via a first medium access control (MAC) control element (CE); multiplexing, to generate a MAC packet data unit (PDU), the first MAC CE in a MAC service data unit (SDU) after multiplexing a second MAC CE in the MAC SDU based on the first MAC CE having a higher priority than the second MAC CE, wherein the second MAC CE may be different than the first MAC CE; and sending (e.g., transmitting) the MAC PDU comprising the first MAC CE and the second MAC CE.

A wireless device may perform various operations. The wireless device may trigger a delay reporting procedure for sending (e.g., transmitting) delay information corresponding to one or more logical channels via a first medium access control (MAC) control element (CE); triggering a buffer status report (BSR); multiplexing, to generate a MAC packet data unit (PDU), a second MAC CE in a MAC service data unit (SDU) based on the first MAC CE having a lower priority than the second MAC CE, wherein the second MAC CE may correspond to the triggered buffer status report (BSR); and sending (e.g., transmitting) the MAC PDU comprising the first MAC CE.

A wireless device may perform various operations. The wireless device may trigger a delay reporting procedure for sending (e.g., transmitting) a first medium access control (MAC) control element (CE) for delay information corresponding to one or more logical channels; triggering a second procedure, wherein: the second procedure may be different than the delay reporting procedure; and the second procedure may be for transmission of a second MAC CE that is different than the first MAC CE; and sending (e.g., transmitting) the MAC PDU comprising the second MAC CE based on a priority of a logical channel of the first MAC CE being lower than or equal to a priority of a logical channel of the second MAC CE.

A wireless device may perform various operations. The wireless device may trigger an enhanced buffer status report (BSR) based on (e.g., in response to) arrival of a first uplink data, corresponding to one or more first logical channels, for sending (e.g., transmitting) the enhanced BSR via a first medium access control (MAC) control element (CE); and sending (e.g., transmitting) a MAC PDU comprising at least one of the first MAC CE and a second MAC CE, wherein the sending (e.g., transmitting) may be based on prioritization of: a logical channel of the first MAC CE; and a logical channel of the second MAC CE, wherein the sending (e.g., transmitting) the MAC PDU may be via at least one uplink shared channel (UL-SCH) resource. The wireless device may further determine: a priority of the logical channel of the first MAC CE being greater than or equal to a priority of the logical channel of the second MAC CE; and the at least one UL-SCH resource accommodating the first MAC CE. The wireless device may further multiplex the first MAC CE in the MAC PDU before multiplexing the second MAC CE in the MAC PDU, wherein the MAC PDU may comprise the first MAC CE and the second MAC CE. The wireless device may further not multiplex the second MAC CE in the MAC PDU based on the at least one UL-SCH resource not accommodating the second MAC CE, wherein the MAC PDU may comprise the first MAC CE and may not comprise the second MAC CE. The wireless device may further determine: a priority of the logical channel of the first MAC CE being lower than or equal to a priority of the logical channel of the second MAC CE; and the at least one UL-SCH resource accommodating the second MAC CE. The wireless device may further multiplex the second MAC CE in the MAC PDU before multiplexing the first MAC CE in the MAC PDU, wherein the MAC PDU may comprise the first MAC CE and the second MAC CE. The wireless device may further not multiplex the first MAC CE in the MAC PDU based on the at least one UL-SCH resource not accommodating the first MAC CE, wherein the MAC PDU may comprise the second MAC CE and may not comprise the first MAC CE. The wireless device may further determine the first MAC CE having a higher priority that the first uplink data of the one or more logical channels, wherein the MAC PDU may not comprise the first uplink data of the one or more logical channels, wherein the second MAC CE may be at least one of: a MAC CE for timing advance report (TAR); a MAC CE for buffer status report (BSR); a MAC CE for power headroom report (PHR); a MAC CE for positioning measurement gap activation/deactivation request; a MAC CE for a quantity (e.g., number) of desired guard symbols; or a MAC CE for case-6 timing request, wherein the BSR may not comprise padding BSR, wherein the BSR may be at least one of: an extended BSR; a Pre-emptive BSR; an extended Pre-emptive BSR; a side-link (SL)-BSR; wherein the SL-BSR may be prioritized for logical channel prioritization (LCP) procedure; wherein the SL-BSR may be not prioritized for LCP procedure; wherein the SL-BSR may not comprise padding SL-BSR; wherein the PHR may be at least one of: a single entry PHR; an enhanced single entry PHR; a multiple entry PHR; or an enhanced multiple entry PHR; wherein the BSR may correspond to a second uplink data of one or more second logical channels; wherein the one or more second logical channels may be different than the one or more logical channels; wherein data volume size of the first uplink data may be larger than data volume size of the second uplink data. The wireless device may further determine data volume size of the first uplink data being larger than a threshold. The wireless device may determine data volume size of the second uplink data being smaller than a threshold, wherein a granularity of buffer size levels of the enhanced BSR may be smaller than a granularity of buffer size levels of the BSR, wherein: buffer size levels of the enhanced BSR may not be derived based on Table 6.2.1-2 of 3GPP TR 38.321 or Table 6.2.1-2b of 3GPP TR 38.321; and buffer size levels of the BSR may be derived based on Table 6.2.1-2 of 3GPP TR 38.321 or Table 6.2.1-2b of 3GPP TR 38.321, wherein the enhanced BSR may comprise delay information of the first uplink data, wherein the first uplink data may comprise one or more PDUs, wherein the one or more PDUs may belong to a PDU set, wherein the one or more PDUs may belong to at least one PDU set, wherein a PDU of the one or more PDUs may be an End PDU of a PDU set, wherein the first MAC CE may comprise/indicate one or more first values, wherein each value of one or more first values may indicate a remaining time or delay budget of a PDU of the one or more PDUs, wherein the first MAC CE may comprise/indicate one or more second values, wherein each value of one or more second values may indicate a remaining time or delay budget of a PDU set of the at least one PDU set, wherein the first MAC CE may comprise/indicate a minimum/maximum/average remaining time/delay budget of the one or more PDUs, wherein the first MAC CE may comprise/indicate a minimum/maximum/average remaining time/delay budget of the at least one PDU set. The wireless device may further send (e.g., transmit) a user equipment (UE)-capability message to a base station, wherein the UE-capability message may comprise at least one of: a capability for sending (e.g., transmitting) the enhanced BSR; a capability for triggering the enhanced BSR; or a capability for measuring/determining delay budget/remaining time of a first uplink data of the one or more logical channels. The wireless device may further receive one or more configuration parameters configuring a plurality of logical channels, wherein the plurality of logical channels may comprise the one or more logical channels, wherein the one or more configuration parameters may enable/configure the wireless device for the triggering the enhanced BSR, wherein the one or more configuration parameters may enable/configure the wireless device for transmitting the first MAC CE.

A wireless device may perform various operations. The wireless device may trigger an enhanced buffer status report (BSR) based on (e.g., in response to) arrival of a first uplink data, corresponding to one or more first logical channels, for sending (e.g., transmitting) the enhanced BSR via a first medium access control (MAC) control element (CE); and sending (e.g., transmitting) a MAC PDU comprising at least one of the first MAC CE and a second MAC CE, wherein the sending (e.g., transmitting) may be based on a logical channel prioritization of the first MAC CE and a logical channel of the second MAC CE.

A wireless device may perform various operations. The wireless device may trigger an enhanced buffer status report (BSR) based on (e.g., in response to) arrival of a first uplink data, corresponding to one or more first logical channels, for sending (e.g., transmitting) the enhanced BSR via a first medium access control (MAC) control element (CE); and sending (e.g., transmitting) the MAC PDU comprising the first MAC CE based on a priority of a logical channel of the first MAC CE being higher than or equal to a priority of a logical channel of a second MAC CE, wherein the second MAC CE may be different than the first MAC CE.

A wireless device may perform various operations. The wireless device may trigger an enhanced buffer status report (BSR) based on (e.g., in response to) arrival of a first uplink data, corresponding to one or more first logical channels, for sending (e.g., transmitting) the enhanced BSR via a first medium access control (MAC) control element (CE); multiplexing the first MAC CE in a MAC packet data unit (PDU) based on: a logical channel of the first MAC CE having a higher priority than a logical channel of a second MAC CE, wherein the second MAC CE may correspond to a triggered buffer status report (BSR); and at least one uplink shared channel (UL-SCH) resource accommodating the first MAC CE; and sending (e.g., transmitting), via the at least one UL-SCH resource, the MAC PDU comprising the first MAC CE.

A wireless device may perform various operations. The wireless device may trigger an enhanced buffer status report (BSR) based on (e.g., in response to) arrival of a first uplink data, corresponding to one or more first logical channels, for sending (e.g., transmitting) the enhanced BSR via a first medium access control (MAC) control element (CE); multiplexing, to generate a MAC packet data unit (PDU), the first MAC CE in a MAC service data unit (SDU) based on: a logical channel of the first MAC CE having a higher priority than a logical channel of a second MAC CE, wherein the second MAC CE may correspond to a triggered buffer status report (BSR); and at least one uplink shared channel (UL-SCH) resource accommodating the first MAC CE; and sending (e.g., transmitting), via the at least one UL-SCH resource, the MAC PDU comprising the first MAC CE.

A wireless device may perform various operations. The wireless device may trigger an enhanced buffer status report (BSR) based on (e.g., in response to) arrival of a first uplink data, corresponding to one or more first logical channels, for sending (e.g., transmitting) the enhanced BSR via a first medium access control (MAC) control element (CE); multiplexing, to generate a MAC packet data unit (PDU), the first MAC CE in a MAC service data unit (SDU) before multiplexing a second MAC CE in the MAC SDU based on the first MAC CE having a higher priority than the second MAC CE, wherein the second MAC CE may be different than the first MAC CE; and sending (e.g., transmitting) the MAC PDU comprising the first MAC CE and the second MAC CE.

A wireless device may perform various operations. The wireless device may trigger an enhanced buffer status report (BSR) based on (e.g., in response to) arrival of a first uplink data, corresponding to one or more first logical channels, for sending (e.g., transmitting) the enhanced BSR via a first medium access control (MAC) control element (CE); and sending (e.g., transmitting) the MAC PDU comprising a second MAC CE based on a priority of a logical channel of the first MAC CE being lower than or equal to a priority of a logical channel of the second MAC CE, wherein the second MAC CE may be different than the first MAC CE.

A wireless device may perform various operations. The wireless device may trigger an enhanced buffer status report (BSR) based on (e.g., in response to) arrival of a first uplink data, corresponding to one or more first logical channels, for sending (e.g., transmitting) the enhanced BSR via a first medium access control (MAC) control element (CE); multiplexing a second MAC CE in a MAC packet data unit (PDU) based on: a logical channel of the first MAC CE having a lower priority than a logical channel of the second MAC CE, wherein the second MAC CE may correspond to a triggered buffer status report (BSR); and at least one uplink shared channel (UL-SCH) resource accommodating the second MAC CE; and sending (e.g., transmitting), via the at least one UL-SCH resource, the MAC PDU comprising the second MAC CE.

A wireless device may perform various operations. The wireless device may trigger an enhanced buffer status report (BSR) based on (e.g., in response to) arrival of a first uplink data, corresponding to one or more first logical channels, for sending (e.g., transmitting) the enhanced BSR via a first medium access control (MAC) control element (CE); multiplexing, to generate a MAC packet data unit (PDU), the second MAC CE in a MAC service data unit (SDU) based on: a logical channel of the first MAC CE having a lower priority than a logical channel of a second MAC CE, wherein the second MAC CE may correspond to a triggered buffer status report (BSR); and at least one uplink shared channel (UL-SCH) resource accommodating the second MAC CE; and sending (e.g., transmitting), via the at least one UL-SCH resource, the MAC PDU comprising the second MAC CE.

A wireless device may perform various operations. The wireless device may trigger an enhanced buffer status report (BSR) based on (e.g., in response to) arrival of a first uplink data, corresponding to one or more first logical channels, for sending (e.g., transmitting) the enhanced BSR via a first medium access control (MAC) control element (CE); multiplexing, to generate a MAC packet data unit (PDU), the first MAC CE in a MAC service data unit (SDU) after multiplexing a second MAC CE in the MAC SDU based on the first MAC CE having a higher priority than the second MAC CE, wherein the second MAC CE may be different than the first MAC CE; and sending (e.g., transmitting) the MAC PDU comprising the first MAC CE and the second MAC CE.

A wireless device may perform various operations. The wireless device may trigger an enhanced buffer status report (BSR) based on (e.g., in response to) arrival of a first uplink data, corresponding to one or more first logical channels, for sending (e.g., transmitting) the enhanced BSR via a first medium access control (MAC) control element (CE); triggering a buffer status report (BSR); multiplexing, to generate a MAC packet data unit (PDU), a second MAC CE in a MAC service data unit (SDU) based on the first MAC CE having a lower priority than the second MAC CE, wherein the second MAC CE may correspond to the triggered buffer status report (BSR); and sending (e.g., transmitting) the MAC PDU comprising the second MAC CE.

A wireless device may perform various operations. The wireless device may trigger a first buffer status report (BSR) based on (e.g., in response to) arrival of a first uplink data corresponding to one or more first logical channels; prioritizing the first BSR for a logical channel prioritization (LCP) procedure; and sending (e.g., transmitting), based on (e.g., in response to) the prioritizing the first BSR for the LCP procedure, a MAC PDU comprising at least one of a first MAC CE for the first BSR and a second MAC CE, wherein the sending (e.g., transmitting) may be based on prioritization of: a logical channel of the first MAC CE; and a logical channel of the second MAC CE, wherein the sending (e.g., transmitting) the MAC PDU may be via at least one uplink shared channel (UL-SCH) resource, wherein the prioritizing the first BSR for the LCP procedure may be based on at least one BSR prioritizing rule being satisfied, wherein the at least one BSR prioritizing rule being satisfied based on at least one of: data size volume of the first uplink data of the first BSR being based on a first BSR table, wherein the first BSR table may be different than Table 6.2.1-2 of 3GPP TR 38.321 or Table 6.2.1-2b of 3GPP TR 38.321; the first BSR may comprise delay information of the one or more first logical channels; data size volume of the first uplink data being larger than a threshold; the first uplink data comprising an End PDU of a PDU set; a delay budget/remaining time of a PDU of the PDU set being smaller than a threshold; or the at least one UL-SCH resources not accommodating the first BSR corresponding to the one or more logical channels, wherein the one or more logical channels may be prioritized, wherein the wireless device may determine whether the at least one BSR prioritizing rule may be satisfied or not based on a PDU set information of at least one PDU set, wherein the at least one PDU set may correspond to the first uplink data, wherein the wireless device may determine whether the at least one BSR prioritizing rule may be satisfied or not based on a PDU set related assistance information of at least one PDU set, wherein the PDU set related assistance information may comprise a PDU Set Integrated Indication (PSII) of a PDU set of the at least one PDU set, wherein the PSII of the PDU set may indicate whether all PDUs of the PDU set are needed for the usage of the PDU set by application layer or not, wherein: the at least one BSR prioritizing rule may be satisfied based on (e.g., in response to) the PSII of the PDU set indicating all PDUs of the PDU set may be needed for the usage of the PDU set by application layer; and the at least one BSR prioritizing rule may not be satisfied based on (e.g., in response to) the PSII of the PDU set indicating not all PDUs of the PDU set may be needed for the usage of the PDU set by application layer, wherein the PDU set related assistance information may comprise a PDU-Set Delay Budget (PSDB) of a PDU set of the at least one PDU set, wherein the at least one BSR prioritizing rule may be satisfied based on (e.g., in response to) the PSDB of the PDU set being smaller than a threshold, wherein the at least one BSR prioritizing rule may be satisfied based on (e.g., in response to) a delay budget of the at least one PDU set being smaller than a threshold, wherein the delay budget of the at least one PDU set may be at least one of: a minimum PSDB of PSDBs of the at least one PDU set; a maximum PSDB of PSDBs of the at least one PDU set; or an average PSDB of PSDBs of the at least one PDU set; wherein the first BSR may not comprise padding BSR; wherein the first uplink data may not comprise a side link (SL) data. The wireless device may further determine: a priority of the logical channel of the first MAC CE being greater than or equal to a priority of the logical channel of the second MAC CE; and the at least one UL-SCH resource accommodating the first MAC CE. The wireless device may further multiplex the first MAC CE in the MAC PDU before multiplexing the second MAC CE in the MAC PDU, wherein the MAC PDU may comprise the first MAC CE and the second MAC CE. The wireless device may further not multiplex the second MAC CE in the MAC PDU based on the at least one UL-SCH resource not accommodating the second MAC CE, wherein the MAC PDU may comprise the first MAC CE and may not comprise the second MAC CE. The wireless device may further determine: a priority of the logical channel of the first MAC CE being lower than or equal to a priority of the logical channel of the second MAC CE; and the at least one UL-SCH resource accommodating the second MAC CE. The wireless device may further multiplex the second MAC CE in the MAC PDU before multiplexing the first MAC CE in the MAC PDU, wherein the MAC PDU may comprise the first MAC CE and the second MAC CE. The wireless device may further not multiplex the first MAC CE in the MAC PDU based on the at least one UL-SCH resource not accommodating the first MAC CE, wherein the MAC PDU may comprise the second MAC CE and may not comprise the first MAC CE. The wireless device may further determine the first MAC CE having a higher priority that the first uplink data of the one or more logical channels, wherein the MAC PDU may not comprise the first pending data of the one or more logical channels, wherein the second MAC CE may be at least one of: a MAC CE for timing advance report (TAR); a MAC CE for a second buffer status report (BSR); a MAC CE for power headroom report (PHR); a MAC CE for positioning measurement gap activation/deactivation request; a MAC CE for a quantity (e.g., number) of desired guard symbols; or a MAC CE for case-6 timing request, wherein the second BSR may not comprise padding BSR, wherein the second BSR may be at least one of: an extended BSR; a Pre-emptive BSR; an extended Pre-emptive BSR; a side-link (SL)-BSR; wherein the SL-BSR may be prioritized for logical channel prioritization (LCP) procedure; wherein the SL-BSR may not be prioritized for LCP procedure; wherein the SL-BSR may not comprise padding SL-BSR; wherein the PHR may be at least one of: a single entry PHR; an enhanced single entry PHR; a multiple entry PHR; or an enhanced multiple entry PHR, wherein the second BSR may correspond to one or more second logical channels, wherein the one or more second logical channels may be different than the one or more logical channels. The wireless device may further determine the second BSR not being prioritized for the LCP procedure based on (e.g., in response to) at least one BSR prioritization rule not being satisfied. The wireless device may further send (e.g., transmit) a user equipment (UE)-capability message to a base station, wherein the UE-capability message may comprise a capability for prioritization of the first BSR. The wireless device may further receive one or more configuration parameters configuring a plurality of logical channels, wherein the plurality of logical channels may comprise the one or more logical channels, wherein the one or more configuration parameters may enable/configure the wireless device for prioritizing the first BSR corresponding to the one or more logical channels.

A wireless device may perform various operations. The wireless device may trigger a first buffer status report (BSR) based on (e.g., in response to) arrival of a first uplink data corresponding to one or more first logical channels; prioritizing the first BSR for a logical channel prioritization (LCP) procedure; and sending (e.g., transmitting), based on (e.g. in response to) the prioritizing the first BSR for the LCP procedure, a MAC PDU comprising at least one of the first MAC CE for the first BSR and a second MAC CE, wherein the sending (e.g., transmitting) may be based on a logical channel prioritization of the first MAC CE and a logical channel of the second MAC CE.

A wireless device may perform various operations. The wireless device may trigger a first buffer status report (BSR) based on (e.g., in response to) arrival of a first uplink data corresponding to one or more first logical channels; prioritizing the first BSR for a logical channel prioritization (LCP) procedure; and sending (e.g., transmitting), based on (e.g., in response to) the prioritizing the first BSR for the LCP procedure, the MAC PDU comprising the first MAC CE for the first BSR based on a priority of a logical channel of the first MAC CE being higher than or equal to a priority of a logical channel of a second MAC CE, wherein the second MAC CE may be different than the first MAC CE.

A wireless device may perform various operations. The wireless device may trigger a first buffer status report (BSR) based on (e.g., in response to) arrival of a first uplink data corresponding to one or more first logical channels; prioritizing the first BSR for a logical channel prioritization (LCP) procedure; multiplexing, based on (e.g., in response to) the prioritizing the first BSR for the LCP procedure, the first MAC CE for the first BSR in a MAC packet data unit (PDU) based on: a logical channel of the first MAC CE having a higher priority than a logical channel of a second MAC CE, wherein the second MAC CE may correspond to a triggered buffer status report (BSR); and at least one uplink shared channel (UL-SCH) resource accommodating the first MAC CE; and sending (e.g., transmitting), via the at least one UL-SCH resource, the MAC PDU comprising the first MAC CE.

A wireless device may perform various operations. The wireless device may trigger a first buffer status report (BSR) based on (e.g., in response to) arrival of a first uplink data corresponding to one or more first logical channels; prioritizing the first BSR for a logical channel prioritization (LCP) procedure; multiplexing, based on (e.g., in response to) the prioritizing the first BSR for the LCP procedure and to generate a MAC packet data unit (PDU), the first MAC CE for the first BSR in a MAC service data unit (SDU) before multiplexing a second MAC CE in the MAC SDU based on the first MAC CE having a higher priority than the second MAC CE, wherein the second MAC CE may be different than the first MAC CE; and sending (e.g., transmitting) the MAC PDU comprising the first MAC CE and the second MAC CE.

A wireless device may perform various operations. The wireless device may trigger a first buffer status report (BSR) based on (e.g., in response to) arrival of a first uplink data corresponding to one or more first logical channels; prioritizing the first BSR for a logical channel prioritization (LCP) procedure; and sending (e.g., transmitting), based on (e.g., (in response to) the prioritizing the first BSR for the LCP procedure, the MAC PDU comprising a second MAC CE based on a priority of a logical channel of the first MAC CE for the first BSR being lower than or equal to a priority of a logical channel of the second MAC CE, wherein the second MAC CE may be different than the first MAC CE.

A wireless device may perform a method comprising multiple operations. The wireless device may receive one or more radio resource control configuration parameters indicating: delay information for one or more logical channels; a threshold associated with the delay information and a reporting of the delay information; and may send, based on a remaining time associated with data for transmission satisfying the threshold, an indication of the delay information, wherein the sending the indication of the delay information comprises sending a medium access control (MAC) control element (CE) packet data unit (PDU) comprising a first MAC CE, and wherein the method further comprises: determining, for a delay reporting procedure, a first MAC CE comprising delay information associated with the one or more logical channels; multiplexing, in the MAC PDU, the first MAC CE based on: a first logical channel associated with the first MAC CE having a higher priority than a second logical channel associated with a second MAC CE associated with a triggered buffer status report (BSR); and at least one uplink shared channel (UL-SCH) resource accommodating the first MAC CE. The wireless device may determine the delay information based on a smallest remaining time of at least one packet of a logical channel group associated with the data for transmission, wherein the logical channel group comprises at least one logical channel of the one or more logical channels, wherein the indication comprises a first medium access control (MAC) control element (CE), and wherein a priority of a first logical channel of the first MAC CE is: greater than to a priority of a second logical channel of a MAC CE for buffer status report (BSR), wherein the BSR is a prioritized side link (SL)-BSR; and less than a priority of a third logical channel of a MAC CE for timing advance report (TAR), wherein: the indication comprises a first medium access control (MAC) control element (CE), and the first MAC CE comprises a buffer size corresponding to a first logical channel; the one or more radio resource control configuration parameters indicate a first buffer status report (BSR) table of a plurality of BSR tables for use by at least one logical channel, wherein the first BSR table allows a refined BSR compared to a second BSR table of the plurality of BSR tables; and the buffer size, corresponding to the first logical channel being in the at least one logical channel, is based on the first BSR table. The wireless device may send a capability message comprising at least one of: an indication of a capability to send delay information; an indication of a capability to trigger the delay reporting procedure; or an indication of a capability to determine a delay budget associated with the one or more logical channels, wherein the packet may be a packet data convergence protocol (PDCP) service data unit (SDU) or a radio link control (RLC) packet data unit (PDU). The wireless device may avoid multiplexing the first MAC CE in a MAC packet data unit (PDU) based on: a logical channel of the first MAC CE having a lower priority than a logical channel of a second MAC CE, wherein the second MAC CE may correspond to a triggered listen-before-talk (LBT) procedure; and at least one uplink shared channel (UL-SCH) resource accommodating the second MAC CE and not accommodating the first MAC CE; and sending, via the at least one UL-SCH resource, the MAC PDU comprising the second MAC CE, wherein the first MAC CE may further comprise a buffer size corresponding to a first logical channel; wherein the buffer size may be based on the first BSR table in response to the first logical channel being in the at least one logical channel. The wireless device may comprising send at least one user equipment (UE)-capability message indicating a capability for sending BSR based on the first BSR table, wherein the sending the first MAC CE may comprise triggering a scheduling request (SR); wherein the sending the MAC PDU may be via at least one uplink shared channel (UL-SCH) resource. The wireless device may determine: a priority of the logical channel of the first MAC CE being greater than or equal to a priority of the logical channel of the second MAC CE; and the at least one UL-SCH resource accommodating the first MAC CE. The wireless device may multiplex the first MAC CE in the MAC PDU before multiplexing the second MAC CE in the MAC PDU, wherein the MAC PDU comprises the first MAC CE and the second MAC CE. The wireless device may skip or avoid multiplexing the second MAC CE in the MAC PDU after multiplexing the first MAC CE in the MAC PDU based on the at least one UL-SCH the first MAC CE and does not comprise the second MAC CE. The wireless device may determine: a priority of the logical channel of the first MAC CE being lower than or equal to a priority of the logical channel of the second MAC CE; and the at least one UL-SCH resource accommodating the second MAC CE. The wireless device may multiplex the second MAC CE in the MAC PDU before multiplexing the first MAC CE in the MAC PDU. The wireless device may skip or avoid multiplexing the first MAC CE in the MAC PDU after multiplexing the second MAC CE in the MAC PDU based on the at least one UL-SCH resource not accommodating the first MAC CE, wherein the MAC PDU may not comprise the second MAC CE and may not comprise the first MAC CE. The wireless device may determine the one or more logical channels being with a first pending data. The wireless device may determine the first MAC CE having a higher priority that the first pending data of the one or more logical channels, wherein the MAC SDU may not comprise the first pending data of the one or more logical channels; wherein the second MAC CE may be at least one of: a MAC CE for listen-before-talk (LBT) failure; a MAC CE for timing advance report (TAR); a MAC CE for buffer status report (BSR); a MAC CE for power headroom report (PHR); a MAC CE for positioning measurement gap activation/deactivation request; a MAC CE for a number of desired guard symbols; or a MAC CE for case-6 timing request; wherein the BSR may not comprise/include a padding BSR; wherein the SL-BSR may be prioritized for a logical channel prioritization (LCP) procedure; wherein the SL-BSR may not prioritized for an LCP procedure; wherein the SL-BSR may not comprise a padding SL-BSR; wherein the PHR may be at least one of: a single entry PHR; an enhanced single entry PHR; a multiple entry PHR; or an enhanced multiple entry PHR; wherein the BSR may correspond to one or more second logical channels, wherein the one or more second logical channels may be different than the one or more logical channels; wherein the BSR may correspond to the one or more logical channels; wherein the triggering the delay reporting may be after/in response to the BSR being triggered. The wireless device may determine the triggered BSR not being canceled. The wireless device may cancel the triggered delay reporting based on the triggered BSR being cancelled. The wireless device may cancel the triggered delay reporting based on the sending the MAC PDU comprising the first MAC CE, wherein the first pending data comprises one or more PDUs; wherein the one or more PDUs may belong to a PDU Set; wherein the one or more PDUs may belong to at least one PDU Set; wherein a PDU of the one or more PDUs may be an End PDU of a PDU Set; wherein the first MAC CE may comprise/indicate one or more first values, wherein each value of the one or more first values may indicate a remaining time or delay budget of a PDU of the one or more PDUs; wherein the first MAC CE comprises or indicates at least of: a minimum remaining time of the one or more PDUs, maximum remaining time of the one or more PDUs, average remaining time of the one or more PDUs, a minimum delay budget of the one or more PDUs, maximum delay budget of the one or more PDUs, or average delay budget of the one or more PDUs; wherein the one or more configuration parameters may enable/configure the wireless device for transmitting the first MAC CE. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may perform a method comprising multiple operations. The wireless device may determine for a delay reporting procedure, a first medium access control (MAC) control element (CE) comprising delay information associated with one or more logical channels. The wireless device may multiplex, in a MAC packet data unit (PDU), the first MAC CE based on: a first logical channel associated with the first MAC CE having a higher priority than a second logical channel associated with a second MAC CE, wherein the second MAC CE may be associated with a triggered buffer status report (BSR); and at least one uplink shared channel (UL-SCH) resource accommodating the first MAC CE. The wireless device may send, via the at least one UL-SCH resource, the MAC PDU comprising the first MAC CE. The wireless device may receive one or more radio resource control configuration parameters indicating: delay information for the one or more logical channels; a threshold associated with the delay information; and a reporting of the delay information; and wherein the sending the MAC PDU comprising the first MAC CE may be based on a remaining time, associated with data for transmission, satisfying the threshold; and wherein the first MAC CE may further comprise an indication of the delay information. The wireless device may send a capability message comprising at least one of: an indication of a capability to transmit delay information; an indication of a capability to trigger the delay reporting procedure; or an indication of a capability to determine a delay budget associated with the one or more logical channels. The wireless device may receive one or more configuration parameters that configure a plurality of logical channels comprising the one or more logical channels. The wireless device may receive one or more configuration parameters that configure the wireless device to trigger the delay reporting procedure for the one or more logical channels, wherein the MAC PDU may comprise the first MAC CE and the second MAC CE. The wireless device may trigger, based on the BSR being triggered, the delay reporting procedure, wherein the BSR may be at least one of: an extended BSR; a pre-emptive BSR; an extended pre-emptive BSR; or a side-link (SL) BSR; wherein the delay information may comprise at least one or more indications of: a remaining time associated with one or more PDUs or one or more PDU sets; a minimum remaining time associated with one or more PDUs or one or more PDU sets; a maximum remaining time associated with one or more PDUs or one or more PDU sets; an average remaining time associated with one or more PDUs or one or more PDU sets; a delay budget associated with one or more PDUs or one or more PDU sets; a minimum delay budget associated with one or more PDUs or one or more PDU sets; a maximum delay budget associated with one or more PDUs or one or more PDU sets; or an average delay budget associated with one or more PDUs or one or more PDU sets, wherein the packet may be a packet data convergence protocol (PDCP) service data unit (SDU) or a radio link control (RLC) packet data unit (PDU). The wireless device may avoid multiplexing the first MAC CE in a MAC packet data unit (PDU) based on: a logical channel of the first MAC CE having a lower priority than a logical channel of a second MAC CE, wherein the second MAC CE may correspond to a triggered listen-before-talk (LBT) procedure; and at least one uplink shared channel (UL-SCH) resource accommodating the second MAC CE and not accommodating the first MAC CE; and sending, via the at least one UL-SCH resource, the MAC PDU comprising the second MAC CE, wherein the first MAC CE may further comprise a buffer size corresponding to a first logical channel; wherein the buffer size may be based on the first BSR table in response to the first logical channel being in the at least one logical channel. The wireless device may comprising send at least one user equipment (UE)-capability message indicating a capability for sending BSR based on the first BSR table, wherein the sending the first MAC CE may comprise triggering a scheduling request (SR); wherein the sending the MAC PDU may be via at least one uplink shared channel (UL-SCH) resource. The wireless device may determine: a priority of the logical channel of the first MAC CE being greater than or equal to a priority of the logical channel of the second MAC CE; and the at least one UL-SCH resource accommodating the first MAC CE. The wireless device may multiplex the first MAC CE in the MAC PDU before multiplexing the second MAC CE in the MAC PDU, wherein the MAC PDU comprises the first MAC CE and the second MAC CE. The wireless device may skip or avoid multiplexing the second MAC CE in the MAC PDU after multiplexing the first MAC CE in the MAC PDU based on the at least one UL-SCH resource not accommodating the second MAC CE, wherein the MAC PDU may comprise the first MAC CE and does not comprise the second MAC CE. The wireless device may determine: a priority of the logical channel of the first MAC CE being lower than or equal to a priority of the logical channel of the second MAC CE; and the at least one UL-SCH resource accommodating the second MAC CE. The wireless device may multiplex the second MAC CE in the MAC PDU before multiplexing the first MAC CE in the MAC PDU. The wireless device may skip or avoid multiplexing the first MAC CE in the MAC PDU after multiplexing the second MAC CE in the MAC PDU based on the at least one UL-SCH resource not accommodating the first MAC CE, wherein the MAC PDU may not comprise the second MAC CE and may not comprise the first MAC CE. The wireless device may determine the one or more logical channels being with a first pending data. The wireless device may determine the first MAC CE having a higher priority that the first pending data of the one or more logical channels, wherein the MAC SDU may not comprise the first pending data of the one or more logical channels; wherein the second MAC CE may be at least one of: a MAC CE for listen-before-talk (LBT) failure; a MAC CE for timing advance report (TAR); a MAC CE for buffer status report (BSR); a MAC CE for power headroom report (PHR); a MAC CE for positioning measurement gap activation/deactivation request; a MAC CE for a number of desired guard symbols; or a MAC CE for case-6 timing request; wherein the BSR may not comprise/include a padding BSR; wherein the SL-BSR may be prioritized for a logical channel prioritization (LCP) procedure; wherein the SL-BSR may not prioritized for an LCP procedure; wherein the SL-BSR may not comprise a padding SL-BSR; wherein the PHR may be at least one of: a single entry PHR; an enhanced single entry PHR; a multiple entry PHR; or an enhanced multiple entry PHR; wherein the BSR may correspond to one or more second logical channels, wherein the one or more second logical channels may be different than the one or more logical channels; wherein the BSR may correspond to the one or more logical channels; wherein the triggering the delay reporting may be after/in response to the BSR being triggered. The wireless device may determine the triggered BSR not being canceled. The wireless device may cancel the triggered delay reporting based on the triggered BSR being cancelled. The wireless device may cancel the triggered delay reporting based on the sending the MAC PDU comprising the first MAC CE, wherein the first pending data comprises one or more PDUs; wherein the one or more PDUs may belong to a PDU Set; wherein the one or more PDUs may belong to at least one PDU Set; wherein a PDU of the one or more PDUs may be an End PDU of a PDU Set; wherein the first MAC CE may comprise/indicate one or more first values, wherein each value of the one or more first values may indicate a remaining time or delay budget of a PDU of the one or more PDUs; wherein the first MAC CE comprises or indicates at least of: a minimum remaining time of the one or more PDUs, maximum remaining time of the one or more PDUs, average remaining time of the one or more PDUs, a minimum delay budget of the one or more PDUs, maximum delay budget of the one or more PDUs, or average delay budget of the one or more PDUs; wherein the one or more configuration parameters may enable/configure the wireless device for transmitting the first MAC CE. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may perform a method comprising multiple operations. The wireless device may trigger a delay reporting procedure; may determine, for the delay reporting procedure, a first medium access control (MAC) control element (CE) comprising delay information associated with one or more logical channels; may multiplex, in a MAC packet data unit, the first MAC CE, wherein the multiplexing may be based on: a first priority of a first logical channel associated with the first MAC CE; and a second priority of a second logical channel associated with a second MAC CE, the first MAC CE; may send, via at least one uplink shared channel (UL-SCH) resource accommodating the first MAC CE, the MAC PDU comprising the first MAC CE. The wireless device may send a capability message comprising at least one of: an indication of a capability to transmit delay information; an indication of a capability to trigger the delay reporting procedure; or an indication of a capability to determine a delay budget associated with the one or more logical channels. The wireless device may receive one or more configuration parameters that configure: a plurality of logical channels comprising the one or more logical channels; and the wireless device to trigger the delay reporting procedure for the one or more logical channels. The wireless device may determine that pending data may be associated with the one or more logical channels, wherein the delay information may comprise at least one or more indications of: a remaining time associated with one or more PDUs or one or more PDU sets; or a delay budget associated with one or more PDUs or one or more PDU sets, wherein the packet may be a packet data convergence protocol (PDCP) service data unit (SDU) or a radio link control (RLC) packet data unit (PDU). The wireless device may avoid multiplexing the first MAC CE in a MAC packet data unit (PDU) based on: a logical channel of the first MAC CE having a lower priority than a logical channel of a second MAC CE, wherein the second MAC CE may correspond to a triggered listen-before-talk (LBT) procedure; and at least one uplink shared channel (UL-SCH) resource accommodating the second MAC CE and not accommodating the first MAC CE; and sending, via the at least one UL-SCH resource, the MAC PDU comprising the second MAC CE, wherein the first MAC CE may further comprise a buffer size corresponding to a first logical channel; wherein the buffer size may be based on the first BSR table in response to the first logical channel being in the at least one logical channel. The wireless device may comprising send at least one user equipment (UE)-capability message indicating a capability for sending BSR based on the first BSR table, wherein the sending the first MAC CE may comprise triggering a scheduling request (SR); wherein the sending the MAC PDU may be via at least one uplink shared channel (UL-SCH) resource. The wireless device may determine: a priority of the logical channel of the first MAC CE being greater than or equal to a priority of the logical channel of the second MAC CE; and the at least one UL-SCH resource accommodating the first MAC CE. The wireless device may multiplex the first MAC CE in the MAC PDU before multiplexing the second MAC CE in the MAC PDU, wherein the MAC PDU comprises the first MAC CE and the second MAC CE. The wireless device may skip or avoid multiplexing the second MAC CE in the MAC PDU after multiplexing the first MAC CE in the MAC PDU based on the at least one UL-SCH the first MAC CE and does not comprise the second MAC CE. The wireless device may determine: a priority of the logical channel of the first MAC CE being lower than or equal to a priority of the logical channel of the second MAC CE; and the at least one UL-SCH resource accommodating the second MAC CE. The wireless device may multiplex the second MAC CE in the MAC PDU before multiplexing the first MAC CE in the MAC PDU. The wireless device may skip or avoid multiplexing the first MAC CE in the MAC PDU after multiplexing the second MAC CE in the MAC PDU based on the at least one UL-SCH resource not accommodating the first MAC CE, wherein the MAC PDU may not comprise the second MAC CE and may not comprise the first MAC CE. The wireless device may determine the one or more logical channels being with a first pending data. The wireless device may determine the first MAC CE having a higher priority that the first pending data of the one or more logical channels, wherein the MAC SDU may not comprise the first pending data of the one or more logical channels; wherein the second MAC CE may be at least one of: a MAC CE for listen-before-talk (LBT) failure; a MAC CE for timing advance report (TAR); a MAC CE for buffer status report (BSR); a MAC CE for power headroom report (PHR); a MAC CE for positioning measurement gap activation/deactivation request; a MAC CE for a number of desired guard symbols; or a MAC CE for case-6 timing request; wherein the BSR may not comprise/include a padding BSR; wherein the SL-BSR may be prioritized for a logical channel prioritization (LCP) procedure; wherein the SL-BSR may not prioritized for an LCP procedure; wherein the SL-BSR may not comprise a padding SL-BSR; wherein the PHR may be at least one of: a single entry PHR; an enhanced single entry PHR; a multiple entry PHR; or an enhanced multiple entry PHR; wherein the BSR may correspond to one or more second logical channels, wherein the one or more second logical channels may be different than the one or more logical channels; wherein the BSR may correspond to the one or more logical channels; wherein the triggering the delay reporting may be after/in response to the BSR being triggered. The wireless device may determine the triggered BSR not being canceled. The wireless device may cancel the triggered delay reporting based on the triggered BSR being cancelled. The wireless device may cancel the triggered delay reporting based on the sending the MAC PDU comprising the first MAC CE, wherein the first pending data comprises one or more PDUs; wherein the one or more PDUs may belong to a PDU Set; wherein the one or more PDUs may belong to at least one PDU Set; wherein a PDU of the one or more PDUs may be an End PDU of a PDU Set; wherein the first MAC CE may comprise/indicate one or more first values, wherein each value of the one or more first values may indicate a remaining time or delay budget of a PDU of the one or more PDUs; wherein the first MAC CE comprises or indicates at least of: a minimum remaining time of the one or more PDUs, maximum remaining time of the one or more PDUs, average remaining time of the one or more PDUs, a minimum delay budget of the one or more PDUs, maximum delay budget of the one or more PDUs, or average delay budget of the one or more PDUs; wherein the one or more configuration parameters may enable/configure the wireless device for transmitting the first MAC CE. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may perform a method comprising multiple operations. The wireless device may trigger a delay reporting procedure for transmitting delay information, corresponding to one or more logical channels, in a first medium access control (MAC) control element (CE); may multiplex the first MAC CE in a MAC packet data unit (PDU) based on: a logical channel of the first MAC CE having a higher priority than a logical channel of a second MAC CE, wherein the second MAC CE may correspond to a triggered buffer status report (BSR); and at least one uplink shared channel (UL-SCH) resource accommodating the first MAC CE; may send, via the at least one UL-SCH resource, the MAC PDU comprising the first MAC CE, wherein the packet may be a packet data convergence protocol (PDCP) service data unit (SDU) or a radio link control (RLC) packet data unit (PDU). The wireless device may avoid multiplexing the first MAC CE in a MAC packet data unit (PDU) based on: a logical channel of the first MAC CE having a lower priority than a logical channel of a second MAC CE, wherein the second MAC CE may correspond to a triggered listen-before-talk (LBT) procedure; and at least one uplink shared channel (UL-SCH) resource accommodating the second MAC CE and not accommodating the first MAC CE; and sending, via the at least one UL-SCH resource, the MAC PDU comprising the second MAC CE, wherein the first MAC CE may further comprise a buffer size corresponding to a first logical channel; wherein the buffer size may be based on the first BSR table in response to the first logical channel being in the at least one logical channel. The wireless device may comprising send at least one user equipment (UE)-capability message indicating a capability for sending BSR based on the first BSR table, wherein the sending the first MAC CE may comprise triggering a scheduling request (SR); wherein the sending the MAC PDU may be via at least one uplink shared channel (UL-SCH) resource. The wireless device may determine: a priority of the logical channel of the first MAC CE being greater than or equal to a priority of the logical channel of the second MAC CE; and the at least one UL-SCH resource accommodating the first MAC CE. The wireless device may multiplex the first MAC CE in the MAC PDU before multiplexing the second MAC CE in the MAC PDU, wherein the MAC PDU comprises the first MAC CE and the second MAC CE. The wireless device may skip or avoid multiplexing the second MAC CE in the MAC PDU after multiplexing the first MAC CE in the MAC PDU based on the at least one UL-SCH resource not accommodating the second MAC CE, wherein the MAC PDU may comprise the first MAC CE and does not comprise the second MAC CE. The wireless device may determine: a priority of the logical channel of the first MAC CE being lower than or equal to a priority of the logical channel of the second MAC CE; and the at least one UL-SCH resource accommodating the second MAC CE. The wireless device may multiplex the second MAC CE in the MAC PDU before multiplexing the first MAC CE in the MAC PDU. The wireless device may skip or avoid multiplexing the first MAC CE in the MAC PDU after multiplexing the second MAC CE in the MAC PDU based on the at least one UL-SCH resource not accommodating the first MAC CE, wherein the MAC PDU may not comprise the second MAC CE and may not comprise the first MAC CE. The wireless device may determine the one or more logical channels being with a first pending data. The wireless device may determine the first MAC CE having a higher priority that the first pending data of the one or more logical channels, wherein the MAC SDU may not comprise the first pending data of the one or more logical channels; wherein the second MAC CE may be at least one of: a MAC CE for listen-before-talk (LBT) failure; a MAC CE for timing advance report (TAR); a MAC CE for buffer status report (BSR); a MAC CE for power headroom report (PHR); a MAC CE for positioning measurement gap activation/deactivation request; a MAC CE for a number of desired guard symbols; or a MAC CE for case-6 timing request; wherein the BSR may not comprise/include a padding BSR; wherein the SL-BSR may be prioritized for a logical channel prioritization (LCP) procedure; wherein the SL-BSR may not prioritized for an LCP procedure; wherein the SL-BSR may not comprise a padding SL-BSR; wherein the PHR may be at least one of: a single entry PHR; an enhanced single entry PHR; a multiple entry PHR; or an enhanced multiple entry PHR; wherein the BSR may correspond to one or more second logical channels, wherein the one or more second logical channels may be different than the one or more logical channels; wherein the BSR may correspond to the one or more logical channels; wherein the triggering the delay reporting may be after/in response to the BSR being triggered. The wireless device may determine the triggered BSR not being canceled. The wireless device may cancel the triggered delay reporting based on the triggered BSR being cancelled. The wireless device may cancel the triggered delay reporting based on the sending the MAC PDU comprising the first MAC CE, wherein the first pending data comprises one or more PDUs; wherein the one or more PDUs may belong to a PDU Set; wherein the one or more PDUs may belong to at least one PDU Set; wherein a PDU of the one or more PDUs may be an End PDU of a PDU Set; wherein the first MAC CE may comprise/indicate one or more first values, wherein each value of the one or more first values may indicate a remaining time or delay budget of a PDU of the one or more PDUs; wherein the first MAC CE comprises or indicates at least of: a minimum remaining time of the one or more PDUs, maximum remaining time of the one or more PDUs, average remaining time of the one or more PDUs, a minimum delay budget of the one or more PDUs, maximum delay budget of the one or more PDUs, or average delay budget of the one or more PDUs; wherein the one or more configuration parameters may enable/configure the wireless device for transmitting the first MAC CE. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein.

A non-transitory tangible computer readable media may comprise instructions executable by one or more processors configured to cause operations of multi-carrier communications described herein. An article of manufacture may comprise a non-transitory tangible computer readable machine-accessible medium having instructions encoded thereon for enabling programmable hardware to cause a device (e.g., a wireless device, wireless communicator, a wireless device, a base station, and the like) to allow operation of multi-carrier communications described herein. The device, or one or more devices such as in a system, may include one or more processors, memory, interfaces, and/or the like. Other examples may comprise communication networks comprising devices such as base stations, wireless devices or user equipment (wireless device), servers, switches, antennas, and/or the like. A network may comprise any wireless technology, including but not limited to, cellular, wireless, WiFi, 4G, 5G, 6G, any generation of 3GPP or other cellular standard or recommendation, any non-3GPP network, wireless local area networks, wireless personal area networks, wireless ad hoc networks, wireless metropolitan area networks, wireless wide area networks, global area networks, satellite networks, space networks, and any other network using wireless communications. Any device (e.g., a wireless device, a base station, or any other device) or combination of devices may be used to perform any combination of one or more of steps described herein, including, for example, any complementary step or steps of one or more of the above steps.

Although examples are described herein, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
receiving, by a wireless device, one or more radio resource control configuration parameters indicating:
delay information for one or more logical channels; and
a threshold associated with the delay information; and
sending, based on a remaining time associated with data for transmission satisfying the threshold, an indication of the delay information.

2. The method of claim 1, wherein the sending the indication of the delay information comprises sending a medium access control (MAC) control element (CE) packet data unit (PDU) comprising a first MAC CE, and wherein the method further comprises:
determining, for a delay reporting procedure, a first MAC CE comprising delay information associated with the one or more logical channels;
multiplexing, in the MAC PDU, the first MAC CE based on:
a first logical channel associated with the first MAC CE having a higher priority than a second logical channel associated with a second MAC CE associated with a triggered buffer status report (BSR); and
at least one uplink shared channel (UL-SCH) resource accommodating the first MAC CE.

3. The method of claim 1, further comprising determining the delay information based on a smallest remaining time of at least one packet of a logical channel group associated with the data for transmission, wherein the logical channel group comprises at least one logical channel of the one or more logical channels,
wherein the remaining time satisfying the threshold comprises the remaining time being less than the threshold.

4. The method of claim 1, wherein the indication comprises a first medium access control (MAC) control element (CE), and wherein a priority of a first logical channel of the first MAC CE is:
greater than to a priority of a second logical channel of a MAC CE for buffer status report (BSR), wherein the BSR is a prioritized side link (SL)-BSR; and
less than a priority of a third logical channel of a MAC CE for timing advance report (TAR).

5. The method of claim 1, wherein:
the indication comprises a first medium access control (MAC) control element (CE), and the first MAC CE comprises a buffer size corresponding to a first logical channel;
the one or more radio resource control configuration parameters indicate a first buffer status report (BSR) table of a plurality of BSR tables for use by at least one logical channel, wherein the first BSR table allows a refined BSR compared to a second BSR table of the plurality of BSR tables; and
the buffer size, corresponding to the first logical channel being in the at least one logical channel, is based on the first BSR table.

6. The method of claim 1, further comprising sending a capability message comprising at least one of:
an indication of a capability to send delay information;
an indication of a capability to trigger the delay reporting procedure; or
an indication of a capability to determine a delay budget associated with the one or more logical channels.

7. A method comprising:
determining, by a wireless device and for a delay reporting procedure, a first medium access control (MAC) control element (CE) comprising delay information associated with one or more logical channels;
multiplexing, in a MAC packet data unit (PDU), the first MAC CE based on:
a first logical channel associated with the first MAC CE having a higher priority than a second logical channel associated with a second MAC CE, wherein the second MAC CE is associated with a triggered buffer status report (BSR); and
at least one uplink shared channel (UL-SCH) resource accommodating the first MAC CE; and
sending, via the at least one UL-SCH resource, the MAC PDU comprising the first MAC CE.

8. The method of claim 7, further comprising:
receiving, by the wireless device, one or more radio resource control configuration parameters indicating:
delay information for one or more logical channels; and
a threshold associated with the delay information; and
wherein the sending the MAC PDU comprising the first MAC CE is based on a remaining time, associated with data for transmission, satisfying the threshold; and
wherein the first MAC CE further comprises an indication of the delay information.

9. The method of claim 7, further comprising sending a capability message comprising at least one of:
an indication of a capability to transmit delay information;
an indication of a capability to trigger the delay reporting procedure; or
an indication of a capability to determine a delay budget associated with the one or more logical channels.

10. The method of claim 7, further comprising receiving one or more configuration parameters that configure a plurality of logical channels comprising the one or more logical channels.

11. The method of claim 7, further comprising receiving one or more configuration parameters that configure the wireless device to trigger the delay reporting procedure for the one or more logical channels.

12. The method of claim 7, wherein the MAC PDU comprises the first MAC CE and the second MAC CE.

13. The method of claim 7, further comprising triggering, based on the BSR being triggered, the delay reporting procedure.

14. The method of claim 7, wherein the BSR is at least one of:
an extended BSR;
a pre-emptive BSR;
an extended pre-emptive BSR; or
a side-link (SL) BSR.

15. The method of claim 7, wherein the delay information comprises at least one or more indications of:
a remaining time associated with one or more PDUs or one or more PDU sets;
a minimum remaining time associated with one or more PDUs or one or more PDU sets;
a maximum remaining time associated with one or more PDUs or one or more PDU sets;
an average remaining time associated with one or more PDUs or one or more PDU sets;
a delay budget associated with one or more PDUs or one or more PDU sets;
a minimum delay budget associated with one or more PDUs or one or more PDU sets;
a maximum delay budget associated with one or more PDUs or one or more PDU sets; or
an average delay budget associated with one or more PDUs or one or more PDU sets.

16. A method comprising:
triggering, by a wireless device, a delay reporting procedure;
determining, for the delay reporting procedure, a first medium access control (MAC) control element (CE) comprising delay information associated with one or more logical channels;
multiplexing, in a MAC packet data unit, the first MAC CE, wherein the multiplexing is based on:
a first priority of a first logical channel associated with the first MAC CE; and
a second priority of a second logical channel associated with a second MAC CE, the first MAC CE; and
sending, via at least one uplink shared channel (UL-SCH) resource accommodating the first MAC CE, the MAC PDU comprising the first MAC CE.

17. The method of claim 16, further comprising transmitting a capability message comprising at least one of:
an indication of a capability to transmit delay information;
an indication of a capability to trigger the delay reporting procedure; or
an indication of a capability to determine a delay budget associated with the one or more logical channels.

18. The method of claim 16, further comprising receiving one or more configuration parameters that configure:
a plurality of logical channels comprising the one or more logical channels; and
the wireless device to trigger the delay reporting procedure for the one or more logical channels.

19. The method of claim 16, further comprising determining that pending data is associated with the one or more logical channels.

20. The method of claim 16, wherein the delay information comprises at least one or more indications of:
a remaining time associated with one or more PDUs or one or more PDU sets; or
a delay budget associated with one or more PDUs or one or more PDU sets.
